(19) United States
(12) Patent Application Publication
(10) Pub. No.: US 2007/0109940 A1
(43) Pub. Date: May 17, 2007

(54) INFORMATION STORAGE MEDIUM, INFORMATION RECORDING METHOD,AND INFORMATION REPRODUCING METHOD

(76) Inventors: Hideo Ando, Hino-shi (JP); Yutaka Kashihara, Chigasaki-shi (JP); Akihito Ogawa, Kawasaki-shi (JP); Hideki Takahashi, Kashiwa-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/564,186

(22) Filed: Nov. 28, 2006

Related U.S. Application Data
(63) Continuation of application No. 11/369,096, filed on Mar. 7, 2006.
Application No. 11/369,096 is a continuation of application No. PCT/JP05/13677, filed on Jul. 20, 2005.

(30) Foreign Application Priority Data
Jul. 20, 2004 (JP) JP2004/212346

(51) Int. Cl. G11B 20/12

(52) U.S. Cl. 369/59.25; 369/275.3

(57) ABSTRACT

According to one embodiment, there is provided an information storage medium in which an error checking and correction block is formed of recording frames including data identifier information, the error checking and correction block is divided into sub-blocks, the same recording frame is distributed over sub-blocks, and each of data identifier in an even-numbered recording frame and data identifier in an odd-numbered recording frame are distributed in a different sub-block.

### CROSS-REFERENCE TO RELATED APPLICATIONS

This is a Continuation Application of PCT Application No. PCT/JP2005/013677, filed Jul. 20, 2005, which was published under PCT Article 21(2) in English.

This application is based upon and claims the benefit of priority from Japanese Patent Application No. 2004-212346, filed Jul. 20, 2004, the entire contents of which are incorporated herein by reference.

### BACKGROUND

1. Field

One embodiment of the invention relates to an information storage medium (or information recording medium); and an information recording method and an information reproducing method using the medium.

2. Description of the Related Art

Such an information storage medium includes an optical disk known as DVD (digital versatile disk). The existing DVD standards include the read-only DVD-ROM standard, recordable DVD-R standard, (about 1000 times) rewritable DVD-RW standard, (more than 10000 times) rewritable DVD-RAM standard.

An ECC (error checking and correction) block in an existing DVD has a single product code structure (see Japanese Patent Publication No. 3071828).

In recent years, various methods of achieving a higher recording density on such an optical disk have been proposed. Since an increase in the recording density increases the line density, use of the ECC block structure in the current DVD standards as it is makes an allowable burst length of error shorter than that in the existing DVD. This causes the problem of making optical disks less sensible to dust and flaws.

In the recordable DVD standards, intermediate information (recording location management information) during the interruption of recording is recorded inside the lead-in area (see Japanese Patent No. 2621459). Each time recording interruption takes place, intermediate information must be additionally recorded. As the recording density is increased and the amount of recorded data becomes much larger, the number of interruptions of recording increases and therefore the amount of intermediate information also increases. Since the recording data and intermediate data are stored in separate special areas, taking into account the convenience of editing the recording data, even if there is an available space in the recording area of recording data, recording cannot be done, because an increase in the frequency of occurrences of recording interruption causes the recording place of intermediate information located inside the lead-in area to get saturated and therefore the recording place of intermediate information disappears. As a result, the current DVD standards limit the maximum number of interruptions of recording permitted to a single optical disk (information storage medium), which causes the problem of impairing the convenience of the user.

Since an ECC block in a conventional information storage medium has a single product code structure, making the recording density higher shortens the allowable burst length of error, which causes the problem of making the storage medium less sensible to dust and flaws.

Furthermore, in a recordable information storage medium, the maximum number of interruptions of recording is limited, which causes the problem of decreasing the user's convenience.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an explanatory diagram illustrating the configuration of an embodiment of an information recording and reproducing apparatus of the present invention;

FIG. 2 shows a detailed configuration of the peripheral part including the synchronizing code position extracting unit 145 of FIG. 1;

FIG. 3 shows a signal processing circuit using a slice level detecting method;

FIG. 4 shows a detailed configuration of the slicer 310 of FIG. 3;

FIG. 5 shows a signal processing circuit using a PRML detecting method;

FIG. 6 shows the configuration of the Viterbi decoder 156 of FIG. 1 or 5;

FIG. 7 shows state transition in PR (1, 2, 2, 2, 1) class;

FIG. 8 is a flowchart to help explain a method of creating a “next border representing mark NBM” in an overwriting process;

FIG. 9 shows the configuration and dimensions of an information storage medium in the embodiment;

FIG. 10 shows a method of setting physical sector numbers in a recordable information storage medium or a read-only information storage medium with a single layer structure;

FIG. 11 shows a method of setting physical sector numbers in a dual-layer read-only information storage medium;

FIGS. 12A and 12B show a method of setting physical sector numbers in a rewritable information storage medium;

FIG. 13 shows the values of general parameters in a read-only information storage medium;

FIG. 14 shows the values of general parameters in a recordable information storage medium

FIG. 15 shows the values of general parameters in a rewritable information storage medium;

FIG. 16 is a diagram showing a comparison of a detailed data structure in the system lead-in area SYLDI and the data lead-in area DTLDI between various information storage media;

FIG. 17 shows a data structure in the RMD duplication zone RDZ and the recording location management zone in a recordable information storage medium;

FIGS. 18A and 18B are a diagram showing a comparison of a data structure in the data area DTA and the data lead-out area DTLDO between various information storage media;

FIG. 19 shows a waveform (write strategy) of recording pulses performing test recording into the drive test zone;

FIG. 20 is a diagram illustrating a definition of recording pulse shape;

FIG. 21 is an explanatory diagram illustrating the configuration of the border area in the recordable information storage medium;

FIG. 22 shows a data structure in the control data zone CDZ and the R physical information zone RIZ;

FIGS. 23A and 23B show concretely the contents of information in the physical format information PFI and the R physical format information R_PFI;

FIG. 24 is a diagram showing a comparison between the contents of detailed information recorded in the arranging location information in the data area DTA;

FIG. 25 shows a detailed data structure of the recording management data RMD;

FIG. 26 shows a detailed data structure of the recording management data RMD;

FIG. 27 shows a detailed data structure of the recording management data RMD;

FIG. 28 shows a detailed data structure of the recording management data RMD;

FIG. 29 shows a detailed data structure of the recording management data RMD;

FIG. 30 shows a detailed data structure of the recording management data RMD;

FIG. 31 schematically shows the conversion procedure as far as configuring a physical sector structure;

FIG. 32 shows the structure of a data frame;

FIG. 33 shows initial values given to the shift register when a frame is created after scrambling and a circuit configuration of the feedback shift register;

FIG. 34 is an explanatory diagram illustrating an ECC block structure;

FIG. 35 is a diagram to help explain a frame arrangement after scrambling;

FIG. 36 is a diagram to help explain a PO interleaving method;

FIG. 37 is a diagram to help explain the structure of a physical sector;

FIG. 38 is a diagram to help explain the contents of a synchronizing code pattern;

FIG. 39 shows the configuration of a modulation block;

FIG. 40 is a diagram to help explain a concatenation rule for code words;

FIG. 41 shows a concatenation of a code word and a sync code;

FIG. 42 is a diagram to help explain a separation rule for reproducing a code word;

FIG. 43 shows a conversion table in the modulation method of the present invention;

FIG. 44 shows a conversion table in the modulation method of the present invention;

FIG. 45 shows a conversion table in the modulation method of the present invention;

FIG. 46 shows a conversion table in the modulation method of the present invention;

FIG. 47 shows a conversion table in the modulation method of the present invention;

FIG. 48 shows a conversion table in the modulation method of the present invention;

FIG. 49 shows a demodulation table in the modulation method of the present invention;

FIG. 50 shows a demodulation table in the modulation method of the present invention;

FIG. 51 shows a demodulation table in the modulation method of the present invention;

FIG. 52 shows a demodulation table in the modulation method of the present invention;

FIG. 53 shows a demodulation table in the modulation method of the present invention;

FIG. 54 shows a demodulation table in the modulation method of the present invention;

FIG. 55 shows a demodulation table in the modulation method of the present invention;

FIG. 56 shows a demodulation table in the modulation method of the present invention;

FIG. 57 shows a demodulation table in the modulation method of the present invention;

FIG. 58 shows a demodulation table in the modulation method of the present invention;

FIG. 59 is a diagram to help explain a reference code pattern;

FIG. 60 is a diagram to help explain a data unit of recording data on an information storage medium;

FIG. 61 shows a comparison between the data recording formats of various information storage media;

FIG. 62 is an explanatory diagram illustrating a comparison between the data structure of each type of information storage medium and that of a conventional equivalent;

FIG. 63 is an explanatory diagram illustrating a comparison between the data structure of each type of information storage medium and that of a conventional equivalent;

FIG. 64 is a diagram to help explain 180° phase modulation and NRZ techniques in wobble modulation;

FIG. 65 is a diagram to help explain the relationship between a wobble shape and address bits in the address bit area;

FIG. 66 is a diagram illustrating a comparison between a wobble arrangement and recording locations in a recordable information storage medium and those in a rewritable information storage medium;

FIG. 67 is a diagram to help explain a comparison between a wobble arrangement and recording locations in a recordable information storage medium and those in a rewritable information storage medium;

FIG. 68 is a diagram to help explain an address defining method in each of a recordable information storage medium and a rewritable information storage medium;

FIG. 69 is a diagram to help explain the recording format of address information in wobble modulation on a rewritable information storage medium;

FIG. 70 shows the Gray code;

FIG. 71 shows an algorithm that realizes the Gray code conversion concretely;

FIG. 72 is a diagram to help explain an example of forming an uncertain bit area in a groove area;

FIG. 73 shows the arrangement locations of modulation areas on a recordable information storage medium;

FIG. 74 shows an arrangement in a wobble data unit related to a primary arrangement location and a secondary arrangement location in a modulation area;

FIG. 75 is a diagram to help explain a comparison between a wobble sync pattern and the positional relationship in a wobble data unit;

FIG. 76 shows a modulation area arrangement location in a physical segment on a recordable information storage medium;

FIG. 77 is a diagram illustrating a comparison between the data structure in wobble address information on a rewritable information storage medium and that on a recordable information storage medium;

FIG. 78 shows the relationship between a method of combining a wobble sync pattern and type identify information on physical segments and an arrangement pattern of modulation areas;

FIG. 79 shows the layout of a recording cluster;

FIG. 80 shows a data recording method for rewritable data recorded on a rewritable information storage medium;

FIG. 81 is a diagram to help explain a data random shift of rewritable data recorded on a rewritable information storage medium;

FIG. 82 is a diagram to help explain a recording method for additional recording onto a recordable information storage medium;

FIG. 83 shows an optical reflectance range of each of a High-to-Low recording film and a Low-to-High recording film;

FIG. 84 shows a detailed structure of an ECC block after PO interleaving of FIG. 36;

FIG. 85 shows a data structure of recording management data RMD;

FIG. 86 shows another embodiment different from FIG. 21 related to the structure of the border area in a recordable information storage medium;

FIG. 87 is a diagram illustrating a comparison between the present embodiment and an existing DVD-R;

FIG. 88 is a diagram to help explain physical format information;

FIG. 89 is a diagram to help explain the basic concept of recording management data RMD;

FIG. 90 is a flowchart for the processing procedure immediately after an information storage medium is installed in an information reproducing apparatus or an information recording and reproducing apparatus;

FIG. 91 is a flowchart to help explain a method of recording additional information onto a recordable information storage medium in an information recording and reproducing apparatus;

FIG. 92 is a diagram to help explain the concept of a method of setting an extendable recording location management zone RMZ;

FIG. 93 is a detailed diagram of FIG. 92;

FIG. 94 is a diagram to help explain a border zone;

FIG. 95 is a diagram to help explain the process of closing a second and later bordered areas in the information recording and reproducing apparatus;

FIG. 96 is a diagram to help explain a processing method when an end process (or a finalizing process) is carried out after the bordered area is closed temporarily in the information recording and reproducing apparatus;

FIG. 97 is a diagram to help explain the principle of an extended recording location management zone EX.RMZ recorded in a border-in area;

FIG. 98 is a diagram to help explain an R zone;

FIG. 99 is a diagram to help explain the concept of a method of recording additional information in a plurality of places simultaneously using R zones;

FIG. 100 shows the relationship between a method of setting R zones and recording management data RMD in the information recording and reproducing apparatus;

FIG. 101 shows a correlation between an R zone and recording management data RMD when the first bordered area is closed;

FIG. 102 is a diagram to help explain the procedure for an end process (or a finalizing process) in the information recording and reproducing apparatus;

FIG. 103 is a diagram to help explain the principle of setting an extended recording location management zone EX.RMZ using R zones;

FIG. 104 shows the relationship between a new setting of an extended recording location management zone using R zones and recording management data RMD;

FIG. 105 is a diagram to help explain the concept of a processing method when the existing recording location management zone RMZ is filled to capacity in the same bordered area;

FIG. 106 is a diagram to help explain the concept of the extension of a test zone;

FIG. 107 is a diagram to help explain the concept of the extension of a test zone;

FIG. 108 is a diagram to help explain a method of retrieving a recording location in the latest recording management data RMD using RMD duplication zone RDZ in the information reproducing apparatus or the information recording and reproducing apparatus;

FIG. 109 shows a detailed configuration of the wobble signal detector 135 in the information recording and reproducing apparatus;

FIG. 110 is a signal waveform diagram to help explain the operation of the wobble signal detector 135 in the information recording and reproducing apparatus;

FIG. 111 is a signal waveform diagram to help explain the principle of the operation of the phase locked loop circuit 356;

FIG. 112 is a circuit diagram to help explain the principle of the operation a beat canceller included in the phase detector 358;

FIG. 113 shows recording condition parameters expressed as a function of mark length/preceding space length;

FIG. 114 is a diagram to help explain the reflectivity in an unrecorded location and that in a recorded location in each type of recording film;

FIG. 115 is a diagram illustrating a comparison between the reflectivity in each area in one type of recording film with that in another;

FIG. 116 shows the size of a border zone BRDZ;

FIG. 117 shows the size of a terminator;

FIG. 118 shows a data structure of data ID;

FIG. 119 is a diagram to help explain a method of setting various data lead-out areas after a finalizing process;

FIG. 120 is a diagram to help explain a method of setting various data lead-out areas after a finalizing process;

FIG. 121 is a diagram to help explain another embodiment of a data structure of recording management data RMD;

FIGS. 122A and 122B show a diagram to help explain another embodiment of a data structure of recording management data RMD;

FIGS. 123A and 123B show another data structure of RMD field 1;

FIG. 124 is a diagram to help explain another embodiment of a data structure of wobble address information in a recordable information storage medium; and

FIGS. 125A, 125B, 125C, 125D, 125E, 125F, 125G, 125H, 125I, 125J, 125K, 125L, 125M, 125N, 125O, 125P, 125Q, and 125R show a table listing points and effects related to the present embodiment.

### DETAILED DESCRIPTION

Various embodiments according to the invention will be described hereinafter with reference to the accompanying drawings. In general, according to one embodiment of the invention, there is provided an information storage medium in which an error checking and correction block is formed of recording frames including data identifier information, the error checking and correction block is divided into sub-blocks, the same recording frame is distributed over sub-blocks, and each of data identifier in an even-numbered recording frame and data identifier in an odd-numbered recording frame are distributed in a different sub-block.

According to another embodiment of the present invention, there is provided an information recording method using an information storage medium in which an error checking and correction block is formed of recording frames including data identifier information, and the error checking and correction block is divided into sub-blocks, the information recording method comprising distributing the same recording frame over sub-blocks; and distributing each of data identifier in an even-numbered recording frame and data identifier in an odd-numbered recording frame in a different sub-block.

According to another embodiment of the present invention, there is provided an information reproducing method using an information storage medium in which an error checking and correction block is formed of recording frames including data identifier information, the error checking and correction block is divided into sub-blocks, the same recording frame is distributed over the sub-blocks, and each of data identifier in an even-numbered recording frame and data identifier in an odd-numbered recording frame are distributed in a different sub-block, the information reproducing method comprising reproducing the error checking and correction block and carrying out an error correcting process.

According to another embodiment of the present invention, there is provided an information storage medium comprising a data area in which an extendable recording management data area can be set; and a lead-in area.

According to another embodiment of the present invention, there is provided an information recording method using an information storage medium which has a data area in which an extendable recording management data area can be set and a lead-in area, the information recording method comprising setting a new recording management data area in the data area when a free space of a currently set recording management area has decreased to a specific value or less.

According to another embodiment of the present invention, there is provided an information reproducing method using an information storage medium which has a data area in which an extendable recording management data area can be set and a lead-in area, the information reproducing method comprising sequentially searching for recording management data areas and reproducing recording management data which is most recently recorded.

Hereinafter, referring to the accompanying drawings, embodiments of an information storage medium, an information recording method, and an information reproducing method according to the present invention will be explained.

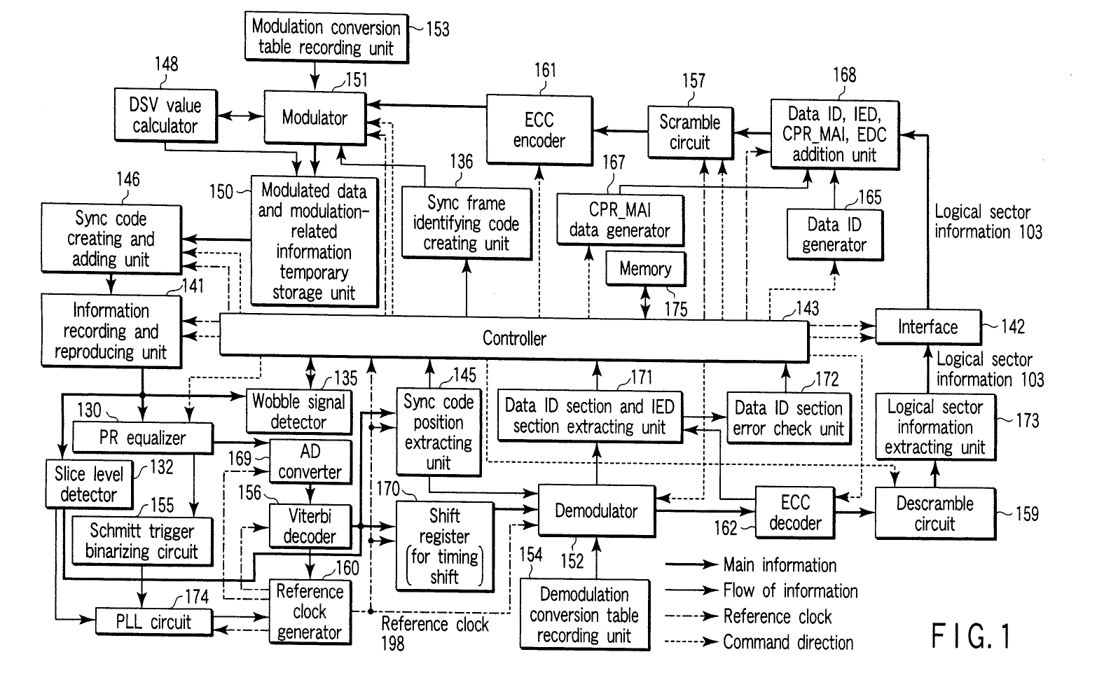

FIG. 1 is an explanatory diagram illustrating the configuration of an embodiment of an information recording and reproducing apparatus. In FIG. 1, the part above a controller 143 represents mainly an information recording control system for an information storage medium. In FIG. 1, an embodiment of an information reproducing apparatus corresponds to the part excluding the information recording control system. In FIG. 1, a thick solid-line arrow represents the flow of main information meaning a reproduction signal or a recording signal, a thin sold-line arrow the flow of information, a single-dot-dash line arrow a reference clock line, a thin broken line arrow the direction of command destination.

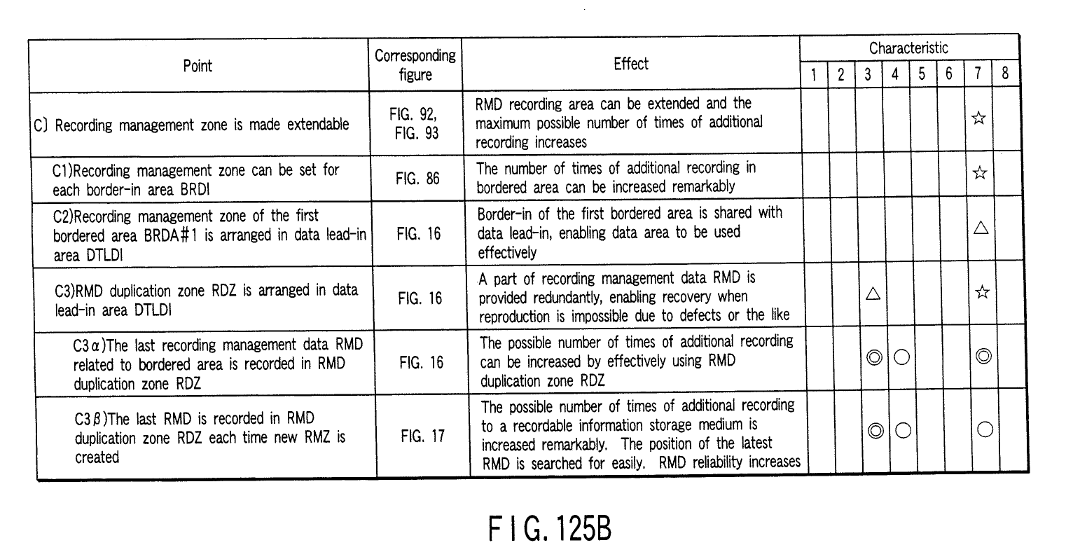

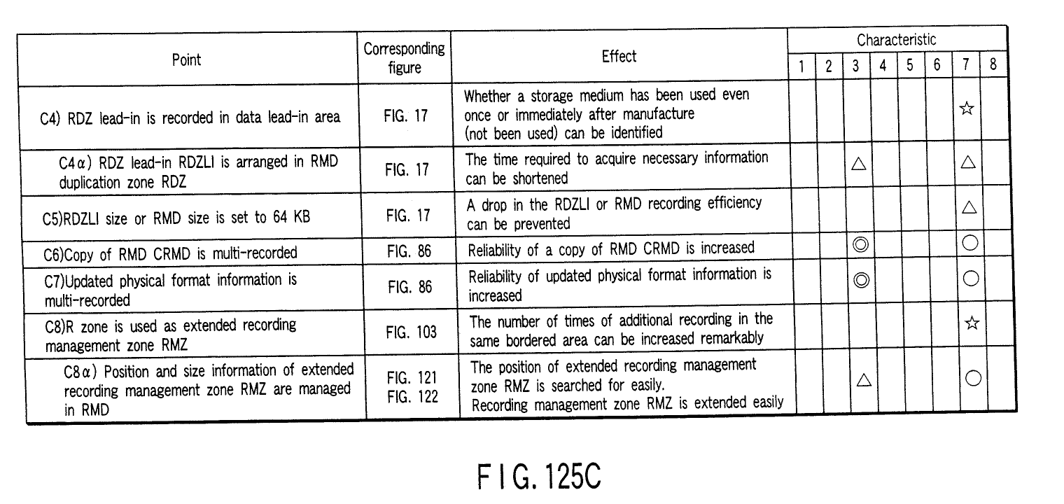

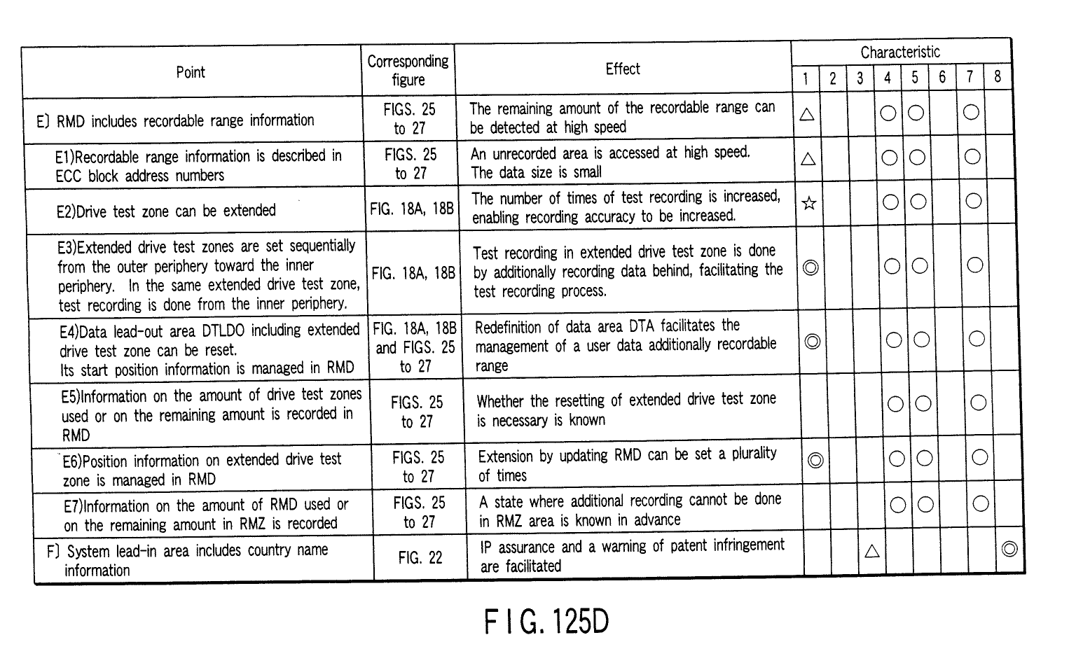

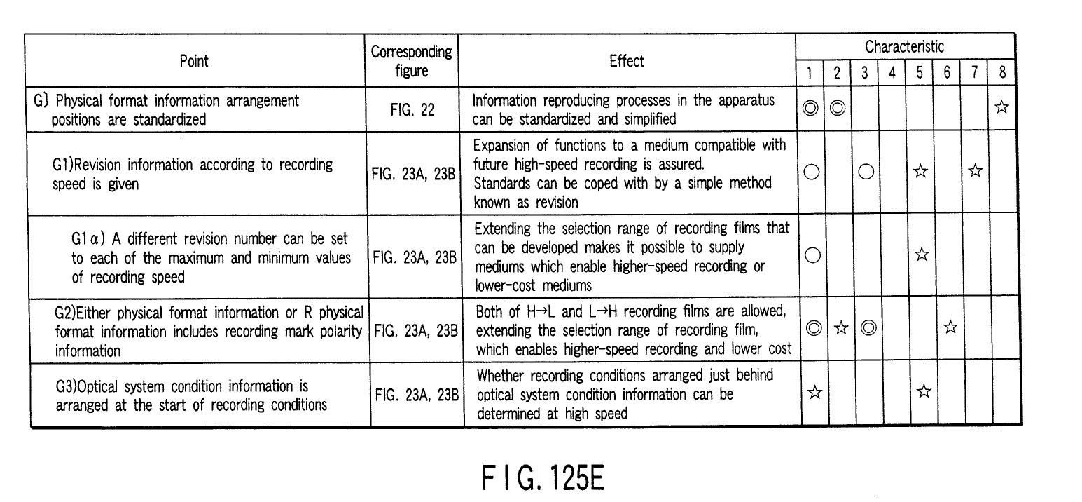

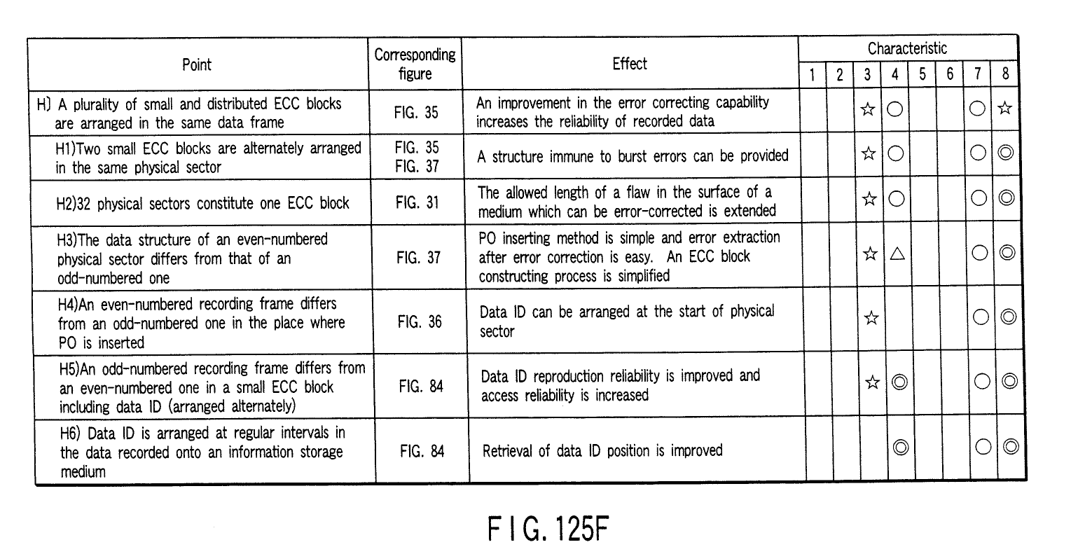

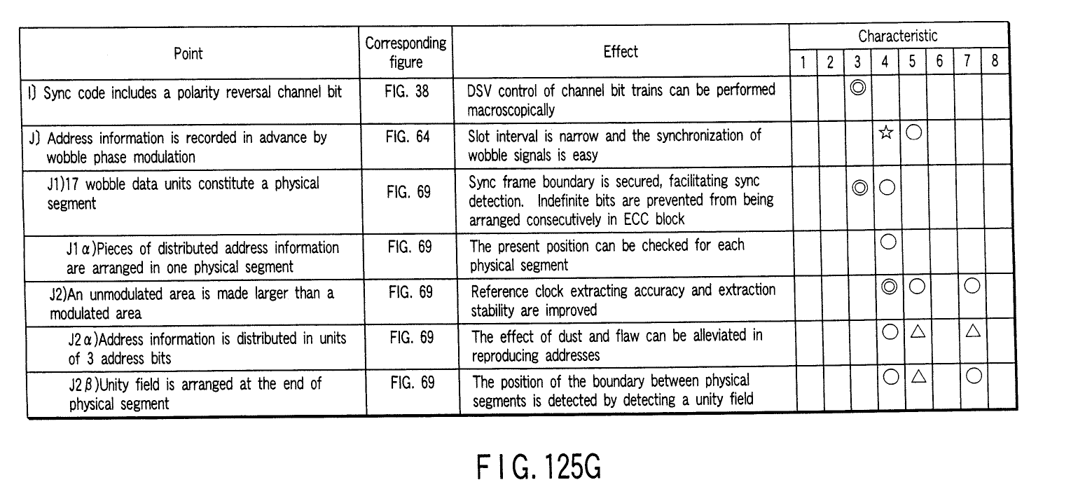

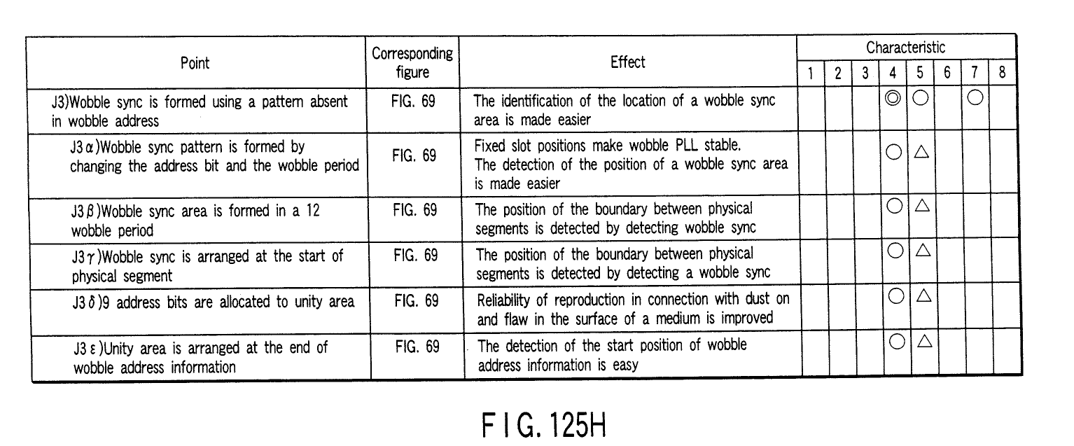

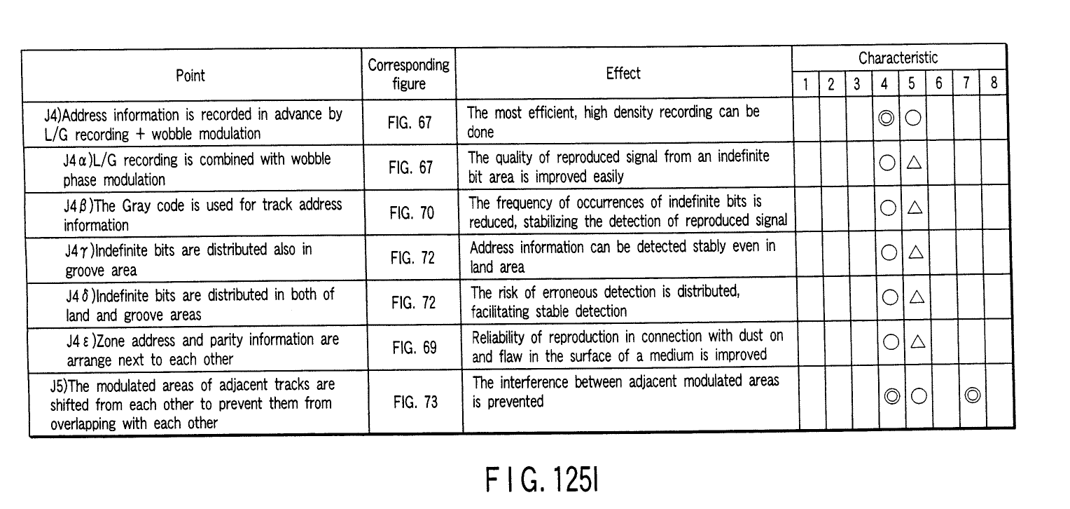

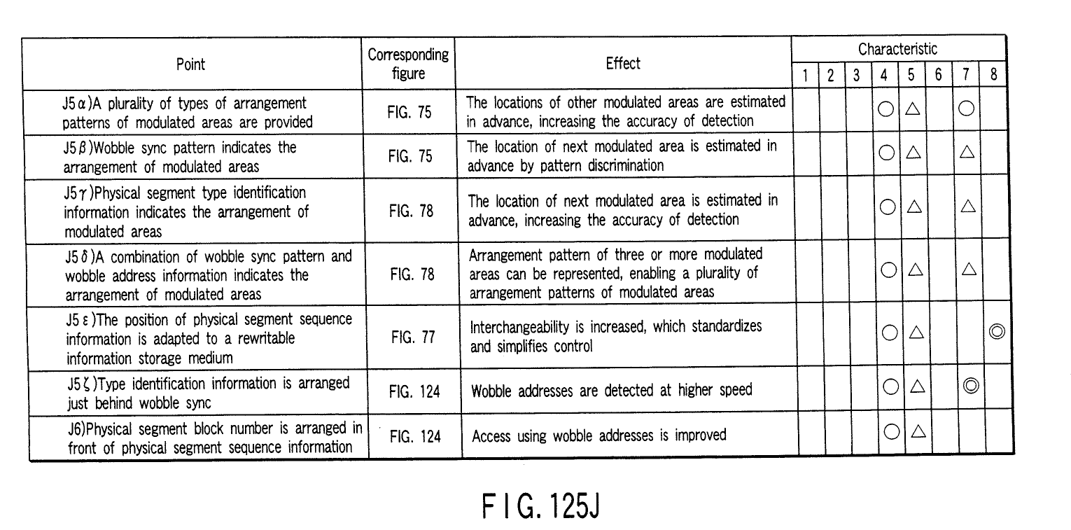

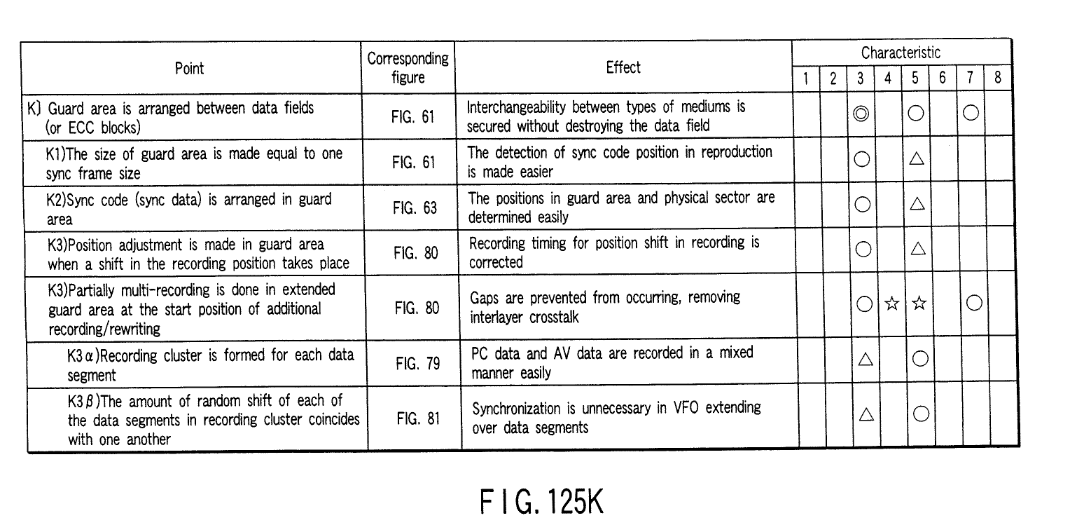

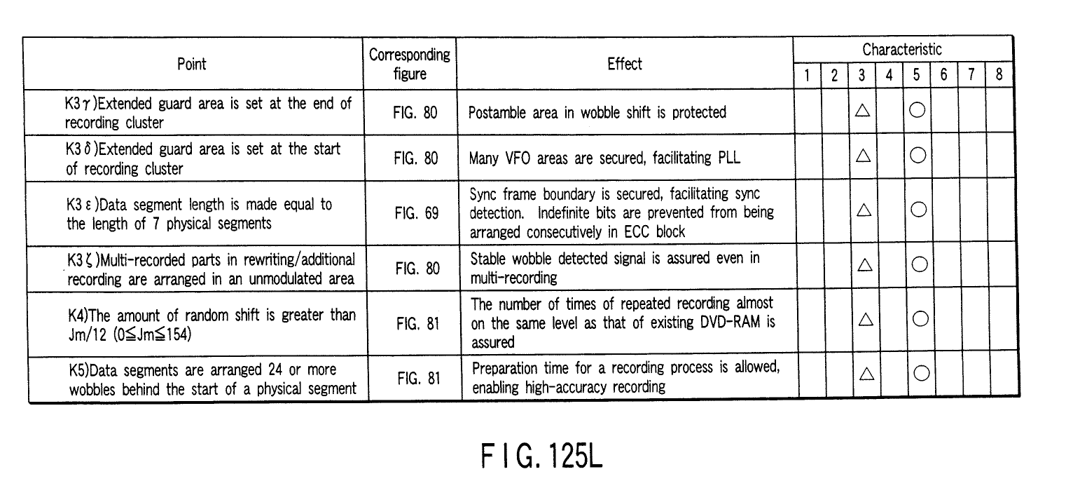

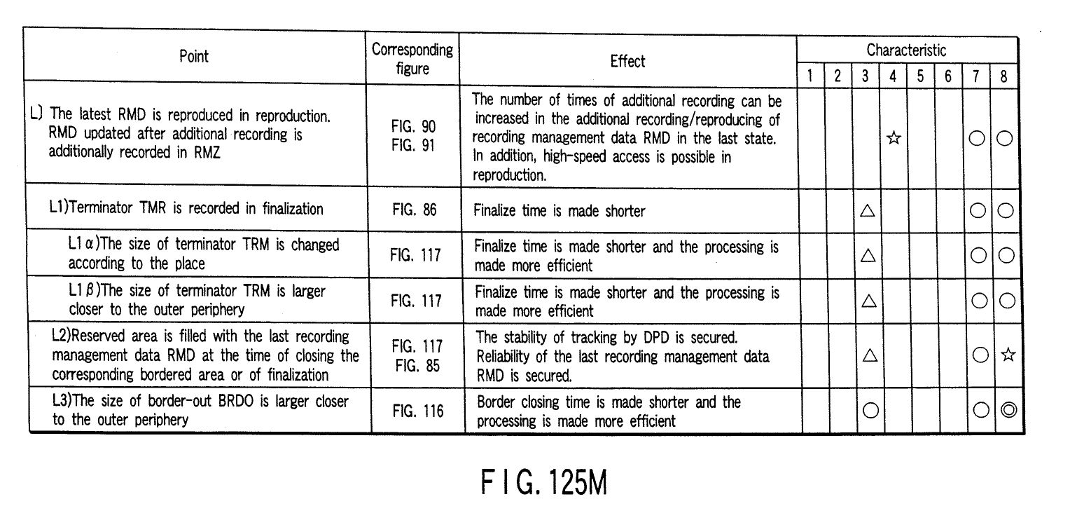

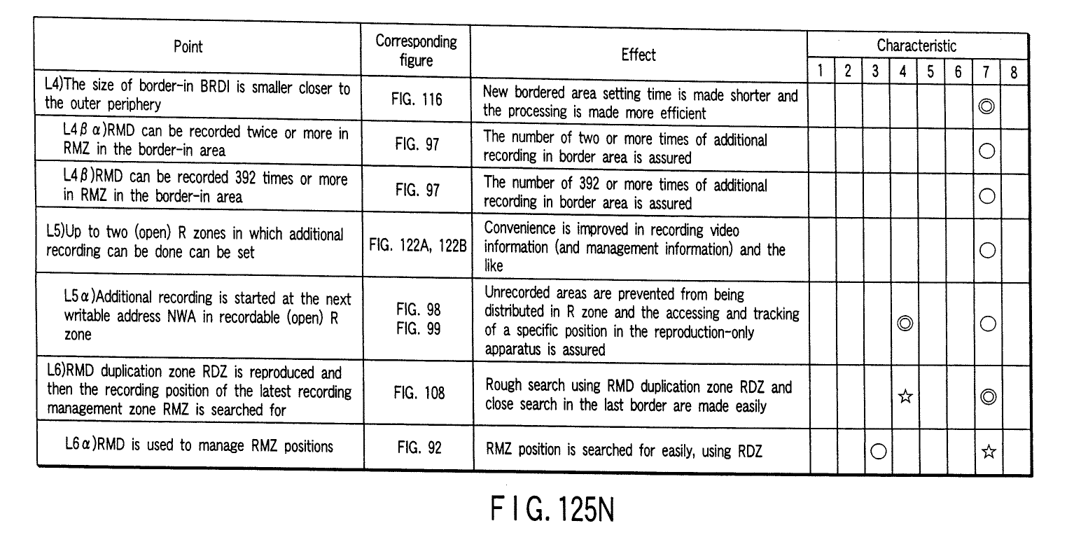

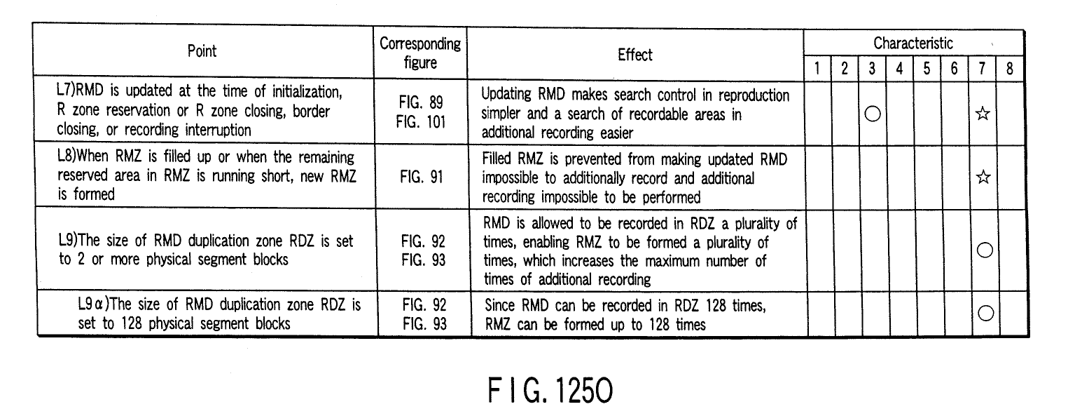

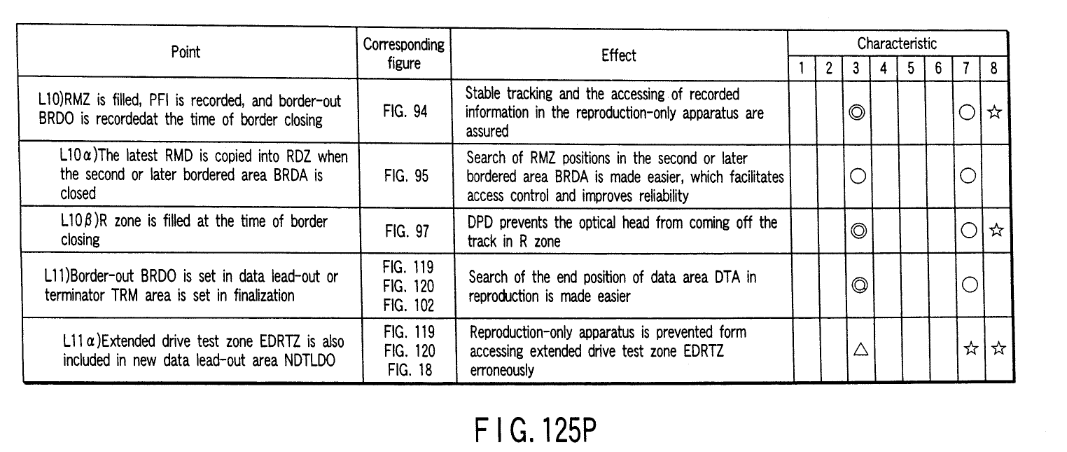

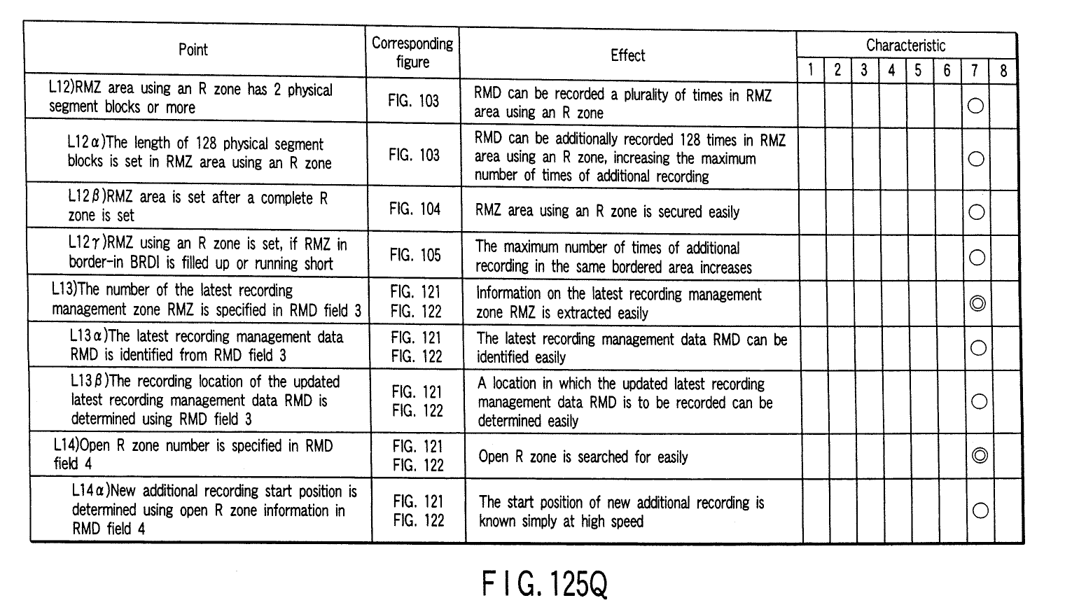

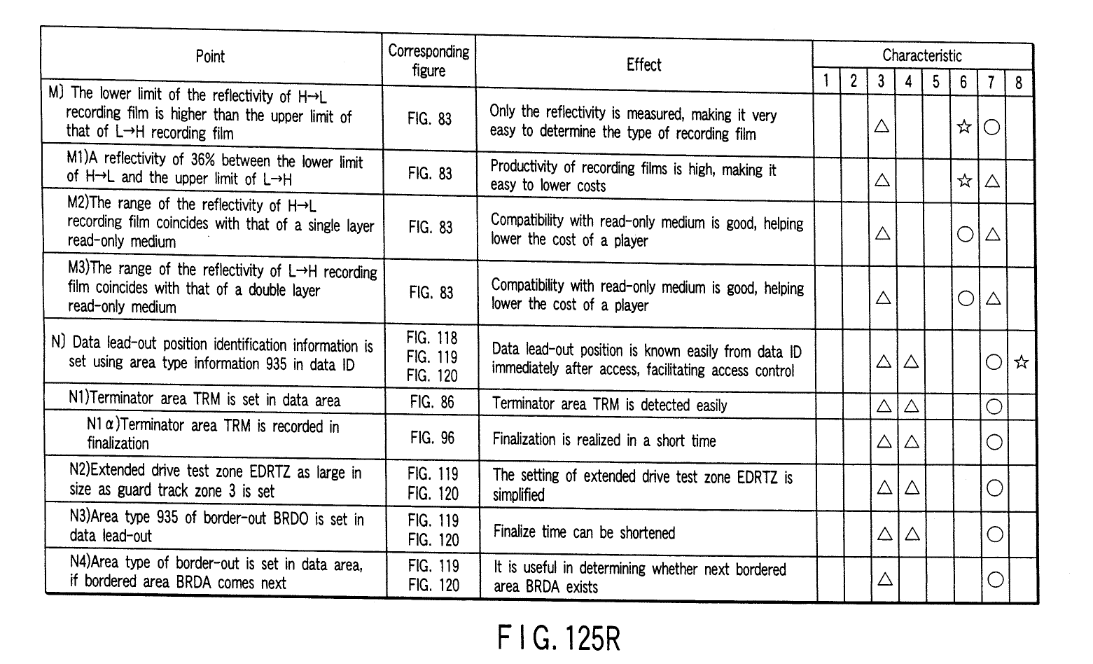

In FIG. 1, an optical head (not shown) is provided in an information recording and reproducing unit 141. In the embodiment, information is reproduced using PRML (Partial Response Maximum Likelihood) techniques, thereby achieving a higher recording density of an information storage medium (point [A] in FIG. 125A). Since the results of various experiments have shown that use of PR (1, 2, 2, 2, 1) as a PR class enables not only the line density to be increased but also the reliability of the reproduction signal (e.g., the reliability of demodulation when a servo correction error, such as blurring or track shift, occurs) to be improved, PR (1, 2, 2, 2, 1) is used in this embodiment (point (A1) in FIG. 125A). In the embodiment, the modulated channel bit train is recorded onto an information storage medium according to the (d, k; m, n) modulation rule (meaning RLL (d, k) in the m/n modulation in the above-described writing method). Specifically, ETM (Eight to Twelve Modulation) that converts 8-bit data into 12-channel bits (where m=8 and n=12) is used as a modulation method. As run length limited (RLL) restrictions placed on the length of consecutive “0s” in the modulated channel bit train, RLL (1, 10) conditions with the minimum value of the number of consecutive “0s” being d=1 and the maximum value being k=10 are applied. In the embodiment, the channel bit interval is shortened close to its limit, aiming at making the recording density of the information storage medium higher. As a result, for example, when the pattern “101010101010101010101010”, the repetition of a pattern with d=1, is recorded onto an information storage medium and the data is reproduced at the information recording and reproducing unit 141, the amplitude of the reproduced raw signal is almost buried in noise, since the frequency of the reproduction signal approaches the cut-off frequency of the MTF characteristic of the reproducing optical system. Therefore, PRML (Partial Response Maximum Likelihood) techniques are used as a method of reproducing recording marks or bits whose density has been improved to the limit (cut-off frequency) of the MTF characteristic.

Specifically, the signal reproduced at the information recording and reproducing unit 141 is subjected to reproduction waveform correction at a PR equalizer 130. With the timing of a reference clock 198 sent from a reference clock generator 160, an AD converter 169 samples the signal passed through the PR equalizer 130 and converts the signal into digital signal, followed by a Viterbi decoding process at a Viterbi decoder 156. The data after the Viterbi decoding process is treated as identical data with that binarized at a conventional slice level. When PRML techniques are used, a shift in the sampling timing at the AD converter 169 increases the error rate of data after Viterbi decoding. Thus, to increase the accuracy of sampling timing, the information reproducing apparatus or the information recording and reproducing apparatus particularly has a separate sampling timing extracting circuit (a combination of a Schmitt trigger binarizing circuit 155 and a PLL circuit 174).

The Schmitt trigger binarizing circuit 155 has a specific range of slice reference level for binarization (actually the voltage value in the forward direction of the diode). Only when the specific range is exceeded, the binarizing circuit 155 binarizes the signal. Therefore, for example, if the pattern “101010101010101010101010” has been input as described above, the signal amplitude is so small that binarization is not performed. If a rougher pattern, for example, “1001001001001001001001” has been input, since the amplitude of the reproduced raw signal becomes larger, the switching between the polarities of a binarized signal is performed with the “1” timing at the Schmitt trigger binarizing circuit 155. In this embodiment, NRZI (Non-Return to Zero Invert) techniques are used and the position of “1” in the pattern coincides with the recording mark or the periphery (boundary part) of the pit.

The PLL circuit 174 detects the difference in frequency and phase between the binarized signal output from the Schmitt trigger binarizing circuit 155 and the reference clock signal 198 sent from the reference clock generator 160 and changes the frequency and phase of the output clock of the PLL circuit 174. Using the output signal of the PLL circuit 174 and decoding characteristic information on the Viterbi decoder 156 (although not shown concretely, information on the convergence length (the distance to convergence) in the pathmetric memory in the Viterbi decoder 156), the reference clock generator 160 applies feedback to (the frequency and phase of) the reference clock 198 so that the error rate after Viterbi decoding may be decreased. The reference clock 198 generated at the reference lock generator 160 is used as reference timing in processing a reproduction signal.

A synchronizing code position extracting unit 145 detects the positions of synchronizing codes (sync codes) mixed in the output data string of the Viterbi decoder 156 and extracts the starting position of the output data. With the starting position as a reference, a demodulation circuit 152 demodulates the data temporarily stored in a shift register 170. In the embodiment, the original bit train is reproduced by referring to a conversion table recorded in a demodulation conversion table recording unit 154 for every 12 channel bits. Thereafter, an ECC decoder 162 carries out an error correction process. Then, a descramble circuit 159 performs descrambling. In a recording-type (rewritable or recordable) information storage medium of the embodiment, address information has been recorded beforehand by wobble modulation. A wobble signal detector 135 reproduces the address information (that is, determines the contents of the wobble signal) and supplies information necessary to access a desired location to the controller 143.

The information recording control system above the controller 143 will be explained. A data ID generator 165 creates data ID information according to the recording location on the information storage medium. When a CPR_MAI data generator 167 creates copy control information, a data ID, IED, CPR_MAI, EDC adding unit 168 adds various pieces of information, including data ID, IED, CPR_MAI, and EDC to the information to be recorded. Thereafter, a descramble circuit 157 performs descrambling. Then, after an ECC encoder 161 constructs an ECC block and a modulator 151 converts the ECC block into a channel bit train, a synchronizing code creating and adding unit 146 adds a synchronizing code to the bit train, and the information recording and reproducing unit 141 records the data onto an information storage medium. In modulation, a DSV (Digital Sum Value) value calculator 148 calculates DSV values after modulation one after another. The values are fed back to code conversion in modulation.

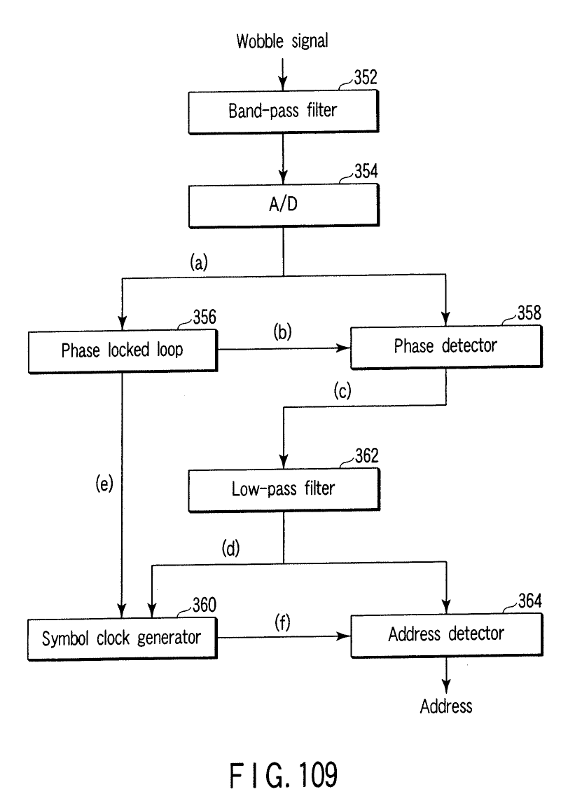

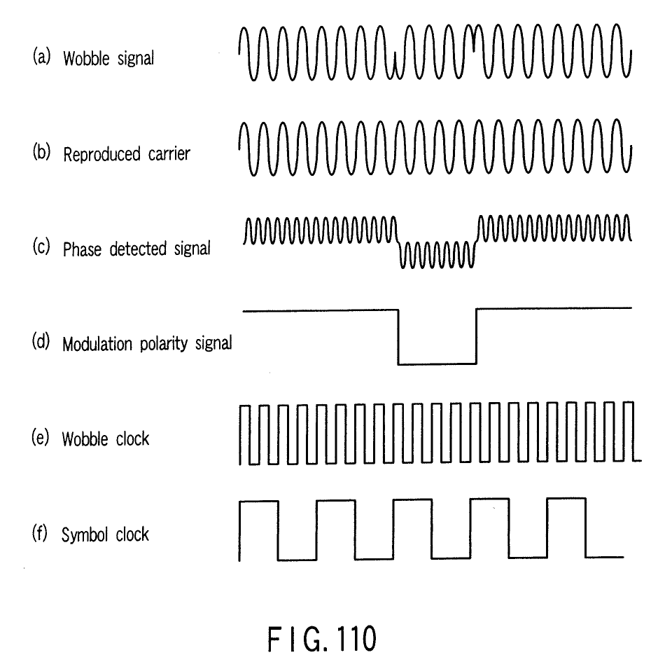

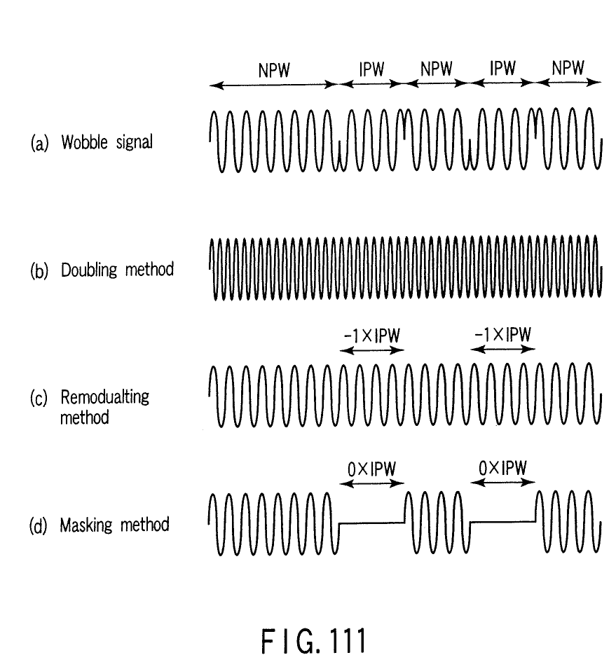

FIG. 109 and FIG. 110 are diagrams to help explain a detailed configuration of the wobble signal detector 135 (FIG. 1) in the information recording and reproducing apparatus of the embodiment.

The wobble signal is input to a band-pass filter 352. The output of the band-pass filter 352 is input to an A/D converter 354. The A/D converter 354 inputs a digital wobble signal (signal (a) in FIG. 110) to a phase locked loop circuit 356 and a phase detector 358. The phase locked loop circuit 356 locks the phase of the input signal and extracts and supplies a reproduced carrier signal (signal (b) in FIG. 110) to the phase detector 358. On the basis of the reproduced carrier signal, the phase detector 358 detects the phase of the wobble signal and supplies a phase detection signal (signal (c) in FIG. 110) to a low-pass filter 362. The phase locked loop circuit 356 locks the phase of the input signal and extracts the wobble signal (signal (e) in FIG. 110) and supplies the wobble signal to a symbol clock generator 360. The low-pass filter 362 also supplies a modulation polarity signal (signal (d) in FIG. 110) to the symbol clock generator 360, which generates a symbol clock (signal (f) in FIG. 110) and supplies the symbol clock to an address detector 364. The address detector 364 detects an address on the basis of the modulation polarity signal (signal (d) in FIG. 110) output from the low-pass filter 362 and the symbol clock (signal (f) in FIG. 110) generated at the symbol clock generator 360.

FIG. 111 is a diagram to help explain the principle of the operation of the phase locked loop circuit 356 of FIG. 109. The embodiment uses a wobble PLL method which phase-synchronizes a wobble signal (NPW). However, since the input wobble signal includes a normal phase wobble (NPW) and an inverted phase wobble (IPW) as shown in (a) in FIG. 111, the removal of the modulation components is needed. The modulation components are removed in the following three ways:

Wobble squaring method: Squaring the wobble enables the modulation components to be removed as shown in FIG. 111 (signal (b)). PLL synchronizes with a squared wobble.

Remodulating method: The modulation components can be removed by modulating again a wobble modulation area in opposite phase as shown in FIG. 111 (signal (c)).

Masking method: The modulation components can be removed by stopping phase control (or fixing the phase error to zero) in a wobble modulation area as shown in FIG. 111 (signal (d)).

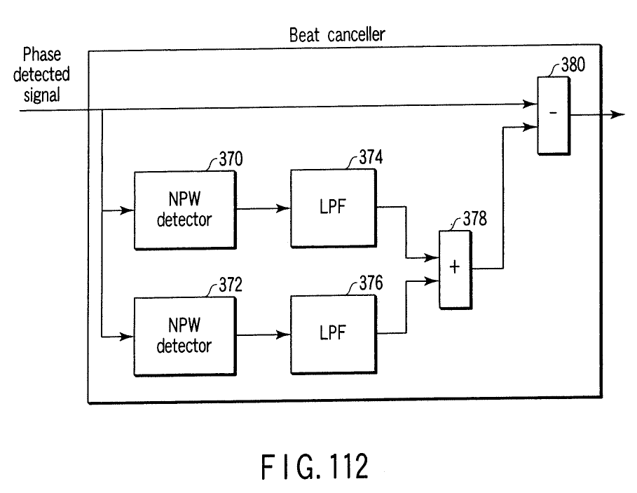

FIG. 112 is a diagram to help explain the principle of the operation of a beat canceller (not shown) included in the phase detector 358 of FIG. 109. The phase detection signal detected at the phase detector 358 is supplied to a normal phase wobble (NPW) detector 370 and an inverted phase wobble (IPW) detector 372, thereby detecting the detection amplitude of the normal phase wobble (NPW) and that of the inverted phase wobble (IPW). The outputs of the normal phase wobble (NPW) detector 370 and the inverted phase wobble (IPW) detector 372 pass through low-pass filters 374, 376, and are supplied to an adder 378, which detects an offset component. The phase detection signal and the output of the adder 378 are supplied to a subtracter 380, which cancels the wobble beat components from the phase detection signal. The output of the subtracter 380 is supplied as the phase detection signal to a low-pass filter 362 of FIG. 109.

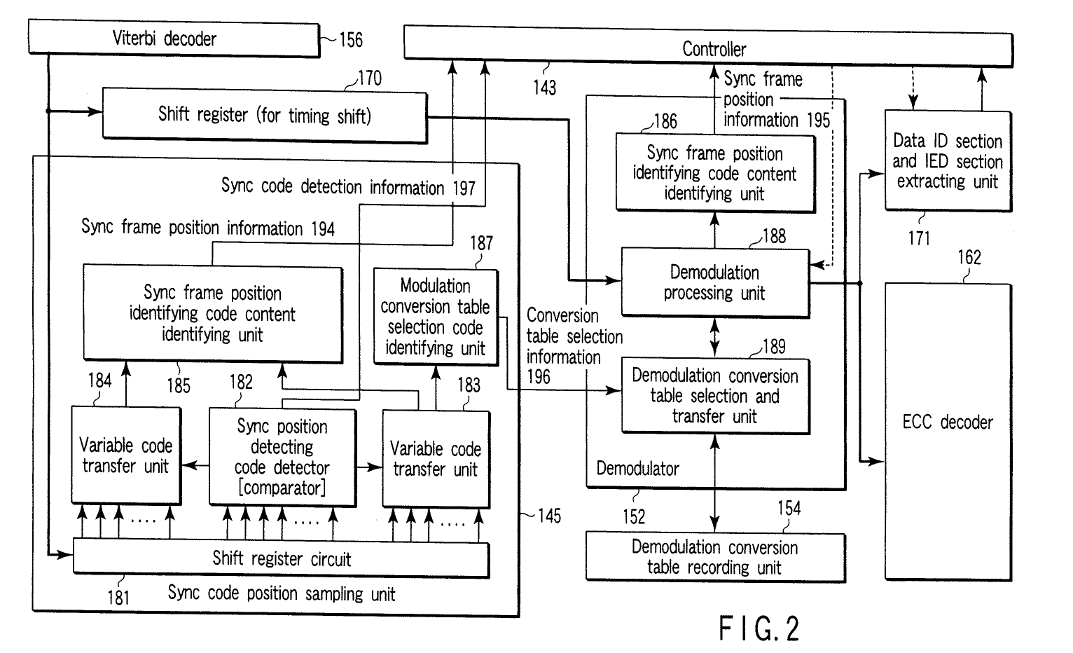

FIG. 2 shows a detailed configuration of the peripheral part including the synchronizing code position extracting unit 145. A synchronizing code is made up of a synchronizing position detecting code part with a fixed pattern and a variable code part. A synchronizing position detecting code detector 182 detects the position of the synchronizing position detecting code part with the fixed pattern from the channel bit train output from the Viterbi decoder 156. Variable code transfer units 183, 184 extract data about the variable codes existing before and after the synchronizing position detecting code part. A sync frame position identifying code content identifying unit 185 determines in which sync frame of the sector explained later the detected synchronizing code locates. User information recorded on the information storage medium is transferred to the shift register 170, a demodulation processing unit 188 in the demodulation circuit 152, and the ECC decoder 162 one after another in that order.

In the embodiment, as shown in point [A] of FIG. 125A, reproducing is done by PRML techniques in the data area, data lead-in area, and data lead-out area, thereby achieving a higher recording density of an information storage medium (particularly an improvement in the line density), whereas as shown in point [B] of FIG. 125A, reproducing is done by slice level detecting techniques in the system lead-in area and system lead-out area, thereby securing not only the interchangeability with an existing DVD but also the stabilization of reproduction.

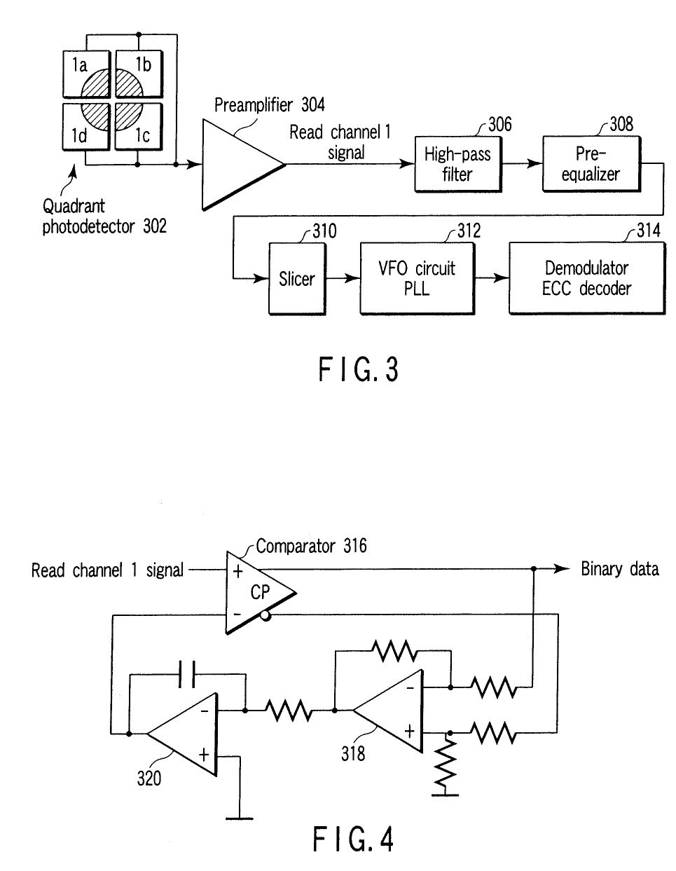

FIG. 3 shows an embodiment of a signal processing circuit using the slice level detecting method used in reproduction in the system lead-in area and system lead-out area. A quadrant photodetector 302 of FIG. 3 is arranged in an optical head existing in the information recording and reproducing unit 141 of FIG. 1. A signal obtained by summing the sense signals from the respective light-detecting cells of the quadrant photodetector 302 is called a read channel 1 signal. A portion from a preamplifier 304 to a slicer 310 in FIG. 3 shows a detailed configuration of a slice level detector 132 of FIG. 1. The reproduction signal obtained from the information storage medium passes through a high-pass filter 306 that cuts off the frequency components lower than the frequency band of the reproduction signal and then is subjected to a waveform equalizing process at a pre-equalizer 308. Experiments have shown that use of a 7-tap equalizer as the pre-equalizer 308 minimizes the circuit size and enables the reproduction signal to be detected with high accuracy. Thus, in the embodiment, a 7-tap equalizer is used. A VFO & PLL circuit 312 of FIG. 3 corresponds to the PLL circuit 174 of FIG. 1. A modulator & ECC decoder 314 of FIG. 3 corresponds to the demodulation circuit 152 and EEC decoder 162 of FIG. 1.

FIG. 4 shows a detailed configuration of the slicer 310 of FIG. 3. The slicer 310 slices the read channel 1 signal to generate a binary signal (binary data) by using a comparator 316. In this embodiment, using a duty feedback method, the output signals of low-pass filters 318, 320 are set to the slice level in binarization with respect to the inverted signal of binary data after binarization. In the embodiment, the cut-off frequency of the low-pass filters 318, 320 is set at 5 KHz. When the cut-off frequency is high, the slice level fluctuates fast, which makes the output signals more liable to be affected by noise. Conversely, when the cut-off frequency is low, the slice level responds slow, which makes the output signals more liable to be affected by dust on or flaws in the information storage medium. Taking into account the relationship between RLL (1, 10) and the reference frequency of the channel bit, the cut-off frequency is set at 5 KHz.

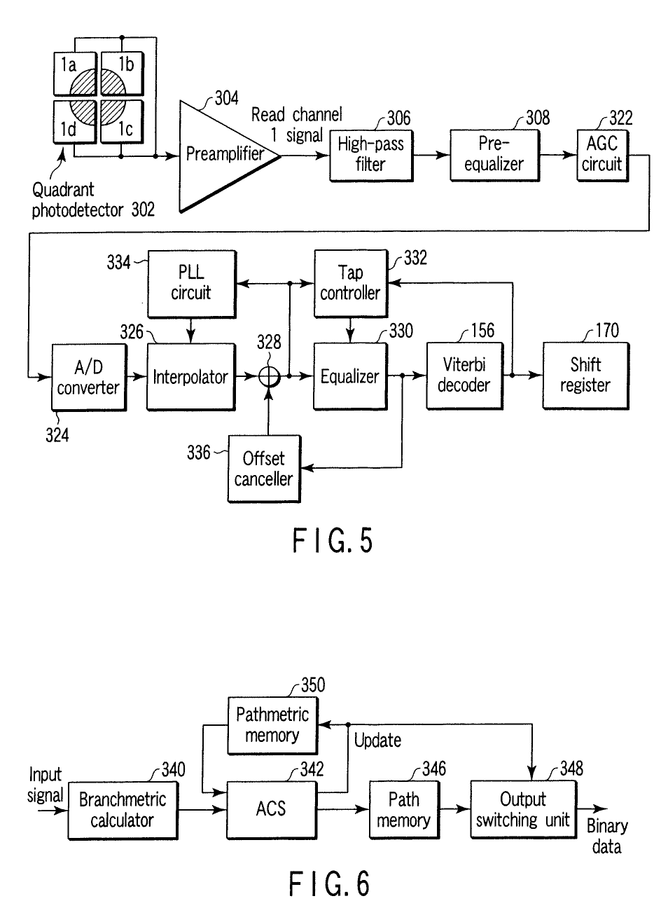

FIG. 5 shows a signal processing circuit which reproduces a signal in the data area, data lead-in area, and data lead-out area by using the PRML detecting method. The quadrant photodetector 302 of FIG. 5 is arranged in an optical head existing in the information recording and reproducing unit 141 of FIG. 1. A signal obtained by summing the sense signals from the respective light-detecting cells of the quadrant photodetector 302 is called a read channel 1 signal. A detailed configuration of the PR equalizer 130 of FIG. 1 is composed of the respective circuits ranging from a preamplifier 304 to a tap controller 332, an equalizer 330, and an offset canceller 336. A PLL circuit 334 of FIG. 5 is a part of the PR equalizer 130 of FIG. 1 and differs from the Schmitt trigger binarizing circuit 155 of FIG. 1. A primary cut-off frequency of the high-pass filter 306 in FIG. 5 is set at 1 KHz. As in FIG. 3, a 7-tap equalizer is used as the pre-equalizer (because use of a 7-tap equalizer minimizes the circuit size and enables the reproduction signal to be detected with high accuracy). The sampling clock frequency of an A/D converter 324 is at 72 MHz and the digital output is an 8-bit one. When the PRML detecting method is affected by level fluctuations (DC offset) in the entire reproduction signal, an error is liable to occur in Viterbi demodulation. To eliminate the effect, the offset canceller 336 corrects the offset using the signal obtained from the output of the equalizer 330. In the embodiment of FIG. 5, an adaptive equalizing process is carried out at the PR equalizer 130 of FIG. 1. To do this, a tap controller 332 is used which automatically modifies each tap coefficient in the equalizer using the output signal of the Viterbi decoder 156.

FIG. 6 shows the configuration of the Viterbi decoder 156 of FIG. 1 or 5. A branchmetric calculator 340 calculates the branchmetric for all of branches expected from the input signal and sends the calculated value to an ACS 342. The ACS 342, which stands for Add Compare Select, calculates the pathmetric by adding the branchmetric for each of the expected paths and transfers the result of the calculation to a pathmetric memory 350. At this time, the ACS 342 does calculations also referring to the information in the pathmetric memory 350. A path memory 346 temporarily stores an expected situation of each path (transition) and the value of the pathmetric calculated at the ACS 342 according to the path. An output switching unit 348 compares the pathmetric for each path with another and selects the path whose pathmetric value is the smallest.

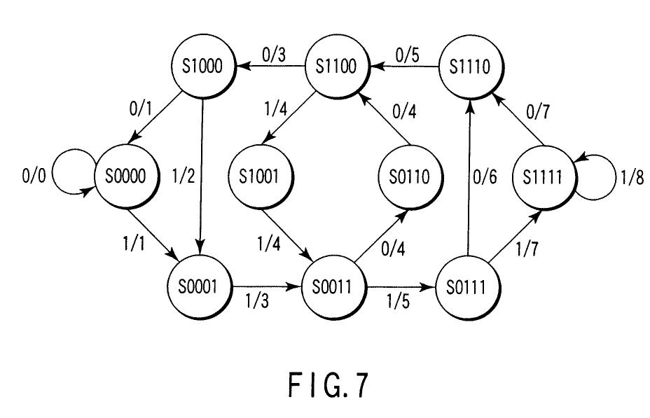

FIG. 7 shows state transition in PR (1, 2, 2, 2, 1) class in the embodiment. In the transitions of states expected in PR (1, 2, 2, 2, 1) class, only the one shown in FIG. 7 is possible, the Viterbi decoder 156 determines a path which can be present (or expected) in decoding, on the basis of the transition diagram of FIG. 7.

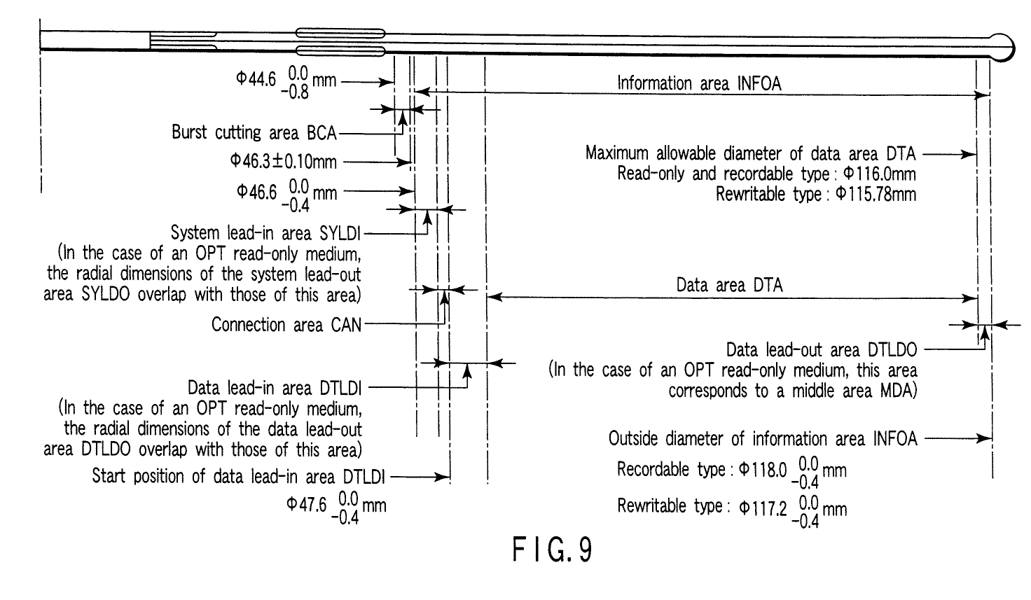

FIG. 9 shows the configuration and dimensions of an information storage medium in the embodiment. In the embodiment, the following three types of information storage medium are explained:
“Read-only information storage medium” which is for reproduction only and impossible to record
“Recordable information storage medium” which enables additional recording
“Rewritable information storage medium” which enables rewriting

As shown in FIG. 9, the three types of information storage medium share most of the configuration and dimensions. In each of the three types of information storage medium, a burst cutting area BCA, a system lead-in area SYLDI, a connection area CNA, a data lead-in area DTLDI, and a data area DTA are arranged from the inner periphery in that order. In all of the information storage media excluding OPT read-only media, a data lead-out area DTLDO is provided on the outer periphery. As described later, in OPT read-only media, a middle area MDA is provided in the outer periphery. In the system lead-in area SYLDI, information is recorded in emboss (pre-pit) form. This area is for reproduction only (disables additional recording) in each of the recordable information storage medium and the rewritable one.

In a read-only information storage medium, information is recorded in the data lead-in area DTLDI in emboss (prepit) form, whereas in a recordable and a rewritable information storage medium, the data lead-in area DTLDI enables new information to be recorded (or rewriting in the rewritable one) by forming recording marks. As described later, in a recordable and a rewritable information storage medium, areas enabling new information to be recorded (or rewriting in the rewritable one) and read-only areas where information is recorded in emboss (prepit) form are mixed in the data lead-out area DTLDO. As described above, in the data area DTA, data lead-in area DTLDI, data lead-out area DTLDO, and middle area MDA of FIG. 9, the signals recorded there are reproduced by the PRML method, thereby achieving a higher recording density of the information storage medium (point [A] in FIG. 125A). At the same time, in the system lead-in area SYLDI and system lead-out area SYLDO, the signals recorded there are reproduced by the slice level detecting method, thereby securing the interchangeability with an existing DVD and the stabilization of reproduction (point [B] in FIG. 125A).

Unlike the present DVD standards, the burst cutting area BCA and the system lead-in area SYLDI do not overlap with each other and are separated from each other spatially ((B2) in point of FIG. 125A) in the embodiment of FIG. 9. Separating the burst cutting area BCA and the system lead-in area SYLDI physically from each other prevents the information recorded in the system lead-in area SYLDI and the information recorded in the burst cutting area BCA from interfering with each other in reproducing information, which enables information to be reproduced with high accuracy.

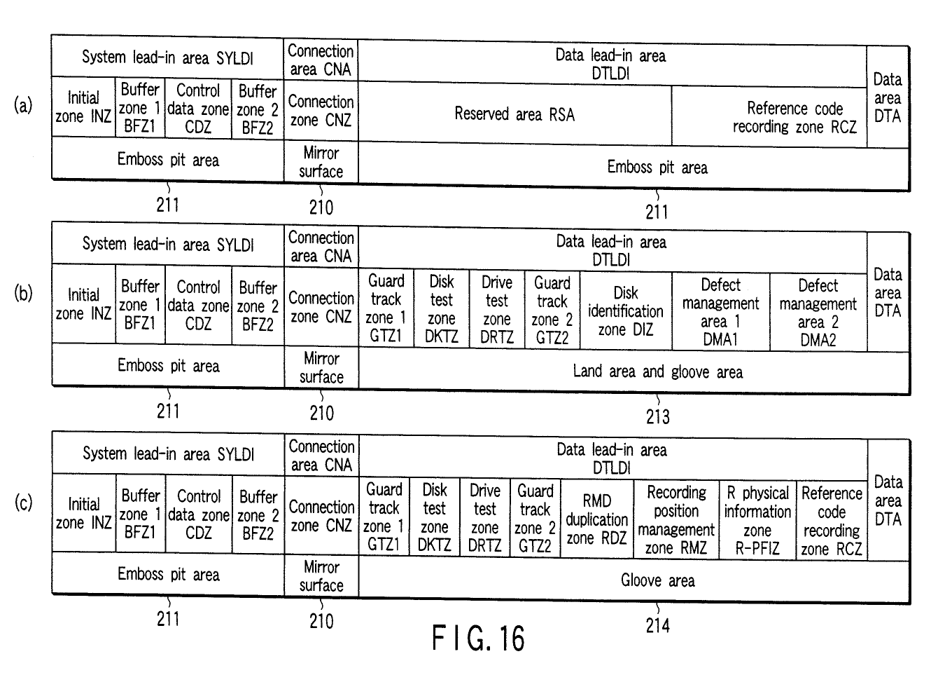

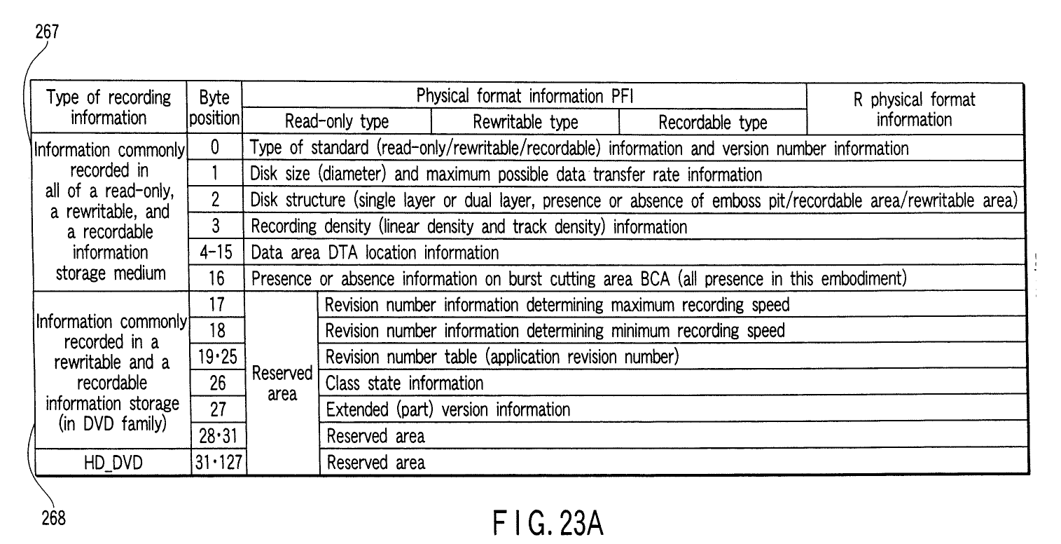

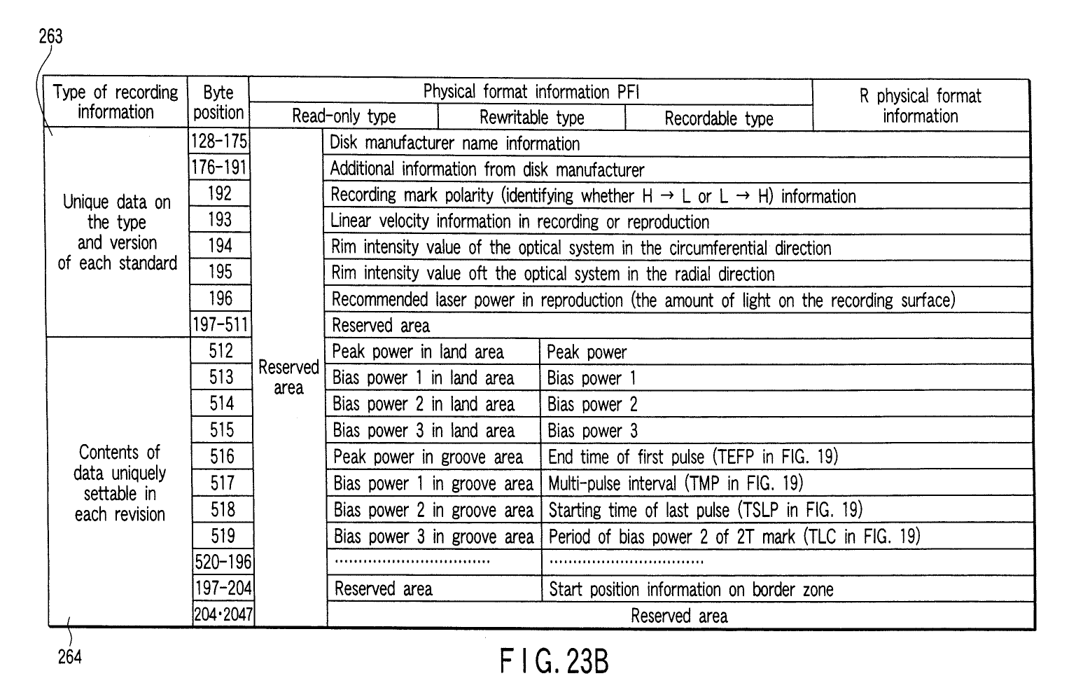

Another embodiment related to the embodiment shown in (B2) in point of FIG. 125A is a method of forming a microscopic concavo-convex shape previously in a place where the burst cutting area BCA is provided, when a Low-to-High recording film is used as shown in (B3) in point of FIG. 125A. When information about the polarity of the recording mark (determination of whether the recording film is High-to-Low or Low-to-High) existing at the 192^{nd} byte in FIG. 23B is explained later, the explanation will go as follows: the present embodiment incorporates not only a conventional High-to-Low recording film but also a Low-to-High recording film into the standard books, increasing a selection of recording films, which enables not only high-speed recording to be realized but also a low-cost medium to be supplied (point (G2) in FIG. 125E). As described later, the embodiment also takes into account a case where a Low-to-High recording film is used. Data (barcode data) recorded in the burst cutting area BCA is recorded by subjecting a recording film to local laser exposure. As shown in FIG. 16, since the system lead-in area SYLDI is formed in the emboss pit area 211, the amount of light reflection from the reproduction signal from the system lead-in area SYLDI is smaller than the amount of light reflection from a mirror surface 210. If the burst cutting area BCA is brought into the state of the mirror surface 210 and a Low-to-High recording film is used, the reproduction signal from the data written in the burst cutting area BCA appears in the direction in which the amount of light reflection increases as compared with the level of light reflection from the mirror surface 210 (in an unrecorded state). This results in a great difference between the positions (amplitude levels) of the maximum and minimum levels of the reproduction signal from the data created in the burst cutting area BCA and the positions (amplitude levels) of the maximum and minimum levels of the reproduction signal from the system lead-in area SYLDI. As described later in an explanation of FIG. 16 (and point (B4) of FIG. 125A), the information reproducing apparatus or information recording and reproducing apparatus carries out processes in this order:

Reproducing the information in the burst cutting area BCA
(2) Reproducing the information in the control data zone CDZ in the system lead-in area SYLDI
(3) Reproducing the information in the data lead-in area DTLDI (in the case of a recordable or a rewritable information storage medium)
(4) Readjusting (optimizing) the reproducing circuit constant in the reference code recording zone RCZ
(5) Reproducing the information recorded in the data area DTA or recording new information

Therefore, if there is a great difference between the reproduction signal amplitude level from the data portion recorded in the burst cutting area BCA and the reproduction signal amplitude level from the system lead-in area SYLDI, a problem arises: the reliability of information reproduction decreases. To solve this problem, this embodiment is characterized by forming a microscopic concavo-convex portion beforehand in the burst cutting area BCA when a Low-to-High recording film is used (point (B3) in FIG. 125A). Forming a microscopic concavo-convex portion in advance makes the light reflection level from the BCA lower than the light reflection level from the mirror surface 210 because of the effect of light interference and decreases greatly the difference between the reproduction signal amplitude level (sense level) from the data portion recorded in the burst cutting area BCA and the reproduction signal amplitude level (sense level) from the system lead-in area SYLDI before recording data (barcode data) by local laser exposure, which improves the reliability of information reproduction. Furthermore, the process in moving from (1) to (2) becomes easier.

When a Low-to-High recording film is used, there is a method of using an emboss pit area 211 as in the system lead-in area SYLDI as a concrete description of a microscopic concavo-convex portion previously formed in the burst cutting area BCA. Another embodiment is a method of using a groove area 214 or a land area and groove area 213 as in the data lead-in area DTLDI or the data area DTA. As described in the explanation of the embodiment (point (B2) in FIG. 125A) which arranges the system lead-in area SYLDI and the burst cutting area BCA separately, when the burst cutting area BCA overlaps with the emboss pit area 211, the noise components to the reproduction signal from the data created in the burst cutting area BCA increase because of unwanted interference. When the groove area 214 or land area and groove area 213 is used instead of the emboss pit area 211 as an embodiment of the microscopic concavo-convex portion in the burst cutting area BCA, the noise components to the reproduction signal from the data portion recorded in the burst cutting area BCA due to unwanted interference decrease, which improves the quality of the reproduction signal.

If the track pitch of the groove area 214 or the land area and groove area 213 formed in the burst cutting area BCA is caused to coincide with the track pitch of the system lead-in area SYLDI, the productivity of the information storage medium is improved. Specifically, when a master disk of an information storage medium is produced, the feed motor speed at the exposure unit of a master disk recording apparatus is made constant, thereby forming emboss pits in the system lead-in area. At this time, the track pitch of the groove area 214 or the land area and groove area 213 formed in the burst cutting area BCA is caused to coincide with the track pitch of the emboss pits in the system lead-in area SYLDI, which enables the feed motor speed to be kept constant over the burst cutting area BCA and the system lead-in area SYLDI. Therefore, the feed motor speed need not be changed in the middle, which makes it difficult for pitch irregularity to occur and improves the productivity of the information storage medium.

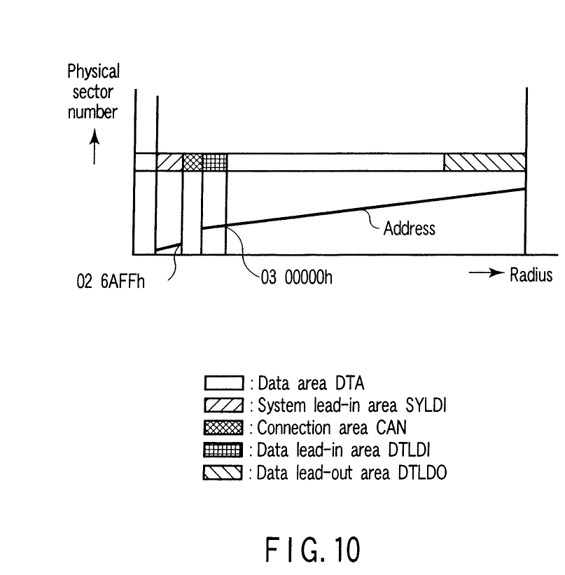

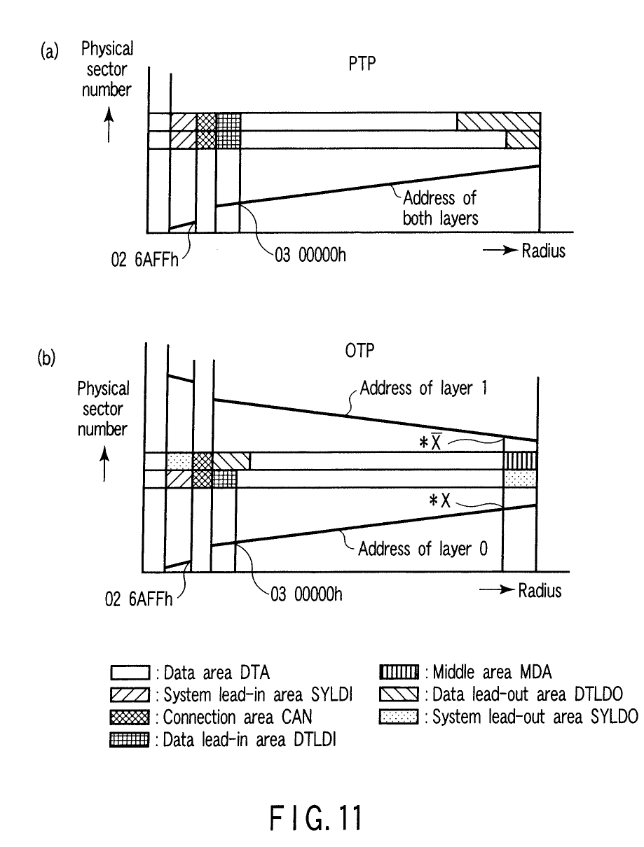

In all of the three types of information storage media, the minimum management unit of information recorded in an information storage medium is a 2048-byte sector unit. A physical address for the 2048-byte sector unit is defined as a physical sector number. FIG. 10 shows a method of setting a physical sector number in a recordable information storage medium and a read-only information storage medium with a single layer structure. No physical sector number is given to the burst cutting area BCA and connection area CNA. Physical sector numbers are set to the system lead-in area SYLDI, data area DTA, and data lead-out area DTLDO in ascending order from the inner periphery. Setting is done so that the last physical sector number in the system lead-in area SYLDI may be “026AFFh” and the physical sector number at the starting position in the data area DTA may be “030000h.”

There are two methods of setting physical sector numbers in a read-only information storage medium with a dual layer structure. One is a parallel arrangement (Parallel Track Path) PTP shown in a portion (a) of FIG. 11 in which the physical number setting method of FIG. 10 is applied to both of the dual layers. The other method is an opposite arrangement (Opposite Track Path) OPT shown in a portion (b) of FIG. 11 in which physical sector numbers are set from the inner periphery toward the outer periphery in ascending order in the front layer (Layer 0) and from the outer periphery toward the inner periphery in ascending order in the back layer (Layer 1). In the OPT arrangement, a middle area MDA, a data lead-out area DTLDO, and a system lead-out area SYLDO are arranged.

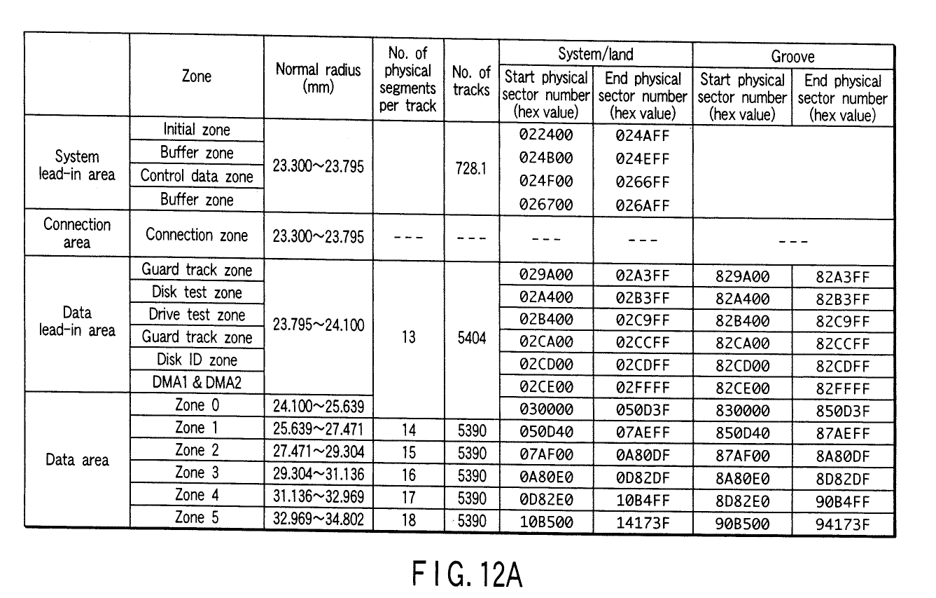

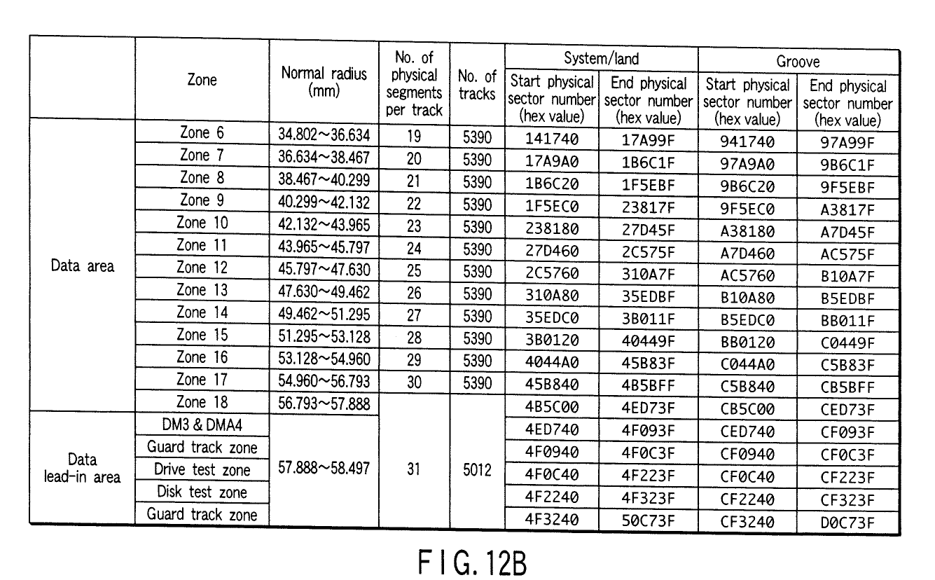

FIGS. 12A and 12B show a method of setting physical sector numbers in a rewritable information storage medium. In a rewritable information storage medium, physical sector numbers are set in each of the land area and groove area. The data area DTA is divided into 19 zones.

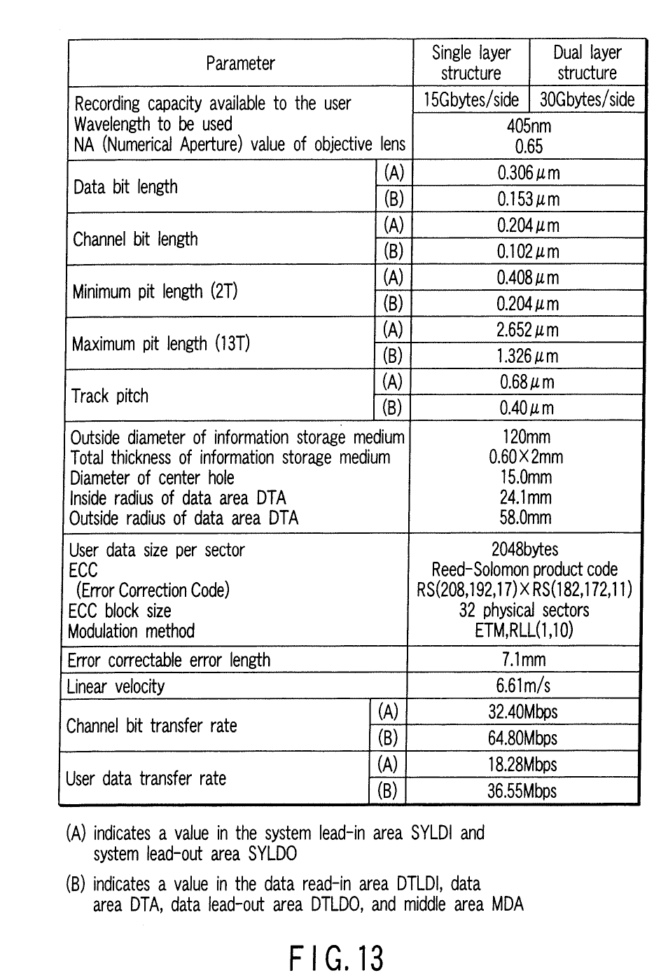

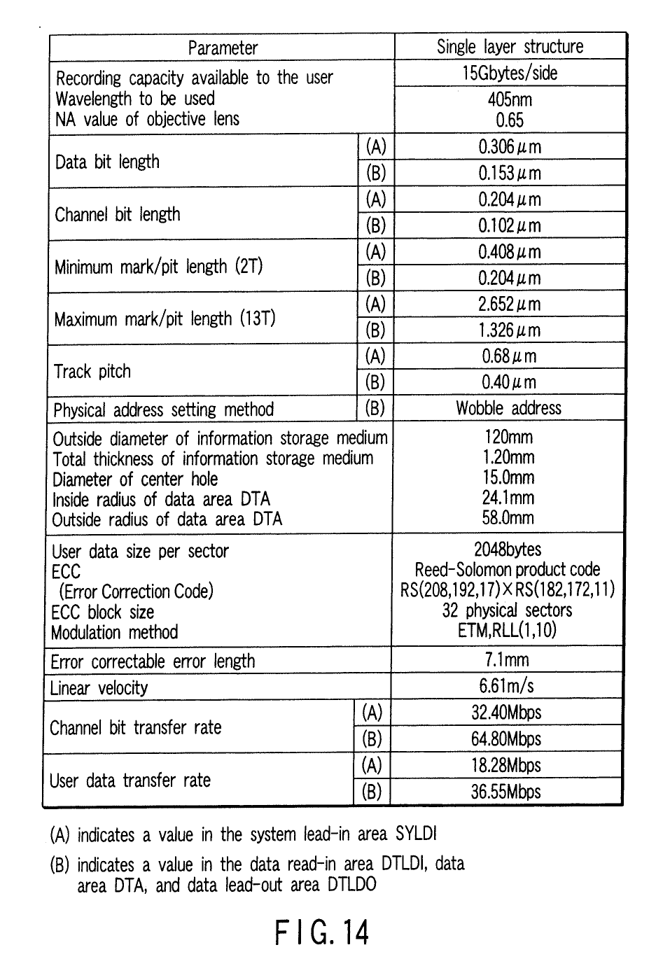

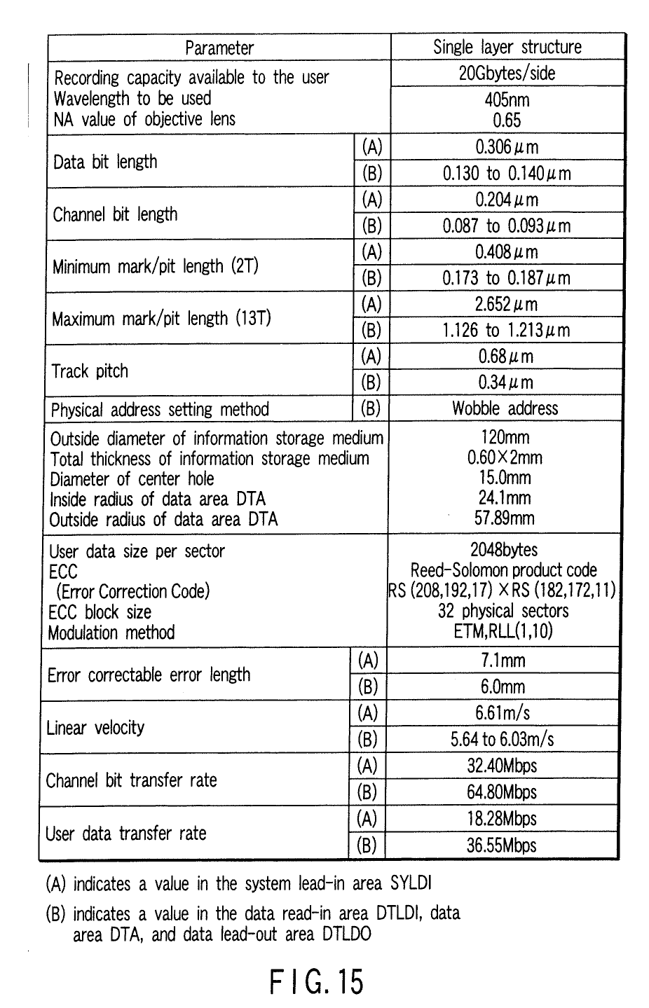

FIG. 13 shows the values of various parameters in the embodiment of a read-only information storage medium. FIG. 14 shows the values of various parameters in the embodiment of a recordable information storage medium. FIG. 15 shows the values of various parameters in the embodiment of a rewritable information storage medium. As seen from a comparison between FIG. 13 or 14 and FIG. 15 (particularly a comparison between item (B) in the figures), the track pitch and line density (data bit length) are shortened in a rewritable information storage medium, thereby increasing the recoding capacity, as compared with a read-only or a recordable information storage medium. As described later, land/groove recording is used in a rewritable information storage medium, thereby shortening the track pitch while reducing the effect of crosstalk of adjacent tracks. The embodiment is characterized in that, in each of a read-only information storage medium, a recordable information storage medium, and a rewritable information storage medium, the data bit length and the track pitch (corresponding to the recording density) of the system lead-in/-out area SYLDI/SYLDO are made greater (or the recording density is made lower) than the data lead-in/-out area DTLDI/DTLDO (point (B1) in FIG. 125A).

The data bit length and track pitch of the system lead-in/-out area SYLDI/SYLDO are brought close to the values of the lead-in area of an existing DVD, thereby securing the interchangeability with an existing DVD. In this embodiment, too, as with an existing DVD-R, the step of an emboss in the system lead-in/-out area SYLDI/SYLDO is set shallow. This makes the depth of a pre-groove in a recordable information storage medium shallower, producing the effect of increasing the modulation degree of the reproduction signal from the recording mark formed in additional writing on the pre-groove. Conversely, there arises an opposite problem: the modulation degree of the reproduction signal from the system lead-in/-out area SYLDI/SYLDO becomes smaller. To overcome this problem, the data bit length (and track pitch) of the system lead-in/-out area SYLDI/SYLDO is made rougher, thereby separating (making much lower) the repeat frequency of pits and spaces in the densest position from the optical cut-off frequency of the reproduction objective MTF (Modulation Transfer Function), which makes it possible to increase the amplitude of the reproduction signal from the system lead-in/-out area SYLDI/SYLDO and stabilize reproduction.

FIG. 16 shows a comparison of a detailed data structure in the system lead-in SYLDI and data lead-in area DTLDI between various information storage media. The diagram (a) of FIG. 16 shows a data structure of a read-only information storage medium. The diagram (b) of FIG. 16 shows a data structure of a rewritable information storage medium. The diagram (c) of FIG. 16 shows a data structure of a recordable information storage medium. Although not shown, there is a burst cutting area BCA inside the system lead-in area SYLDI. The system lead-in area SYLDI is recorded in an emboss form. The connection area is a mirror portion.

As shown in the diagram (a) of FIG. 16, in a read-only information storage medium, the system lead-in area SYLDI, data lead-in area DTLDI, and data area DTA are all emboss pit areas 211 where emboss pits are formed, except that only the connection zone CNZ is a mirror surface 210. The system lead-in area SYLDI is an emboss pit area 211 and the connection zone CNZ is a mirror surface 210, which are common to various types of information storage medium. As shown in the diagram (b) of FIG. 16, in a rewritable information storage medium, a land area and groove area 213 is formed in the data lead-in area DTLDI and data area DTA. As shown in the diagram (c) of FIG. 16, in a recordable information storage medium, a groove area 214 is formed in the data lead-in area DTLDI and data area DTA. Recording marks are formed in the land area and groove area 213 or the groove area 214, thereby recording information.

An initial zone INZ indicates the starting position of the system lead-in area SYLDI. As information having a meaning recorded in the initial zone INZ, data ID (Identification Data) information including information about the physical sector numbers or logical sector numbers is arranged discretely. As described later, data-frame-structure information made up of the data ID, IED (ID Error Detection code), main data in which user information is recorded, and EDC (Error Detection Code) is recorded in a physical sector. The data-frame-structure information is also recorded in the initial zone INZ. However, since all of the main data in which user information is recorded are set to “00h” in the initial zone INZ, it is only the aforementioned data ID information that has a meaning in the initial zone INZ. From the physical sector number or logical sector number recorded there, the present position can be known. Specifically, in a case where reproduction is started from the information in the initial zone INZ when the information recording and reproducing unit 141 of FIG. 1 starts to reproduce the information from the information storage medium, information on the physical sector number or logical sector number recorded in the data ID information is first extracted. While checking the present position on the information storage medium, the information recording and reproducing unit 141 moves to the control data zone CDZ.

A first and a second buffer zone BFZ1, BFZ2 are each composed of 32 ECC blocks. As shown in FIGS. 13 to 15, since an ECC block is composed of 32 physical sectors, 32 ECC blocks correspond to 1024 physical sectors. As in the initial zone INZ, in the first and second buffer zones BFZ1, BFZ2, the main data are all set to “00h.”

A connection zone CNZ in the connection area CNA is an area for physically separating the system lead-in area SYLDI and data lead-in area DTLDI from each other. This area is a mirror surface where neither any emboss pit nor any pre-groove exists.

The reference code zone RCZ in each of a read-only information storage medium and a recordable information storage medium is an area used for adjusting the reproducing circuit of a reproducing apparatus (e.g., for automatically adjusting each tap coefficient in adaptive equalization effected in the tap controller 332 of FIG. 5). In this area, the aforementioned data-frame-structure information is recorded. The length of a reference code is one ECC block (=32 sectors). This embodiment is characterized in that the reference code zone RCZ in each of a read-only information storage medium and a recordable information storage medium is placed next to the data area DTA (point (A2) in FIG. 125A). In the structure of each of an existing DVD-ROM and an existing DVD-R disk, a control data zone is provided between the reference code zone and the data area, which separates the reference code zone and the data area from each other. When the code zone and the data area are separated from each other, the amount of tilt and light reflectance of the information storage medium or the recording sensitivity of a recording film (in the case of a recordable information storage medium) change slightly, which causes a problem: even if the circuit constant of the reproducing apparatus has been adjusted in the reference code zone, the optimum circuit constant in the data area deviates from the original value. To solve this problem, a reference code zone RCZ is provided adjacent to the data area DTA, which enables the optimized state to be kept with the same circuit constant even in the adjacent data area DTA, when the circuit constant of the information reproducing apparatus is optimized in the reference code zone RCZ. To reproduce a signal with high accuracy in any place in the data area DTA, the following steps are carried out:

Optimize the circuit constant of the information reproducing apparatus in the reference code zone RCZ
(2) Optimize again the circuit constant of the information reproducing apparatus, while reproducing the part closest to the reference code zone RCZ in the data area DTA
(3) Optimize further again the circuit constant, while reproducing the information at the midpoint between the target position in the data area DTA and the position optimized in (2)
(4) Move to the target position and reproduce the signal

Going through these steps enables the signal to be reproduced at the target position with very high accuracy.

A first and a second guard track zone GTZ1, GTZ2 existing in each of a recordable information storage medium and a rewritable information storage medium are areas for defining the starting boundary position of the data lead-in area DTLDI and the boundary position between the disk test zone DKTZ and drive test zone DRTZ. This area is set as an area in which recording must not be done by forming recording marks. Since the first and second guard track zones GTZ1, GTZ2 exist in the data lead-in area DTLDI, a pre-groove area is formed beforehand in a recordable information storage medium and a groove area and land area is formed beforehand in a rewritable information storage medium. Since wobble addresses have been recorded in the pre-groove area or groove area, and land area as shown in FIGS. 13 to 15, the present position on the information storage medium is determined using the wobble addresses.

A disk test zone DKTZ is an area for the information storage medium manufacturer to conduct a quality test (evaluation).

A drive test zone DRTZ is secured as an area for the information recording and reproducing apparatus to do test recording before recording information onto the information storage medium. After the information recording and reproducing apparatus does test recording in this area beforehand and calculates the optimum recording condition (write strategy), it can record information in the data area DTA under the optimum recording condition.

As shown in the diagram (b) of FIG. 16, the information in a disk identification zone DIZ in a rewritable information storage medium, which is an optional information recording area, is an area in which a set of the information reproducing apparatus manufacturer name information, its additional information, and a drive description made up of an area recordable by the manufacturer can be additionally recorded on a set basis.

As shown in the diagram (b) of FIG. 16, a first defect management area DMA1 and a second defect management area DMA2 are areas where defect management information in the data area DTA is recorded. For example, substitution place information for the occurrence of a defective part is recorded in the areas.

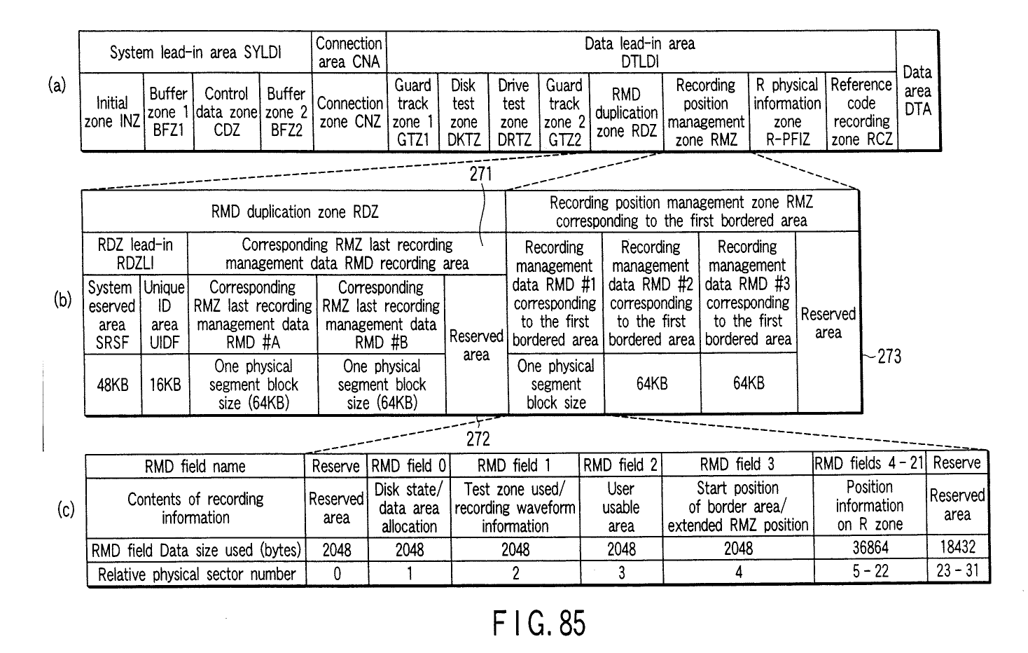

As shown in the diagram (c) of FIG. 16, in a recordable information storage medium, an RMD duplication zone RDZ, a recording management zone RMZ, an R physical information zone R-FIZ are provided separately. In the recording management zone RMZ, recording management data RMD, which is management information on the recording position of data updated by a data additional recording process, is recorded (which will be explained later in detail). As described in FIG. 85 later, in this embodiment, a recording management zone RMZ is set in each bordered area BRDA, which enables the area of the recording management zone RMZ to be extended. As a result, even if the frequency of additional recording is increased and therefore the recording management data RMD area needed increases, the recording management data RMD can be recorded by extending the recording management zone RMZ. As a result, the effect of increasing the number of times of additional recording remarkably is obtained. In this case, in the embodiment, a recording management zone RMZ is provided in the border-in area BRDI corresponding to each bordered area BRDA (or provided just in front of each bordered area BRDA). In the embodiment, the border-in area BRDI corresponding to the first bordered area BRDA#1 and the data lead-in area DTLDI share an area, eliminating the formation of the first border-in area BRDI in the data area DTA, which enables the data area DTA to be used effectively (point (C2) in FIG. 125B). That is, the recording management zone RMD in the data lead-in area DTLDI shown in the diagram (c) of FIG. 16 is used as the recording place of the recording management data RMD corresponding to the first bordered area BRDA#1 (point (C2) in FIG. 125B).

An RMD duplication zone RDZ is a place in which recording management data RMD satisfying the following condition is recorded. As in the embodiment, having the recording management data RMD redundantly increases the reliability of the recording management data RMD (point (C3) in FIG. 125B). Specifically, even when the recording management data RMD in the recording management zone RMD cannot be read because of the influence of dust on or flaws in the surface of a recordable information storage medium, the recording management data RMD recorded in the RMD duplication zone RDZ may be reproduced and further the remaining necessary information may be acquired by tracing, which enables the latest recording management data RMD to be reproduced (point (C3β) in FIG. 125B).

In the RMD duplication zone RDZ, the recording management data RMD at the time of closing a border (or a plurality of borders) is recorded (point (C3α) in FIG. 125B). As described later, since one border is closed and a new recording management zone RMZ is defined each time a subsequent new bordered area is set, it may be said that, each time a new recording management zone RMZ is created, the last recording management data RMD related to the preceding bordered area is recorded in the RMD duplication zone RDZ. If the same information is recorded in the RMD duplication zone RDZ each time the recording management data RMD is additionally recorded on the recordable information storage medium, the RMD duplication zone RMD is filled up with a relatively small number of times of additional recording, with the result that the upper limit of the number of times of additional recording is small. In contrast, as in the embodiment, if a new recording management zone RMZ is created when a border is closed or when the recording management zone RMZ in the border-in area BRDI has got full and a new recording management zone RMZ is created using an R zone, only the last recording management data RMD in the current recording management zone RMZ is recorded in the RMD duplication zone RDZ, which enables the RMD duplication zone RDZ to be used effectively and increases the number of times of additional recording (points (C3) and (C3β) in FIG. 125B).

For instance, when the recording management data RMD in the recording management zone RMZ corresponding to the bordered area BRDA in the middle of additional recording (before border closing is done) cannot be reproduced due to dust on or flaws in the surface of the recordable information storage medium, the recording management data RMD recorded at the end of the RMD duplication zone RDZ, which enables the position of the already closed bordered area to be known. Therefore, tracing the remaining part of the data area DTA of the information storage medium makes it possible to acquire the place of the bordered area BRDA in the middle of additional recording (before border closing is done) and the contents of the information recorded there, which enables the latest recording management data RMD to be reproduced.

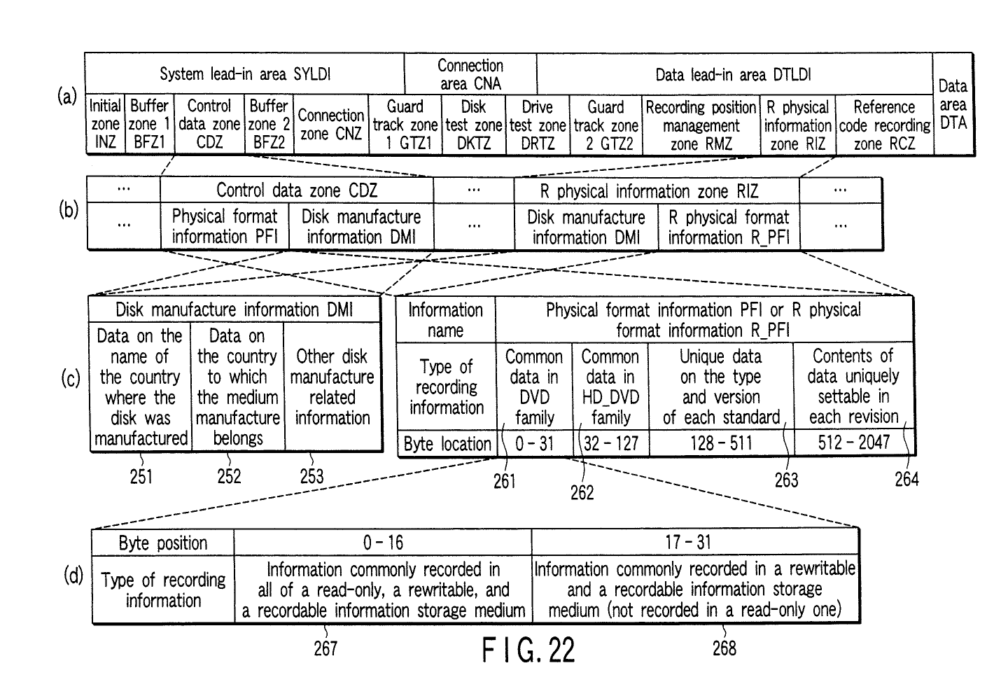

Information similar to physical format information PFI (which will be explained later in detail using FIG. 22) in a control data zone CDZ existing in each of the diagrams (a) to (c) of FIG. 16 is recorded in an R physical information zone R-PFIZ.

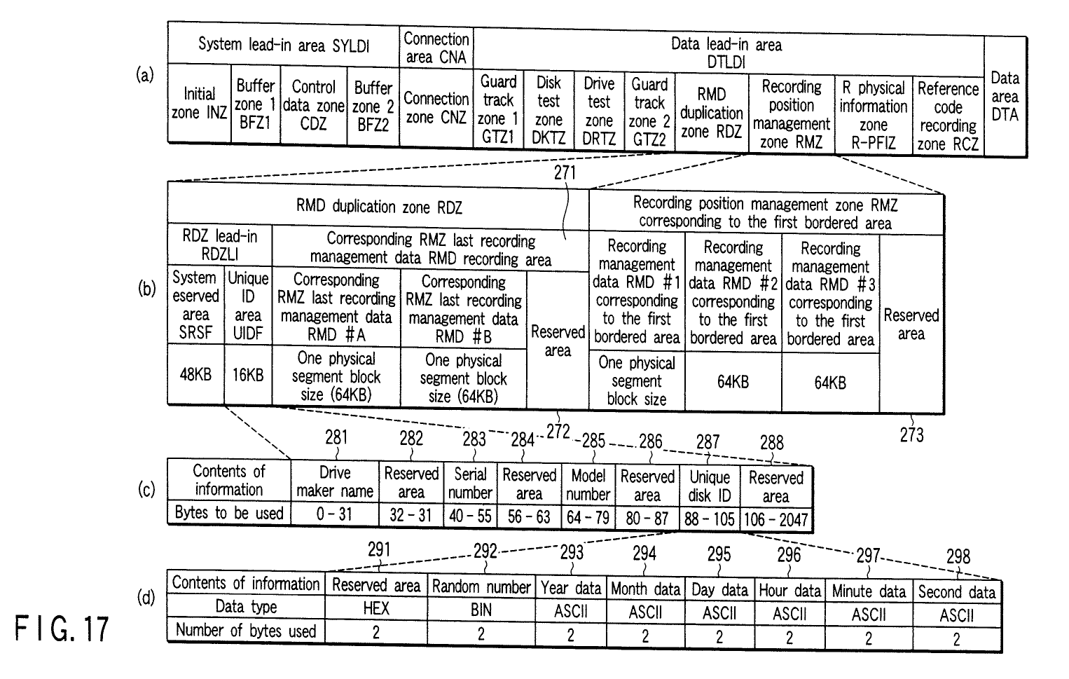

FIG. 17 shows a data structure in the RMD duplication zone RDZ and recording management zone RMZ in a recordable information storage medium (the diagram (c) of FIG. 16). The diagram (a) of FIG. 17 shows the same as in the diagram (c) of FIG. 16. The diagram (b) of FIG. 17 is an enlarged diagram of the RMD duplication zone RDZ and the recording management zone RMD in the diagram (c) of FIG. 16. As described above, data about recording management corresponding to the first bordered area BRDA is recorded in an item of recording management data RMD in the recording management zone RMZ in the data lead-in area DTLDI. Each time the contents of the recording management data RMD are updated in doing additional recording on the recordable information storage medium, the data is added to the end one after another as new recording management data RMD. Specifically, the recording management data RMD is recorded in size units of one physical segment block (a physical segment block will be explained later). Each time the contents of the data are updated, new recording management data RMD is added to the end one after another. The diagram (b) of FIG. 17 shows a case where, when recording management data RMD#1, RMD#2 have been recorded, since the management data has been changed, the changed (or updated) data is recorded as recording management data RMD#3 immediately behind recording management data RMD#2. Therefore, there are reserved areas 273 in the recording management zone RMZ so as to enable further additional recording.

The diagram (b) of FIG. 17 shows the structure of a recording management zone RMZ existing in the data lead-in area DTLDI. The structure of the recording management zone RMZ (or extended recording management zone called extended RMZ) existing in the border-in area BRDI or bordered area BRDA is also the same as that of the diagram (b) of FIG. 17.

In the embodiment, when the first bordered area BRDA#1 is closed or when the finalizing process of the data area DTA is performed, all of the reserved area 273 shown in the diagram (b) of FIG. 17 is filled with the last recording management data RMD (point (L2) in FIG. 125M). This produces the following effects:

An “unrecorded” reserved area 273 is eliminated, which assures the stabilization of tracking correction by a DPD (Differential Phase Detection) method.

A multiple last recording management data RMD are written over the previous reserved area 273, which increases reliability remarkably in reproducing the last recording management data RMD.

It is possible to prevent different recording management data RMD from being written erroneously into an unrecorded reserved area 273.

The processing method is not limited to the recording management zone RMZ in the data lead-in area DTLDI. In the recording management zone RMZ (or extended recording management zone called extended RMZ) in the border-in area BRDI or the bordered area BRDA (explained later) too, when the corresponding bordered area BRDA is closed or the data area DTA is finalized, all of the reserved area 273 is filled with the last recording management data RMD.

The RMD duplication zone RDZ is divided into RDZ read-in area RDZLI and a recording area 271 for the corresponding RMZ last recording management data RMD. As shown in the diagram (b) of FIG. 17, the RDZ lead-in RDZLI is composed of a system reserved area SRSF whose data size is 48 KB and a unique ID area UIDF whose data size is 16 KB. All of the system reserved area SRSF is set to “00h.”

The embodiment is characterized in that RDZ lead-in area RDZLI is recorded in a recordable data lead-in area DTLDI (point (C4) in FIG. 125C). A recordable information storage medium of the embodiment is shipped immediately after manufacture in such a manner that the RDZ lead-in area RDZLI is unrecorded. When the recordable information storage medium is used in an information recording and reproducing apparatus on the user side, the information in the RDZ lead-in area RDZLI is recorded for the first time. Therefore, immediately after the recordable information storage medium is installed in the information recording and reproducing apparatus, it is determined whether information has been recorded in the RDZ lead-in area RDZLI, which makes it possible to know easily whether the recordable information storage medium is immediately after manufacture and shipment or has been used at least once. In addition, as shown in the diagram (b) of FIG. 17, the embodiment is characterized in that the RMD duplication zone RDZ is provided closer to the inner periphery than the recording management zone RMZ corresponding to the first bordered area BRDA and the RDZ lead-in area RDZLI is provided in the RMD duplication zone RDZ (point (C4α) in FIG. 125C).

Information (RDZ lead-in area RDZLI) as to whether a recordable information storage medium is immediately after manufacture and shipment or has been used at least once is placed in the RMD duplication zone RDZ used for a common purpose (an improvement in the reliability of the recording management data RMD), which improves the usability of information acquisition. Placing the RDZ lead-in area RDZLI closer to the inner periphery than the recording management zone RMZ shortens the time required to acquire necessary information. When an information storage medium is installed in the information recording and reproducing apparatus, the information recording and reproducing apparatus starts reproduction at the burst cutting area BCA provided at the innermost periphery as shown in FIG. 9, moves the reproducing position gradually toward the outside, and changes the reproducing place from the system lead-in area SYLDI to the data lead-in area DTLDI. The information recording and reproducing apparatus determines whether information has been recorded in the RDZ lead-in area RDZLI in the RMD duplication zone RDZ. In a recordable information storage medium which is immediately after shipment and hasn't ever been recorded into, since no recording management data RMD has been recorded in the recording management zone RMD, if no information has been recorded in the RDZ lead-in area RDZLI, the information recording and reproducing apparatus determines that it is “immediately after shipment and unused,” which enables the reproduction of the recording management zone RMZ to be omitted and therefore the time required to collect information to be shortened.

As shown in the diagram (c) of FIG. 17, information on an information recording and reproducing apparatus which used (started to record data into) a recordable information storage medium immediately after shipment for the first time is recorded in the unique ID area UIDF. That is, the drive maker ID 281 for the information recording and reproducing apparatus, the serial number 283 of the information recording and reproducing apparatus, and the model number 285 are recorded. In the unique ID area UIDF, 2 KB (to be exact, 2048 bytes) of the same information shown in the diagram (c) of FIG. 17 is recorded repeatedly eight times. As shown in the diagram (d) of FIG. 17, year information 293, month information 294, day information 295, hour information 296, minute information 297, and second information 298 about the time that the information storage medium was used (or recorded into) for the first time are recorded into the unique disk ID 287. The data types of the individual pieces of information are written in HEX, BIN, and ASCII. The number of bytes used is either 2 bytes or 4 bytes.

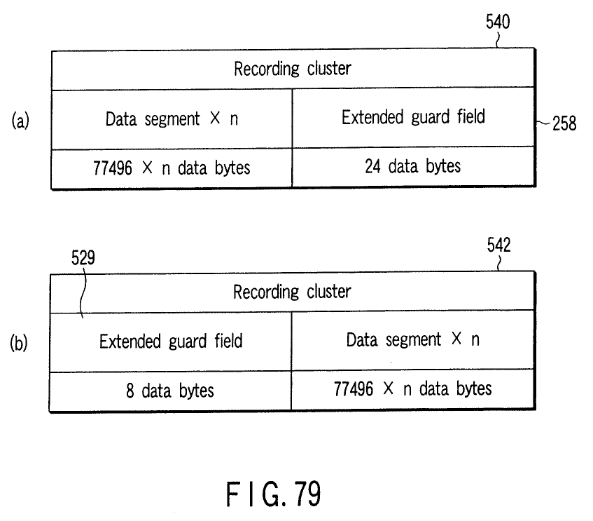

This embodiment is characterized in that each of the size of the area of RDZ lead-in area RDZLI and the size of an item of the recording management data RMD is 64 KB, that is, an integral multiple of the user data size in a single ECC block (point (C5) in FIG. 125C). In the case of a recordable information storage medium, after a part of the data in one ECC block are changed, the changed data in the ECC block cannot be rewritten on the information storage medium. Therefore, particularly in the case of the recordable information storage medium, the data is recorded in units of a recording cluster (b) composed of an integral multiple of a data segment including one ECC block as shown in the diagram (b) of FIG. 79. Thus, if the size of the area of RDZ lead-in area RDZLI and the size of one item of the recording management data RMD differ from the user data size in the ECC block, a padding area or a stuffing area to match with the recording cluster unit is needed, which practically lowers the recording efficiency. In the embodiment, the size of the area of RDZ lead-in area RDZLI and the size of one item of the recording management data RMD are set to an integral multiple of 64 KB, thereby preventing the recording density from decreasing.

The corresponding RMZ last recording management data RMD recording area 271 in the diagram (b) of FIG. 17 will be explained. As described earlier, there is a method of recording intermediate information during the interruption of recording in the lead-in area as described in Japanese Patent No. 2621459 as prior art. In this case, each time recording is interrupted or each time additional recording is done, intermediate information (in the embodiment, recording management data RMD) must be additionally recording one after another. Therefore, if recording is interrupted frequently or if additional recording is done frequently, a problem arises: the area is soon filled and therefore, an additional recording cannot be done. To solve this problem, the present invention is characterized in that an RMD duplication zone RDZ is set as an area in which the updated recording management data RMD can be recorded only when special conditions are fulfilled and the recording management data RMD sampled out under the special conditions are recorded. In this way, the frequency of addition of recording management data RMD to the RMD duplication zone RDZ is lowered, which prevents the RMD duplication zone RDZ from being filled and increases the number of times of additional recording into the recordable information storage medium remarkably.

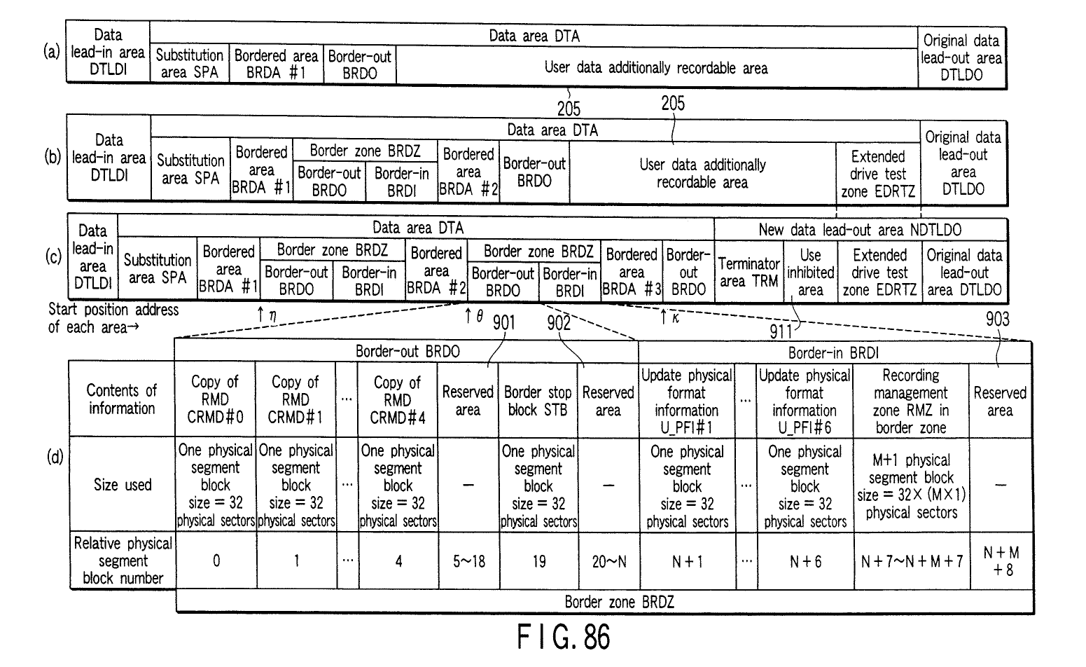

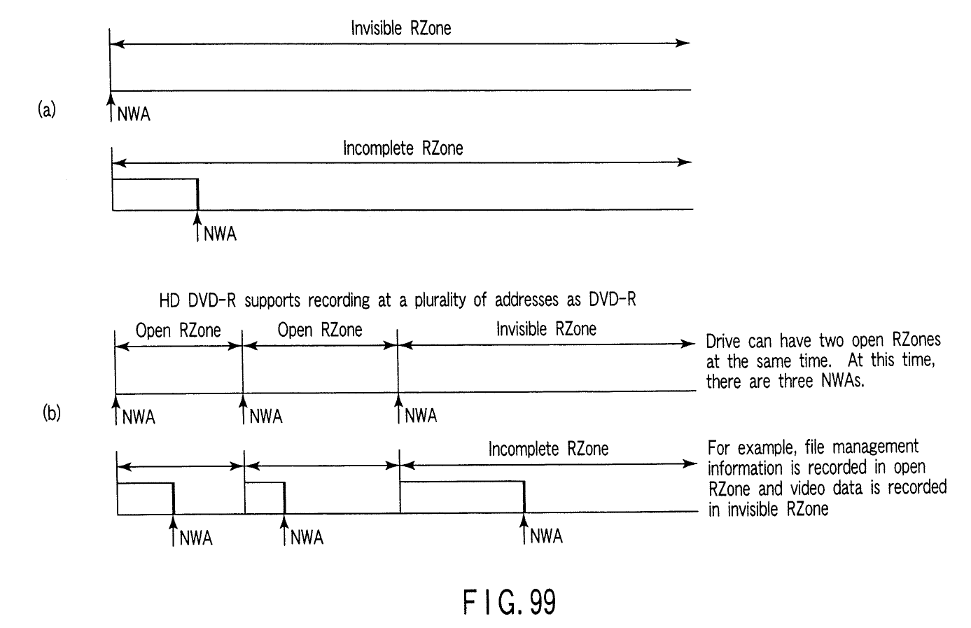

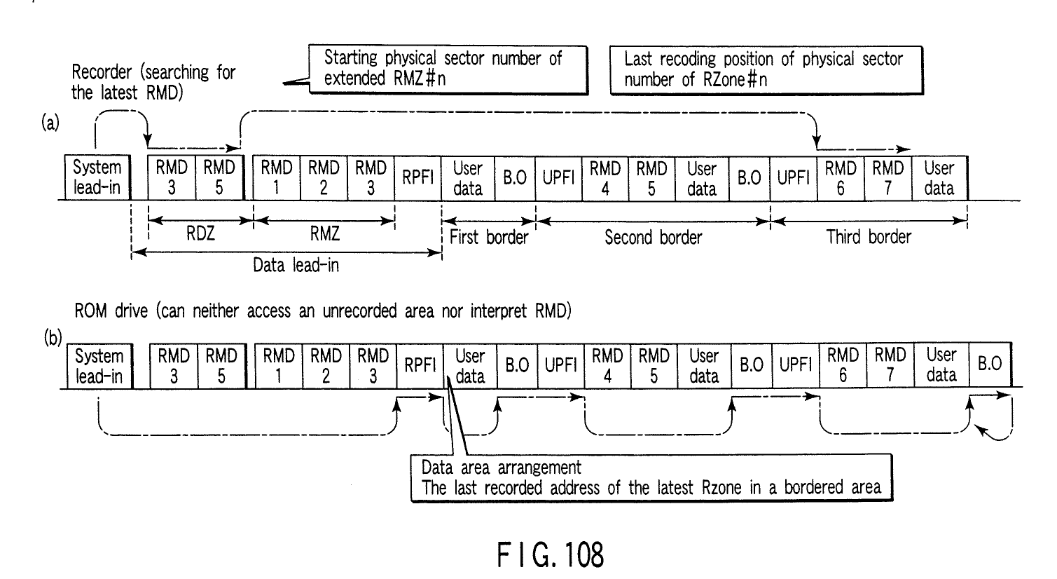

In parallel with this, recording management data RMD updated every additional recording is recorded additionally into the recording management zone RMZ in the border-in area BRDI of FIG. 86 (or into the data lead-in area DTLI in the first bordered area BRDA#1 as shown in the diagram (a) of FIG. 17) or into the recording management zone using an R zone shown in FIG. 99. Then, when a new recording management zone RMZ is created, such as when the next bordered area BRDA is created (or a new border-in area BRDI is set) or when a new recording management zone RMZ is created in the R zone, the last recording management data RMD (or the latest one immediately before a new recording management zone RMZ is formed) is recorded in (the corresponding RMZ last recording management data RMD recording area 271 in) the RMD duplication zone RDZ (point (C4) in FIG. 125C). As a result, the number of times of additional recording into a recordable information storage medium increases remarkably. Use of this area makes it easier to retrieve the position of the latest RMD. A method of retrieving the position of the latest RMD using the area will be explained later using FIG. 108.

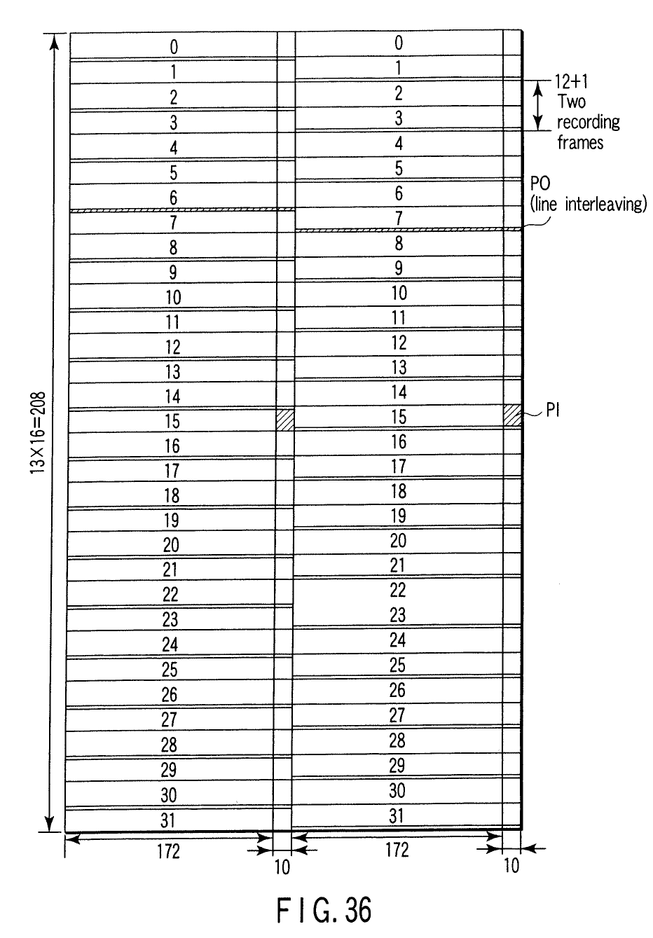

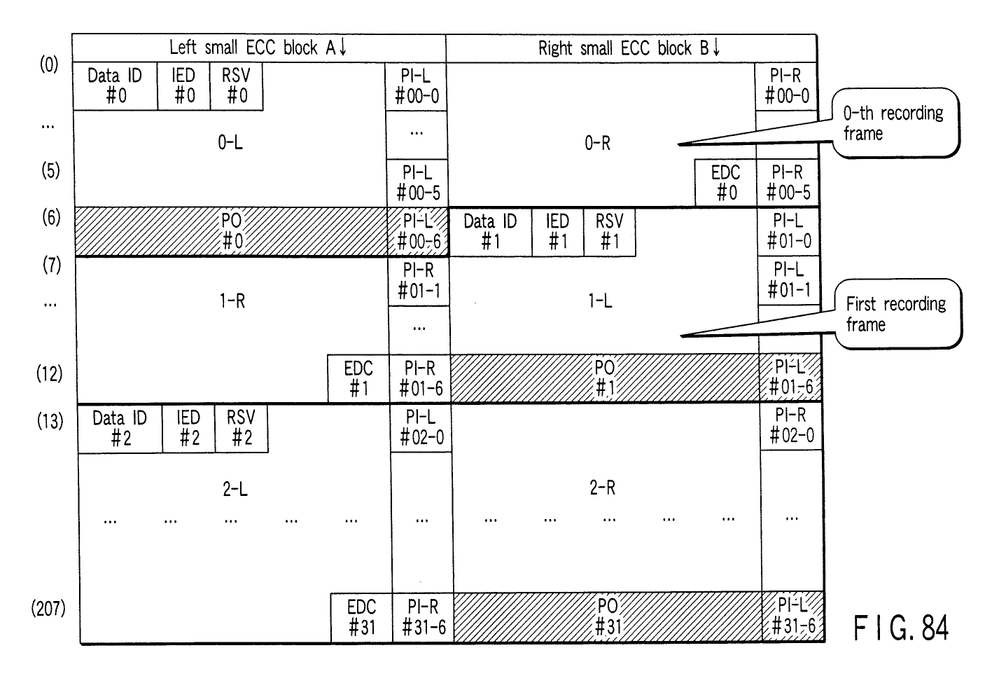

FIG. 85 shows a data structure of the recording management data RMD shown in FIG. 17. Diagrams (a) and (b) of FIG. 85 are the same as those of FIG. 17. As described above, in this embodiment, since the border-in area BRDI for the first bordered area BRDA#1 is partly shared with the data lead-in area DTLDI, recording management data RMD#1 to RMD#3 corresponding to the first bordered area are recorded in the recording management zone RMZ in the data lead-in area DTLDI. When no data is recorded in the data area DTA, the recording management zone RMZ is a reserved area 273, which is an unrecorded state. Each time data is recorded additionally into the data area DTA, updated recording management data RMD is recorded in the beginning place of the reserved area 273. Recording management data RMD corresponding to the first bordered area in the recording management zone RMZ is added one after another. The size of recording management data RMD recorded additionally each time in the recording management zone RMZ is set to 64 Kbytes (point (C5) in FIG. 125C). As shown in FIG. 36 or FIG. 84, in this embodiment, to create one ECC block using 64 KB of data, the data size of recording management data RMD is made equal to one ECC block size, thereby simplifying the additional recording process.

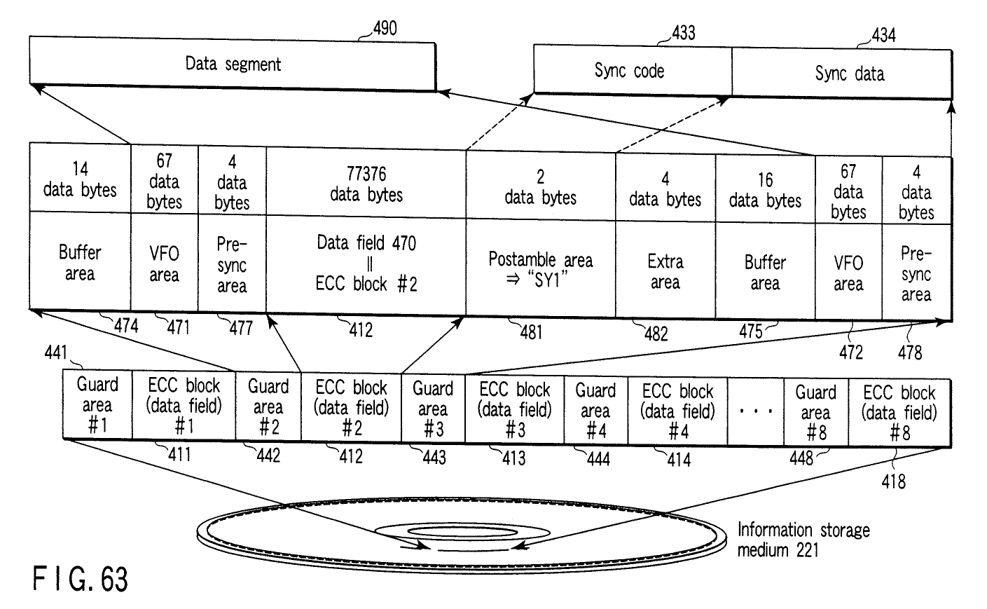

As shown in FIGS. 63, 69, and 80, in this embodiment, part of the guard areas 442, 443 are added in front of and behind one ECC block 412, thereby constructing a data segment 490. Extended guard fields 258, 259 are added to one or more (an n number of) data segments, thereby constructing recording clusters 540, 542, which are additional recording units or rewriting units. When recording management data RMD is recorded, recording management data RMD is added sequentially as recording clusters 540, 542 including only one data segment (one ECC block) in the recording management zone RMZ. As shown in FIG. 69, the length of a place in which one data segment 531 is recorded coincides with the length of one physical segment block composed of seven physical segments 550 to 556.

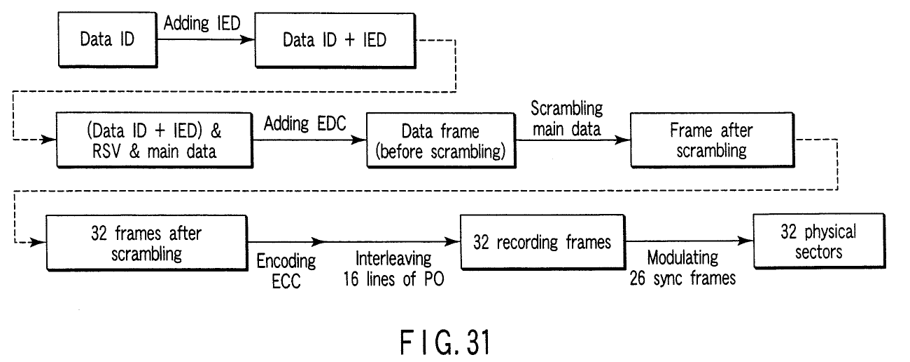

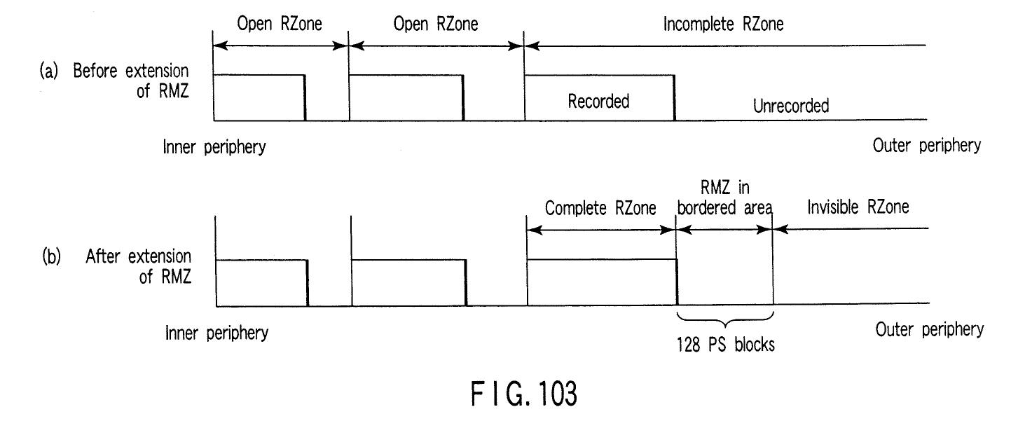

The diagram (c) of FIG. 85 shows a data structure of recording management data RMD#1. In the diagram (c) of FIG. 85, the data structure of recording management data RMD#1 in the data lead-in area DTLDI is shown. Recording management data RMD#A, RMD#B (the diagram (b) of FIG. 17) recorded in the RMD duplication zone RDZ, (extended) recording management data RMD (the diagram (d) of FIG. 86) recorded in border-in area BRDI explained later, (extended) recording management data RMD (FIG. 103) recorded in the R zone, and RMD copy CRMD (the diagram (d) of FIG. 86) recorded in the border-out area BRDO also have the same structure. As shown in the diagram (c) of FIG. 85, an item of recording management data RMD is made up of a reserved area and “0” to “21” RMD fields. As explained later using FIG. 31, one ECC block composed of 64 KB of user data contains 32 physical sectors. In one physical sector, 2 KB (to be exact, 2048 bytes) of user data are recorded. According to the user data size recorded in one physical sector, the individual RMD fields are divided in units of 2048 bytes and are assigned relative physical sector numbers. RMD fields are recorded on a recordable information storage medium in the order of the relative physical sector numbers.

The outline of data content recorded in each RMD field is as follows:

RMD field 0—Information on the disk state and data area allocation (information on the location of various data in the data area)

RMD field 1—Information on the test zone used and recorded recording waveforms

RMD field 2—Area available to the user

RMD field 3—Information on the starting position of the border area and the position of extended RMZ

RMD fields 4 to 21—Information on the position of R zone

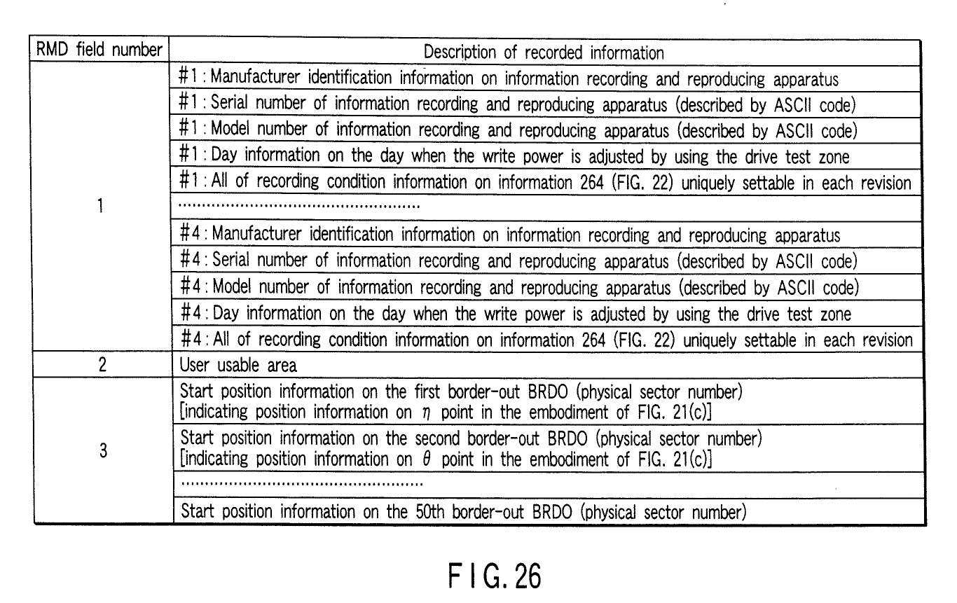

The contents of concrete information in recording management data RMD will be explained later using FIGS. 25 to 30. The contents of information in the R physical information zone RIA shown in the diagram (c) of FIG. 16 will also be explained in detail later using FIGS. 22 to 24.

As shown in the diagrams (a) to (c) of FIG. 16, this embodiment is characterized in that the system lead-in area SYLDI is provided opposite the data area, with the data lead-in area DTLDI between them, in each of a read-only, a recordable, and a rewritable information storage medium (point (B4)) in FIG. 125A) and further in that the burst cutting area BCA is provided opposite to the data lead-in area DTLDI, with the system lead-in area SYLDI between them as shown in FIG. 9. When an information storage medium is mounted in an information reproducing apparatus or an information recording and reproducing apparatus, the information reproducing apparatus or information recording and reproducing apparatus carries out processes in this order:

Reproducing the information in the burst cutting area BCA
(2) Reproducing the information in the control data zone CDZ of the system lead-in area SYLDI
(3) Reproducing the information in the data lead-in area DTLDI (in the case of a recordable or a rewritable information storage medium)
(4) Readjusting (optimizing) the reproducing circuit constant in the reference code recording zone RCZ
(5) Reproducing the information recorded in the data area DTA or recording new information

As shown in FIG. 16, since pieces of information are arranged from the inner periphery in the order of the above processes, unnecessary access to the inner part is not needed and the data area DTA can be reached with a decreased number of accesses, which produces the effect of making faster the reproduction of the information recorded in the data area DTA or making earlier the starting time of recording new information. Since the slice level detecting method is used to reproduce the signal in the system lead-in area SYLDI (point [B] in FIG. 125A) and the PRML method is used to reproduce the signal in the data lead-in area DTLDI and the data area DTA (point [A] in FIG. 125A), if the data lead-in area DTLDI is arrange next to the data area DTA, when the data is reproduced sequentially from the inner periphery, the slice level detector is switched to the PRML detector only once between the system lead-in area SYLDI and the data lead-in area DTLDI, which enables the signal to be reproduced continuously stably. Therefore, the number of times the reproducing circuits are switched according to the reproducing procedure is smaller, which simplifies processing control and therefore makes the reproduction starting time in the data area earlier.

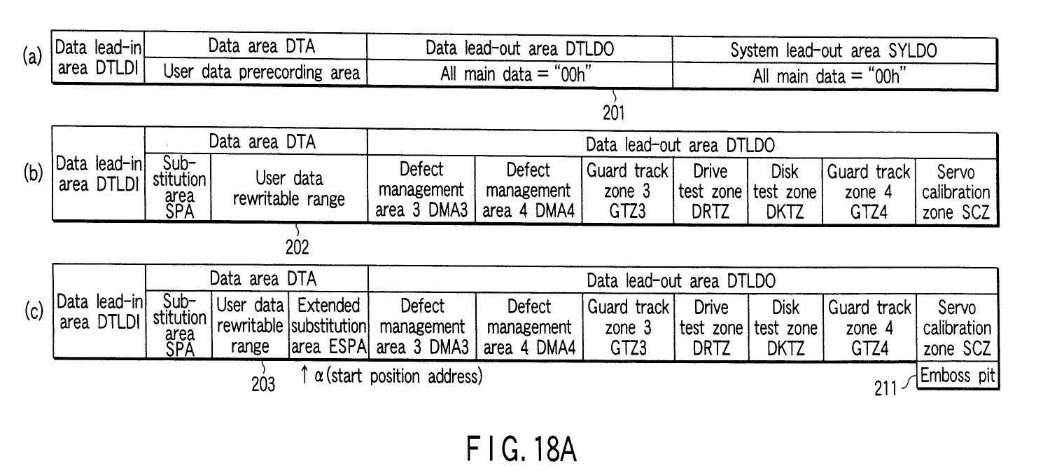

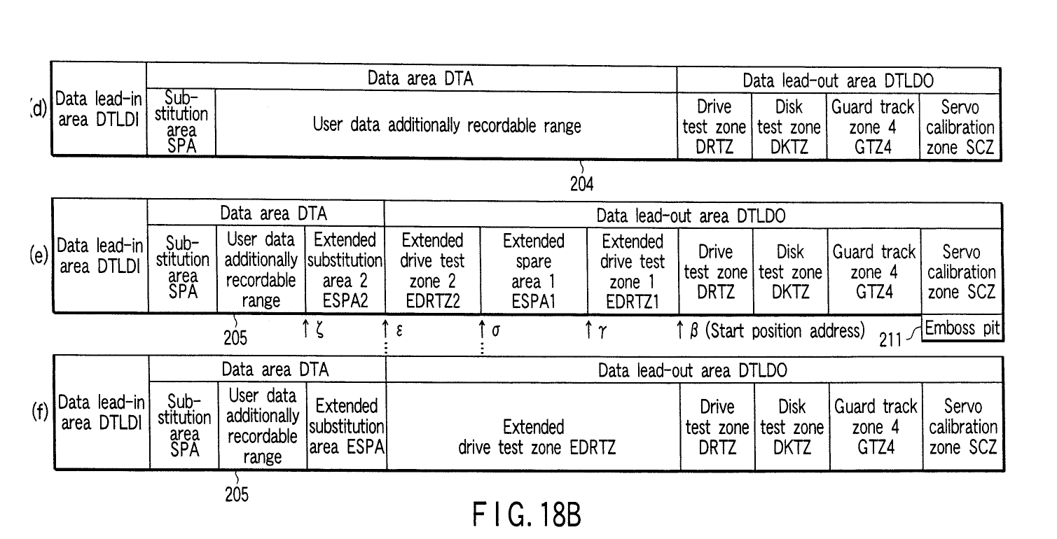

FIGS. 18A and 18B shows a comparison of a data structure of the data area DTA and data lead-out area DTLDO between the various types of information storage medium. The diagram (a) of FIG. 18A shows a data structure of a read-only information storage medium. Diagrams (b) and (c) of FIG. 18A show a data structure of a rewritable information storage medium. Diagrams (d) to (f) of FIG. 18B show a data structure of a recordable information storage medium. Diagrams (b) and (d) show a data structure in the initial state (before recording). Diagrams (c), (e) and (f) show a data structure in a state where recording (additional recording or rewriting) has progressed to some extent.

As shown in diagram (a), in a read-only information storage medium, the data recorded in the data lead-out area DTLDO and system lead-out area SYLDO has a data frame structure (which will be described later) as in the first and second buffer zones BFZ1, BFZ2 of FIG. 16. All of the main data there are set to “00h.” In a read-only information storage medium, all of the area of the data area DTA can be used as a user data prerecording area 201. As described later, in each embodiment of a recordable and a rewritable information storage medium, user data rewritable/additionally recordable range are made narrower than the data area DTA.

In a recordable information storage medium or a rewritable information storage medium, a substitution area SPA is provided in the innermost part of the data area DTA. If a defective part occurs in the data area DTA, a substituting process is carried out using the substitution area SPA. In the case of a rewritable information storage medium, the substitute history information (defect management information) is recorded into the first and second defect management areas DMA1, DMA2 of diagram (b) of FIG. 16 and into the third and fourth defect management areas DMA3, DMA4 of diagrams (b) and (c) of FIG. 18A. The defect management information recorded in the third and fourth defect management areas DMA3, DMA4 of diagrams (b) and (c) of FIG. 18A is the same as that recorded in the first and second defect management areas DMA1, DMA2 of diagram (b) of FIG. 16. In the case of a recordable information storage medium, substitute history information (defect management information) when a substituting process is carried out is recorded in the data lead-in area DTLDI of diagram (c) of FIG. 16 and in copy information C_RMZ about the contents of recording into a recording management zone existing in a border zone explained later. While defect management is not performed on an existing DVD-R disk, there have been strong demands that the reliability of information recorded on a recordable information storage medium should be increased, because an increase in the number of DVD-R disks manufactured has permitted partially defective DVD-R disks to appear on the market. In this embodiment, as shown in diagrams (d) to (f) of FIG. 18B, a substitution area SPA is also provided in a recordable information storage medium, which enables defect management by a substituting process. Therefore, even if a recordable information storage medium is partially defective, the medium is subjected to a defect management process, which enables the reliability of the recorded information to be improved.

In a rewritable information storage medium or a recordable information storage medium, if many defects have occurred, the information recording and reproducing apparatus on the user side make a determination and brings the medium into the state immediately after the user purchased the medium as shown in diagrams (b) and (d) and automatically sets extended substitution areas ESPA, ESPA1, ESPA2 to expand the substitution place. In this way, the extended substitution areas ESPA, ESPA1, ESPA2 are made settable, which makes it possible to sell media with many defects due to manufacturing conditions. As a result, the manufacturing yield of the medium increases, which enables the price of the medium to get lower?

As shown in diagrams (c), (e) and (f), when extended substitution areas ESPA, ESPA1, ESPA2 are further provided in the data area DTA, the user data rewriting or the additionally recordable ranges 203, 205 decreases. Therefore, the position information must be managed. In a rewritable information storage medium, the information is recorded in the first to fourth defect management areas DMA1 to DMA4 and further in the control data zone CDZ as described later. In the case of a recordable information storage medium, the information is recorded in the data lead-in area DTLDI and the recording management zone RMZ existing in the border-out area BRDO as described later. As described later, the information is recorded in the recording management data RMD in the recording management zone RMZ. Since the recording management data RMD is additionally recorded in the recording management zone RMZ in a updating manner each time the contents of the management data are updated, the information can be updated and managed with good timing, even if how many times the extended substitution area is set again (the embodiment shown in diagram (e) of FIG. 18B shows a state where extended substitution area 1 EAPA1 is set and where even after the extended substitution area 1 EAPA is all used up, defects are so many that another substitution area has to be set and therefore an extended substitution area 2 ESPA2 is further set later).

A third guard track zone GTZ3 shown in diagrams (b) and (c) of FIG. 18A is provided to separate a fourth defect management area DMA4 and a drive test zone DRTZ from each other. A guard track zone GTZ4 is provided to separate a disk test zone DKTZ and a servo calibration zone SCZ from each other. Like the first and second guard track zones GTZ1, GTZ2, the third and fourth guard track zones GTZ3, GTZ4 are determined to areas in which recording must not be done in recording mark form. Since the third and fourth guard track zones GTZ3, GTZ4 exist in the data lead-out area DTLDO, a pre-groove area has been formed in these areas in a recordable information storage medium and a groove area and a land area have been formed in these area in a rewritable information storage medium. Since a wobble address has been recorded in the pre-groove area or the groove area and land area as shown in FIGS. 13 to 15, the present position on the information storage medium is determined using the wobble address.

As in FIG. 16, a drive test zone DRTZ is secured as an area for the information recording and reproducing apparatus to do test recording before recording information onto the information storage medium. After the information recording and reproducing apparatus does test recording in this area beforehand and calculates the optimum recording condition (write strategy), it can record information in the data area DTA under the optimum recording condition.

As in FIG. 16, a disk text zone DKTZ is an area for the information storage medium manufacturer to conduct a quality test (evaluation).

In a recordable information storage medium, a pre-groove area has been formed in all of the area of the data lead-out area DTLDO excluding the servo calibration zone SCZ. In a rewritable information storage medium, a groove area and a land area have been formed in the same area. This enables recording marks to be recorded (or additionally recorded or rewritten). As shown in diagram (c) of FIG. 18A and diagram (e) of FIG. 18B, the servo calibration zone SCZ is made up of an emboss pit area 211 in place of the pre-groove area 214 or land area and groove area 213 as in the system lead-in area SYLDI. This area forms a continuous track of emboss pits following the other area in the data lead-out area DTLDO. The track, which is spirally continuous, forms emboss pits along the circumference of the information storage medium through 360 degrees. The area is provided to detect the amount of tilt of the information storage medium using a DPD (Deferential Phase Detecting) method. If the information storage medium inclines, an offset occurs in the track shift sense signal amplitude using the DPD method. It is possible to detect the amount of tilt from the magnitude of the offset and the direction of tilt from the offset direction with high accuracy. Using the principle, an emboss pit which enables DPD detection is formed in the outermost periphery of the information storage medium (or the outer periphery of the data lead-out area DTLDO) in advance, which enables the tilt to be detected inexpensively with high accuracy without adding a (tilt detecting) special part to the optical head existing in the information recording and reproducing unit 141 of FIG. 1. Furthermore, by detecting the amount of tilt at the outer periphery, the stabilization of servo can be realized even in the data area DTA (by tilt amount correction).

In this embodiment, the track pitch in the servo calibration zone SCZ is caused to match with another area in the data lead-out area DTLDO, thereby improving the productivity of the information storage medium, which enables the medium to be produced at lower cost as a result of an improvement in the yield. Specifically, in a recordable information storage medium, a pre-groove is formed in the other area in the data lead-out area DTLDO. When a master disk of a recordable information storage medium is manufactured, the pre-groove is made by keeping constant the feed motor speed of the exposure unit of the master disk manufacturing apparatus. At this time, the track pitch in the servo calibration area SCS is caused to match with the other area of the data lead-out area DTLDO, thereby keeping constant the feed motor speed also in the servo calibration zone SCZ, which makes pitch irregularities less liable to take place and therefore improves the productivity of the information storage medium.

Another embodiment is a method of causing at least one of the track pitch or data bit length in the servo calibration zone SCZ to match with the track pitch or data bit length in the system lead-in area SYLDI. As described above, the amount of tilt and the direction of tilt in the servo calibration zone SCZ have been measured using the DPD method. Using the result in the data area DTA too, the servo has been stabilized in the data area DTZ. A method of estimating the amount of tilt in the data area DTA is to measure the amount of tilt and its direction in the system lead-in area SYLDI in advance by the DPD and estimate the amount of tilt using the relationship with the result of measurements in the servo calibration zone SCZ. When the DPD method is used, the amount of offset of the sense signal amplitude to the tilt of the information storage medium and the direction in which an offset appears change, depending on the track pitch of the emboss pit and the data bit length. Therefore, at least one of the track pitch or data bit length in the servo calibration zone SCZ is caused to match with the track pitch or data bit length in the system lead-in area SYLDI, thereby causing the amount of offset of the sense signal amplitude and the detection characteristic in the direction in which an offset occurs to coincide with that in the servo calibration zone SCZ and system lead-in area SYLDI, which produces the effect of making it easier to correlate them and to estimate the amount of tilt and the direction of tilt in the data area DTA.

As shown in diagram (c) of FIG. 16 and diagram (c) of FIG. 18A, in a recordable information storage medium, a drive test zone DRTZ is provided on each of the inner periphery side and the outer periphery side. The larger the number of times of test recording to the drive test zone DRTZ, the more minutely the optimum recording condition can be searched for by minutely assigning detailed parameters. This improves the recording accuracy for the data area DTA. In a rewritable information storage medium, the drive test zone DRTZ can be reused by rewriting. In a recordable information storage medium, when an attempt is made to raise the recording accuracy by increasing the number of times of test recording, a problem arises: the drive test zone DRTZ is used up soon. To solve this problem, this embodiment is characterized in that an extended drive test zone EDRTZ can be set in a direction from the outer periphery toward the inner periphery as needed, thereby enabling the extension of a drive test zone (point (E2) in FIG. 127). In the embodiment, the method of setting an extended drive test zone and the method of doing test recording in the set extended drive test zone are characterized in that:

Extended drive test zones EDRTZ are set (or framed) collectively one after another from the outer periphery (closer to the data lead-out area DTLDO) toward the inner periphery.

As shown in diagram (e) of FIG. 18A, extended drive test zone 1 EDRTZ1 is set as a collective area in the place closest to the outer periphery in the data area (or the place closest to the data lead-out area DTLDO). After extended drive test zone 1 EDRTZ1 is used up, extended drive test zone 2 EDRTZ2 can be set as a collective area existing closer to the inner periphery than extended drive test zone 1 EDRTZ1.

Test recording is done from the inner periphery side in the extended drive test zone EDRTZ (point (E3) in FIG. 125D).

When test recording is done in the extended drive test zone EDRTZ, it is done along the groove area 214 provided spirally from the inner periphery toward the outer periphery. Present test recording is performed in an unrecorded place immediately behind the (recorded) place in which the preceding test recording was done.

The data area is so configured that additional recording is done along the groove area 214 provided spirally from the inner periphery toward the outer periphery. Test recording in the extended drive test zone is done behind the place where the preceding test recording was done, making it possible to carry out the process of “checking the place where the preceding test recording was done”<the process of “doing the present test recording” serially in that order, which not only facilitates the test recording process but also makes it easier to manage the places where test recording was done in the extended drive test zone EDRTZ.

Data lead-out area DTLDO including the extended drive test zone EDRTZ can be set again (point (E4) in FIG. 125D)

The diagram (e) of FIG. 18B shows an example of setting two extended substitution areas ESPA1, ESPA2 and two extended drive test zones EDRTZ1, EDRTZ2 in the data area DTA. In this case, this embodiment is characterized in that data lead-out area DTLDO can be set again in the area including the extended drive test zone EDRTZ2 as shown in the diagram (f) of FIG. 18B (point (E4) in FIG. 125D). In parallel with this, the range of the data area DTA is set again in such a manner that the range is made narrower, which makes it easier to manage the user data additionally recordable range 205 existing in the data area DTA. If resetting is done as shown in the diagram (f) of FIG. 18B, the extended substitution area ESPA1 setting place shown in the diagram (e) of FIG. 18B is regarded as “already used-up extended substitution area” and it is determined that an unrecorded area (additional test recording allowable area) exists only in the extended substitution area ESPA2 in the extended drive test zone EDRTZ. In this case, nondefective information recorded in the extended substitution area ESPA1 and used for substitution is moved bodily to an unsubstituted area in the extended substitution area ESPA2 and the defect management information is rewritten. At this time, the starting position information on the reset data lead-out area DTLDO is recorded in the arrangement location information of the latest (updated) data area DTA in RMD field of the recording management data RMD as shown in FIGS. 25 to 30.

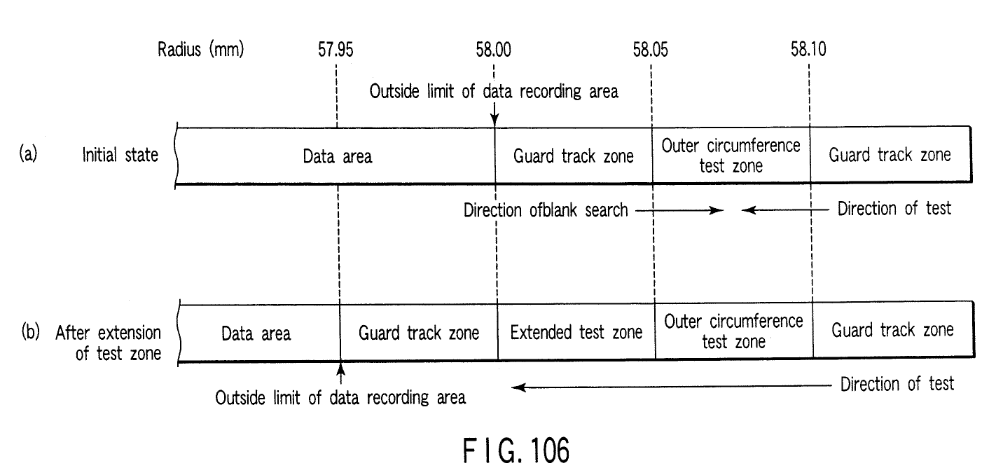

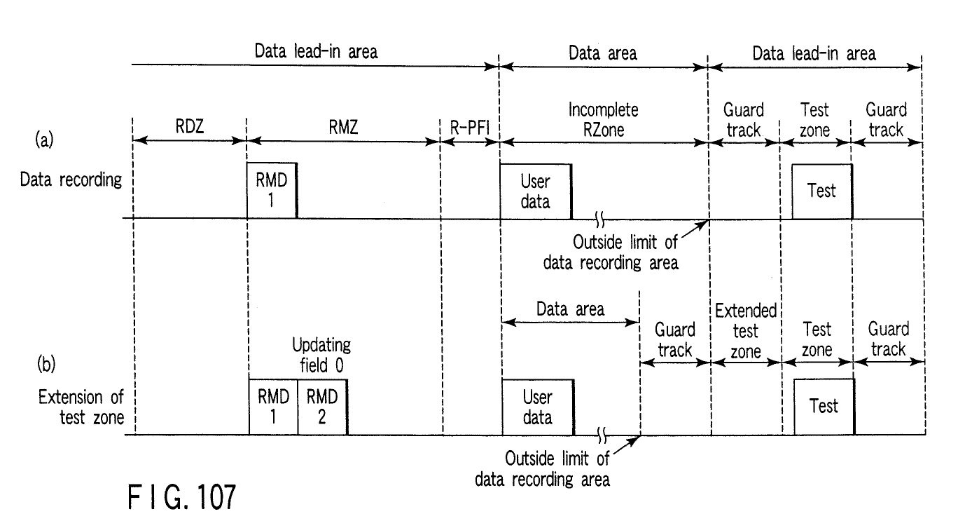

Referring to FIGS. 106 and 107, the extension of a test zone will be explained.

A test zone is an area for optimizing a recording waveform. There are an inner-periphery test zone and an outer-periphery test zone. As shown in the diagram (a) of FIG. 106, in the initial state, there are a guard track zone, an outer-periphery test zone, and a guard track zone outside a data area. The boundary between the data area and the guard track zone is the outer-periphery-side limit of the data recording area. Blank search is made from the inner periphery toward the outer periphery and a test is conducted from the outer periphery toward the inner periphery. Recording for optimization is done, starting with the outermost part of the test zone. The last address used is stored in RMD. As shown in the diagram (b) of FIG. 106, the outer-periphery test zone can be extended only once. The extended test zone is set to the previous guard track zone. The guard track zone is shifted that much toward the inner periphery, making the data area narrower. As shown in the diagram (a) of FIG. 107, if the test zone is filled up before the data is filled up, a guard track is newly set in the peripheral part of the data area as shown in the diagram (b) of FIG. 107 and the previous guard track is set as an extended test zone. At the same time, the updated recording management data RMD is additionally recorded in the recording management zone RMZ in the data lead-in area DTLDI.

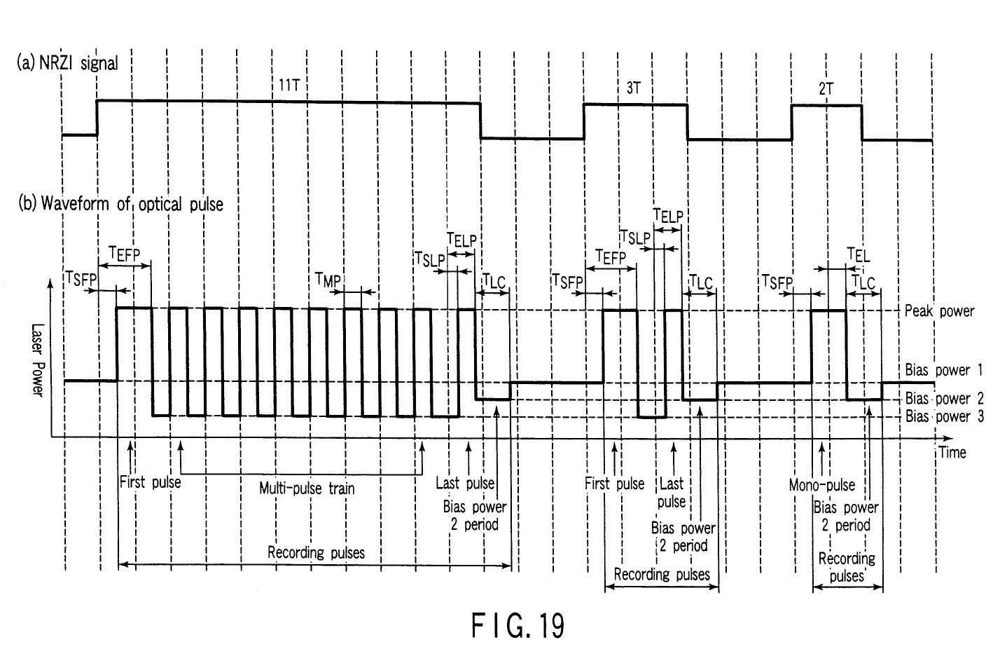

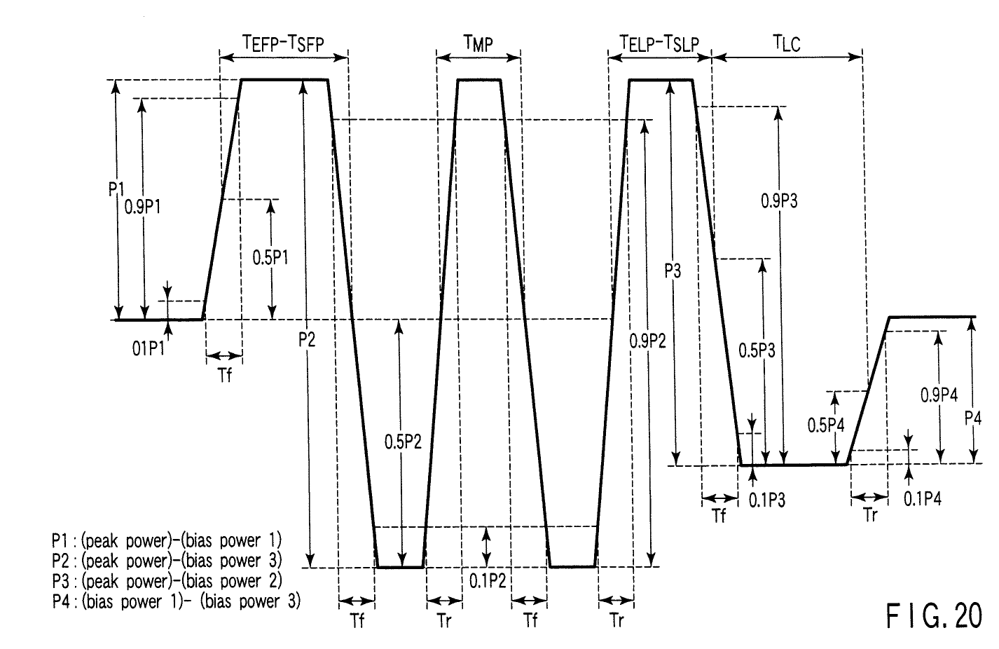

FIG. 19 shows a waveform (write strategy) of recording pulses used for test recording to the drive test zone. FIG. 20 shows a definition of a recording pulse form.

Marks and spaces are written over a disk by irradiating pulses of peak power, first bias power, second bias power, and third bias power. Marks are overwritten on a disk by irradiating pulses modulated between the peak power and the third bias power. Spaces are overwritten on a disk by irradiating pulses of the first bias power.

SbER, which is means for evaluating random errors, corresponds to a bit error rate caused by random errors.

Before measuring PRSNR and SbER, the coefficient of the equalizer is calculated using a minimum square error (MSE) algorithm.

Recording pulses are made up of optical pulses as shown in FIG. 19.

A recording pulse with a 2 T mark is composed of a mono pulse and a pulse of the second bias power following the mono pulse. A recording pulse with a 3 T mark is composed of a first pulse, a last pulse, and a pulse of the second bias power following the last pulse. A recoding pulse with a 3 T mark or more is composed of a first pulse, a multi-pulse train, a last pulse, and a pulse of the second bias power following the last pulse. A T is a cannel clock period.

<Recording Pulse Structure for a 2 T Mark>

T_{SFP} after the rising edge of an NRZI signal, the generation of a mono pulse is started. The generation is completed 1 T−T_{ELP} before the falling edge of the NRZI signal. The period of the mono pulse is 1 T−T_{ELP}+T_{SFP}−T_{ELP} and T_{SFP} are recorded in the control data zone. The period of the second bias power following the mono pulse is T_{LC}. T_{LC} is recorded in the control data zone.

<Recording Pulse Structure for 2 T or More Mark>

T_{SEP} after the rising edge of an NRZI signal, the generation of a first pulse is started. T_{EFP} after the falling edge of the NRZI signal, the generation is completed. T_{EFP} and T_{SEP} are recorded in the control data zone. A recording pulse corresponding to 4 T to 13 T is a multi-pulse train. The multi-pulse train is a repetition of a pulse with a pulse width of TMP and a period of T. 2 T after the rising edge of the NRZI signal, the generation of a multi-pulse is started. 2 T before the falling edge of the NRZI signal, the generation of the last pulse in the multi-pulse train is completed. T_{MP} is recorded in the control data zone.

1 T−T_{SLP} before the rising edge of the NRZI signal, the generation of the last pulse is started. 1 T−T_{ELP} before the falling edge of the NRZI signal, the generation of the last pulse is completed.

T_{ELP} and T_{SLP} are recorded in the control data zone.

The pulse width of the pulse of the second bias power following the last pulse is T_{LC}. T_{LC} is recorded in the control data zone.

T_{EFP}−T_{SFP}, T_{MP}, T_{ELP}−T_{SLP}, and T_{LC} are the maximum periods of a half width. The maximum periods of the half width of each optical pulse are defined in FIG. 20. The rising period Tr and the falling period Tf are 1.5 ns or less. The difference between the rising period Tr and the falling period Tf is 0.5 ns or less.

T_{SFP}, T_{EFP}, T_{SLP}, T_{ELP}, T_{MP}, and T_{LC} are recorded in the control data zone in units of ( 1/32)T. They take the following values:

T_{SFP} is 0.25 T or more and 1.50 T or less.

T_{ELP} is 0.00 T or more and 1.00 T or less.

T_{EFP} is 1.00 T or more and 1.75 T or less.

T_{SLP} is −0.10 or more and 1.00 T or less.

T_{LC} is 0.00 T or more and 1.00 T or less.

T_{MP} is 0.15 T or more and 0.75 T or less.

The following restrictions are imposed on adaptive control parameters T_{SFP}, T_{ELP}, and T_{LC}:

The difference between the maximum value and minimum value of T_{SFP} is 0.50 T or less.

The difference between the maximum value and minimum value of T_{ELP} is 0.50 T or less.

The difference between the maximum value and minimum value of T_{LC} is 1.00 T or less.

The width of mono pulse 1 T−T_{SFP}+T_{ELP} is 0.25 T or more and 1.50 T or less.

These parameters are controlled with a precision of ±0.2 ns.

If the peak power period of the first pulse and that of the multi-pulse train overlap with each other, a composite peak power period is the sum total of these consecutive peak power periods. If the peak power period of the first pulse and that of the last pulse overlap with each other, a composite peak power period is the sum total of these consecutive peak power periods. If the peak power period of the end pulse in the multi-pulse train and that of the last pulse overlap with each other, a composite peak power period is the sum total of these consecutive peak power periods.

The recording power has the following four levels: peak power, first bias power, second bias power, and third bias power. These are optical power which are projected onto the reading surface of a disk and used to record marks and spaces.

The peak power, first bias power, second bias power, and third bias power are recorded in the control data zone. The maximum value of the peak power does not exceed, for example, 10.0 mW. The maximum value of each of the first bias power, second bias power, and third bias power does not exceed, for example, 4.0 mW.

The average peak power of each of the mono pulse, first pulse, and last pulse fulfills the following requirement:
|(average peak power)−(peak power)|≦5% of peak power

The average first bias power and average second bias power fulfill the following requirements:
|(average first peak power)−(first bias power)|≦5% of first bias power
|(average second peak power)−(second bias power)|≦5% of second bias power

The average power of the multi-pulse train is the average power of an instantaneous value of the power in the measuring period.

The measuring period includes all of the multi-pulse train and is a multiple of T. The average power of the multi-pulse train fulfills the following requirement:
|(average power of multi-pulse train)−(peak power+third bias power)/2|≦5% of (peak power+second bias power)/2

An instantaneous value of power is an instantaneous value of actual power.

The average power is the average value of an instantaneous value of power in a specific power range.

The power range of the average value of power satisfies the following requirements:
the average value of peak power: |(actual power)−(peak power)|≦10% of peak power
the average value of first bias power: |(actual power)−(first bias power)|≦10% of first bias power
the average value of second bias power: |(actual power)−(second bias power)|≦10% of second bias power
the average value of third bias power: |(actual power)−(third bias power)|≦10% of third bias power

The period required to measure the average power does not exceed the pulse width period of each pulse.

Instantaneous-value power satisfies the following requirements:
|(instantaneous-value peak power)−(peak power)|≦10% of peak power
|(instantaneous-value first bias power)−(first bias power)|≦10% of first bias power
|(instantaneous-value second bias power)−(second bias power)|≦10% of second bias power
|(instantaneous-value third bias power)−(third bias power)|≦10% of third bias power

To control the mark edge position accurately, the timing of the first pulse, last pulse, and mono pulse is modulated.

The mark lengths of NRZI are classified into M2, M3, and M4. The mark lengths M2, M3, and M4 indicate 2 T, 3 T, and 3 T or more, respectively.

The space lengths immediately in front of a mark are classified into LS2, LS3, and LS4. The space lengths LS2, LS3, and LS4 indicate 2 T, 3 T, and 3 T or more, respectively.

The space lengths immediately behind a mark are classified into TS2, TS3, and TS4. The space lengths TS2, TS3, and TS4 indicate 2 T, 3 T, and 3 T or more, respectively.

T_{LC} is modulated as a function of the category of the mark length of NRZI. Therefore, T_{LC} has the following three values:

T_{LC}(M2), T_{LC}(M3), T_{LC}(M4)

T_{LC}(M) represents the value of T_{LC} when the category of the mark length of the NRZI is M.

The values of these three T_{LC} are recorded in the control data zone.

T_{SFP} is modulated as a function of the category of the mark length of NRZI and the category of the space length of NRZI immediately in front of the mark. Therefore, T_{SFP} has the following nine values:

T_{SFP}(M2, LS2), T_{SFP}(M3, LS2), T_{SFP}(M4, LS2)

T_{SFP}(M2, LS3), T_{SFP}(M3, LS3), T_{SFP}(M4, LS3)

T_{SFP}(M2, LS4), T_{SFP}(M3, LS4), T_{SFP}(M4, LS4)

T_{SFP}(M, LS) indicates the value when the category of the mark length of the NRZI signal is M and the category of the space length of NRZI immediately in front of the mark is LS. These nine values of T_{SFP} are recorded in the control data zone.

T_{ELP} is modulated as a function of the category of the mark length of NRZI and the category of the space length of NRZI immediately behind the mark. Therefore, T_{ELP} has the following nine values:

T_{ELP}(M2, TS2), T_{ELP}(M3, TS2), T_{ELP}(M4, TS2)

T_{ELP}(M2, TS3), T_{ELP}(M3, TS3), T_{ELP}(M4, TS3)

T_{ELP}(M2, TS4), T_{ELP}(M3, TS4), T_{ELP}(M4, TS4)

T_{ELP}(M, TS) indicates the value when the category of the mark length of the NRZI signal is M and the category of the space length of NRZI immediately in front of the mark is TS. These nine values of T_{ELP} are recorded in the control data zone.

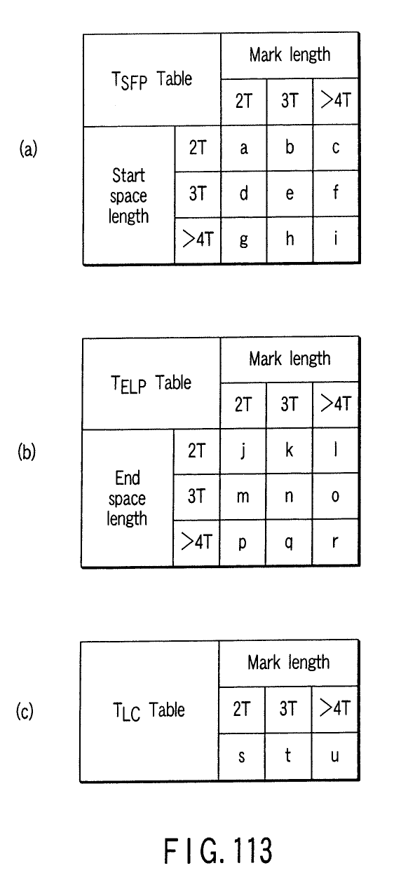

The value of T_{SFP} is expressed as a function of the mark length and the preceding space length using “a” to “i” (diagram (a) of FIG. 113). The value of T_{ELP} is expressed as a function of the mark length and the succeeding space length using “j” to “r” (diagram (b) of FIG. 113). The value of T_{LC} is expressed as a function of the mark length using “s” to “u” (diagram (c) of FIG. 113).

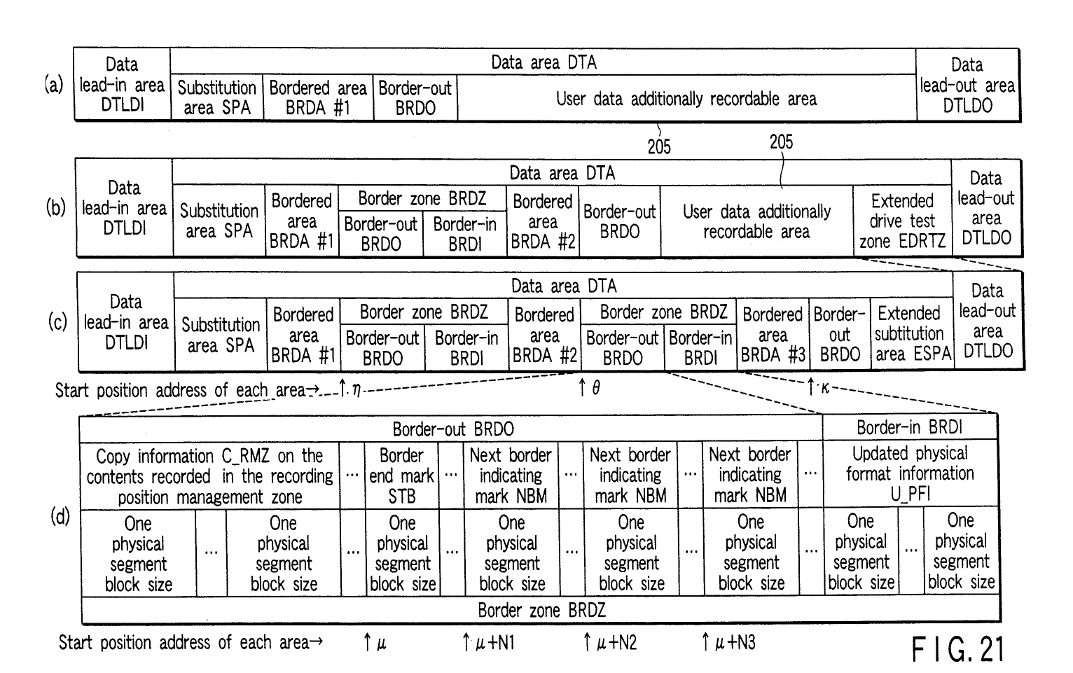

Referring to FIG. 21, the structure of a border area in a recordable information storage medium will be explained. When a border area is set in a recordable information storage medium for the first time, bordered area BRDA#1 is set on the inner-periphery side (on the side closest to the data lead-in area DTLDI) and a border-out area BRDO is formed behind the bordered area BRDA#1.

When the setting of another bordered area BRDA#2 is desired, a subsequent border-in area BRDI (#1) is formed behind the preceding border-out area BRDO (#1) as shown in the diagram (b) of FIG. 21 and then a subsequent bordered area BRDA#2 is set. When the closing of the next bordered area BRDA#2 is desired, a border-out area BRDO is formed immediately behind the bordered area BRDA#2. In this embodiment, a state where a subsequent border-in area BRDI (#1) is formed behind the preceding border-out area BRDO (#1) so as to form a set is called a border zone BRDZ. The border zone BRDZ is set to prevent the optical head from overrunning between the bordered areas BRDAs when reproduction is performed on the information reproducing apparatus (based on the DPD detesting method). Therefore, when a recordable information storage medium in which information has been recorded is reproduced by an information reproducing apparatus, it is necessary for the recordable information storage medium that a border-out area BRDO and a border-in area BRDI have been recorded and a border closing process has been carried out. In the border closing process, a border-out area BRDO is recorded behind the last bordered area BRDA. The first bordered area BRDA#1 is composed of more than 4080 physical segment blocks. The first bordered area BRDA#1 has to have a width of 1.0 mm or more along the radius of the recordable information storage medium. The diagram (b) of FIG. 21 shows an example of setting an extended drive test zone EDRTZ in the data area DTA.

The diagram (c) of FIG. 21 shows a state after the recordable information storage medium is finalized. The diagram (c) of FIG. 21 shows an example of incorporating an extended drive test zone EDRTZ into the data lead-out area DTLDO and setting an extended substitution area ESPA. In this case, the additionally recordable range 205 of the user data is filled with the last border-out area BRDO so that there may be no space left in the range 205.

The diagram (d) of FIG. 21 shows a detailed structure of the border zone BRDZ. Each piece of information is recorded in units of one physical segment block. At the beginning of the border-out area BRDO, copy information C_RMZ on the contents recorded in the recording management zone is recorded and a border stop block STB indicating the end of the border-out area BRDO is recorded. If there is another border-in area BRDI, a first Next Border Marker NBM indicating that there is a border area following “N1-th” physical segment block from the physical segment block in which the border stop block STB has been recorded, a second Next Border Marker NBM indicating that there is a border area following the “N2-th” physical segment block, and a third Next Boarder Marker NBM indicating there is a border area following the “N3-th” physical segment block are recorded discretely in a total of three places in units of one physical segment block. In the next border-in area BRDI, Update Physical Format Information U_PFI is recorded.

In an existing DVD-R or DVD-RW disk, if the next border area is absent (in the last border-out area BRDO), the place in which “Next Border marker NBM” is to be recorded (or the place of one physical segment block size) is kept as “no data recorded place.” If border closing is done in this state, a recordable information storage medium (existing DVD-R or DVD-RW disk) can be reproduced on a conventional DVD-ROM drive or a conventional DVD player. With a conventional DVD-ROM or a conventional DVD player, using a recording mark recorded on a recordable information storage medium (or existing DVD-R or DVD-RW disk), track shift detecting is done by a DPD (Differential Phase Detecting) method. In the “no data recorded place,” however, no recording mark exists over one physical segment block size. Therefore, since track shift detecting cannot be done using the DPD (Differential Phase Detecting) method, track servo cannot be applied stably. As measures to cope with the problem with the existing DVD-R or DVD-RW disk, this embodiment uses a new method as follows:

If there is no next border area, specific-pattern data is recorded in the “place where Next Border Marker NBM is to be recorded” in advance.

If there is a next border area, an overwriting process with a specific recording pattern is carried out partially and discretely in the place of the “Next Border Marker NBM” in which the specific-pattern data has been recorded, which enables the information to be used as identifying information indicating that “there is a next border area.”

As described above, setting a next border marker by overwriting produces the following effect: even if a next border does not come as shown in item (1), a recording mark with a specific pattern can be formed in the “place where a next border marker NBM is to be recorded, which enables track servo to be applied stably even when track shift detecting is done by the DPD method in an information reproducing apparatus after border closing. In a recordable information storage medium, if a new recording mark is recorded even partially over the part where a recording mark has been formed, the stabilization of the PLL circuit of FIG. 1 can be impaired in the information recording and reproducing apparatus or information reproducing apparatus. To overcome this fear, this embodiment further uses new methods as follows:

A method of changing the overwriting situation according to the place in the same data segment when writing data over the position of the “Next Border Marker NBM” of one physical segment block size.

Overwriting data on the sync data 432 and preventing overwriting on the sync code 431.

Overwriting data on the areas excluding data ID and IED.

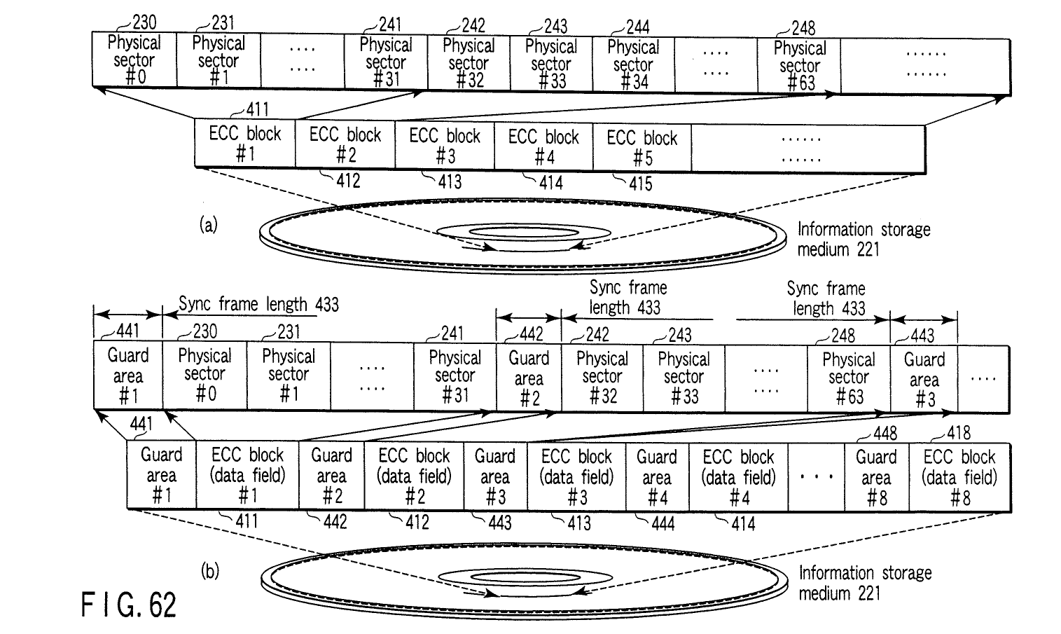

As described later in detail using FIGS. 62 and 63, data fields 411 to 418 for recording user data and guard areas 441 to 448 are recorded alternately on the information storage medium. A combination of data fields 411 to 418 and guard areas 441 to 448 is called a data segment 490. One data segment length coincides with one physical segment block length. The PLL circuit of FIG. 1 pulls in PLL more easily in the VFO areas 471, 472 of FIG. 63. Therefore, even if PLL goes out of tune just in front of the VFO areas 471, 472, PLL is pulled in easily using the VFO areas 471, 472, which alleviates an adverse effect on the entire system of the information recording and reproducing apparatus or information reproducing apparatus. Using this situation, the overwriting situation is changed according to the place in the data segment and the amount of specific patterns written over the back of the same data segment closer to the VFO areas 471, 472, which makes it easier to determine the “Next Border Marker” and prevents the accuracy of the signal PLL from deteriorating in reproduction.

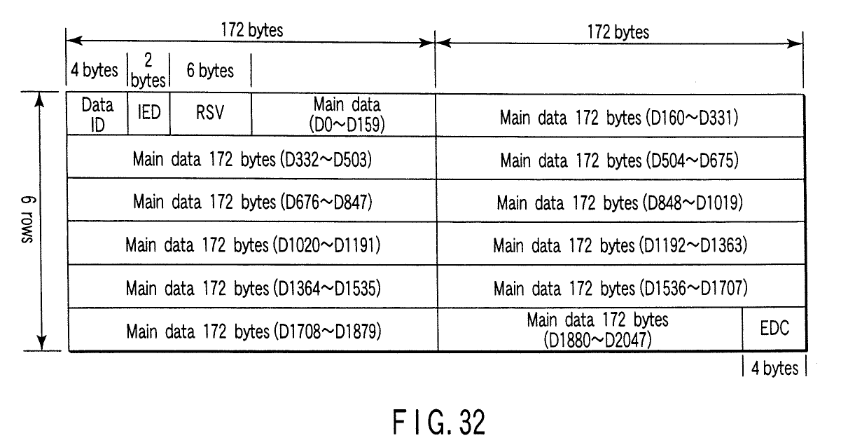

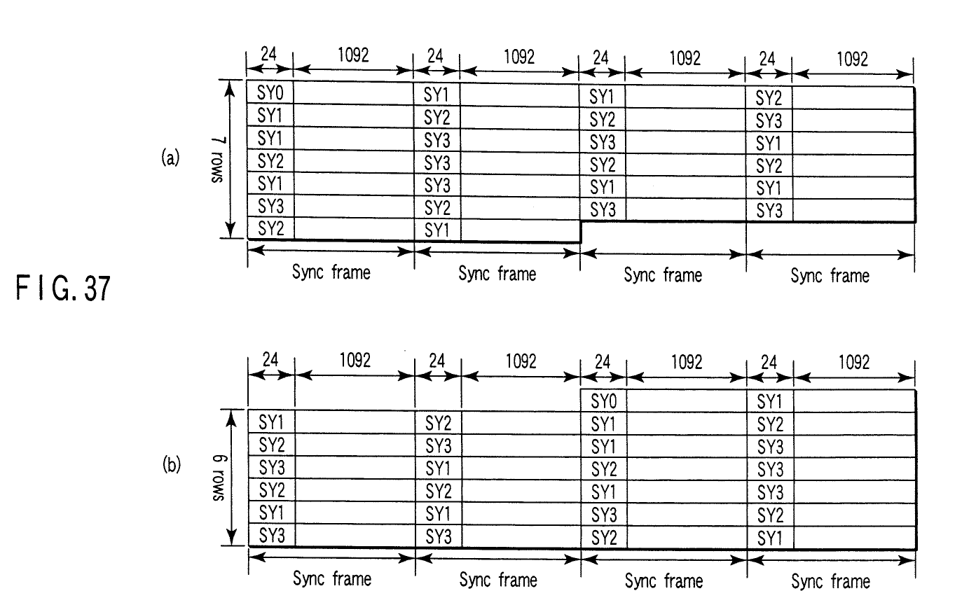

As described in detail using FIGS. 63 and 37, one physical sector is composed of a combination of an area in which sync codes 433 (SY0 to SY3) are arranged and sync data 434 placed between the synch codes 433. The information recording and reproducing apparatus or information reproducing apparatus extracts the sync codes 433 (SY0 to SY3) from the channel bit train recorded on the information storage medium, thereby detecting a break in the channel bit train. As described later, location information (physical sector number or logical sector number) on the data recorded on the information storage medium is extracted from the information in the data ID of FIG. 32. Using IED just behind the data ID, an error in the data ID is detected. Therefore, this embodiment not only (5) prevents data from being overwritten on the data ID and IED but also (4) overwrites data partially on the sync data 432 excluding the sync code 431, which makes it possible to detect the data ID location using the sync code 431 and reproduce (decipher) the information recorded in the data ID even in “Next Border Marker NBM.”

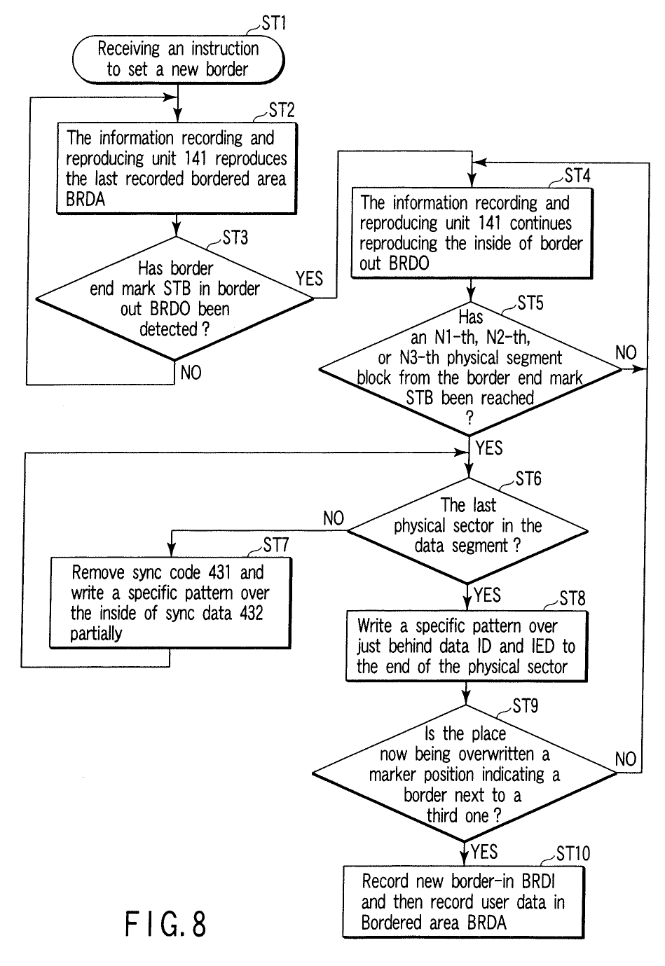

FIG. 8 is a flowchart for writing data over the place of “Next Border Marker NBM” to help explain concretely what has been described above. When the controller 143 of the information recording and reproducing apparatus receives an instruction to set a new border via an Interface 142 (step ST1), the controller 143 controls the information recording and reproducing unit 141 to start to reproduce the bordered area BRDA placed at the end (step ST2). The information recording and reproducing unit 141 continues tracing along the pre-groove in the bordered area BRDA, while tracking until it detects a border stop block STB in the border-out area (step ST3). As shown in the diagram (d) of FIG. 21, behind the border stop block STB, next border markers NBM recorded in a specific pattern have been provided for the N1-th, N2-th, and N3-th physical segment blocks. The information recording and reproducing unit 141 searches for the position of “Next Border Marker NBM” (step ST5), while producing the border-out area BRDO, counting the number of physical segment blocks. As described above, a concrete example of the method of “(3) changing the overwriting situation according to the place in the same data segment” is to secure a wider overwriting area at least in the last physical unit in the same data segment.

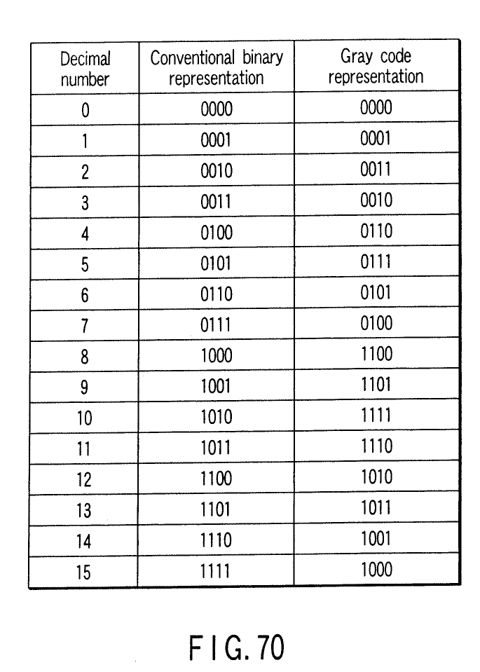

When the last physical sector in the data segment has been detected (step ST6), data is overwritten just behind the data ID and IED to the end of the last physical sector, leaving the data ID and IED (or without overwriting the data ID and IED) (step ST9). In the same data segment excluding at least the last physical sector, the sync data 432 is partially overwritten with specific pattern, excluding the area of the sync codes 431 (SY0 to SY3) shown in FIG. 37 or FIG. 70 explained later (step ST7). This process is carried out for each “Next Border Marker NBM.” After the third “Next Border Marker NBM” has been overwritten (step ST9), a new border-in area BRDI is recorded and then user data is recorded in the bordered area BRDA (step ST10).

FIG. 86 shows another embodiment differing from the structure of the border area in the recordable information storage medium of FIG. 21. Diagrams (a) and (b) of FIG. 86 show the same contents as diagrams (a) and (b) of FIG. 21. FIG. 86 differs from FIG. 21 in the state after the recordable information storage medium is finalized. For example, as shown in the diagram (c) of FIG. 86, if finalization is desired after the recording of information into bordered area BRDA#3 is completed, border-out area BRDO is formed just behind bordered area BRDA#3 in a border closing process. Thereafter, a terminator area TRM is formed behind the border-out area BRDO just behind bordered area BRDA#3 (point (L1) in FIG. 125M), thereby shortening the time required for finalization.

In the embodiment of the diagram (c) of FIG. 21, the space ranging from the last bordered area BRDA#3 to just in front of the extended substitution area ESPA has to be filled with a border-out area BRDO. It requires a long time to form a border-out area BRDO, which makes the finalize time longer. In contrast, in the embodiment shown in the diagram (c) of FIG. 86, a relatively short terminator area TRM is set. All of the area outside the terminator area TRM is set again as a new data lead-out area DTLDO and the unrecorded part outside the terminator area TRM is set as an inhibited area 911. The inhibited area 911 need not be filled with data and may remain unrecorded, which shortens the finalize time. Specifically, when the data area DTA is finalized, a relatively short terminator area TRM is formed at the end of the recording data (just behind the border-out area BRDO: differently from the embodiment shown in the diagram of (c) of FIG. 21, the border-out area BRDO need not be set all the way to the end of the data area and may be relatively narrow in width).

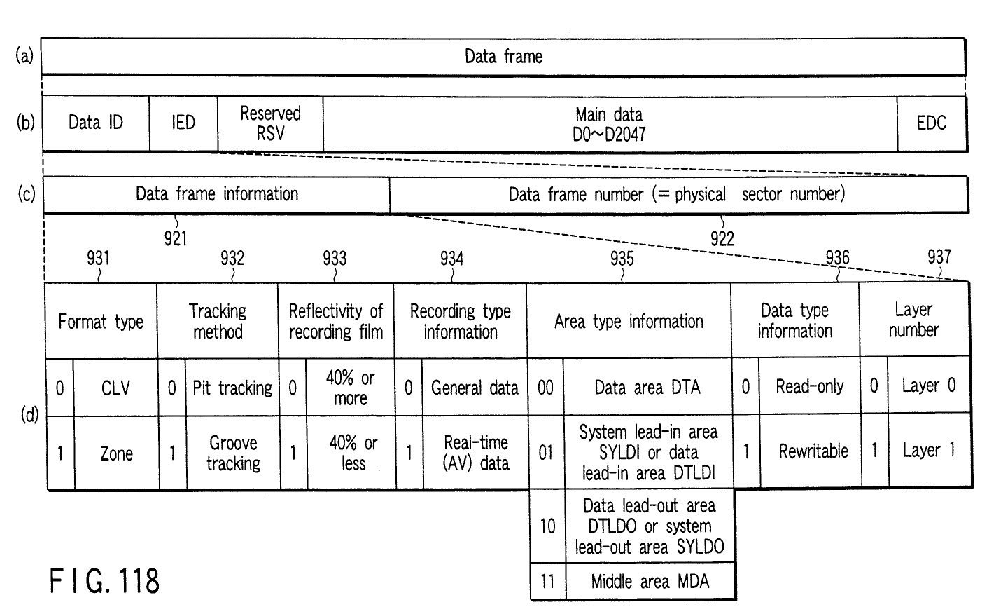

All of the information in the main data (the main data in the data frame as described later in FIG. 32) in the area is set to “00h.” The attribute (type information) of the area is set the same as the type information in the data lead-out area DTLDO, which causes the terminator area TRM to be defined again as a new data lead-out area DTLDO as shown in the diagram (c) of FIG. 86. As shown in the diagram (d) of FIG. 118, the type information in the area is recorded in area type information 931 in the data ID. Specifically, area type information 935 in the data ID in the terminator area TRM is set to “10b” as shown in the diagram (d) of FIG. 18, which means that the terminator area TRM exists in the data lead-out area DTLDO.

The present embodiment is characterized in that data lead-out position area type identifying information is set using the area type information 935 in the data ID (point [N] in FIG. 125R). Consider a case where, in the information recording and reproducing apparatus or information reproducing apparatus of FIG. 1, the information recording and reproducing unit 141 roughly accesses a specific target position on a recordable information storage medium. Immediately after rough access, the information recording and reproducing unit 141 has to first reproduce the data ID to determine what position on the recordable information storage medium has been reached and decrypt data frame number 922 shown in the diagram (c) of FIG. 118. Since area type information 935 is near data frame number 922 in the data ID, just decrypting the area type information 935 makes it possible to determine instantaneously whether the information recording and reproducing unit 141 is in the data lead-out area DTLDO, which enables access control to be simplified and made faster. As described above, setting a terminator area TRM in the data ID gives data lead-out area DTLDO identifying information (point (N1) in FIG. 125R), which makes it easier to detect the terminator area TRM.

Furthermore, when the last border-out area BRDO is set as an attribute of the data lead-out area NDTLDO as an exception (that is, when area type information 935 in the data ID of the data frame in the border-out area BRDO is set to “10b”: data lead-out area), a terminator area TRM is not set. In this case, the area outside the border-out area BRDO is inhibited from being used. Therefore, when the terminator area TRM with the attribute of the data lead-out area NDTLDO has been recorded, the terminator area TRM is regarded as a part of the data lead-out are NDTLDO. Thus, data cannot be recorded into the data area DTA and therefore the data area may be left in the form of an inhibited area 911 as shown in the diagram (c) of FIG. 86.

In this embodiment, the size of the terminator area TRM is changed according to the position on the recordable information storage medium, thereby shortening the finalize time and making the processing more efficiently (point (L1α) in FIG. 125M). The terminator area TRM not only indicates the last position of the recording data but also is used to prevent an overrun due to a track shift, even when it is used in an information reproducing apparatus which detects a track shift by the DPD method. Therefore, the width of the terminator area TRM in the direction of radius of the recordable information storage medium (or the width of the part filled with the terminator area TRM) must be at least 0.05 mm or more in length from the viewpoint of the detection characteristics of the information reproducing apparatus. Since the length of one round on the recordable information storage medium differs according to the radial position, the number of physical segment blocks included in one round differs according to the radial position. Therefore, as shown in FIG. 117, the size of the terminator area TRM differs according to the radial position, that is, the physical sector number of the physical sector first located in the terminator area TRM. As the position goes closer to the outer periphery, the size of the terminator area TRM grows larger (point (L1β) in FIG. 125M). The values in FIG. 117 are given using the number of physical segment blocks as units. The minimum value of the physical sector number of an allowable terminator area TRM must be larger than “04FE00h.” This comes from the following constrained condition: the first bordered area BRDA#1 must be composed of 4080 or more physical segment blocks and the first bordered area BRDA#1 must be 1.0 mm or more in width in the direction of radius of the recordable information storage medium. The terminator area TRM has to start from the boundary position of physical segments blocks.

In the diagram (d) of FIG. 86, for the same reason as described above, a place in which each piece of information is recorded is set on a single physical segment block size basis. In each physical segment block, a total of 64 KB of user data recorded discretely in 32 physical sectors are recorded. As shown in the diagram (d) of FIG. 86, relative physical segment block numbers are set to the individual pieces of information. The individual pieces of information are recorded one after another onto the recordable information storage medium in ascending order of relative physical segment block numbers. In the embodiment of FIG. 86, RMD copy information CRMD#0 to CRMD#4 having the same contents are written five times into copy information recording area C_RMZ of the contents recorded in the recording management zone in the diagram (d) of FIG. 21 (point (C6) in FIG. 125C). The multiple writing increases the reliability of reproduction. Even if there is dust on or flaws in the recordable information storage medium, copy information CRMD about the contents recorded in the recording management zone can be reproduced stably. While the border stop block STB in the diagram (d) of FIG. 86 corresponds to the border stop block STB in the diagram (d) of FIG. 21, the embodiment shown in the diagram (d) of FIG. 86 does not have “Next Border Marker NBM” as in the embodiment shown in the diagram (d) of FIG. 21. The information in the main data (see FIG. 32) in reserved areas 901, 902 are all set to “00h.”

In the diagram (d) of FIG. 86, at the beginning of the border-in area BRDI, identical information is recorded as update physical format information U_PFI six times from N+1 to N+6 in the form of relative physical segment block numbers (point (C7) in FIG. 125C), thereby constructing update physical format information U_PFI as shown in the diagram (d) of FIG. 21. In this way, update physical format information U_PFI is recorded a plurality of times, thereby improving the reliability of information.

The diagram (d) of FIG. 86 is characterized in that a recording management zone RMZ in the border zone is recorded in the border-in area BRDI (point (C1) in FIG. 125B). As shown in FIG. 17, the size of the recording management zone RMZ in the data lead-in area DTLDI is relatively small. If a new bordered area BRDA is set frequently, recording management data RMD recorded in the recording management zone RMZ are saturated and the setting of a new bordered area BRDA cannot be done in the middle of setting. As shown in the diagram (d) of FIG. 86, a recording management zone RMZ in which recording management data RMD about subsequent bordered area BRDA#3 is recorded is provided in the border-in area BRDI, which enables not only a new bordered area BRDA to be set many times but also the number of additional recording in a bordered area BRDA to be increased remarkably.

When bordered area BRDA#3 following the border-in area BRDI including the recording management zone RMZ in the border zone BRDZ is closed or when the data area DTA is finalized, the last recording management data RMD has to be recorded repeatedly into the unrecorded reserved area 273 (shown in the diagram (d) of FIG. 85) in the recording management zone RMZ, thereby filling up the reserved area (point (L2) in FIG. 125M). This eliminates an unrecorded reserved area 273, which not only prevents the deviation from the track (by the DPD method) in reproduction on the information reproducing apparatus but also increase the reliability of the reproduction of recording management data RMD by multiple recording of recording management data RMD. All of the data in the reserved area 903 (particularly the values of the main data in FIG. 32) are set to “00h.”

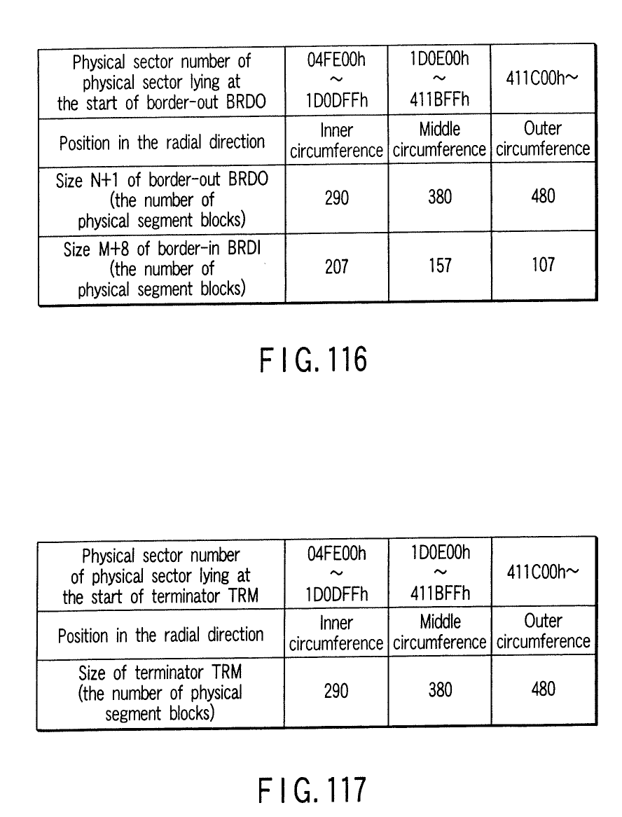

FIG. 116 shows the size of a border zone BRDZ in this embodiment. The values in FIG. 116 are represented using the number of physical segment blocks as a unit. The size of a border-out area BRDO becomes larger as the position gets closer to the outer periphery (point (L3) in FIG. 125M). The value coincides with the size of a terminator area TRM as shown in FIG. 117. The size of a border zone BRDZ varies according to the position in the direction of radius of the recordable information storage medium. The basis for the border-out area BRDO size coincides with the basis for the terminator area TRM size. The width of the border zone BRDZ in the radial direction must be 0.05 mm or more. The border-out area BRDO has to be started from the position of the boundary between physical segment blocks. Moreover, the minimum physical sector number of the border-out area BRDO has to exceed “04FE00h.”

The border-out area BRDO has the function of preventing an overrun due to the deviation from the track on the information reproducing apparatus using the DPD method. The border-in area BRDI need not have a large size, except that it has update physical format information U_PFI and the information in the recording management zone RMZ in the border zone. Therefore, to shorten the time (required to record data in the border zone BRDZ) in setting a new bordered area BRDA, a reduction in the size is desired. In the diagram (a) of FIG. 86, since the user data additionally recordable range 205 is sufficiently wide before the formation of border-out area BRDO by border closing and the probability that additional writing will be done many times is high, the value of “M” in the diagram of FIG. 86 has to be set large so that recording management data can be recorded many times in the recording management zone RMZ in the border zone. In contrast, in the diagram (b) of FIG. 86, since the user data additionally recordable range 205 is narrower before bordered area BRDA#2 is border-closed and before the border-out area BRDO is recorded, it is conceivable that the number of times the recording management data is additionally recorded into the recording management zone RMZ in the border zone is not so large. Therefore, the setting size of the recording management zone RMZ in the border-in area BRDI just in front of bordered area BRDA#2 can be made relatively small. That is, an estimated number of additional recording of recording management data is larger when the border-in area BRDI is placed closer to the inner periphery. An estimated number of additional recording of recording management data is smaller when the border-in area is placed closer to the outer periphery. Therefore, the embodiment is characterized in that the border-in area BRDI size becomes smaller on the outer periphery side (point (L4) in FIG. 125N). As a result, the time required to set a new bordered area BRDA is made shorter and the processing is made more efficient.

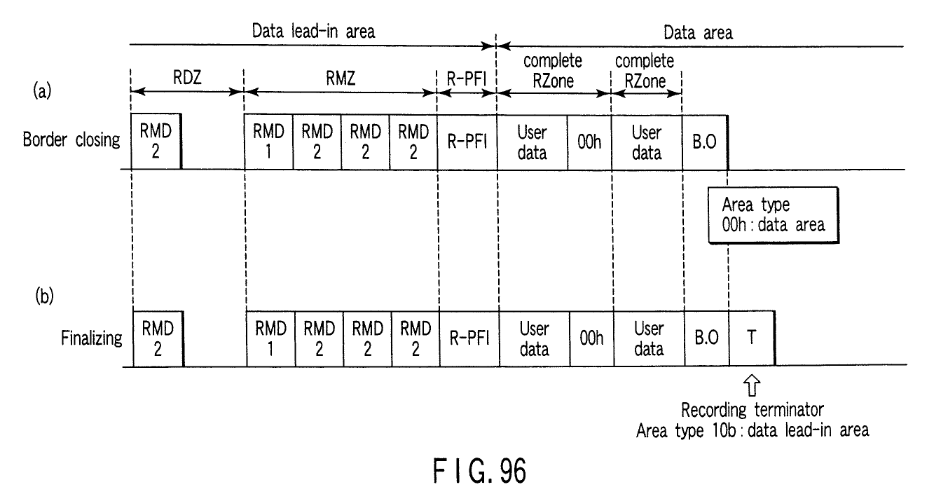

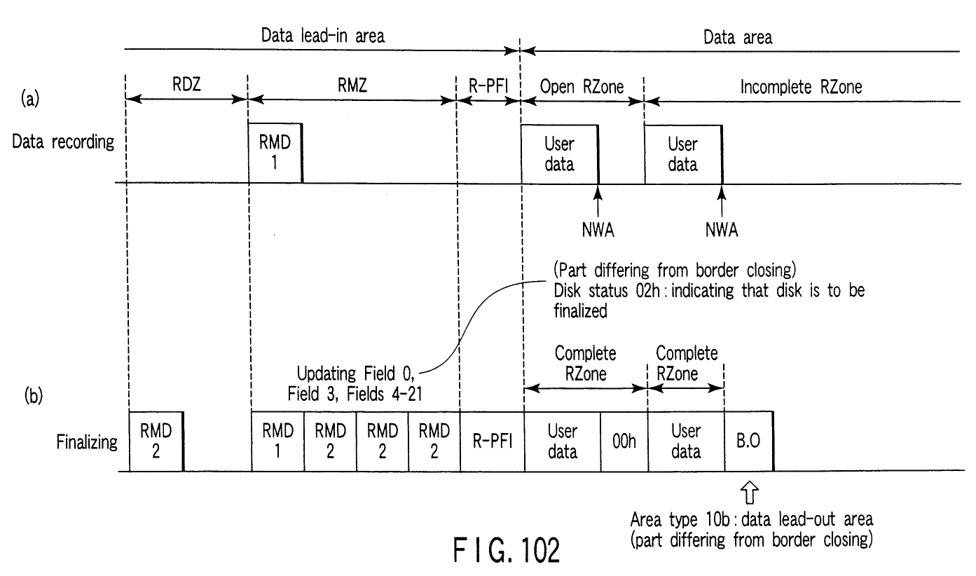

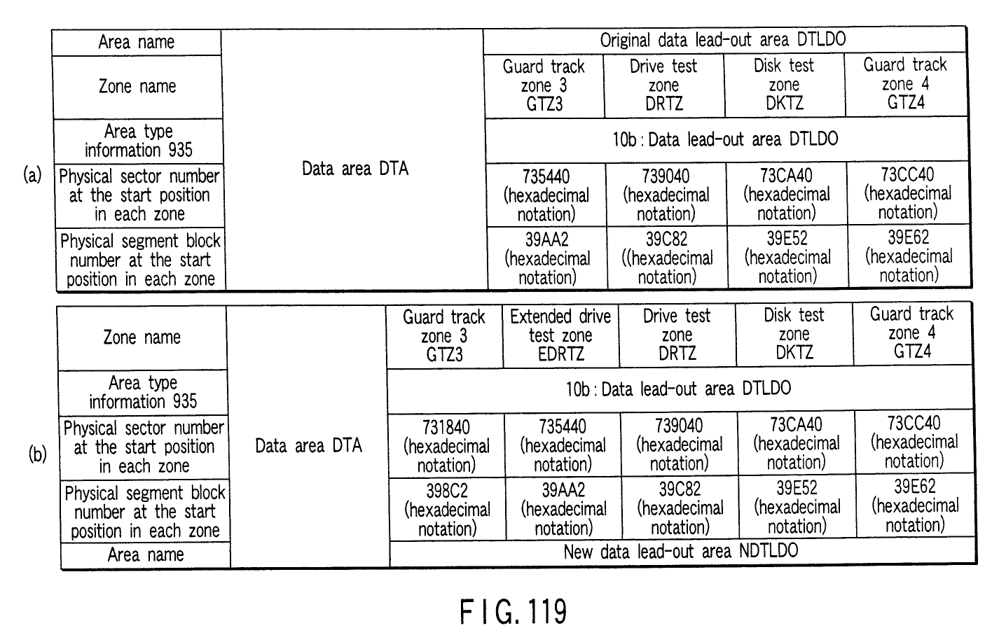

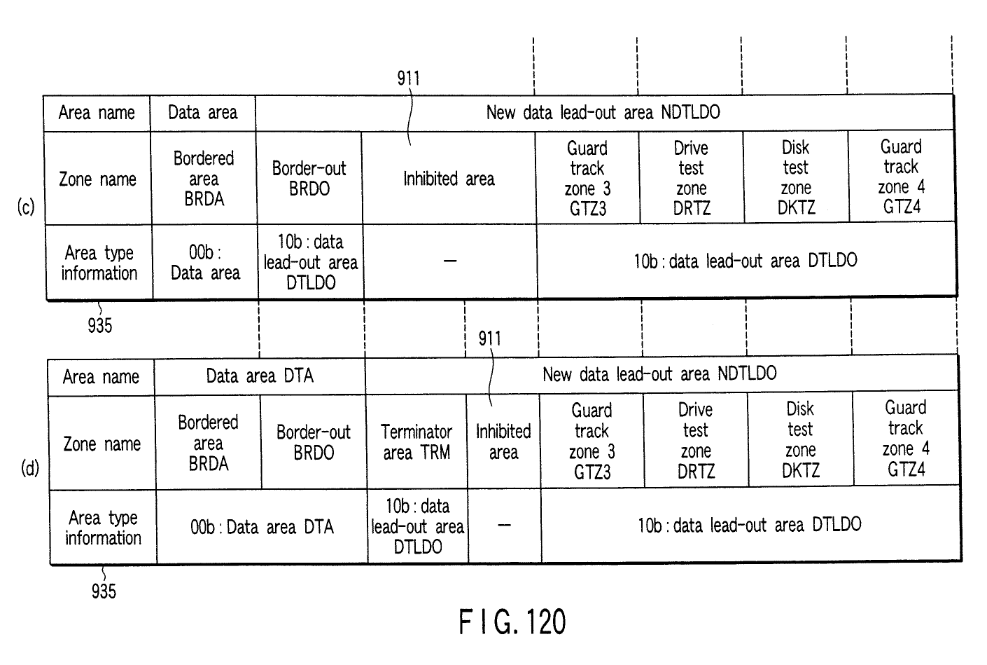

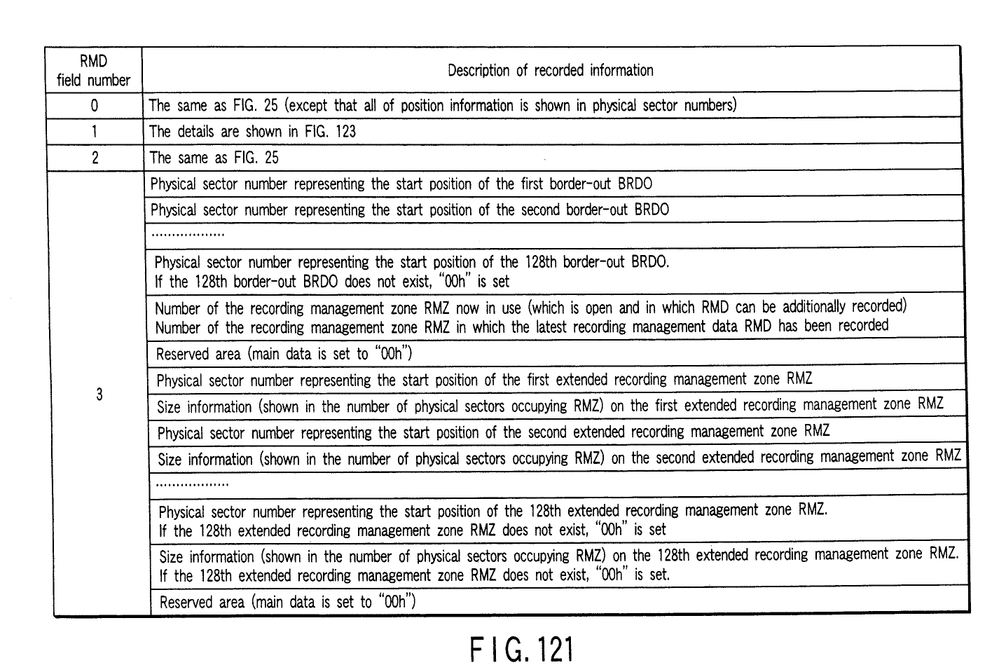

FIGS. 119 and 120 show a method of setting various data lead-out areas after the finalizing process in this embodiment. The diagram (a) of FIG. 119 shows the range of the original data lead-out area DTLDO shown in FIGS. 18A and 18B. The physical sector number and physical segment number in the stating position of each zone are set in advance as follows: 735440h, 39AA2h in hexadecimal representation are preset in a third guard track zone GTZ3, 739040h, 39C82h in hexadecimal representation are preset in a drive test zone DRTZ, 73CA40h, 39E52h in hexadecimal representation are preset in a disk test zone DKTZ, and 73CC40h, 39E62h in hexadecimal representation are preset in a fourth guard track zone GTZ4. As shown in the diagram (f) of FIG. 18B, in this embodiment, the extended drive test zone EDRTZ has been set as a data lead-out area DTLDO after a finalizing process. In a method shown in the diagram (b) of FIG. 119(b) as another embodiment, an extended drive test zone EDRTZ equivalent to the size of the third guard track zone is set (point (N2) in FIG. 125R) and the third guard track zone is translated. That is, the starting position (the physical sector number or physical segment block number) of the third guard track zone GTZ3 in the original data lead-out area DTLDO is caused to coincide with the starting position of the extended drive test zone EDRTZ. This produces the effect of simplifying the setting of an extended drive test zone EDRTZ. The diagram (d) of FIG. 120 shows a method of setting a terminator area TRM and subsequent areas as a new data lead-out area DTLDO by setting area type information 935 (shown in the diagram (d) of FIG. 118) in the data ID of the terminator area TRM shown in the diagram (c) of FIG. 86 to “10b” (point (N1) in FIG. 125R). A concrete finalizing process using this method will be explained later using FIG. 96. In this case, area type information 935 (shown in the diagram (b) of FIG. 118) in border-out area BRDO just in front of the terminator area TRM is set to “00b” and border-out area BRDO is included in the data area DTA. Another method of this embodiment is to set area type information 935 (shown in the diagram (d) of FIG. 118) in the data ID of border-out area BRDO to “10b” as shown in the diagram (c) of FIG. 120, thereby setting in a new data lead-out area NDTLDO (point (N3) in FIG. 125R). Use of this method not only facilitates the process of retrieving a data lead-out area but also makes it unnecessary to set a terminator area TRM, which shortens the finalize time. A concrete finalizing process using this method will be explained later using FIG. 102.

A logical recording unit of information recorded in bordered area BRDA shown in the diagram (c) of FIG. 21 is called an R zone. Therefore, a bordered area BRDA is composed of at least one R zone. An existing DVD-ROM uses a file system called “UDF bridge” in which both of file management information complying with UDF (Universal Disc Format) and file management information complying with ISO9660 are recorded simultaneously onto a single information storage medium. The file management method conforming to ISO9660 has a rule that a file must be recorded continuously onto an information storage medium. That is, the information in a file is inhibited from being divided and arranged in discrete positions on the information storage medium. Therefore, for example, when information has been recorded in a manner conforming to the UDF bridge, all of the information constituting one file is recorded continuously. Therefore, an area in which one file is recorded continuously can be adapted so as to construct an R zone.

The explanation has been given, centering around the data structure of information recorded on the recordable information storage medium. Hereinafter, the basic concepts and basic ideas of recording management data RMD, extendable recording management zone RMZ, R zone, border zone, various physical formats will be explained. In addition, various processing methods, including border closing and finalizing, based on the basic concepts and ideas, will be explained.

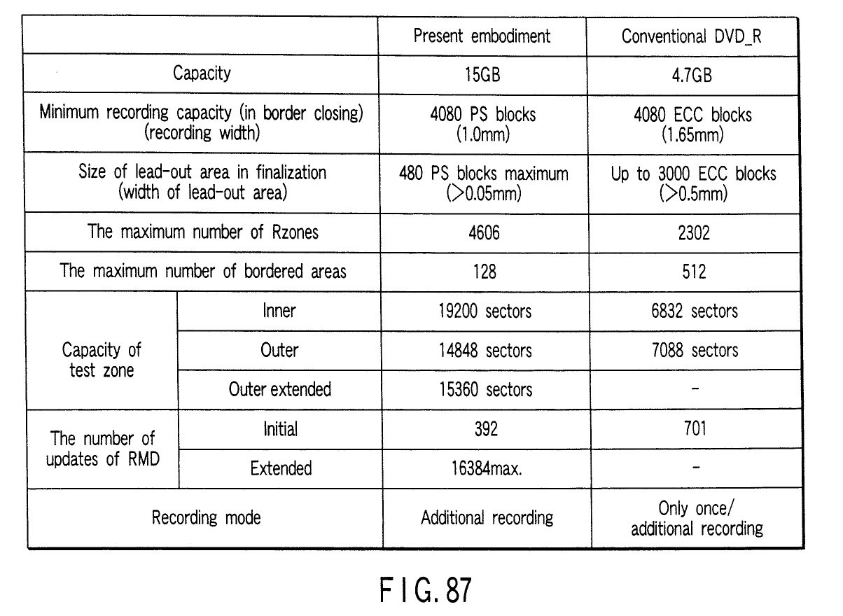

FIG. 87 shows a comparison between the present embodiment and an existing DVD-R (point [L] in FIG. 125M). In this embodiment, to shorten the border closing time, the recording width of the minimum recording capacity (in border closing) is made narrower (1.65 mm to 1.0 mm) than that of an existing DVD-R. As a result, useless recording information is reduced and the finalize time is made shorter. Since the recoding capacity of this embodiment is much larger (4.7 GB to 15 GB) than that of the existing DVD-R, the maximum number of R zones is almost doubled (2302 to 4606). While the recording unit of the existing DVD-R is an ECC block, which of the present embodiment is a physical segment (see FIG. 69). The diagram (b) of FIG. 69 shows a physical length on a disk and the diagram (a) of FIG. 69 shows a length of data to be recorded. In a physical segment block, redundant areas, including a VFO area, a pre-sync area, a postamble area, an extra area, and a buffer area, are added in front of and behind an ECC block, thereby forming a data segment 531. These data segments are combined to form a physical segment, a unit in data recoding.

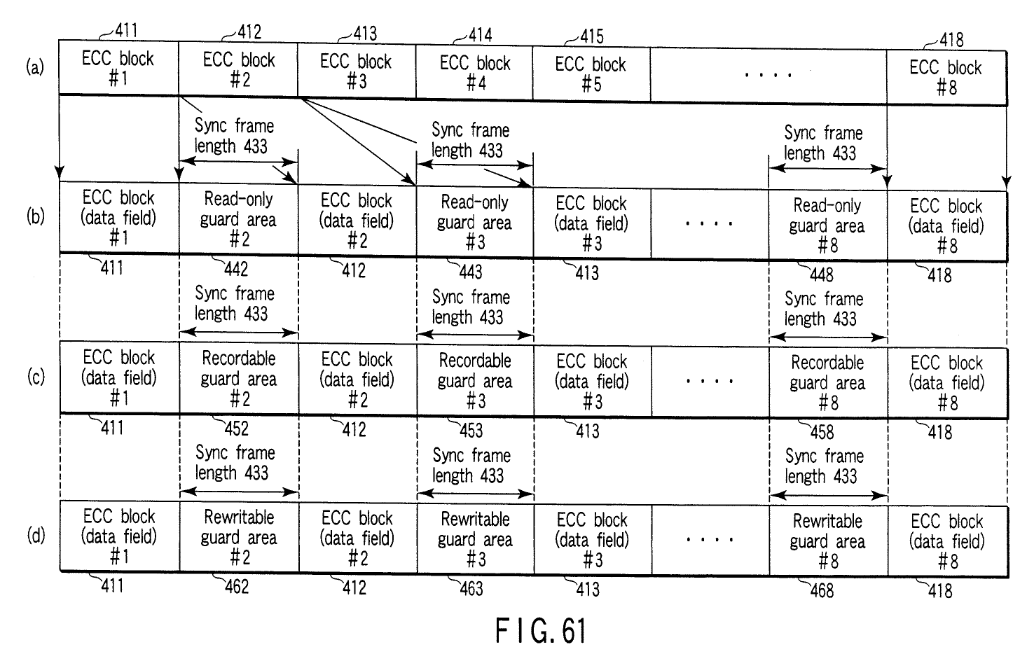

As shown in FIG. 61, since redundant areas (guard areas) are added in front of and behind an ECC block, data cannot be recorded continuously from the end of the ECC block at the time of additional recording. The reason is that, even if an attempt is made to record data from the end of the ECC block, the recoding position may shift slightly due to rotation irregularity or the like. If the recording position shifts forward, the last part of the recorded data disappears due to overwriting. Since the lost data can be reproduced by error correction, there is almost no problem. If the recording position shifts backward, an unrecorded part appears on the disk, preventing reproduction on the player, which is a serious problem. Therefore, presently, when additional recording is done, the recording position is shifted slightly forward and data is written over the last part of the recorded data, thereby destroying the last data. In this embodiment, since a guard area is provided in front of and behind an ECC block, overwriting is done in the guard area and therefore the user data can be additionally recorded stably without destroying the data. Accordingly, the data structure of the embodiment can increase the reliability of the recorded data.

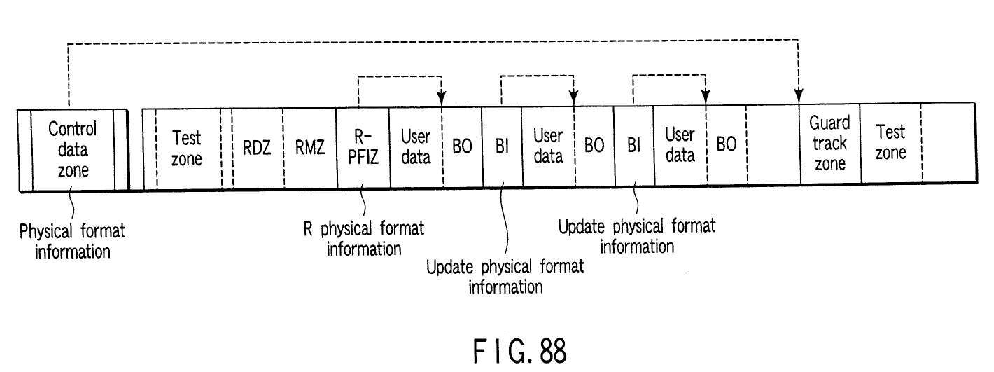

FIG. 88 is a diagram to help explain physical format information in this embodiment. Disk management information is stored in the physical format information. The information can be read on a ROM player. There are three types of physical format information according to the recording position:

Physical format information PFI (in a control data zone in the system lead-in area SYLDI): In this information, HD DVD family common information/data area end address/strategy information and the like are recorded.

R physical format information R-PFI (in the data lead-in area): In this information, a copy of HD DVD family common information/first border outermost circumference address are recorded. The first bordered area shares border-in area with the data-in area (information to be recorded in the border-in area is recorded in the data lead-in area). Therefore, there is no border-in area for the first border.

Update physical format information U-PFI (in the border-in area): In this information, a copy of HD DVD family common information/outermost address of its own border are recorded.

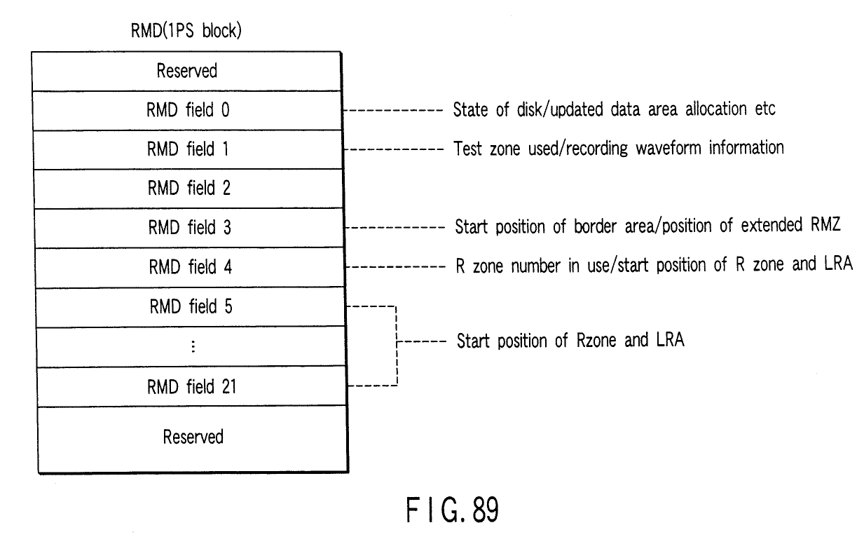

FIG. 89 is a diagram to help explain the basic concept of recording management data RMD in this embodiment. In the data, data for managing the recording state of a recordable disk is stored. A single RMD is composed of a physical segment block. In the RMD, 22 fields are defined. Field 0 stores the state of a disk and updated data area allocation, field 1 stores the test zones used and recording waveform information, field 3 stores the starting position of a border area and the position of an extended RMZ, field 4 stores the R zone number now in use, the starting position of the R zone, and LRA (the last recoding position: last recorded address), and fields 5 to 21 store the starting position of the R zone and LRA.

The update timing of RMD is defined as follows (point (L7) in FIG. 125M):

When the disk is initialized

When an operation, such as an R zone reservation or closing, is performed

When a border is closed and RMZ is extended

When a specific amount of user data is recorded and the recording is interrupted

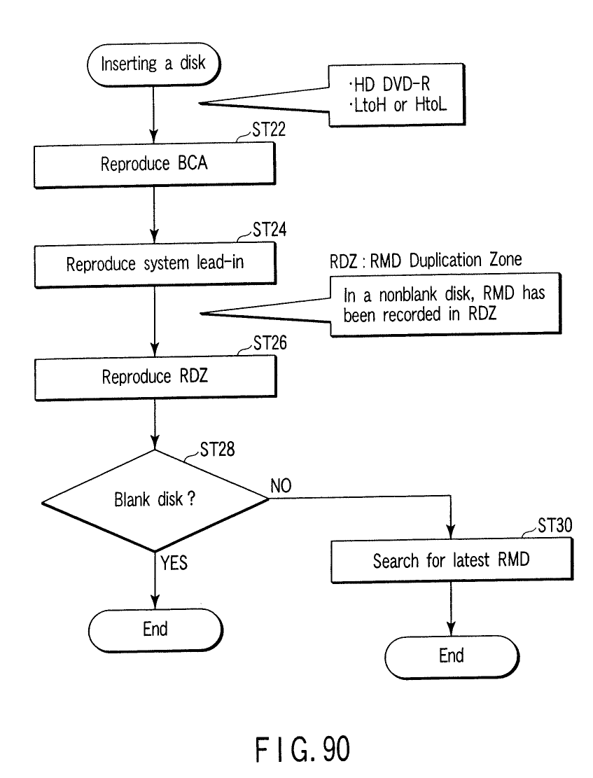

FIG. 90 is a flowchart for the processing procedure immediately after an information storage medium is installed in an information reproducing apparatus or information recording and reproducing apparatus of the present embodiment (point [L] in FIG. 125M).

When the disk is installed in the apparatus, the burst cutting area BCA is reproduced in step ST22. This embodiment supports an HD DVD-R disk. It further supports both of the recording film polarities, “L-H (Low to High)” and “H-L (High to Low).” In step ST24, the system lead-in area is reproduced. In step ST26, the RMD duplication RDZ is reproduced. In the case of a nonblank disk, recording management data RMD has been recorded in the RMD duplication zone RDZ. According to the presence or absence of the recording of recording management data RMD, it is determined in step ST28 whether the disk is a blank one. If the disk is a blank one, the present process is ended. If the disk is not a blank disk, the latest recording management data RMD is searched for in step ST30. Then, the number of the additionally recordable R zone now in use, the start physical segment number of the R zone, and the last recorded address LRA are found. Up to three additionally recordable R zones can be set. When a nonblank disk is discharged, border closing or finalizing is done.

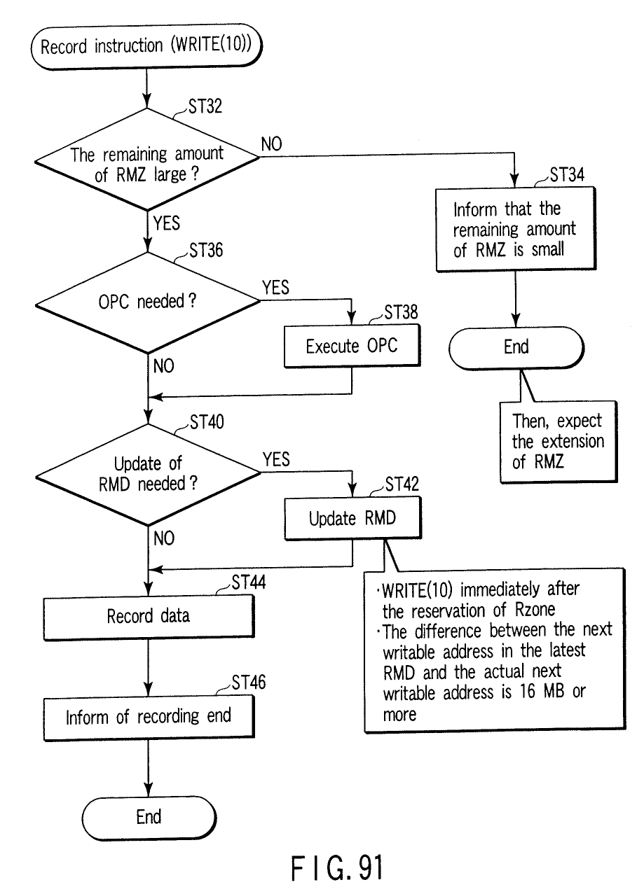

FIG. 91 is a flowchart to help explain a method of recording additional information onto a recordable information storage medium in the information recording and reproducing apparatus of the embodiment. When the host gives a record instruction (write (10)), it is determined in step ST32 whether the remaining amount of the recording management zone RMZ in which recording management data RMD is to be recorded is sufficient. If the remaining amount is not sufficient, the host is informed in step ST34 that “the remaining amount of RMZ is small.” In this case, the extension of the recording management zone RMZ is expected (point (L8) in FIG. 125O).

If the remaining amount is sufficient, it is determined in step ST36 whether OPC (the process of recording how much test recording has been done) is needed. If OPC is needed, OPC is executed in step ST38. In step ST40, it is determined whether the update of the recording management data RMD is needed. The update is needed when a record instruction is given immediately after the reservation of an R zone or when the difference between the next writable address NWA in the latest RMD and the actual next writable address NWA is 16 MB or more. In step ST42, the recording management data RMD is updated. In step ST44, the data is recorded. In step ST46, the host is informed of the recording end and the process is completed.

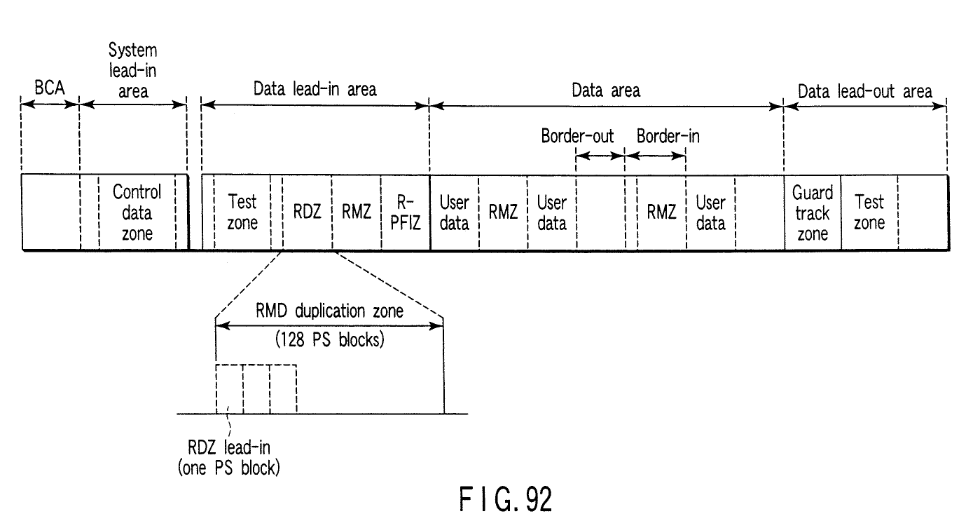

FIG. 92 is a diagram to help explain the concept of a method of setting an extendable recording management zone RMZ in the present embodiment. At the beginning, a recording management zone RMZ for storing recording management data RMD has been set in the data lead-in area. When the recording management zone RMZ has been used up, the data cannot be recorded onto the disk even if the data area is empty. Therefore, if the remaining amount of the recording management zone RMZ becomes small, an extended recording management zone EX.RMZ is set (point [C] in FIG. 125B). The extended recording management zone EX.RMZ may be set in a bordered area BRDA in which user data is recorded or in a border zone (made up of adjacent border-out area and border-in area). That is, the extended recording management zone EX.RMZ in the bordered area and the extended recording management zone EX.RMZ in the border-in area can be mixed on the disk. When the extended recording management zone EX.RMZ has been set, the latest recording management data RMD is copied into the RMD duplication zone RDZ in the form of a physical segment block. The RMD duplication zone RDZ is used to manage the position of the extended recording management zone EX.RMZ (point (L6α) in FIG. 125N). Since the RMD duplication zone RDZ is composed of 128 physical segments, the recording management zone RMZ can be extended 127 times on the disk. The maximum number of border zones on the disk is 128 (points (L9), (L9α) in FIG. 125O). Using 127 extended recording management zones EX.RMZ, the recording management data RMD can be extended 16348 times.

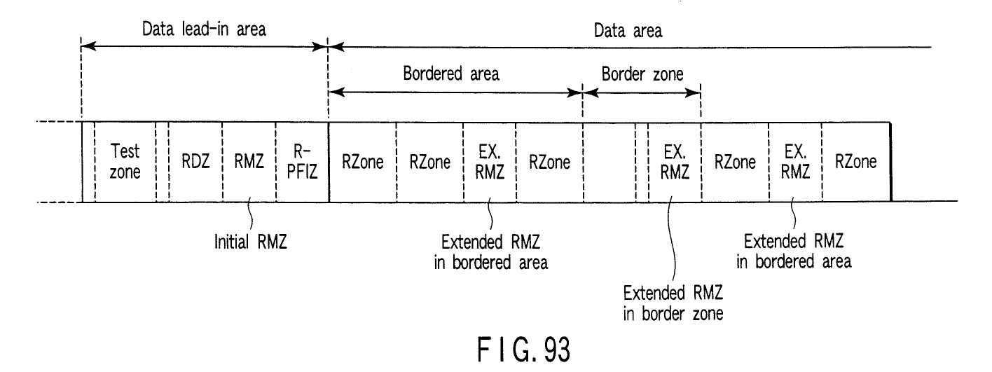

FIG. 93 is a detailed diagram of FIG. 92. Specifically, the extended recording management zone EX.RMZ in the bordered area is set between adjacent R zones. When it is extended to the border zone, it is normally added to the end of the border-in area.

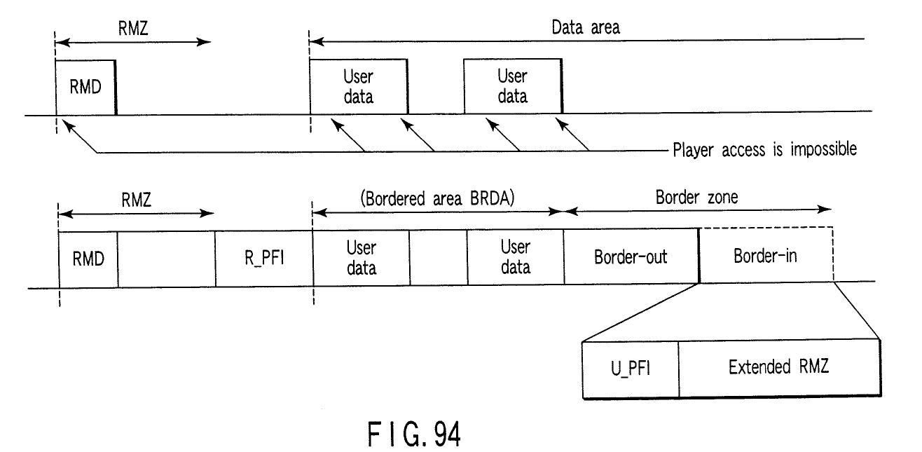

FIG. 94 is a diagram to help explain a border zone in this embodiment. A border zone is recorded to enable reproduction by a ROM player that detects a track by the DPD method. The border zone is composed of border-in area and border-out area. Since the player cannot track the groove, if there is an unrecorded area on the disk, it cannot access the recording management data RMD and the end of the recorded data. Since the track detecting method of the ROM player is the DPD method, the presence of a pre-pit is needed as a prerequisite. The recording film of a DVD-R disk is so designed that a phase shift takes place at a recording mark. It looks as if a phase shift were a pre-pit. Therefore, it is necessary to record an overrun area for reproducing management information and recorded data which the ROM player can read. The former is recorded in the border-in area and the latter is recorded in the border-out area. The border zone is recorded in a border closing operation. When border closing is done, (1) the discontinuous areas in the present recording management zone RMZ and in the user data are padded (point [L10] in FIG. 125P), (2) R physical format information R-PFI is recorded, and (3) border-out area is recorded. In the border-in area, update physical format information U-PFI and extended RMZ are recorded.

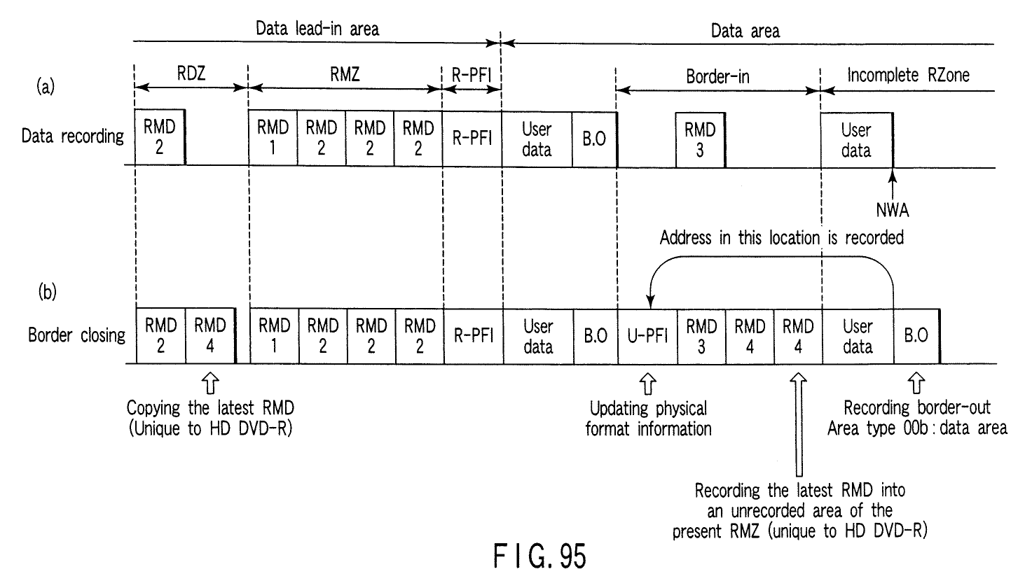

FIG. 95 is a diagram to help explain the process of closing a second and later bordered areas in the information recording and reproducing apparatus of the embodiment. As shown in the diagram (a) of FIG. 95, explanation will be given about a case where border closing is done in a state where user data has been recorded in an incomplete R zone and recording management zone RMZ3 has been recorded in the border-in area. The next writable address NWA in the additionally recordable R zone is recorded into the update physical format information U-PFI set in the border-in area. At the same time, the latest recording management data RMD4 is recorded repeatedly in the remaining part of the border-in area (the unrecorded part of the present recording management zone RMZ). The latest recording management data RMD4 is copied into the RMD duplication zone RDZ (point (L10α) in FIG. 125P). Border-out area is recorded outside the user data. Area type information on the border-out area is 00b: data area.

FIG. 96 is a diagram to help explain a processing method when a finalizing process is carried out after the bordered area is closed temporarily in the information recording and reproducing apparatus of the embodiment. As shown in the diagram (a) of FIG. 96, when border closing is done, the R zone is completed. As shown in the diagram (b) of FIG. 96, a terminator T is recorded outside the border-out area at the end of the data area (point (N1α) in FIG. 125R). Area type information on the terminator is 10b: data lead-out area.

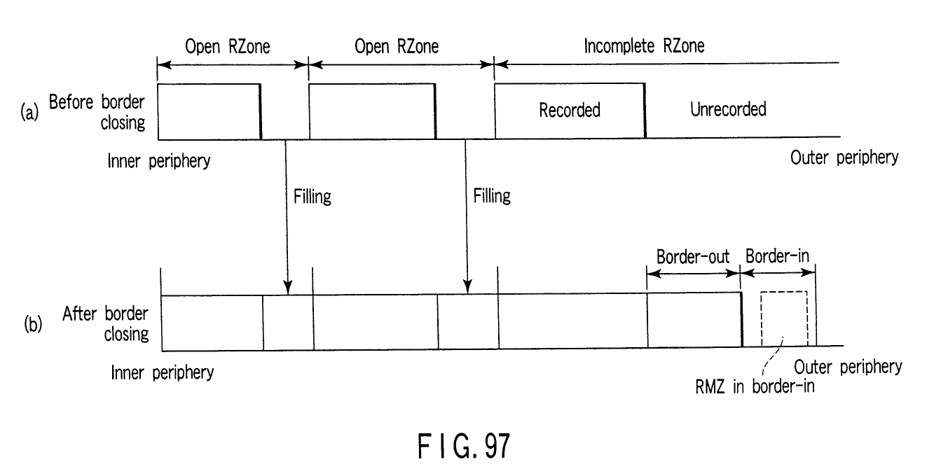

FIG. 97 is a diagram to help explain the principle of an extended recording management zone EX.RMZ recorded in the border-in area in the embodiment. As shown in the diagram (a) of FIG. 97, explanation will be given about a case where border closing is done in a state where three R zones have been set. An R zone is used for the drive to manage the recording positions of user data independently of the file system in order to maintain a physically continuous state on a recordable information storage medium. A part reserved for recording user data in a data recordable area is called an R zone. R zones are classified into two types according to the recording state. An open R zone enables additional data to be added. A complete R zone prevents additional data from being added any more. Up to two open R zones can be set. A reserved part for recording user data in the data recordable area is called an invisible (unspecified) R zone. A subsequent R zone is reserved in an invisible R zone. When data is not added any more, there is no invisible R zone. That is, up to three R zones can be set at a time. In an open R zone, both of the start address and end address of the zone are set. In an invisible R zone, the start address of the zone is set, but the end address is not set.

When border closing is done, the unrecorded part of first and second R zones (open R zone) (the zones are called first, second, and third zones, starting from the inner periphery) is filled with “00h” as shown in the diagram (b) of FIG. 97 and border-out area is recorded outside the recorded data in the third zone (incomplete R zone) (point (L10β) in FIG. 125P). Border-in area is recorded outside the border-out area. In the border-in area, an extended recording management zone EX.RMZ is recorded. As shown in FIG. 87, recording management data RMD can be updated 392 or more times (16384 times) using the extended recording management zone EX.RMZ in the border-in area (point (L4β) in FIGS. 125I). However, before the extended recording management zone EX.RMZ in the border-in area is used, the border must be closed, which takes time.

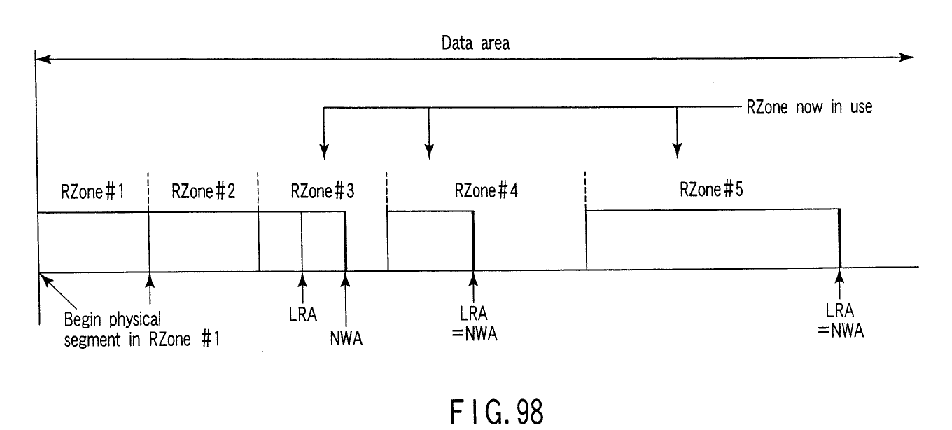

FIG. 98 is a diagram to help explain an R zone in the embodiment. To reproduce the recordable information storage medium, the drive manages the recording position of the user data independently of the file system in order to maintain a physically continuous state. The drive manages the positions of recording on an R zone basis. On the disk, the following information is stored as recording management data RMD:
The number of an additionally recordable R zone now in use
Start physical segment number of an R zone
Last recorded address LRA

Up to three additionally recordable R zones can be set. In FIG. 98, R zone #3, R zone #4, and R zone #5 are additionally recordable R zones. Additional recording is started from the next writable address NWA in an additionally recordable R zone (point (L5α) in FIG. 125N). When additional recording is completed, it follows that the last recorded address LRA=the next writable address NWA. Since neither R zone #1 nor R zone #2 has an unrecorded area, additional data cannot be added any more and therefore they are complete zones.

FIG. 99 is a diagram to help explain the concept of a method of recording additional data in a plurality of places simultaneously using R zones. The diagram (a) of FIG. 99 shows a basic recording method. In the method, no R zone is reserved and data is recorded sequentially in one address NWA in an invisible R zone or an incomplete R zone. An incomplete R zone has no end address set in it and, in this respect, is an invisible R zone. However, in an invisible R zone, any data is recorded at all and the next writable address NWA is the start address, whereas in an incomplete R zone, data is recorded halfway and the next writable address is away from the start address.

The diagram (b) of FIG. 99 shows an example of supporting recording on the basis of a plurality of addressed as in a conventional DVD-R. The drive can set one invisible R zone and two open R zones simultaneously. Therefore, there are three next writable addresses for R zones. For example, file management information can be recorded in an open R zone and video data can be recorded in an invisible R zone. When video data is recorded, the next writable address NWA of the invisible R zone slips out of the start address and becomes an incomplete R zone.

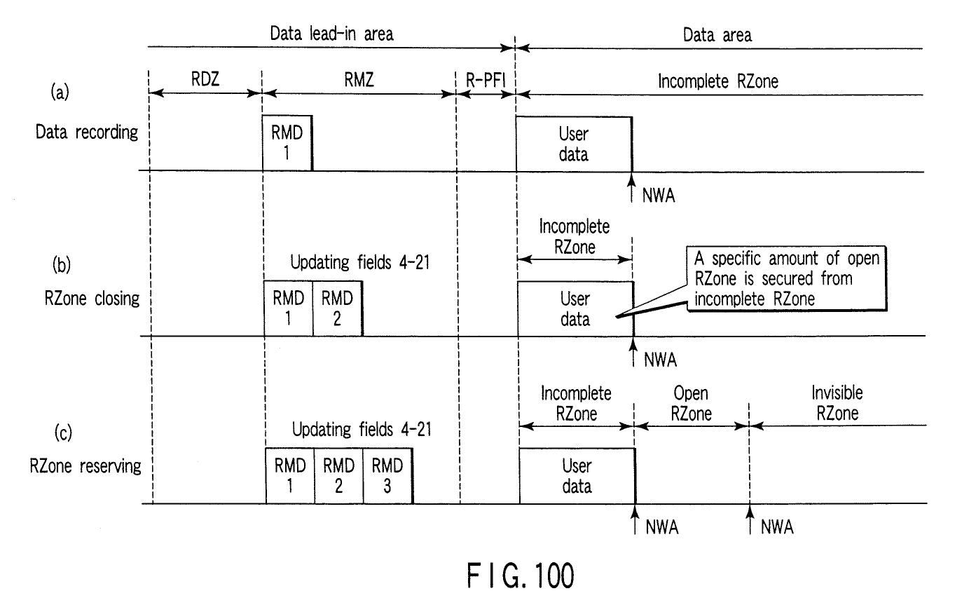

FIG. 100 shows the relationship between a method of setting R zones and recording management data RMD in the information recording and reproducing apparatus of the embodiment. Suppose no open R zone has been set in the data area and only an incomplete R zone exists as shown in the diagram (a) of FIG. 100. Recording management data RMD1 in an incomplete R zone has been recorded in a recording management zone RMZ. Explanation will be given about a case where video data is recorded in an incomplete R zone and then management information is recorded in another zone. First, as shown in the diagram (b) of FIG. 100, to close an R zone, an incomplete R zone is turned into a complete R zone. That is, the end address of the user data is set as the end address of an R zone. Recording management data RMD2 for a complete R zone (RMD fields 4 to 21 are updated) is additionally recorded in the recording management zone RMZ. As shown in the diagram (c) of FIG. 100, an open R zone of a specific size is set (reserved) outside the complete R zone and the outside of the open R zone is set as an invisible R zone. Recording management data RMD3 for the open R zone and invisible R zone is additionally recorded in the recording management zone RMZ.

As described later, an open R zone is also reserved when the recording management zone RMZ is extended.

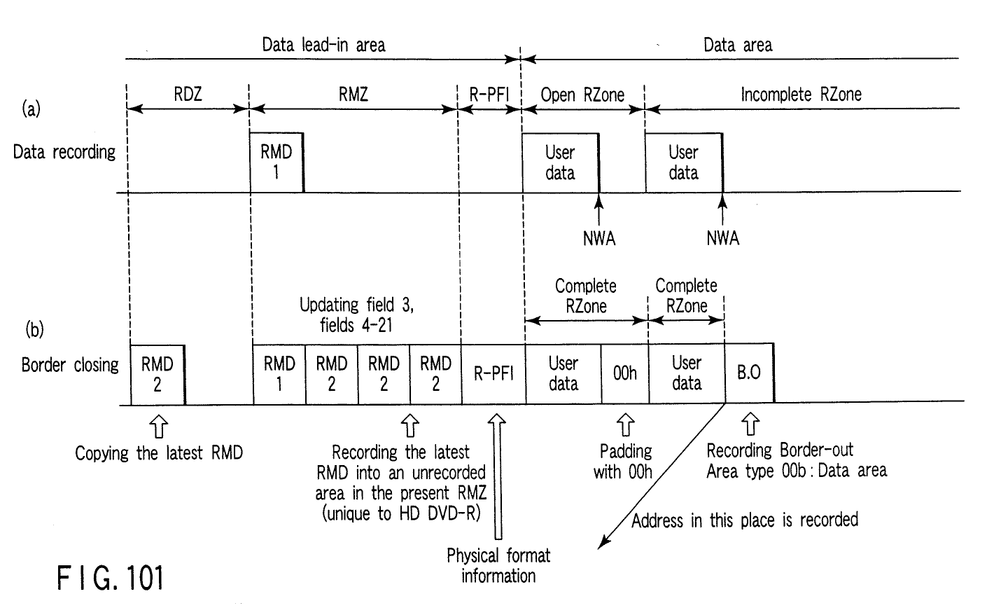

FIG. 101 is a diagram to help a correlation between an R zone and recording management data RMD when the first bordered area is closed. Suppose an open R zone and an incomplete R zone are set in the data area as shown in the diagram (a) of FIG. 101. In the recording management zone RMZ, recording management data RMD1 is recorded. When border closing is done, the unrecorded area of the open R zone is padded with “00h” to form a complete R zone and turn the incomplete R zone into a complete R zone. Outside the complete R zone, border-out area is set. Recording management data RMD2 (fields 3 and 4 to 21 in RMD are updated) in the complete R zone and border-out area is additionally recorded into the recording management zone RMZ and, at the same time, the latest RMD2 is copied into the RMD duplication zone RDZ. The area type of the border-out area is 00b: data area. The start address of the border-out area is recorded into update physical format information U-PFI. Border closing is done to pad an unrecorded part with recording data to enable a recordable storage medium to be reproduced by a player. To do this, the unrecorded area of the recording management zone is padded with the latest RMD2.

FIG. 102 is a diagram to help explain the procedure for a finalizing process in the information recording and reproducing apparatus of the present embodiment. Border closing differs from finalization in that, even when border closing is done, a bordered area can be set (or can be additionally recorded) and that, after finalization is performed, a bordered area can never be additionally recorded. The finalizing process of the embodiment can be realized by modifying a part of a border closing process, which shortens the finalize time. Finalization of FIG. 102 differs from border closing of FIG. 101 in that the area type of border-out area is set as 10b: data lead-out area and that the disk status of field 0 in recording management data RMD2 is set as 02h: “indicates that the disk is finalized” (point (L11) in FIG. 125P). Specifically, when border closing is done, border-out area is set as a bordered area so as to enable border-in area to be set again. In contrast, when finalization is performed, border-out area is set as a data lead-out area so as to close the data area. At the same time, to indicate the finalization of the disk, the disk status of field 0 in recording management data RMD2 is set to 02h. As described above, the data unrecorded area is turned into a data lead-out area, making it unnecessary to fill the unrecorded area of the data area with data, which shortens the finalize time.

FIG. 103 is a diagram to help explain the principle of setting an extended recording management zone EX.RMZ using R zones in this embodiment. The diagram (a) of FIG. 103 is the same as the diagram (a) of FIG. 97. There is a request to extend the recording management zone RMZ without closing the border. In that case, as shown in the diagram (b) of FIG. 103, an incomplete R zone is changed to a complete R zone, a bordered area (128 physical segment blocks) is set outside the complete R zone, and an extended recording management zone EX.RMZ is set in the bordered area (point (C8) in FIG. 125C, points (L12), (L12α) in FIG. 125Q). The part outside the bordered area is an invisible R zone. In this case, when the unrecorded area of the open R zone is filled with data “ooh, border-out area need not be set adjacent to the complete R zone.

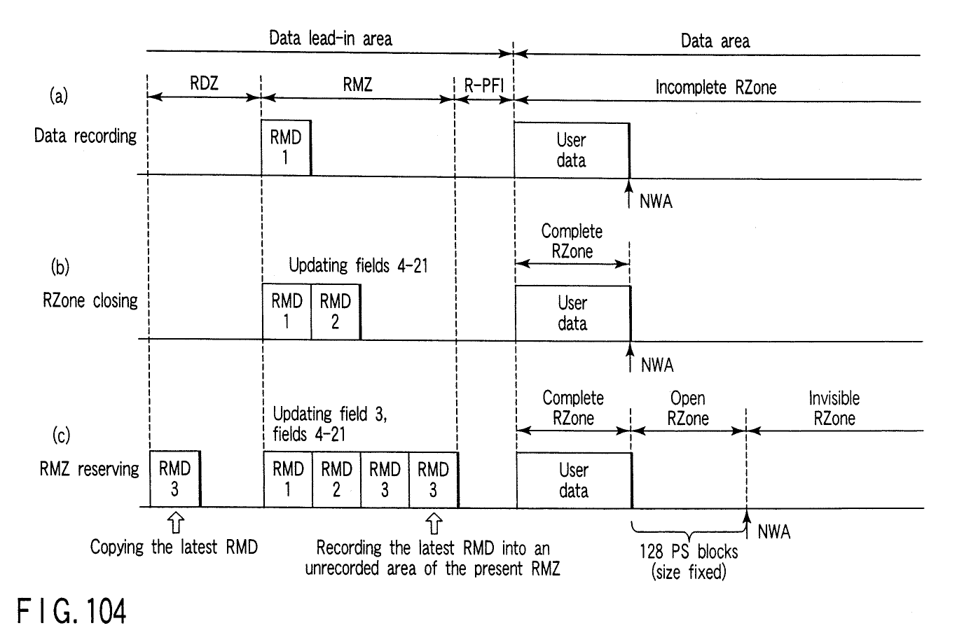

FIG. 104 is a diagram to help explain the relationship between recording management data RMD and a new setting of an extended recording management zone EX.RMZ using R zones. When the remaining capacity of the recording management zone drops below a certain value, the recording management zone RMZ can be extended. As shown in the diagram (a) of FIG. 104, an incomplete R zone is set in the data area and user data is recorded. In the recording management zone RMZ, recording management data RMD1 of the user data is recorded. When the R zone is closed, the incomplete R zone is turned into a complete R zone, as shown in the diagram (b) of FIG. 104. That is, the last address of the user data is set as the last address of the R zone. Recording management data RMD2 (fields 4 to 21 in RMD are updated) in the complete R zone is additionally recorded into the recording management zone RMZ. As shown in the diagram (c) of FIG. 104, an open recording management zone RMZ of a specific size (128 physical segment blocks) is reserved (set) outside the complete R zone and the part outside the open recording management zone RMZ is set as an invisible R zone. Recording management data RMD3 (fields 3, 4 to 21 in RMD are updated) for the open recording management zone RMZ and invisible R zone is additionally recorded into the unrecorded area of the recording management zone RMZ and, at the same time, RMD3 is copied into the RMD duplication zone RDZ (point (L12β) in FIG. 125Q).

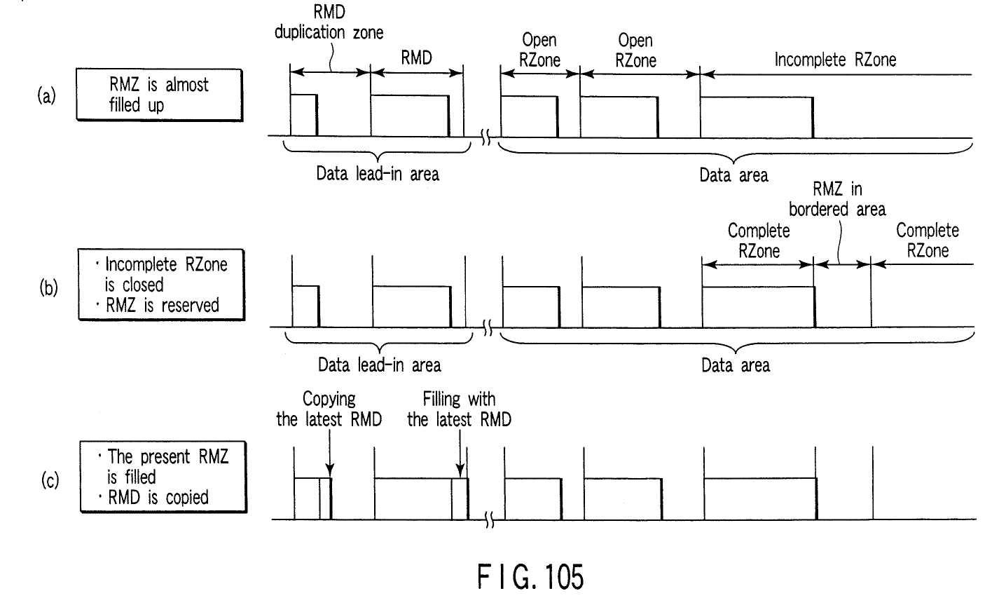

FIG. 105 is a diagram to help explain the concept of a processing method when the existing recording management data RMD is filled up in the same bordered area. As shown in the diagram (a) of FIG. 105, when the recording management zone RMZ in the data lead-in area is almost filled up, the incomplete R zone, as shown in the diagram (b) of FIG. 105, is turned into a complete R zone as in the diagram (b) of FIG. 103, a bordered area (128 physical segment blocks) is set outside the complete R zone. In the bordered area, an extended recording management zone EX.RMZ is set. The part outside the bordered area is an invisible R zone. Thereafter, as shown in the diagram (c) of FIG. 105, the unrecorded area of the recording management zone RMZ is filled with the latest recording management data RMD and the latest recording management data RMD is copied into the RMD duplication zone RDZ (point (L12γ) in FIG. 125Q).

FIG. 108 is a diagram to help explain a method of searching for the recording location of the latest recording management data RMD using an RMD duplication zone RDZ in the information reproducing apparatus or information recording and reproducing apparatus of the present embodiment.

The diagram (a) of FIG. 108 shows a case where the recorder searches for the latest recording management data RMD7. The recording management zone RMZ in the data lead-in area is found from the control data zone in the system lead-in area. Then, the recording management data RMD is traced. Since the start physical sector number of the extended recording management zone RMZ is recorded in the recording management data RMD, the latest recording management data RMD7 in the extended recording management zone RMZ in the third border can be found (point (L6) in FIG. 125N).

As shown in the diagram (b) of FIG. 108, the ROM drive cannot access an unrecorded area and the recording management data RMD cannot be interpreted.

FIG. 22 shows a data structure of a control data zone CDZ and that of an R physical information zone RIZ. As shown in the diagram (b) of FIG. 22, in the control data zone CDZ, there are Physical Format Information PFI and Disk Manufacturing Information DMI. In the R physical information RIZ, there are Disk Manufacturing Information DMI and R Physical Format Information R_PFI.

In the disk manufacturing information DMI, information 251 on the name of the country where the medium was manufactured and information 252 on the country to which the medium manufacturer belongs have been recorded (point [F] in FIG. 125D). A warning of infringement is often given in a country that has a location of manufacture or in a country in which information storage media have been consumed (or used) when a sold information storage medium has infringed a patent. The recording of the above information is required to be done in the information storage medium, making the location of manufacture (country name) clear and facilitating a warning of patent infringement, which guarantees intellectual property and promotes technological advances. Moreover, in the disk manufacturing information DMI, other disk manufacturing information 253 is also recorded.

This embodiment is characterized in that the type of information to be recorded is determined based on the recording place (or the byte positions relative to the starting position) in physical format information PFI or R physical format information R_PFI (point [G] in FIG. 125E). Specifically, in physical format information PFI or R physical format information R_PFI, common information 261 in the DVD family is recorded in a 32-byte area ranging from the 0^{th} byte to 31^{st} byte, common information 262 in the HD_DVD family to be handled in the embodiment is recorded in a 96-byte area ranging from the 32^{nd} byte to 127^{th} bytes, unique information 263 about the types of standard books and part versions is recorded in a 384-byte area ranging from the 128^{th} byte to 511^{th} byte, information corresponding to each revision is recorded in a 1536-type area ranging from the 512^{th} byte to 2047^{th} byte. As described above, the information arrangement positions in the physical format information are standardized according to the contents of information, thereby standardizing the places of recorded information, regardless of the type of medium, which enables the reproducing processes in the information reproducing apparatus or information recording and reproducing apparatus to be standardized and simplified. As shown in the diagram (d) of FIG. 22, the common information in the DVD family recorded in the 0^{th} byte to 31^{st} byte is divided into information 267 that is recorded in the 0^{th} byte to the 16^{th} bytes in each of a read-only, a rewritable, and a recordable information storage medium and information 268 that is recorded in the 17^{th} byte to 31^{st} byte in each of a rewritable and a recordable information storage medium and is not recorded in a read-only information storage medium.

FIGS. 23A and 23B show a comparison between the detailed contents of information in physical format information PFI or R physical format information R_PFI and the types of media (a read-only, a rewritable, or a recordable) in physical format information PFI. As information 267 in the common information 261 in the DVD family recorded in each of a read-only, a rewritable, and a recordable information storage medium, information on the type of standard books (read-only/rewritable/recordable), version number information, medium size (diameter), maximum possible data transfer rate information, medium structure (a single layer of a double layer, the presence or absence of an emboss pit/recordable area/rewritable area), location information on the data area DTA, and information on the presence or absence of a burst cutting area BCA (this area is present in each of a read-only, a rewritable, and a recordable information storage medium) are recorded in that order in byte position 0 to byte position 16.

Revision number information that determines the maximum recording speed, revision number information that determines the minimum recording speed, revision number table (application revision number), class state information, and extended (part) version are recorded in the 17^{th} byte to 27^{th} byte in that order as common information 261 in the DVD family common information 268 similarly recorded in each of a rewritable and a recordable information storage medium. The present embodiment is characterized in that revision information corresponding to the recording speed is recorded in the 17^{th} byte to 27^{th} byte of the recording area of physical format information PFI or R physical format information R_PFI (point (G1) in FIG. 125E). With the development of a medium with an increased recording speed, such as double speed or quad speed, this has involved an immense amount of time and effort to remake standard books accordingly.

In contrast, in this embodiment, a standard book is divided into a version book whose version is changed when the contents are changed greatly and a revision book which is revised according to a small change in the recording speed or the like and is issued. Each time the recording speed is improved, only a revision book where only the revision has been updated is issued. This produces the effect of guaranteeing the function of expanding a medium to a future high-speed-recording-compatible medium. In addition, since standards can be dealt with by a simple method of revision, when a new high-speed-recording-compatible medium is developed, this can be coped with at high speed. This embodiment is particularly characterized in that providing separately a field for revision information that determines the maximum recording speed at the 17^{th} byte and a field for revision information that determines the minimum recording speed at 18^{th} byte enables different revision numbers to be assigned to the maximum and minimum values of the recording speed (point (G1α) in FIG. 125E). For instance, when a recording film which enables very high speed recording has been developed, the recording film makes it possible to record data at very high speed, but often cannot record data suddenly when the recording speed is lowered. In addition, such a recording film as enables the minimum possible recording speed to be lowered may be often very expensive. In contrast, as in the embodiment, revision numbers are made settable separately using the maximum value and minimum value of the recording speed, making the selection range of the developable recording film wider, which produces the effect of enabling a higher-speed recordable medium and a lower-price medium to be supplied. In the information recording and reproducing apparatus of the embodiment, information on the maximum possible recording speed and the minimum possible recording speed for each revision have been known beforehand. When an information storage medium is installed in the information recording and reproducing apparatus, the information recording and reproducing section 141 of FIG. 1 first reads the information in physical format information PFI or R physical format information R_PFI. On the basis of the acquired revision number information, the control section 143 calculates the maximum possible recording speed and minimum possible recording speed of the installed information storage medium, referring to the maximum possible recording speed and minimum possible recording speed for each revision previously recorded in the memory section 175 of the control section 143. On the basis of the result, recording is done at the optimum recording speed.

Next, explanation will be given about unique information 263 on the types and versions of standard books in the 128^{th} byte to 511^{th} byte and the contents of information uniquely settable in the 512^{th} type to 2047^{th} byte on a revision basis in the diagram (c) of FIG. 22. Specifically, in the unique information 263 on the types and versions of standard books in the 128^{th} byte to 511^{th} byte, the meaning of the contents of recording information in each byte position coincides with each other, regardless of whether the information storage medium is either a rewritable one or a recordable one. In information content 264 uniquely set on a revision basis in the 512^{th} byte to 2047^{th} byte, the meaning of the contents of information at each byte position is allowed to be different if the revision is different, in not only a rewritable and a recordable information storage medium differing from each other in type but also the same type of media.

As shown in FIGS. 23A and 23B, in the unique information 263 on the types and versions of standard books where the meaning of the contents of information is the same in each byte position in each of a rewritable and a recordable information storage medium, information on the name of the medium manufacturer, additional information from the medium manufacturer, information on the polarity (identifying whether it is High-to-Low or Low-to-High) of a recording mark, information on linear velocity in recording or reproducing, the rim intensity value of the optical system in the circumferential direction, the rim intensity value of the optical system in the radial direction, and recommended laser power (the amount of light on the recording surface) in reproduction are recorded in that order sequentially.

This embodiment is particularly characterized in that information on the polarity of a recording mark (identifying whether it is High-to-Low or Low-to-High) MPD (Mark Polarity Descriptor) is recorded in the 192^{nd} byte. In a conventional rewritable or recordable DVD disk, only a High-to-Low recording film where the amount of reflected light in a recording mark was low in comparison with the unrecorded state (the reflection level was relatively high) was allowed. When a request was made for “high-speed recording” and “lower price” or the physical performance, including “the decrease of cross erase” and “an increase in the upper limit of the number of times of rewriting,” this could not be dealt with only by a conventional High-to-Low recording film. In contrast, since the present embodiment permits the use of not only a High-to-Low recording film but also a Low-to-High recording film where the amount of reflected light increases in a recording mark, this produces the effect of incorporating not only a conventional High-to-Low recording film but also a Low-to-High recording film into standard books to widen the recording film selection range and therefore enabling high-speed recording and the supply of low-cost media.

A method of implementing a detailed information recording and reproducing apparatus will be explained below. In a version book or a revision book, both of the reproduction signal characteristic of a High-to-Low recording film and that of a Low-to-High recording film are described. According to the description, two types of handling circuits are formed in the PR equalizing circuit 130 and Viterbi decoder 156 shown in FIG. 1. When an information storage medium is installed in the information reproducing section 141, the slice level detecting circuit 132 to read the information in the system lead-in area SYLDI is first activated. After the slice level detecting circuit 132 reads information on the polarity of the recording mark recorded in the 192^{nd} byte (identifying whether it is High-to-Low or Low-to-High), it is determined whether it is a High-to-Low recording film or a Low-to-High recording film. After the circuits in the PR equalizing circuit 130 and Viterbi decoder 156 are switched according to the result of the determination, the information recorded in the data lead-in area DTLDI or data area DTA is reproduced. This method makes it possible to read the information in the data lead-in area DTLDI or data area DTA relatively fast and with high accuracy. While revision number information that determines the maximum recording speed is recorded in the 17^{th} byte and revision number information that determines the minimum recording speed is recorded in the 18^{th} byte, they give only information on the range determining the maximum and minimum values. Since information on the optimum linear speed is needed in recording to record data most stably, its information is recorded in the 193^{rd} byte.

The embodiment is further characterized in that the rim intensity value of the optical system in the radial direction recorded in the 194^{th} byte and that of the optical system in the radial direction recorded in the 195^{th} byte are arranged as optical system condition information in the position that precedes various types of recording condition (write strategy) information included in information content 264 uniquely set on a revision basis. These pieces of information mean condition information on the optical system of the optical head used in determining the recording condition placed behind them. Rim intensity means the distribution of incident light which enters the objective before converging on the recording surface of the information storage medium and is defined as the value of intensity at the periphery of the objective (or at the margin of the pupil surface) if the central intensity of the intensity distribution of incident light is “1.” The intensity distribution of incident light to the objective is not symmetric with respect to a point, but is an elliptic distribution. Since the value of the rim intensity in the radial direction of the information storage medium differs from that in its circumferential direction, the two values are recorded. The larger the value of the rim intensity, the smaller the converged spot size on the recording surface of the information storage medium becomes. As a result, depending on the value of the rim intensity, the optimum recording power condition changes greatly.

Since the information recording and reproducing apparatus has known information on the value of the rim intensity of its own optical head, it first reads the values of the rim intensity of the optical system along each of the circumference and the radius recorded on the information storage medium and compares these values with the values of its own optical head. If the result of the comparison has shown no great difference, the recording condition recorded behind can be applied. If the result of the comparison has shown a great difference, the recording condition recorded behind has to be ignored and the optimum recording condition needs to be determined, while the information recording and reproducing apparatus itself is doing test recording using a drive test zone DRTZ written in FIG. 16, 18A, or 18B.

As described above, it is necessary to determine quickly whether to use the recording condition recorded behind or ignore the information and start to find the optimum recording condition while performing test recording. As shown in FIGS. 23A and 23B, the condition information on the optical system from which the condition has been determined is placed in a position preceding the position in which recommended recording conditions have been recorded, which produces the effect of enabling the rim intensity information to be read and then making it possible to determine at high speed whether the recording condition placed behind can be applied.

As described above, with the present embodiment, the standard books are divided into a version book where the version is changed if the contents have been change greatly and a revision book whose revision is changed according to a small change in the recording speed and then which is issued. Each time the recording speed is improved, only a revision book whose revision alone has been updated is issued. Therefore, since the revision number is different, the recording condition in the revision book changes. Information about the recording condition (write strategy) is recorded in information content 264 uniquely settable mainly in the 512^{th} byte to 2047^{th} byte on a revision basis. As seen from FIGS. 23A and 23B, information content 264 uniquely settable in the 512^{th} byte to 2047^{th} byte on a revision basis permits the meaning of the recorded information content at each byte position to differ if the revision is different, in not only a rewritable and a recordable information storage medium differing in type from each other but also media of the same type.

The definitions of peak power, first bias power, second bias power, and third bias power coincide with the power values defined in FIG. 19. The end time of a first pulse in FIG. 23B means T_{EFP} defined in FIG. 19. The multi-pulse interval in FIG. 23B means T_{MP} defined in FIG. 19. The starting time of a last pulse in FIG. 23B means T_{SLP} defined in FIG. 19. The period of the second bias power of 2 T mark means T_{LC} defined in FIG. 19.

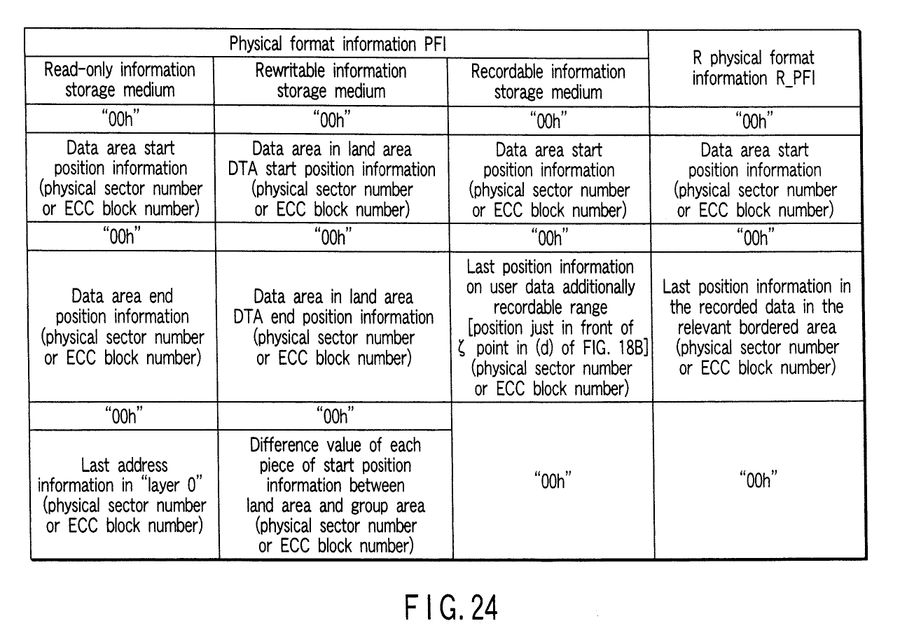

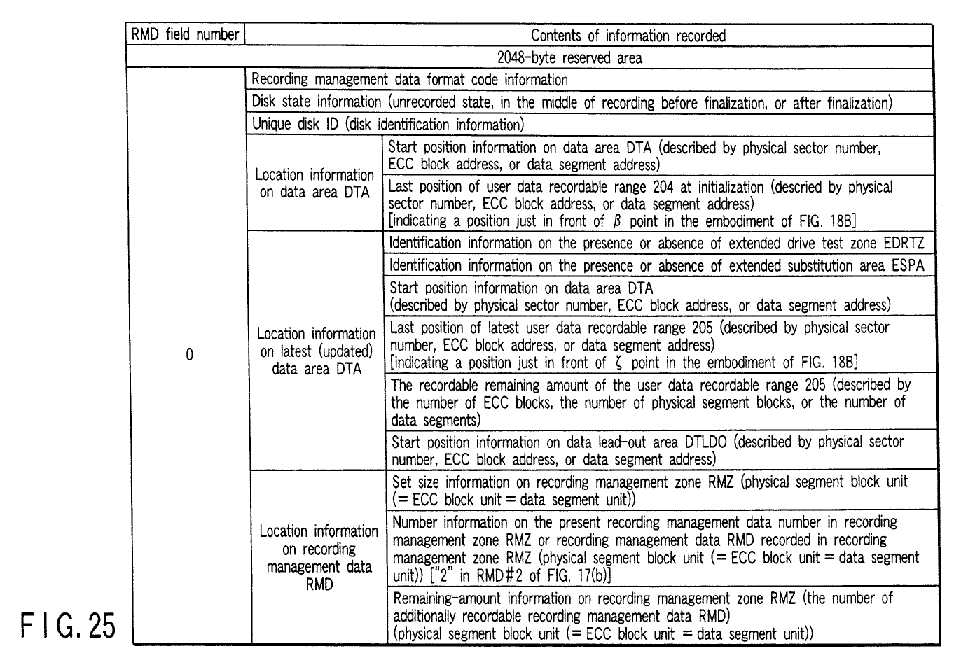

FIG. 24 shows a comparison of detailed information contents between locations in the data area DTA in the 4^{th} byte to the 15^{th} byte. The starting position information on the data area DTA is recorded equally, regardless of the type of medium and of whether physical format information PFI or R physical format information R_PFI is used. End position information on the data area DTA is recorded as information indicting the end position in the information recording and reproducing apparatus.

As shown in FIGS. 12A and 12B, in a rewritable information storage medium, the place whose physical sector number is the largest is in the groove area. End position information on the data area DTA in the land area is recorded there.

In the physical format information PFI on a recordable information storage medium, the last position information of the additionally recordable range of the user data is recorded. For example, in the diagram (d) of FIG. 18B, the position information means a position just in front of ζ point.

In contrast, in the R physical format information R_PFI on a recordable information storage medium, the last position information in the recorded data in the relevant bordered area BRDA is recorded.

Furthermore, in the read-only information storage medium, information on the last address in the “0 layer,” a front layer when viewed from the reproduction optical system is also recorded. In the rewritable information storage medium, the difference value between the starting position of the land area and that of the groove area is also recorded.

As shown in the diagram (c) of FIG. 16, the recording management zone RMZ exists in the data lead-in area DTLDI. Then, as shown in the diagram (d) of FIG. 21, its copy information also exists as copy information C_RMZ on the contents recorded in the recording management zone RMZ in the border-out area BRDO. As shown in the diagram (b) of FIG. 17, in the recording management zone RMZ, recording management data RMD of the same data size as one physical segment block size is recorded. Each time the contents of the recording management data RMD are updated, the updated new recording management data RMD are added behind. FIGS. 25 to 30 show a detailed data structure of one item of recording management data RMD. The recording management data RMD is further divided into small RMD field information RMDF, one piece of which is of a 2048-byte size.

The first 2048 bytes in the recording management data RMD are allocated to a reserved area.

In RMD field 0 made up of the next 2048 bytes, recording management data format code information, medium state information indicating whether the present medium is (1) in the unrecorded state, (2) now being recorded before finalization, or (3) after finalization, unique disk ID (disk identifying information), location information on the data area DTA and on the latest (updated) data DTA, and location information on the recording management data RMD are arranged in that order. In the location information on the data area DTA, starting position information on the data area DTA and last position information (this information indicates a position right in front of β point in the embodiment of the diagram (d) of FIG. 18B) on the recordable range 204 of the user data in initialization are recorded as information indicating the additionally recordable range 204 of the user data in the initial state.

As shown in the diagrams (e) and (f) of FIG. 18B, this embodiment is characterized in that an extended drive test zone EDRTZ and an extended substitution area ESPA can be set in the additionally recordable range 204 of the user data (point (E2) in FIG. 125D). However, such extensions make the additionally recordable range 205 of the user data narrower. The embodiment is characterized in that related information is recorded in “location information on the latest (updated) data area DTA” to prevent user data from being additionally recorded in the extended areas EDRTZ and ESPA. Specifically, from information identifying whether an extended drive test zone EDRTZ is present or absent, it is seen whether an extended drive test zone EDRTZ has been added. From information identifying whether an extended substitution area ESPA is present or absent, it is seen whether an extended substitution area ESPA has been added.

Furthermore, as shown in FIGS. 25 to 30, the last position of the recordable range 205 of the latest user data recorded in location information on the latest (updated) data area DTA in RMD field 0 exists as recordable range information on the additionally recordable range 205 of the user data managed in the recording management data RMD (point [E] in FIG. 125D), enabling the additionally recordable range 205 of the user data in the diagram (f) of FIG. 18B to be found immediately, which makes it possible to detect the size of an unrecorded area recordable in the future (or the remaining amount of the unrecorded area) at high speed. This produces the effect of enabling the programmed recording time set by the user to be recorded into a medium without any omissions at the highest possible picture quality by setting the transfer rate in the optimum recording according to, for example, the programmed recording time set by the user. In the embodiment of the diagram (d) of FIG. 18B, “the last position of the recordable range 205 of the latest user data” means a position just in front of ζ point. These pieces of position information may be written in ECC block address numbers as another embodiment instead of writing them in physical sector numbers (point (E1) in FIG. 125D). As described later, in this embodiment, 32 sectors constitute one ECC block. Therefore, the lower 5 bits of the physical sector number of the sector placed at the head of a specific ECC block coincide with the sector number of the sector placed at the start position of the adjacent ECC block.

When the physical sector number is so set that the lower 5 bits of the physical sector number of the sector placed at the head of the ECC block are “00000,” the values of the lower 6 bits or more of the physical sector numbers of all the sectors existing in the same ECC block coincide with one another. Therefore, address information obtained by removing the lower 5 bits of the physical sector numbers of the sectors existing in the same ECC block and extracting only the data in the lower 6 bits or more is defined as ECC block address information (or ECC block address number). As described later, since data segment address information (or physical segment block number information) previously recorded by wobble modulation coincides with the ECC block address, writing position information in the recording management data RMD in ECC block address numbers produces the following effects:

Access to a recorded area is particularly made faster

The reason is that, since a position information unit in the recording management data RMD coincides with an information unit of data segment addresses previously recorded by wobble modulation, this makes it easy to calculate the difference.

The management data size in the recording management data RMD can be made smaller

The reason is that the number of bits necessary to write address information can be saved by 5 bits per address.

As described later, one physical segment block length coincides with one data segment length. In one data segment, one ECC block of user data is recorded. Therefore, addresses are expressed in “ECC block address numbers,” “ECC block addresses,” “data segment addresses,” “data segment numbers,” “physical segment block numbers,” or the like. All of these expressions are really synonymous terms.

As shown in FIGS. 25 to 30, in location information on the recording management data RMD in RMD field 0, set size information on the recording management zone RMZ in which the recording management data RMD can be additionally recorded sequentially is recorded in unit of ECC block or physical segment block. As shown in the diagram (b) of FIG. 17, since one recording management zone RMZ is recorded on one physical segment block, it is seen from the information how many times the updated recording management data RMD can be additionally recorded in the recording management zone RMZ. Then, the present recording management data number in the recording management zone RMZ is recorded. This means information on the number of items of recording management data RMD already recorded in the recording management zone RMZ. For instance, in the diagram (b) of FIG. 17, suppose the information is present in recording management data RMD#2. Since the information is recording management data RMD second recorded in the recording management zone RMZ, the value “2” is recorded in this field. Then, information on the remaining amount of the recording management zone RMZ is recorded. The information means information on the number of items of recording management data RMD further addable in the recording management zone RMZ. The information is written in physical segment blocks (=ECC blocks=data segments). The following relationship holds between the three types of information:
[Set size information on RMZ]=[Present recording management data number]+[the remaining amount of RMZ]

The present embodiment is characterized in that information on the amount of the recording management zone already used by recording management data RMD or the remaining amount is recorded in the recording area in the recording management data RMD (point (E7) in FIG. 125D).

For instance, when all of the information is recorded onto a single recordable information storage medium at a time, recording management data RMD has to be recorded only once. To do recording by additionally recoding user data minutely onto a single recordable information storage medium (or additionally recording user data into the additionally recordable range 205 of user data in the diagram (f) of FIG. 18B), the recording management data RMD updated each time additional writing is performed has to be additionally recorded. In this case, when recording management data RMD is additionally recorded frequently, the recorded area 206 of the diagram (b) of FIG. 17 is used up. Thus, the information recording and reproducing apparatus has to deal with this problem. Recording information on the amount of the recording management zone already used by recording management data RMD or the remaining amount into the recording area in the recording management data RMD makes it possible to find beforehand that the recording management zone RMZ cannot be additionally recorded into, which enables the information recording and reproducing apparatus to cope with the problem early.

As moving from the diagrams (e) to (f) of FIG. 18, this embodiment is characterized by being capable of setting a data lead-out area DTLDO in such a manner that it includes an extended drive test zone EDRTZ (point (E4) in FIG. 125D). At this time, the starting position of the data lead-out area DTLDO is changed from β point to ε point in the diagram (e) of FIG. 17. To manage this situation, a field in which information on the starting position of the data lead-out area DTLDO is to be recorded is provided in location information on the latest (updated) data area DTA in RMD field 0 as shown in FIGS. 25 to 30. As described above, a drive test (test recording) is recorded in clusters which can be basically extended in data segments (ECC blocks). Therefore, information on the starting position of the data lead-out area DTLDO is written in an ECC block address number. As another embodiment, information on the starting position may be written in the physical sector number of the physical sector placed at the beginning of the first ECC block, the physical segment block number, the data segment address, or the ECC block address.

In RMD field 1, history information on the information recording and reproducing apparatus which has recorded data onto a compatible medium is recorded. Manufacturer identifying information on each of the information recording and reproducing apparatuses, the serial number and model number written in ASCII code, information on the date that the recording power was adjusted using a drive test zone, and information on recording conditions under which additional recording was done are written according to the format of all recording condition information in information 263 (FIG. 23B) that can be uniquely set on a revision basis.

RMD field 2 is an area available to the user. In RMD field 2, the user can record, for example, information on the contents recorded (or to be recorded).

In RMD field 3, information on the starting position of each border zone BRDZ is recorded. That is, as shown in FIGS. 25 to 30, information on the starting positions of the first to fiftieth border-out areas BRDOs is written in physical sector numbers.

For example, in the embodiment of the diagram (c) of FIG. 21, the starting position of the first border-out area BRDO represents the position of η point and the starting position of the second border-out area BRDO represents the position of θ point.

In RMD field 4, position information on an extended drive test zone is recorded. The last position information on the place already used for test recording in the drive test zone DRTZ in the data lead-in area DTLDI of the diagram (c) of FIG. 16 and the last position information on the place already used for test recording in the drive test zone DRTZ in the data lead-out area DTLDO of the diagrams (d) to (f) of FIG. 18B. The drive test zone DRTZ is used sequentially for test recording from the inner periphery (or from a small physical sector number) toward the outer periphery (in the direction in which the physical sector number increases). A unit of place used in test recording is a cluster, which is a unit of additional recording as described later. Therefore, when the last position information on the place already used for test recording is written in an ECC block address number or in a physical sector number, the physical sector number of the physical sector placed at the end of the ECC block used for test recording is written. Since the place once used for test recording has been already recorded into, when next test recording is done, test recording is performed behind the last position already used for test recording. Therefore, using the last position information (=the amount of the drive test zone DRTZ already used) already used for test recording in the drive test zone DRTZ (point (E5) in FIG. 125D), the extended drive test zone EDRTZ can not only find instantly where test recording is to be started but also determine from the information whether there is an empty space enabling test recording in the drive test zone DRTZ.

In the drive test zone DRTZ in the data lead-in area DTLDI, information on the area size that further enables additional writing or flag information that indicates whether the drive test zone DRTZ has been used up, and information on an area size that enables further additional writing in the drive test zone DRTZ in the data lead-out area DTLDO or flag information that indicates whether the drive test zone DRTZ has been used up are recorded. Since the size of the drive test zone DRTZ in the data lead-in area DTLDI and the size of the drive test zone DRTZ in the data lead-out area DTLDO are known, it is possible to determine the size (or the remaining amount) of an area where additional writing can be further done in the drive test zone DRTZ, on the basis of only information on the last position of the place already used for test recording in the drive test zone DRTZ in the data lead-in area DTLDI or in the drive test zone DRTZ in the data lead-out area DTLDO. However, having this information in the recording management data RMD (point (E5) in FIG. 125D) enables the remaining amount of the drive test zone DRTZ to be known immediately, which makes it possible to shorten the time required to determine whether to set a new extended drive test zone EDRTZ.

As another embodiment, in this field, flag information that indicates whether the drive test zone DRTZ has been used up may be recorded instead of information on the size (the remaining amount) of an area where additional writing can be further done in the drive test zone DRTZ. When a flag which enables the fact that the zone DRTZ has been used up to be known immediately is set, this eliminates the possibility that an attempt will be made to do test recording in this area by mistake.

In RMD field 4, information on the number of times of additional setting in the extended drive test zone EDRTZ is recorded. In the embodiment of the diagram (e) of FIG. 18B, since extended drive test zone 1 EDRTZ1 and extended drive test zone 2 EDRTZ2 are set, it follows that “the number of times of additional setting of extended drive test zone EDRTZ=2.” Moreover, in field 4, range information on each extended drive test zone EDRTZ and information on the range already used for test recording are recorded. As described above, when position information on the extended drive test zones is made capable of being managed in the recording management data RMD (point (E6) in FIG. 125D), this makes it possible not only to set the extension of an extended drive test zone EDRTZ a plurality of times but also to manages position information on the extended drive test zones EDRTZ added by updating additional recording of recording management data RMD in the recordable information storage medium. Therefore, it is possible to eliminate the possibility that the extended drive test zone EDRTZ will be mistaken for the additionally recordable range 204 of user data (the diagram (d) of FIG. 17) and user data will be written over the extended drive test zone EDRTZ.

As described above, since test recording is done in a unit of cluster (or ECC block), the range for each extended drive test zone EDRTZ is specified in a unit of ECC block address. In the embodiment of the diagram (e) of FIG. 18B, information on the starting position of the first set extended drive test zone EDRTZ indicates γ point because extended drive test zone 1 EDRTZ1 is set first. Information on the end position of the first set extended drive test zone EDRTZ corresponds to a position just in front of β point. The position information is written in unit of ECC block address number or physical sector number.

While in the embodiment of FIGS. 25 to 30, information on the end position of the extended drive test zone EDRTZ is shown, information on the size of the extended drive test zone EDRTZ may be written instead of the end position information. In this case, the size of the first set extended drive test zone 1 EDRTZ1 is “β-γ.” Moreover, information on the last position of the area already used for test recording in the first set extended drive test zone EDRTZ is also written in a unit of ECC block address number or physical sector number. Then, information on the size (or the remaining amount) of an area where additional writing can be further done in the first set extended drive test zone EDRTZ is recorded. Since the size of the extended drive test zone 1 EDRTZ1 and the size of the area already used there are known from the above information, the size (or the remaining amount) of the area where additional writing can be further done is determined automatically. However, providing this field (point (E5) in FIG. 125D) makes it possible to find instantly whether the present drive test zone is sufficient in carrying out a new drive test (test recording), thereby shortening the time required to determine an additional setting of an extended drive test zone EDRTZ. This field enables information on the size (or the remaining amount) of the area where additional writing can be further done to be recorded. As another embodiment, flag information that indicates whether the extended drive test zone EDRTZ has been used up may be set in this field. When a flag that enables the fact that the zone EDRTZ has been used up to be known instantly is set, this eliminates the possibility that an attempt will be made to do test recording in this area.

A method of setting a new extended drive test zone EDRTZ in the information recording and reproducing apparatus of FIG. 1 and doing test recording there will be explained.

A recordable information storage medium is installed in the information recording and reproducing apparatus.

The information recording and reproducing section 141 reproduces the data formed in the burst cutting area BCA and sends the reproduced data to the control section 143. The control section 143 decrypts the transferred information and determines whether to go to the next step.

The information recording and reproducing section 141 reproduces the information recorded in the control data zone CDZ in the system lead-in area SYLDI and transfers the reproduced information to the control section 143.

The control section 143 compares the value (in the 194^{th} byte and 195^{th} byte of FIG. 23B) of the rim intensity when recommended recording conditions are determined with the value of the rim intensity of the optical head used in the information recording and reproducing section 141 and determines the size of an area necessary for test recording.

The information recording and reproducing section 141 reproduces the information in the recording management data and sends the reproduced information to the control section 143. The control section 143 decrypts the information in RMD field 4 and determines whether there is a margin for the size of the area necessary for test recording determined in step (4). If there is a margin, the information recording and reproducing section 141 proceeds to step (6). If there is no margin, it proceeds to step (9).

A place where test recording is to be done this time is determined from information on the last position of the place already used for test recording in the drive test zone DRTZ or extended drive test zone EDRTZ to be used for test recording in RMD field 4.

Test recording is done over the size determined in step (4), staring from the place determined in step (6).

Since the place used for test recording by the process in step (7) has been increased, recording management data RMD in which information on the last position of the place already used for test recording has been updated is stored in the memory section 175 temporarily. Then, control goes to step (12).

The information recording and reproducing section 141 reads information on “the last position of the recordable range 205 of the latest user data” recorded in RMD field 0 or “information on the last position of the additionally recordable range of user data” recorded in information on the location of the data area DTA in the physical format PFI of FIG. 24. The control section 143 sets the range of a newly set extended drive test zone EDRTZ.

On the basis of the result of step (9), information on “the last position of the recordable range 205 of the latest user data” recorded in RMD field 0 is updated. At the same time, the number of times of additional setting of an extended drive test zone EDRTZ in the RZMD field 4 is incremented by one (or the number of times is increased by one). Then, recording management data RMD obtained by further adding information on the start/end positions of a newly set extended drive test zone EDRTZ is stored temporarily in the memory section 175.

Control goes from step (7) to step (12).

Under the optimum recoding conditions obtained as a result of test recording in step (7), the necessary user information is additionally recorded in the additionally recordable range 205 of user data.

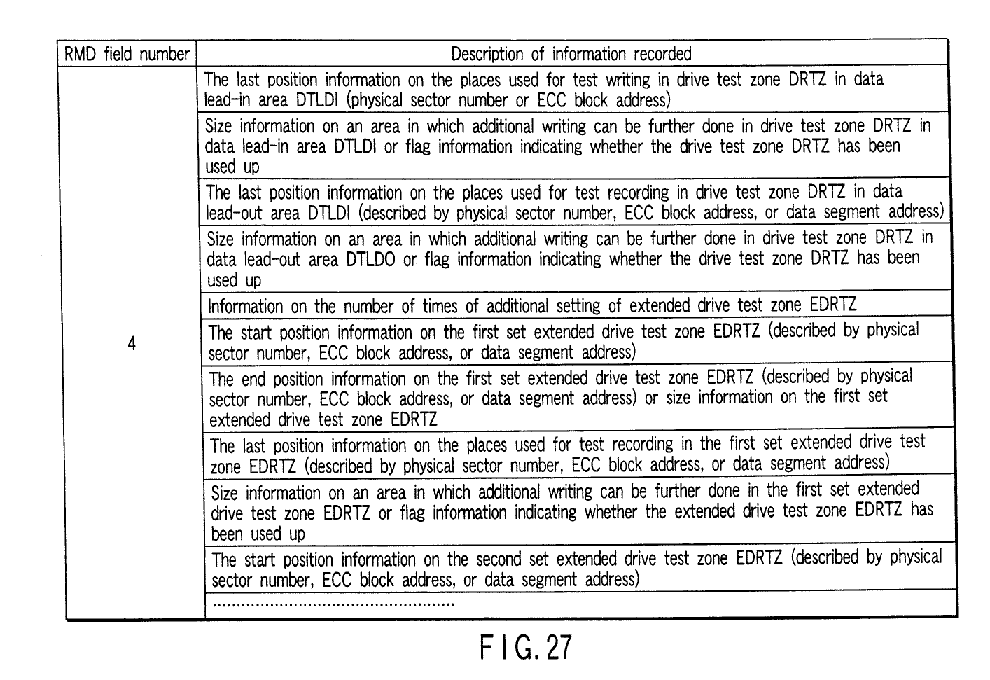

The recording management data RMD updated by additionally recording information (FIG. 27) on the start/end positions of a newly created R zone in step (12) is stored temporarily in the memory section 175.

The control section 143 performs control so that the information recording and reproducing section 141 may additionally record the latest recording management data RMD temporarily stored in the memory section 175 into the unrecorded area 206 (e.g., the diagram (b) of FIG. 17) in the recording management zone RMZ.

As shown in FIG. 27, in RMD field 5, position information on an extended substitution area ESPA is recorded. In a recordable information storage medium, a substitution area is extendable. Position information of the substitution area is managed using recording management data RMD. In the embodiment of the diagram (e) of FIG. 18B, since extended substitution area 1 ESPA1 and extended substitution area 2 ESPA2 are set, “the number of times of additional setting of extended substitution area ESPA” set first in RMD field 5 is “2.” Information on the starting position of the first set extended substitution area ESPA corresponds to the position of δ point, information on the end position of the first set extended substitution area ESPA corresponds to a position just in front of the position of γ point, information on the starting position of the second set extended substitution area ESPA corresponds to the position of ζ point, and information on the end position of the second set extended substitution area ESPA corresponds to a position just in front of the position of E point.

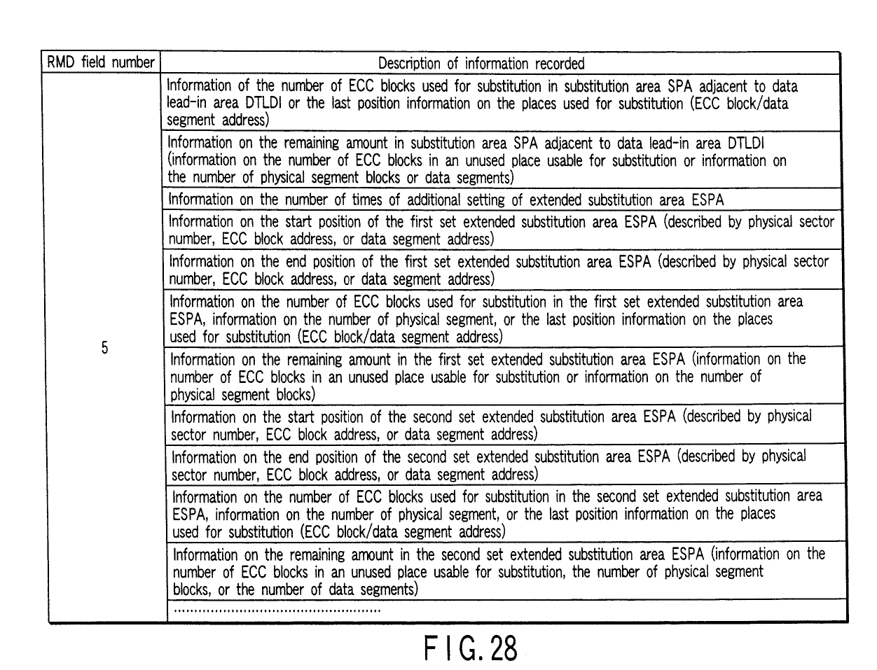

In RMD field of FIG. 28, information on defect management is recorded. In the first column of RMD field of FIG. 28, information on the number of ECC blocks used for substitution in a substitution area adjacent to the data lead-in area DTLDI or the number of physical segments is recorded. In this embodiment, a defective area found in the additionally recordable range 204 of user data is replaced in a unit of ECC block. As described layer, since one data segment constituting one ECC block is recorded into one physical segment block, the number of substitutions already performed is equal to the number of ECC blocks (or the number of physical segment blocks, the number of data segments). Therefore, information written in this column is expressed in a unit of ECC block, physical segment block, or data segment.

With a recordable information storage medium, in a substitution area SPA or an extended substitution area ESPA, a place is often used for a substituting process in the order in which its ECC block address number increases. Therefore, in another embodiment, in this column, the ECC block address number may be written as information on the last position of the place used for substitution. As shown in FIG. 28, in the first set extended substitution area 1 ESPA1 and second set extended substitution area 2 ESPA2, there is a field which is used to record similar information (“information on the number of ECC blocks or information on the number of physical segment blocks already used for substitution in the first set extended substitution area ESPA, or information on the last position of the place used for substitution (ECC block address number)” and “information on the number of ECC blocks or information on the number of physical segment blocks already used for substitution in the second set extended substitution area ESPA, or information on the last position of the place used for substitution (ECC block address number)).” Using these pieces of information, the following effects are obtained:

When a subsequent substituting process is carried out, a substitution place to be newly set for a defective area found in the additionally recordable range 205 of user data is known immediately.

A new substitution is placed just behind the last position of the place used for substitution.

The remaining amount of the substitution area SPA or extended substitution area ESPA is calculated, thereby determining whether the setting of a new extended substitution area ESPA is needed (if the remaining amount is insufficient).

Since the size of the substitution area SPA adjacent to the data lead-in area DTLDI is known beforehand, if there is information on the number of ECC blocks already used for substitution in the substitution area SPA, the remaining amount of the substitution area SPA can be calculated. However, when there is provided a frame in which information on the number of ECC blocks in an unused place usable for future substitution (or information on the remaining amount of the substitution area SPA) or information on the number of physical segment blocks is recorded, this enables the remaining amount to be known immediately, which shortens the time required to determine whether the setting of an extended substitution area ESPA is further needed. For the same reason, there is provided a frame in which “information on the remaining amount of the first set extended substitution area ESPA” and “information on the remaining amount of the second set extended substitution area ESPA” can be recorded. This embodiment enables a substitution area SPA to be extended in a recordable information storage medium and manages its position information in the recording management data RMD. As shown in the diagram (e) of FIG. 18B, first and second extended substitution areas ESPA1, ESPA2 can be set in an arbitrary size at an arbitrary starting position in the additionally recordable range 204 of user data as needed. Therefore, in RMD field 5, information on the number of times of additional setting of an extended substitution area ESPA is recorded, which makes it possible to set information on the starting position of the first set extended substitution area ESPA and information on the starting position of the second set extended substitution area ESPA. These pieces of starting position information are written in a unit of physical sector number or ECC block address number (or physical segment clock number or data segment address). In the embodiment of FIGS. 25 to 30, “information on the end position of the first set extended substitution area ESPA” and “information on the end position of the second set extended substitution area ESPA” have been recorded as information that determines the range of an extended substitution area ESPA. As another embodiment, instead of these pieces of end position information, size information on an extended substitution area ESPA may be recorded using the number of ECC blocks, the number of physical segment blocks, the number of data segments, or the number of physical sectors.

In RMD field 6, defect management information is recorded. In this embodiment, a method of improving the reliability of information on defect processing recorded on an information storage medium is designed to cope with the following two types of mode:

Conventional “substituting mode” in which information to be recorded in a defective place is recorded in a substitution place.

“Multiple mode” in which the same information is recorded twice in different portions on an information storage medium to increase reliability.

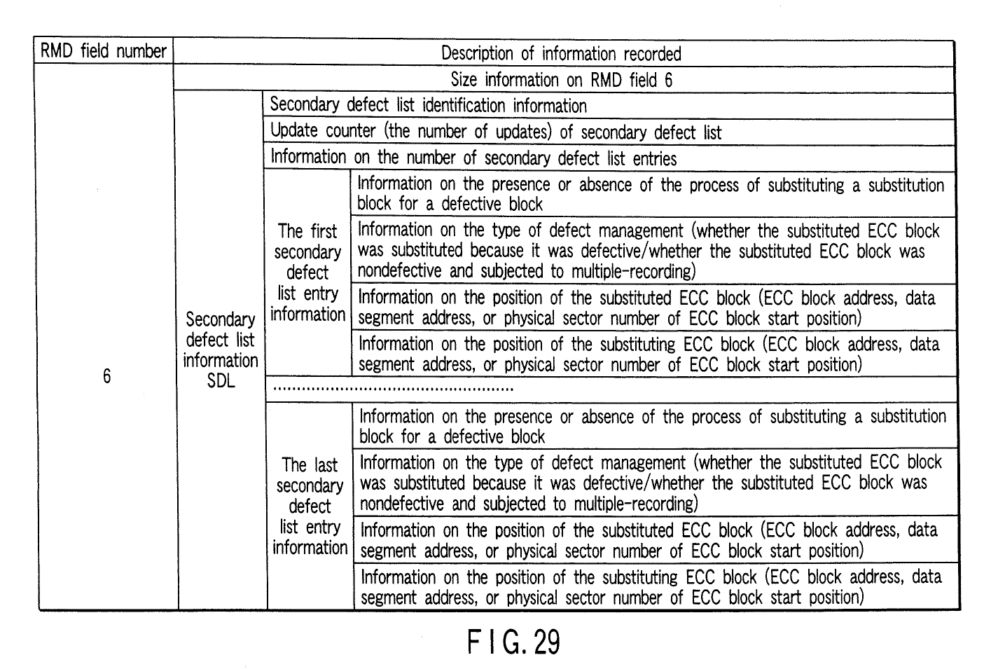

As shown in FIG. 29, information as to which mode is used for processing is recorded in “defect management process type information” in secondary defect list entry information in recording management data RMD. The contents of secondary defect list entry information are as follows:

In the substituting mode
Type information on a defect management process is set to “01” (as in a conventional DVD-RAM)
“Position information on replaced ECC block” means position information on the ECC block found as a defective place in the additionally recordable range 205 of user data. Information to be recorded in this place is recorded in a substitution area or the like, not in this place.
“Position information on substituting ECC block” means position information on the substituting place set in each of a substitution area SPA, a first extended substitution area ESPA1, and a second extended substitution area ESPA2 in the diagram (e) of FIG. 18B. Information to be recorded in a defective place found in the additionally recordable range 205 of user data is recorded in this place.

In the multiple mode
Type information on a defect management process is set to “10”
“Position information on replaced ECC block” is position information on a non-defective place in which information to be recorded is recorded. The information recorded in this place can be reproduced accurately.
“Position information on substituting ECC block” is position information on the place in which the contents identical with those of information recorded in the “position information on replaced ECC block” for the multiple mode set in each of a substitution area SPA, a first extended substitution area ESPA1, and a second extended substitution area ESPA2 are set.

When recoding is done in the “(1) substituting mode,” it is known that the information recorded on an information storage medium can be read exactly immediately after recording. Thereafter, there is a possibility that the recorded information cannot be reproduced because flaws in or dust on the information storage medium due to the user's mishandling or the like. In contrast, when recording is done in the “(2) multiple mode,” even if part of the information cannot be read because the information storage medium has flaws in it or dust attached to it due to the user's mishandling, the same information is backed up in another part, which improves the reliability of reproduction remarkably. If the information unable to be read at this time is subjected to a substituting process in the “(1) substituting mode” using the backed-up information, this further improves the reliability. Therefore, the process in the “(2) multiple mode” or a combination of the process in the “(1) substituting mode” and the process in the “(2) multiple mode” produces the effect of securing high reliability of reproduction after recording, taking measures against flaws and dust into account.

Furthermore, the method of writing information on the position of an ECC block includes not only the method of writing the physical sector number of the physical sector at the start position constituting an ECC block but also a method of writing an ECC block address, a physical segment block address, or a data segment address. As described later, in this embodiment, an area of data in which one ECC block of data fits is called a data segment. A physical segment block is defined as a physical unit on an information storage medium in a place in which data is recorded. The size of one physical segment block coincides with the size of an area in which one data segment is recorded.

The present embodiment also has the mechanism for recording defect position information acquired before a substitution process. This enables not only the information storage medium manufacturer to check the defective state of the additionally recordable range 204 immediately before shipment and record the found defective place in advance (before a substituting process) but also the defective state of the additionally recordable range of user data to be checked when the information recording and reproducing apparatus on the user side carries out an initializing process and the found defective place to be recorded in advance (before a substituting process). Information that indicates the defective position detected before the substituting process is “information on the presence or absence of the process of substituting a substitution block for the defective block” (SLR: Status of Linear Replacement) shown in FIG. 29.

When “information on the presence or absence of the process of substituting a substitution block for the defective block” SLR is “0,”

the defective ECC block specified in “position information on replaced ECC block” is subjected to a substituting process, and

reproducible information has been recorded in the place specified in “position information on substituting ECC block.”

When “information on the presence or absence of the process of substituting a substitution block for the defective block” SLR is “1,”

the defective ECC block specified in “position information on replaced ECC block” means a defective block detected before a substituting process, and

the column for “position information on substituting ECC block” is blank (or has no information recorded in it).

Knowing a defective place in advance produces the effect of carrying out the optimum substituting process at high speed in real time, when the information recording and reproducing apparatus additionally records user data onto the recordable information storage medium. When video information or the like is recorded on an information storage medium, it is necessary to guarantee the continuity of recording. As a result, a high-speed substituting process using the above information is important.

If there is a defect in the additionally recordable range 205 of user data, a substituting process is carried out in a specific place in the substitution area SPA or extended substitution area ESPA. Each time a substituting process is carried out, one piece of secondary defect list entry information is added and information on a set of position information on the defective ECC block and position information on the ECC block used for substitution is recorded in RMD field 6. If a new defective place is found in repeating an additional recording of new user data in the additionally recordable range 205 of user data, a substituting process is carried out, with the result that the number of pieces of secondary list entry information increases. As shown in the diagram (b) of FIG. 17, recording management data RMD in which the number of pieces of secondary list entry information has increased is additionally recorded in the unrecorded area 206 of the recording management zone RMZ, thereby enabling a defect management information area (RMD field 6) to be extended. Use of this method makes it possible to improve the reliability of defect management information itself for the following reasons:

Recording management data RMD can be recorded, avoiding a defective place in the recording management zone RMZ.

Even in the recording management zone RMZ shown in the diagram (b) of FIG. 17, a defective place can occur. The contents of recording management data RMD newly added in the recording management zone RMZ are verified immediately after the additional recording, which makes it possible to detect an unrecordable state caused by a defect. In that case, recording management data RMD is written again next to the defect place, enabling recording management data RMD to be recorded, assuring high reliability.

Even if previous recording management data RMD cannot be reproduced because of flaws in the surface of the information storage medium, a backup can be made to some extent.

For example, in the diagram (b) of FIG. 17, suppose the surface of the information storage medium is damaged due to the user's mistake after recording management data RMD#2 has been recorded and recording management data RMD#2 cannot be reproduced. In this case, recording management data RMD#1 is reproduced instead, which makes it possible to restore the previous defect management information (the information in RMD field 6) to some extent. Size information on RMD field 6 is recorded at the beginning of RMD field 6. The field size is made variable, thereby making it possible to extend the defect management information area (RMD field 6). Each RMD field has been set to a 2048-byte size (equivalent to one physical sector size). If the number of defects in the information storage medium is large and the number of substituting processes increases, the size of secondary defect list information increases and therefore does not fit in a 2048-byte size (equivalent to one physical sector size). Taking the situation into account, RMD field 6 can be set to a multiple of 2048-byte size (or enables recording to be done over a plurality of sectors). That is, when “the size of RMD field 6” has exceeded 2048 bytes, an area containing a plurality of physical sectors is allocated to RMD field 6.

In secondary defect list information SDL, not only the secondary list entry information but also “secondary defect list identifying information” indicating the starting position of secondary defect list information SDL and “secondary defect list update counter (update count information)” indicating count information about how many times secondary defect list information SDL was rewritten are recorded. From “information on the number of secondary defect list entries,” the data size of the entire secondary defect list information SDL is known.

In the additionally recordable range 205 of user data, user data has been recorded logically in a unit of R zone. Specifically, a part of the additionally recordable range 205 of user data reserved to record user data is called an R zone. According to recording conditions, the R zone is divided into two types of R zone. One type of Z zone in which additional user data can be further recorded is called an open R zone. The other type of R zone in which more user data cannot be added is called a complete R zone. The additionally recordable range 205 of user data cannot have three or more open R zones in it. That is, only up to two open R zones can be set in the additionally recordable range 205 of user data. A place where any one of the two types of R zone is not set in the additionally recordable range 205 of user data, or a place that is not reserved (for one of the two types of R zone) to record user data, is called an invisible (unspecified) R zone. When user data has been recorded in all of the additionally recordable range 205 of user data and cannot be added further, there is no invisible R zone there.

In RMD field 7, position information on up to the 254^{th} R zone is recorded. “Information on the total number of R zones” recorded at the beginning of RMD field 7 represents the sum total of the number of invisible R zones, the number of open R zones, and the number of complete R zones logically set in the additionally recordable range 205 of user data. Then, information on the number of first open R zones and information on the number of second open R zones are recorded. As described above, since the additionally recordable range 205 of user data cannot have three or more open R zones, “1” or “0” is recorded (when the first or second open R zone does not exist). Next, information on the staring position and end position of the first complete R zone are written in physical sector numbers. Then, information on the staring position and end position of the second to 254^{th} complete R zones are written in physical sector numbers one after another.

In RMD field 8 and later, information on the staring position and end position of the 255^{th} and later complete R zones are written in physical sector numbers one after another. According to the number of complete R zones, up to RMD field 15 (or up to 2047 complete R zones) can be written into.

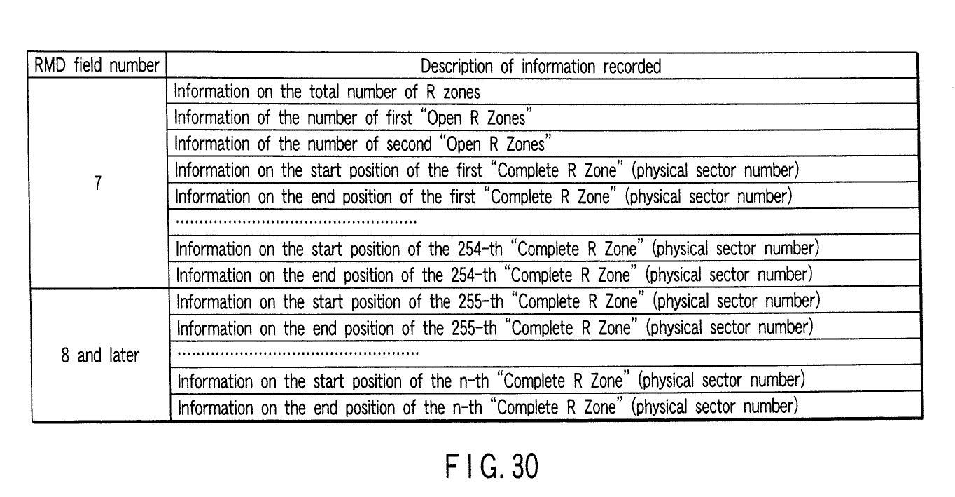

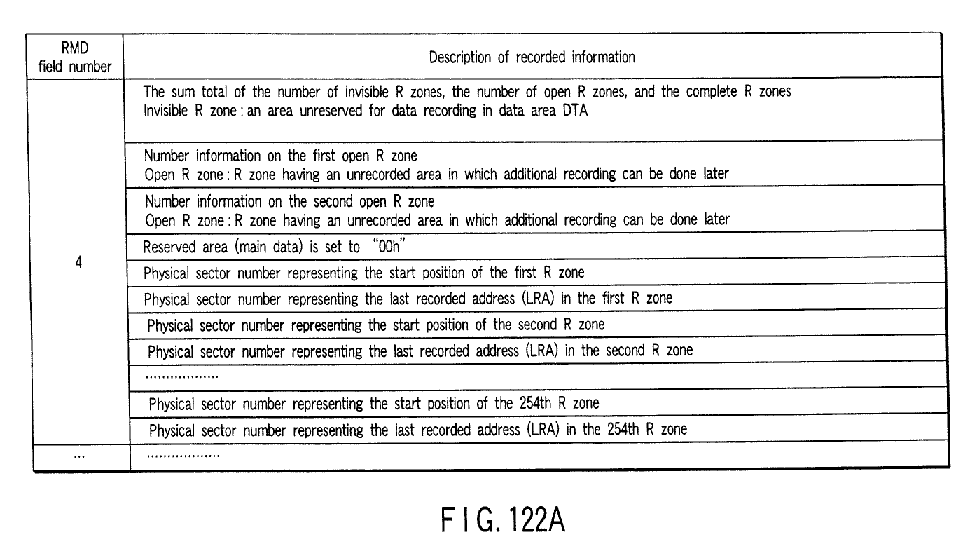

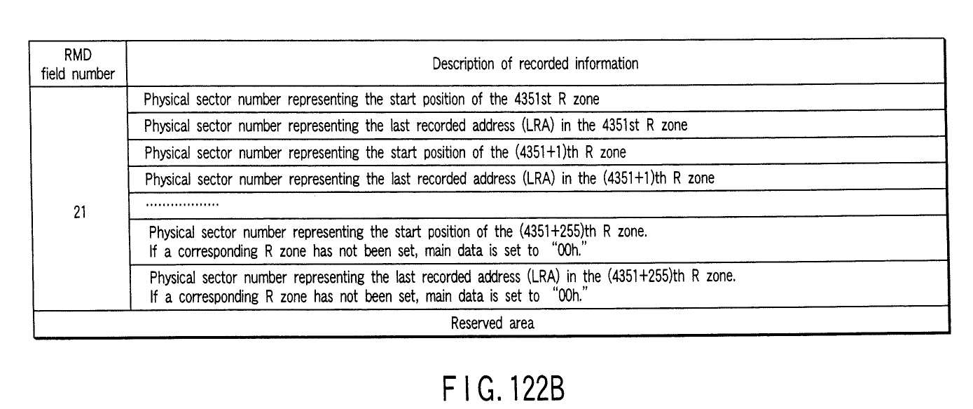

FIGS. 121, 122A and 122B show another embodiment of the data structure of recording management data RMD shown in FIGS. 29 and 30.

In the embodiment of FIGS. 121, 122A and 122B, up to 128 bordered areas BRDA can be set on a single recordable information storage medium. Therefore, information on the start positions of the first to 128^{th} border-out areas BRDOs is recorded in RMD field 3. If bordered areas BRDAs are set only in a part of RMD field 3 (or in 128 border-out areas), “00h” is set as information on the starting positions of the 129^{th} and later border-out areas. This makes it possible to know how many bordered areas BRDAs have been set on the recordable information storage medium just by checking how much information on the starting positions of border-out areas BRDOs has been recorded in RMD field 3.

In the embodiment of FIGS. 121, 122A and 122B, up to 128 extended recording management zones RMZs can be set on a single recordable information storage medium. As described above, there are two types of recording management zone RMZ as follows:

An extended recording management zone RMZ set in border-in area BRDI

An extended recording management zone RMZ set using R zone

In the embodiment of FIGS. 121, 122A and 122B, a set of information on the starting position of an extended recording management zone RMZ (expressed in physical sector numbers) and size information (or information on the number of physical sectors occupied) is recorded in RMD field 3 without distinguishing between the two types, thereby conducting management. While in the embodiment of FIGS. 121, 122A and 122B, a set of information on the starting position of an extended recording management zone RMZ (expressed in physical sector numbers) and size information (or information on the number of physical sectors occupied) is recorded, this invention is not limited to this. For instance, a set of information on the starting position of an extended recording management zone RMZ (expressed in physical sector numbers) and information on the end position (expressed in physical sector numbers) may be recorded. Wile in the embodiment of FIGS. 121, 122A and 122B, extended recording management zones RMZs are numbered in the order in which they are set on the recordable information storage medium, this invention is not limited to this. For instance, extended recording management zones RMZ may be numbered in ascending order of physical sector numbers as the starting positions.

Then, the latest recording management data RMD is recorded and the recording management zone (which is made open and enables additional recording of RMD) now in use is specified using the extended recording management zone RMZ number (point (L13) in FIG. 125Q). Therefore, from these pieces of information, the information recording and reproducing apparatus or information reproducing apparatus knows information on the starting position of the recording management zone (made open) now in use and, on the basis of the information, identifies which is the latest recording management data RMD (point (L13α) in FIG. 125Q). Even if extended recording management zones RMZ are distributed on the recordable information storage medium, use of the data structure of FIGS. 121, 122A and 122B enables the information recording and reproducing apparatus or information reproducing apparatus to identify easily which is the latest recording management data RMD. From these pieces of information, information on the starting position of the recording management zone RMZ (made open) now in use is known and accessing the place makes it possible to know how much the recording management data RMD has been recorded (point (L13β) in FIG. 125Q), which enables the information recording and reproducing apparatus or information reproducing apparatus to know easily where to record the updated latest recording management data. Furthermore, when the above point (2) in which an extended recording management zone RMZ set using R zone is used, the whole of one R zone corresponds directly to one extended recording management zone RMZ. Therefore, the physical sector number representing the starting position of the corresponding extended recording management zone RMZ written in RMD field 3 coincides with the physical sector number representing the starting position of the corresponding R zone written in RMD fields 4 to 21.

In the embodiment of FIGS. 121, 122A and 122B, up to 4606 (4351+255) R zones can be set in a single recordable information storage medium. Position information on these set R zones is recorded into RMD fields 4 to 21. Information on the starting position of each R zone is represented in physical sector numbers and, at the same time, it is recorded in such a manner that it is paired with the physical sector number LRA (Last Recorded Address) representing the last recoding position in each R zone. While the order in which R zones are written in recording management data RMD is the order in which R zones are set in the embodiment of FIGS. 121, 122A and 122B, this invention is not limited to this. For instance, they may be set in ascending order of physical sector numbers representing information on the starting position. When R zones are not set in corresponding numbers, “00h” is set in this field. The total number of R zones set in a single recordable information storage medium is written in RMD field 4. The total number is represented by the sum total of the number of incomplete R zones (areas unreserved for data recording in the data area DTA), the number of open R zones (R zones with an unrecorded area enabling additional recording), and the number of complete R zones (R zones without an unrecorded area enabling additional recording). The total number is equal to the ordinal number of the incomplete R zones.

In the embodiment of FIGS. 121, 122A and 122B, up to two open R zones enabling additional recording can be set (point (L5) in FIG. 125N). Since up to two open R zones can be set, this makes it possible to record video information and audio information requiring continuous recording and continuous reproduction into one open R zone and to record management information on the video information and audio information and general information used in a personal computer or the like or file system management information in the other open R zone. That is, user data can be recorded into separate open R zones according to the type of user data to be recorded. This improves convenience in recording and reproducing AV information (video information and audio information). In the embodiment of FIGS. 121, 122A and 122B, which R zone is an open R zone is specified by the location number of an R zone arranged in RMD fields 4 to 21. That is, which R zone is an open R zone is specified by the number of the R zone corresponding to each of the first and second open R zones (point (L14) in FIG. 125Q). Use of such a data structure makes it easy to search for an open R zone. If there is no open R zone, “00h” is recorded in this field.

As explained in FIG. 98, the end position of the R zone coincides with the last recorded address LRA in a complete R zone, whereas the end position of the R zone differs from the last recorded address LRA in an open R zone. In the middle of additionally recording user information into an open R zone (that is, before the process of additionally recording the recording management data RMD to be updated is completed), the last recorded address LRA does not coincide with the next writable address NWA enabling further additional recording as in R zone #3 of FIG. 98. However, after the process of additionally recording user information has been completed and the process of additionally recording the latest recording management data RMD to be updated has been completed, the last recorded address LRA coincides with the next writable address NWA enabling further additional recording as in R zones #4 and #5 of FIG. 98. Therefore, when new user information is additionally recorded after the process of additionally recording the latest recording management data RMD to be updated has been completed, the control section 143 of the information recording and reproducing apparatus of FIG. 1 executes processing according to the following procedure:

Check the R zone number corresponding to an open R zone written in RMD field 4

Check the physical sector number LRA representing the last recorded address in an open R zone written in RMD fields 4 to 21 and determine the next writable address NWA enabling additional recording

Start additional recording at the determined next writable address NWA enabling additional recording

As described above, the starting position of new additional recording is determined using the open R zone information in RMD field 4 (point (L14α) in FIG. 125Q), thereby enabling the starting position of new additional recording to be extracted easily at high speed.

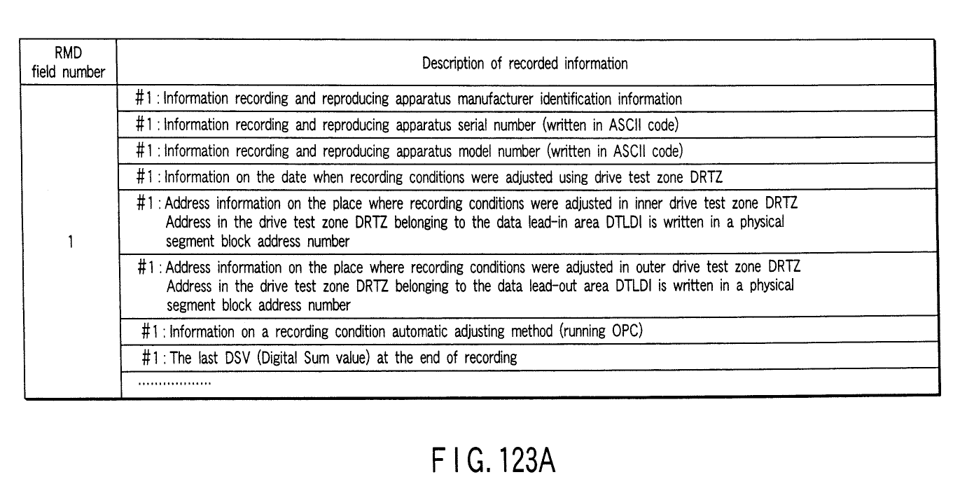

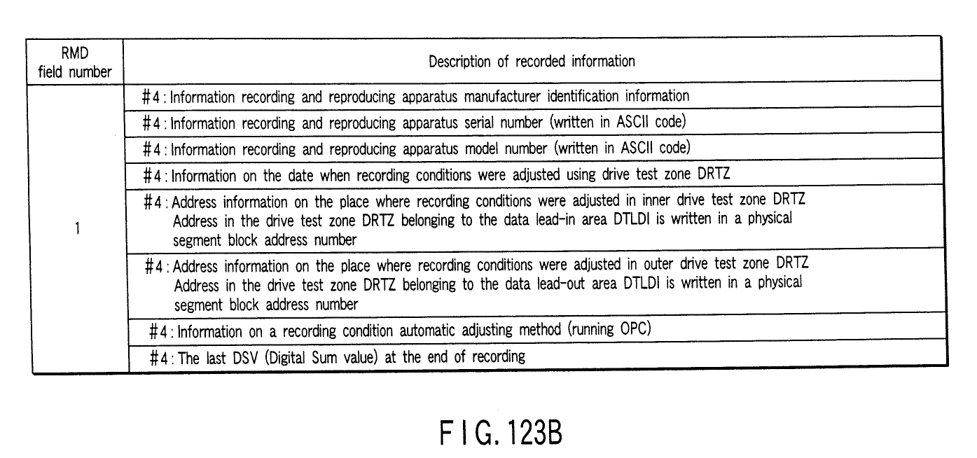

FIGS. 123A and 123B shows a data structure of RMD field 1 in the embodiment of FIGS. 121, 122A and 122B. As compared with the embodiment of FIGS. 25 to 30, address information on the place where recording conditions are adjusted in an inner drive test zone DRTZ (belonging to the data lead-in area DTLDI) and address information on the place where recording conditions are adjusted in an outer drive test zone DRTZ (belonging to the data lead-out area DTLDO) are added. These pieces of information are written in physical segment block address numbers. Furthermore, in an embodiment of FIGS. 123A and 123B, information on a recording condition automatic adjusting method (running OPC) and the last DSV (Digital Sum Value) at the end of the recording are added.

FIG. 31 schematically shows the conversion procedure for configuring an ECC block from a data frame structure in which user data is recorded in a unit of 2048 bytes, adding a sync code, and then forming a physical sector structure to be recorded onto an information storage medium. This conversion procedure is used in each of a read-only information storage medium, a recordable information storage medium, and a rewritable information storage medium. According to the respective conversion stages, a block of data is called data frame, scrambled frame, recording frame, or recorded data field. A data frame, which is a place in which user data is recorded, is made up of 2048 bytes of main data, a 4-byte data ID, a 2-byte ID error detection code (IED), 6-byte reserved bytes RSV, and a 4-byte error detection code (EDC). First, IED (ID error detection code) is added to data ID explained later. The 6-byte reserved bytes and data frame are places in which user data is to be recorded. After 2048 bytes of main data are added and an error detection code (EDC) is added, the main data is scrambled. Then, Cross Reed-Solomon Error Correction Code is applied to the scrambled 32 data frames (scrambled frames), thereby carrying out an ECC encoding process, which configures a recording frame. The recording frame includes outer parity code (Parity of Outer-code) PO and inner parity code (Parity of Inner-code) PI. Each of the parity codes PO and PI is an error correction code created for each ECC block composed of 32 scrambled frames. As described earlier, a recoding frame is subjected to ETM (Eight to Twelve Modulation) in which 8 bits of data are converted into 12 channel bits. Then, a sync code SYNC is added at the head in units of 91 bytes, thereby creating 32 physical sectors. This embodiment is characterized in that 32 sectors constitute one error correction unit (ECC block) as written in the frame at the bottom right of FIG. 31 (point (H2) in FIG. 125E). As described later, the numbers from “0” to “31” in each frame in FIG. 35 or 36 represent the numbers of the individual physical sectors. A total of 32 physical sectors with the numbers from “0” to “31” constitute one large ECC block.

Next-generation DVDs are required to reproduce information accurately by an error correction process, even if a flaw as long as that in the present-generation DVDs have been made in the surface of the information storage medium. In this embodiment, the recording density is increased aiming at a larger capacity.

As a result, in the case of a conventional ECC block=16 sectors, the length of a physical flaw correctable by error correction becomes shorter than that of the conventional DVD. As in the present embodiment, configuring one ECC block using 32 sectors produces the effect of not only lengthening the allowable length of a flaw in the information storage medium which can be corrected by error correction but also securing the interchangeability of the ECC block structure of the existing DVD and the continuity of the format.

FIG. 32 shows the structure of a data frame. A data frame contains 2064 bytes made up of 172 bytes×2×6 rows, which include 2048 bytes of main data. IED, which stands for ID Error Detection Code, means an error detection additional code for data ID information in reproduction. RSV, which stands for Reserve, means a reserved area in which information can be set in the future. EDC, which stands for Error Detection code, means error detection additional code for all of the data frames.

FIG. 118 shows a data structure of data ID shown in FIG. 32. Data ID is composed of data frame information 921 and information on data frame number 922. The data frame number represents the physical sector number 922 of the corresponding data frame.

Data frame information 921 is made up of the following information:
Format type 931—0b: represents CLV

1b: represents a zone configuration
Tracking method 932—0b: uses a DPD (Differential Phase Detect) method suitable for a pit portion

1b: uses a Push-Pull method or a DPP (Differential Push-Pull) method suitable for a pre-groove portion
Reflectivity of the recording film 933—0b: 40% or more

1b: 40% or less
Recording type information 934—0b General data

1b: Real-time data (Audio Video data)
Area type information 935—00b: Data area DTA

01b: System lead-in area SYLDI or data lead-in area DTLDI

10b: Data lead-out area DTLDO or system lead-out area SYLDO
Data type information 936—0b: Read-only data

1b: Rewritable data
Layer number 937—0b: Layer 0

1b: Layer 1

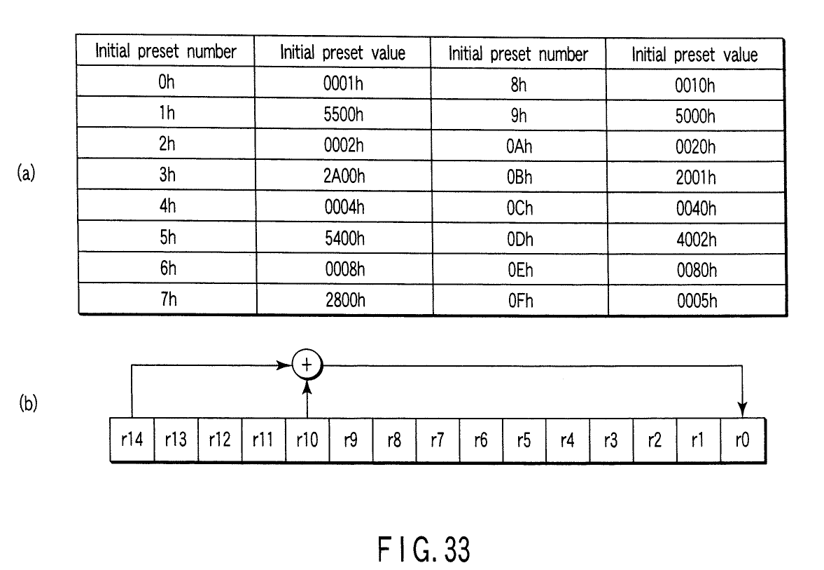

The diagram (a) of FIG. 33 shows an example of initial values given to the feedback shift register when a scrambled frame is formed. The diagram (b) of FIG. 33 shows a circuit configuration of the feedback shift register for forming scramble bytes. r7 (MSB) to r0 (LSB), which are shifted in units of 8 bits, are used as a scramble byte. As shown in the diagram (a) of FIG. 33, 16 preset values are prepared in this embodiment. The initial preset number in the diagram (a) of FIG. 33 is equal to 4 bits (b7 (MSB) to b4 (LSB)) in data ID. When the scrambling of a data frame is started, the initial values of r14 to r0 have to be set to the initial preset values in the table of the diagram (a) of FIG. 33. The same initial preset values are used for 16 consecutive data frames. Then, the initial preset value is changed and the changed same preset value is used for 16 consecutive data frames.

The lower 8 bits of the initial values of r7 to r0 are extracted as scramble byte S0. Thereafter, an 8-bit shift is performed. Then, a scramble byte is extracted. Such operations are repeated 2047 times.

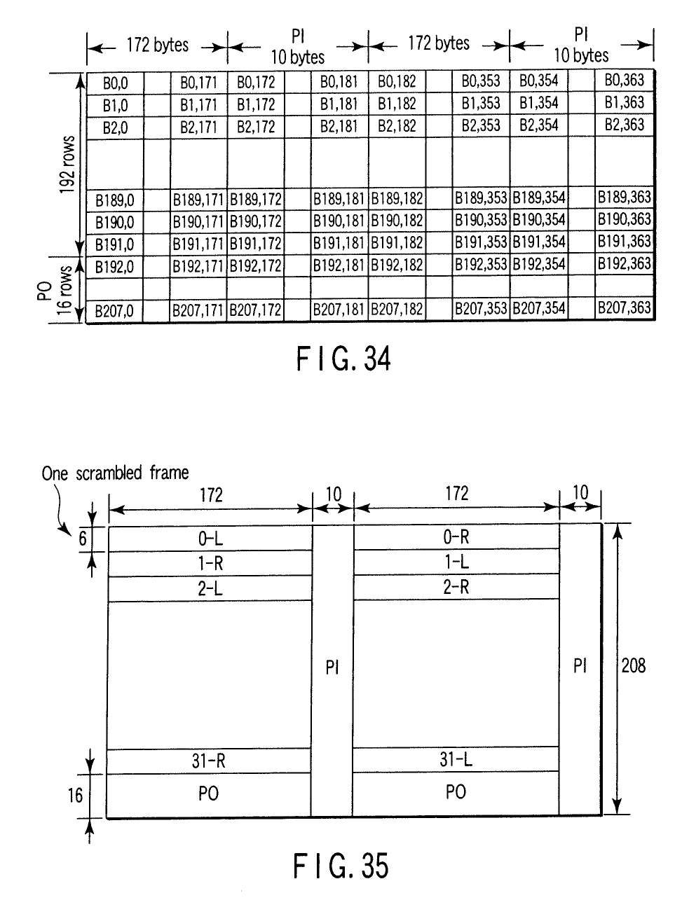

FIG. 34 shows an ECC block in the present embodiment. An ECC block is composed of consecutive 32 scrambled frames. There are provided 192 rows+16 rows in the vertical direction and (172+10)×2 columns in the horizontal direction. Each of B_{0,0}, B_{1,0}, . . . is one byte. PO and PI, which are error correction codes, are outer parity and inner parity, respectively. In this embodiment, an ECC block structure using a product sign is configured. Specifically, data to be recorded on an information storage medium are arranged two-dimensionally. As error correction additional bits, PI (Parity in) is added in the direction of “row” and PO (Parity out) is added in the direction of “column.” Configuring an ECC block structure using a product sign this way makes it possible to assure a high error correction capability using an erasure correction process and a vertical and horizontal repeated correction process.

The ECC block structure of FIG. 34 is characterized in that it differs from the ECC block structure of a conventional DVD in that PI is set in two places in the same “row.” That is, PI of a 10-byte size written in the middle of FIG. 34 is added to 172 bytes provided at left. Specifically, for example, a 10-byte PI from B_{0,172} to B_{0, 181} is added to 172 bytes of data from B_{0,0} to B_{0,171}. A 10-byte PI from B_{1,172} to B_{1, 181} is added to 172 bytes of data from B_{1,0} to B_{1,171}.

PI of a 10-byte size written at right of FIG. 34 is added to 172 bytes provided in the middle at left. Specifically, for example, a 10-byte PI from B_{0,354} to B_{0, 363} is added to 172 bytes of data from B_{0,182} to B_{0,353}.

FIG. 35 is a diagram to help explain the arrangement of a scrambled frame. A unit of (6 rows×172 bytes) is used as a scrambled frame. That is, one ECC block is made up of 32 consecutive scrambled frames. In addition, this system treats (a block of 182 bytes×207 bytes) as a pair. L is given to the number of each scrambled frame in the ECC block at left and R is given to the number of each scrambled frame in the ECC block at right, with the result that the scrambled frames are arranged as shown in FIG. 35. That is, in the left block, left and right scrambled frames are arranged alternately. In the right block, scrambled frames are provided alternately.

Specifically, an ECC block is composed of 32 consecutive scrambled frames. Each row in the left half of an odd-numbered sector is replaced with a row in the right half. 172×2 bytes×192 rows, which are equal to 172 bytes×12 rows×32 scrambled frames, make a data are. A 16-byte PO is added to each set of 172×2 rows to form an outer code for RS (208, 192, 17). A 10-byte PI (RS (182, 172, 11)) is added to each set of 208×2 rows in the right and left blocks. PI is also added to the row of PO. The number in a frame indicates a scrambled frame number. The suffixes R, L mean the right half and left half of a scrambled frame, respectively.

The present embodiment is characterized in that the same data frame is distributed over a plurality of small ECC blocks (point [H] in FIG. 125F). Specifically, in the embodiment, two small ECC blocks constitute a large ECC block. The same data frame is distributed over the two small ECC blocks alternately (point (H1) in FIG. 125F). As explained in FIG. 34, PI of a 10-byte size written in the middle is added to 172 bytes provided on its right side and PI of a 10-byte size written at the right end is added to 172 bytes provided on its left side and in the middle. That is, 172 bytes from the left end of FIG. 34 and PI of consecutive 10 bytes constitute a left small ECC block and 172 bytes in the middle and PI of 10 bytes at the right end constitute a right small ECC block. According to this, the symbols in each frame of FIG. 35 are set. For example, “2-R” in FIG. 35 indicates which of data frame number and right and left small blocks it belongs to (e.g., it belongs to the right small ECC block in the second data frame). In addition, the data in the same physical sector is also distributed over the right and left small ECC blocks alternately in each physical sector finally configured. In FIG. 35, the left-half column is included in the left small ECC block (the left small ECC block A shown in FIG. 84) and the right-half column is included in the right small ECC block (the right small ECC block B shown in FIG. 84).

As described above, distributing the same data frame over a plurality of small ECC blocks (point [H] in FIG. 125F) improves the error correcting capability of the data in the physical sector (FIG. 35), which increases the reliability of the recorded data. For example, suppose the optical head has come off the track and overwritten the recorded data, with the result that one physical sector of data has been destroyed. In this embodiment, since one sector of destructed data is subjected to error correction using two small ECC blocks, the burden of correcting errors in one ECC block is alleviate, which assures higher-performance error correction. Moreover, in the embodiment, since data ID is provided at the start position of each sector even after an ECC block is formed, the data position in access is checked at high speed.

FIG. 36 is a diagram to help explain a PO interleaving method. As shown in FIG. 36, 16 parity rows are distributed one by one. That is, 16 parity rows are arranged in such a manner that one parity row is provided for every two recording frames. The inserting position differs in the right and left blocks. Therefore, a recording frame composed of 12 rows is changed to that composed of 12 rows+1 row. After the row interleaving has been done, 13 rows×182 bytes are referred to as a recording frame. As a result, an ECC block subjected to row interleaving is composed of 32 recording frames. As shown in FIG. 35, in one recording frame, there are 6 rows in each of the right and left blocks. PO is so arranged that it lies in a position in the left block (182×208 bytes) and in a different position in the right block (182×208 bytes). FIG. 35 shows one complete ECC block. However, when data is actually reproduced, such ECC blocks arrive at the error correcting section consecutively. To increase the correcting capability of the error correction process, an interleaving method as shown in FIG. 36 has been used.

Using FIG. 84, the relationship from the structure of one data frame of FIG. 32 to the PO interleaving method of FIG. 36 will be explained in detail. In FIG. 84, the upper part of the ECC block structure subjected to PO interleaving shown in FIG. 36 is enlarged and the locations of data ID, IED, RSV, EDC shown in FIG. 32 are pointed out specifically in the enlarged diagram, which enables the connection between conversions in FIGS. 32 to 36 to be seen at a glance. “0-L”, “0-R”, “1-R”, “1-L” of FIG. 84 correspond to “0-L”, “0-R”, “1-R”, “1-L” of FIG. 35, respectively. “0-L” or “1-L” means the data obtained by scrambling only the main data in the left half of FIG. 32, that is, a set of 172 bytes and 6 rows located in the left of the center line. Similarly, “0-R” or “1-R” means the data obtained by scrambling only the main data in the right half of FIG. 32, that is, a set of 172 bytes and 6 rows located in the right of the center line. Therefore, as seen from FIG. 32, data ID, IED, and RSV are arranged in that order from the first to 12^{th} bytes in the first row (0^{th} row) in “0-L” or “1-L.”

In FIG. 84, the left side of the center line constitutes a small ECC block A and the right side of the center line constitutes a small ECC block B. Therefore, as seen from FIG. 84, data ID#1, data ID#2, IED#0, IED#2, RSV#0, RSV#2 included in “0-L” or “2-L” are included in the left small ECC block A. While in FIG. 35, “0-L” and “2-L” are arranged on the left side and “0-R” and “2-R” are arranged on the right side, “1-R” and “1-L” are reversed in position, with the result that “1-L” is positioned on the right side and “1-R” is positioned on the left side. Since data ID#1, IED#1, RSV#1 are arranged from the first to 12^{th} byte in the first row in “1-L,” the result of reversal of the right and left positions causes ID#1, IED#1, RSV#1 included in “1-L” to be located in the right small ECC block B as seen from FIG. 84.

In this embodiment, a combination of “0-L” and “0-R” is called “0^{th} recording frame” and a combination of “1-L” and “1-R” is called “1^{st} recording frame” in FIG. 84. The boundary between the recording frames is shown by a bold line of FIG. 84. As seen from FIG. 84, data ID is provided at the head of each recording frame and PO and PI-L is located at the end of each recording frame. As shown in FIG. 84, this embodiment is characterized in that an odd-numbered recording frame differs from an even-numbered recording frame in a small ECC block which includes data ID and that a succession of recording frames causes data ID, IED, and RSV to be arranged in the left and right small ECC blocs A and B alternately (point (H5) in FIG. 125F). The error correcting capability in a single small ECC block has its limits and random errors exceeding a specific number and burst errors exceeded a specific length cannot to be subjected to error correction. Arranging data ID, IEC, and RSV in the left and right small ECC blocks alternately as described above enables the reliability of reproduction of data ID to be improved. Specifically, even if many defects have occurred in the information storage medium and either small ECC block cannot be subjected to error correction and therefore the data ID belonging to the ECC block cannot be decrypted, since data ID, IED, and RSV are arranged in the left and right small ECC blocks A and B alternately, the other small ECC block can be subjected to error correction, enabling the remaining data ID to be decrypted. Since there is a continuity of address information in the data ID, the data ID that could not be decrypted can be interleaved using information on the decryptable data ID. As a result, the embodiment of FIG. 84 can increase the reliability of access. The number in parentheses at left of FIG. 84 indicates the row number in an ECC block after PO interleaving. When data is recorded in an information storage medium, recording is done from left to right in the order of row numbers. In FIG. 84, since data ID included in the individual recording frames are arranged at regular intervals (point (H6) in FIG. 125F), the capability of searching for the position of data ID is improved.

FIG. 37 shows a physical sector structure. The diagram (a) of FIG. 37 shows the structure of an even-numbered physical sector and the diagram (b) of FIG. 37 shows the structure of an odd-numbered physical sector. In FIG. 37, information on outer parity PO of FIG. 36 is inserted into the sync data area in the last two sync frames (that is, area formed of a portion of the last sync code SY3 and sync data just behind it and a portion of adjacent sync code SY1 and sync data just behind it) in each of an even recorded data field and an odd recorded data field.

A part of the left PO shown in FIG. 35 is inserted into the last two sync frames in an even-numbered recording data area and a part of the right PO shown in FIG. 35 is inserted into the last two sync frames in an odd-numbered recording data area. As shown in FIG. 35, one ECC block is composed of right and left small ECC blocks. Data on a different PO group (either PO belonging to the left small ECC block or PO belonging to the right small ECC block) is inserted in each sector alternately. Each of an even-numbered physical sector structure of the diagram (a) of FIG. 37 and an even-numbered data structure of the diagram (b) of FIG. 37 is divided in two at the center line. “24+1092+24+1092 channel bits” on the left side are included in the left small ECC block shown in FIG. 34 or 35 and “24+1092+24+1092 channel bits” on the right side are included in the right small ECC block shown in FIG. 34 or 35.

When a physical sector structure shown in FIG. 37 is recorded onto the information storage medium, it is recorded serially column by column. Therefore, for example, when the channel bit data in an even-numbered physical sector structure shown in the diagram (a) of FIG. 37 is recorded onto the information storage medium, 2232 channel bits of data to be recorded first are included in the left small ECC block and 2232 channel bits of data to be recorded next are included in the right small ECC block. Moreover, 2232 channel bits of data to be recorded further are included in the left small ECC block. In contrast, when the channel bit data in an odd-numbered data structure shown in the diagram (b) of FIG. 37 is recorded onto the information storage medium, 2232 channel bits of data to be recorded first are included in the right small ECC block and 2232 channel bits of data to be recorded next are included in the left small ECC block. Moreover, 2232 channel bits of data to be recorded further are included in the right small ECC block.

As described above, this embodiment is characterized in that the same physical sector is caused to belong to two small ECC blocks alternately in units of 2232 channel bits (point (H1) in FIG. 125F). To put it another way, the data in the right small ECC block and the data in the left small ECC block are distributed alternately in units of 2232 channel bits to form physical sectors, thereby recording data onto the information storage medium. This produces the effect of achieving a structure resistant to burst errors. For example, consider a burst error state where a long flaw has been made in the circumferential direction of the information storage medium and more than 172 bytes of data cannot be read. In this case, since the burst error exceeding 172 bytes is distributed over two small ECC blocks, the burden of error correction in one ECC block is alleviated, assuring higher-performance error correction.

As shown in FIG. 37, the present embodiment is characterized in that the data structure of the physical sector differs, depending on whether the physical sector number of a physical sector constituting an ECC block is even or odd (point (H3) in FIG. 125F). Specifically,

A small ECC block (right or left) to which the first 2232 channel bits of data in the physical sector belong differs.

The different PO group of data is inserted alternately on a sector basis.

As a result, even after an ECC block has been configured, the structure that assures the arrangement of data ID at the start positions of all of the physical sectors is assured, which makes it possible to check the data positions at high speed at the time of accessing. Furthermore, inserting PO belonging to different small ECC blocks into the same sector in a mixed manner simplifies the PO inserting method as shown in FIG. 36, which not only makes it easier to extract information sector by sector after the error correcting process in the information reproducing apparatus but also simplifies the process of constructing ECC block data in the information recording and reproducing apparatus.

In a method of realizing concretely what has been described above, a structure where PO interleaving and inserting positions at right differ from those at left is used (point (H4) in FIG. 125F). A part shown by a narrow double line or a part shown by a narrow double line and a slat line in FIG. 36 indicates a PO interleaving and inserting position. In an even-numbered physical sector, PO is inserted in the left-side end. In an odd-numbered physical sector, PO is inserted in the right-side end. Use of this structure enables data ID to be arranged at the start position of the physical sector even after the ECC block is configured, which makes it possible to check the data positions at high speed at the time of accessing.

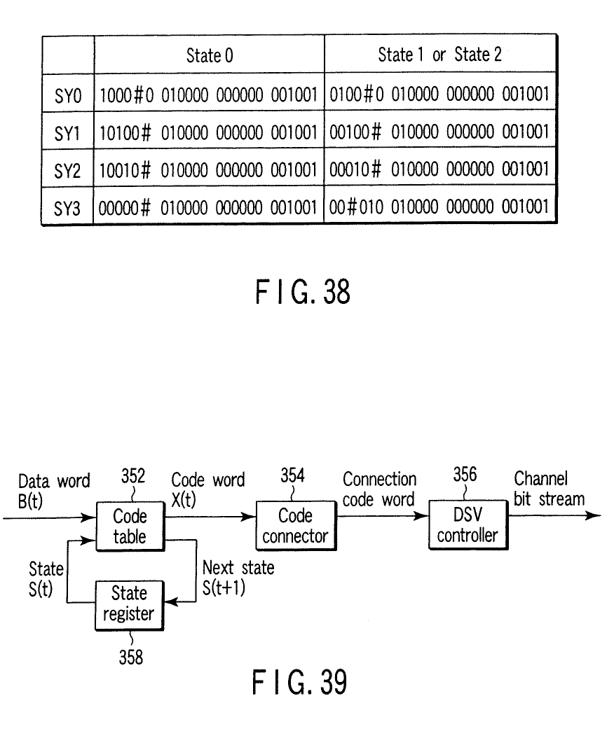

FIG. 38 shows an embodiment of the contents of a concrete pattern ranging from sync codes “SY0” to “SY3” shown in FIG. 37. There are three states from State 0 to State 2 according to the modulation rule (which will be explained in detail later) of the present embodiment. Four sync codes from SY0 to SY3 are set. According to each state, they are selected form the right and left groups of FIG. 38. In the present DVD standard, RLL (2, 10)(Run Length Limited: d=2, k=10: the minimum value of a range of consecutive “0s” is 2 and its maximum value is 10) of 8/16 modulation (converting 8 bits into 16 channel bits) is used as a modulation method. Four states from State 1 to State 4 and eight sync codes from SY0 to SY7 are set in modulation. As compared with this, the types of sync code decreases in this embodiment. The information recording and reproducing apparatus or information reproducing apparatus identifies the type of sync code by a pattern matching method in reproducing the information from the information storage medium. As in the embodiment, decreasing the kinds of sync codes remarkably helps decrease the target patterns necessary for matching, which not only simplifies the necessary process for pattern matching and improves the processing efficiency but also improves the recognition speed.

In FIG. 38, a bit (channel bit) shown by “#” represents a DSV (Digital Sum Value) control bit. As described later, the DSV control bit is so determined that a DSV controller suppressed the DC component (or the value of DSV approaches “0”). This embodiment is characterized in that a sync code includes a polarity reversal channel bit “#” (point [I] in FIG. 125G). The value of “#” can be selectively set to “1” or “0” so as that the DVS value may approach “0” in a macroscopic view, including the frame data areas (the 1092-channel-bit areas of FIG. 37) sandwiching the sync code between them, which produces the effect of enabling DSV control in a macroscopic view.

As shown in FIG. 38, a sync code of the embodiment is composed of the following parts:

Sync position detecting code part

All sync codes have a common pattern and form a fixed code area. Sensing this code enables the location of the sync code to be detected. Specifically, the code corresponds to the last 18 channel bits “010000 000000 001001” in each sync code of FIG. 38.

Modulation conversion table selecting code part

This code is a part of a variable code area and changes according to State number in modulation. The code corresponds to the first one channel bit of FIG. 38. That is, if either State 1 or State 2 is selected, the first one channel bit is “0” in any one of SY0 to SY3. If State 0 is selected, the first one channel bit in the sync code is “1.” By way of exception, the first one channel bit in SY3 in State 0 is “0.”

Sync frame position identifying code part

This is a code used to identify SY0 to SY3 in a sync code and constitutes a part of a variable code area. The code corresponds to the first to sixth channel bits in each sync code of FIG. 38. As described later, from a continuous pattern of 3 consecutive sync codes detected, a relative position in the same sector can be detected.

Polarity reversing code part for suppressing DC component

This code corresponds to the channel bit at “#” position in FIG. 38. As described above, the bit here is reversed (“0”) or is not reversed (“1”), thereby causing the DSV value of the channel bit train including the preceding and following frame data to approach “0.”

This embodiment uses 8/12 modulation (ETM: Eight to Twelve Modulation) and RLL (1, 10) in the modulation method. That is, setting is done so that 8 bits may be converted into 12 channel bits and the minimum value (d value) of a range of consecutive “0s” after conversion may be 1 and its maximum value (k value) may be 10. In the embodiment, use of d=1 makes the density higher than a conventional equivalent. However, at the densest mark, it is difficult to obtain a sufficiently large amplitude of the reproduction signal.

To overcome this problem, the information recording and reproducing apparatus of the embodiment has a PR equalizing circuit 130 and a Viterbi decoder 156 as shown in FIG. 1 and uses PRML (Partial Response Maximum Likelihood) techniques, thereby enabling the signal to be reproduced very stably. With the setting of k=10, there is no possibility that 11 or more “0s” will not be arranged consecutively in general channel bit data. Using this modulation rule, the sync position detecting code part is caused to have a pattern that will never appear in modulated general channel bit data. Specifically, as shown in FIG. 38, the sync position detecting code part have 12 (=k+2) consecutive “0s” in it. The information recording and reproducing apparatus or information reproducing apparatus finds this part and detects the position of the sync position detecting code part. Too many consecutive “0s” makes bit shift errors liable to take place. To alleviate its adverse effect, a pattern with a small number of consecutive “0s” is provided just behind the too long string of “0s” in the sync position detecting code. In the embodiment, since d=1, “101” can be set as a corresponding pattern. As described above, it is difficult to obtain a sufficiently large amplitude of the reproduction signal at “101” (at the densest pattern). Therefore, “1001” is placed instead, thereby making a pattern for the sync position detecting code part as shown in FIG. 38.

The present embodiment is characterized in that the last 18 channel bits in the sync code are used independently as (1) the sync position detecting code part and the first 6 channel bits are shared by (2) the modulation conversion table selecting code part, (3) the sync frame position identifying code part, and (4) the DC suppression polarity reversing code part. Making (1) the sync position detecting code part independent of the rest in the sync code facilitates individual detection, which increases the accuracy of sync position detection. Causing the code parts in (2) to (4) to share the first 6 channel bits makes the data size (channel bit size) of the entire sync code smaller and increases the sync data occupation ratio, which produces the effect of improving the practical data efficiency.

This embodiment is characterized in that, of the four sync codes shown in FIG. 38, only SY0 is placed in the first sync frame position in a sector as shown in FIG. 37. This produces the effect of enabling the start position of a sector to be determined immediately by just detecting SY0 and very simplifying the process of extracting the start position of the sector.

The embodiment is further characterized in that combination patterns of three consecutive sync codes are all different in the same sector.

A common modulation method explained below is used for each of a read-only, a recordable, and a rewritable information storage medium.

An 8-bit data word in a data field is converted into channel bits on a disk by the 8/12 modulation (ETM: Eight to Twelve Modulation) method. The channel bit train converted by the ETM method satisfies a run-length restriction of RLL (1, 10) where channel bit 1b is at least one channel bit or up to 10 channel bits away.

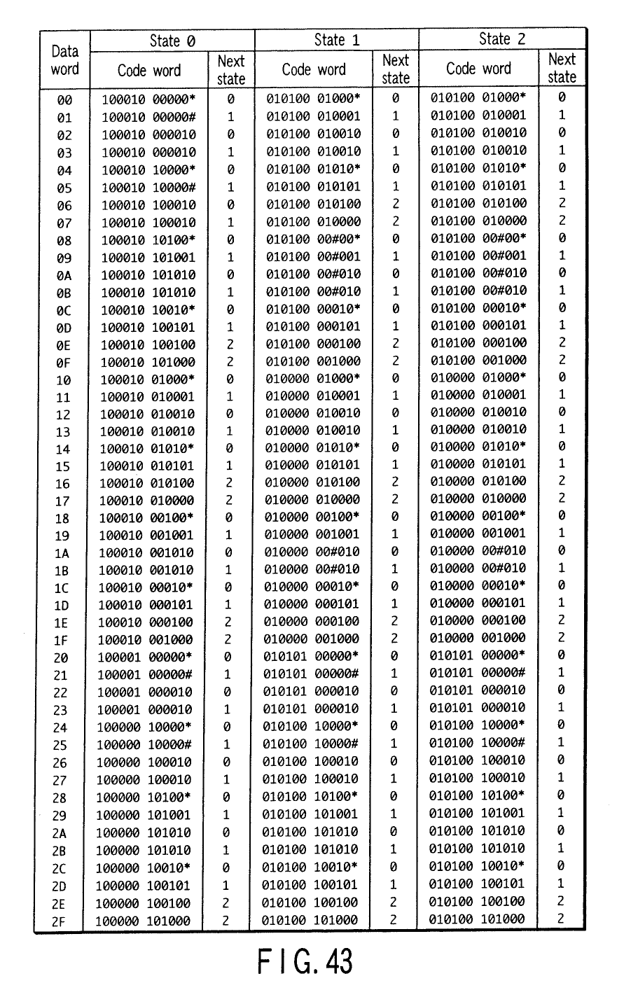

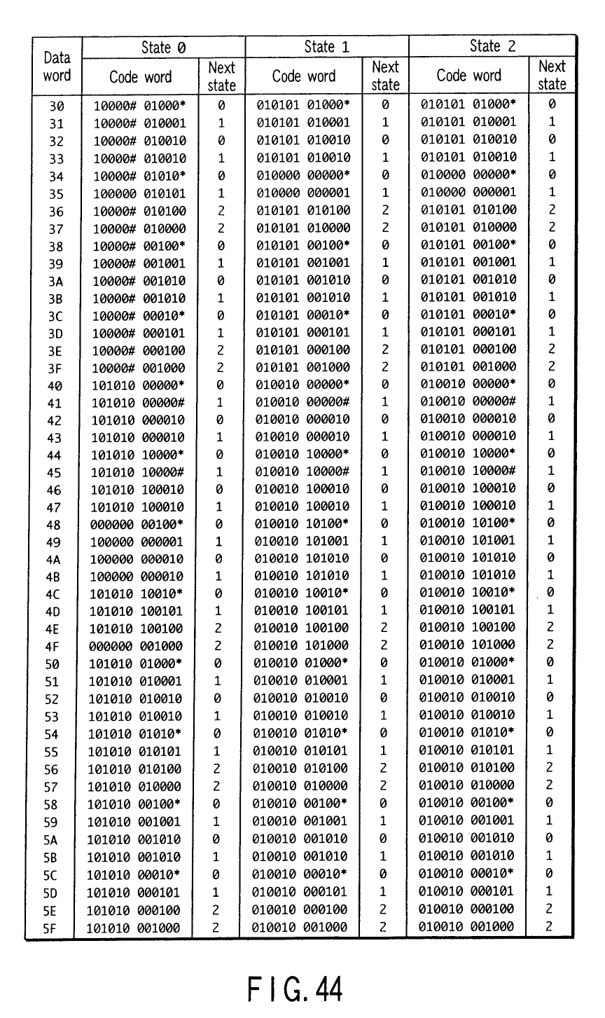

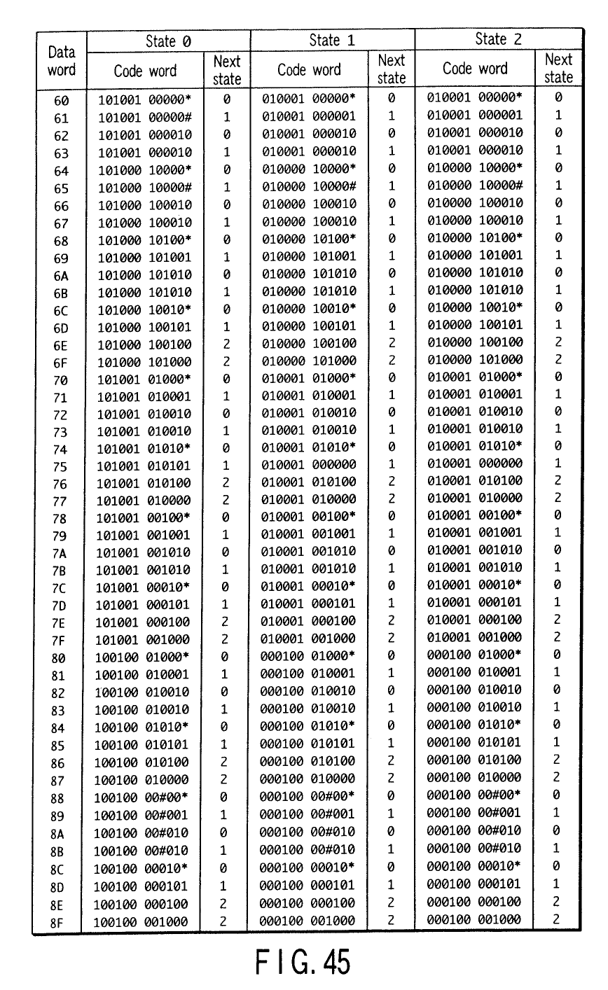

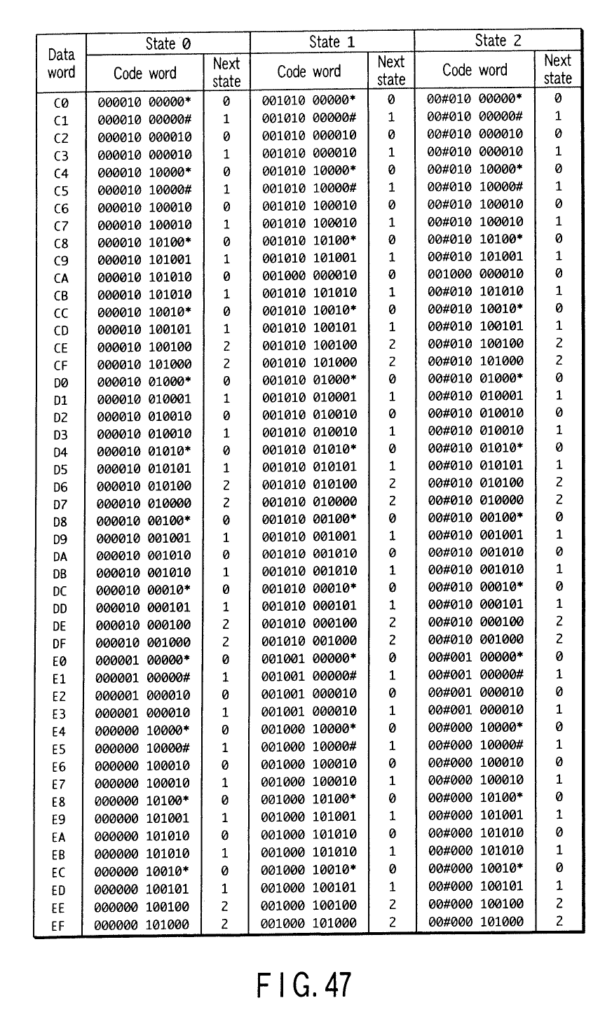

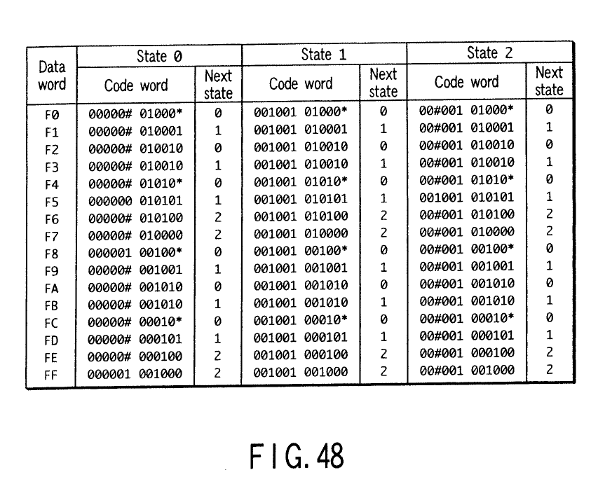

Modulation is performed using a code conversion table shown in FIGS. 43 to 48. The conversion table lists data words “00h” to “FFh,” 12 channel bits for the code word for each of State 0 to State 2, and State of the next data word.

FIG. 39 shows the configuration of a modulation block.

A code table 352 determines code word X(t) and next state S(t+1) from data word B(t) and state S(t) as follows:
X(t)=H{B(t),S(t)}
S(t+1)=G{B(t),S(t)}

where H is a code word output function and G is a next State output function.

A state register 358 inputs next state S(t+1) from a code table 352 and outputs (current) state S(t) to the code table 352.

Some 12 channel bits in the code conversion table include not only “0b” and “1b” but also Asterisk bit “*” and Sharp bit “#.”

Asterisk bit “*” in the code conversion table indicates that the bit is a merging bit. Some code words in the conversion table have a merging bit at LSB. A code connector 354 sets the merging bit to either “0b” or “1b” according to the channel bit following the merging bit. If the following channel bit is “0b,” the merging bit is set to “1b.” If the following channel bit is “1b,” the merging bit is set to “0b.”

Sharp bit “#” in the conversion table indicates that the bit is a DSV control bit. The DSV control bit is determined as a result of DC component suppression control performed by a DSV controller 536.

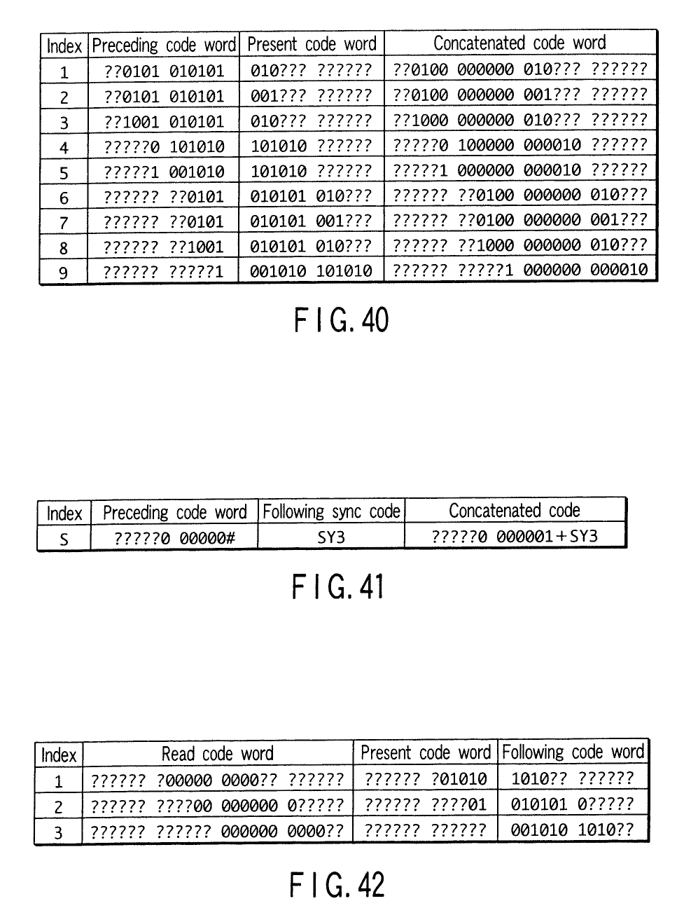

The concatenation rule for code words shown in FIG. 40 is used to concatenate code words obtained from the code table. When two adjacent code words coincide with patterns representing as the preceding code word and present code word in the table, these code words are replaced with a concatenated code word shown in the table. “?” bit is any one of “0b”, “1b”, and “#.” “?” bits in the concatenated word are allocated as the preceding code word and present code word without being replaced.

A concatenation of code words is first applied to the preceding concatenation point. The concatenation rule in the table is applied to the individual concatenation points in the order of indexes. Some code words are replaced twice to connect with the preceding code word and with the following code word. A merging bit for the preceding word code is determined before pattern matching for concatenation. The DSV control bit “#” of the preceding code word or present code word is treated as a special bit before and after code connection. The DSV control bit is neither “0b” nor “1b”, but is “?.” The code word concatenation rule is not used to connect a code word to a sync code. To connect a code word to a sync code, the concatenation rule shown in FIG. 41 is used.

When a recording frame is modulated, a sync code is inserted into the head of each modulation code word in a 91-byte data word. Modulation is started at State 2 behind a sync code. The modulated code word is output sequentially as MSB to the head of each conversion code word and is subjected to NRZI conversion before being recoded onto the disk.

A sync code is determined by performing DC component suppression control.

DC component suppression control (DCC) minimizes the absolute value of accumulated DSV (digital sum value: additions are made, provided that “1b” is set to +1 and “0b” to −1) in an NRZI conversion modulation channel bit stream. A DDC algorithm controls the selection of a code word and a sync code in each of the following cases (a) and (b) to minimize the absolute value of DSV:

Selecting a Sync Code (see FIG. 38)

Selecting DSV Control Bit “#” for a Concatenated Code Word

Selection is determined by the value of accumulated DSV at the position of the DSV bit in each of the concatenated code word and sync code.

DSV on which calculations are based is added to an initial value of 0 at the start of modulation. Additions are continued until the modulation has been completed and DSV is not reset. The selection of a DSV control bit means that the starting point is a DVS control bit and that a channel bit stream to minimize the absolute value of DSV just in front of the following DSV control bit is selected. Of two channel bit streams, the one whose absolute value of DSV is smaller is selected. If two channel bit streams have the same absolute value of DSV, DSV control bit “#” is set to “0b.”

When the maximum DSV in calculating logically possible scenarios is taken into account, a range of DVS calculations has to be at least ±2047.

Hereinafter, a demodulation method will be explained. A demodulator converts a 12-channel-bit code word into an 8-bit data word. A code word is reproduced from a read bit stream using separation rules shown in FIG. 42. When two adjacent code words coincide with a pattern complying with the separation rules, these code words are replaced with the present codeword and the following code word shown in the table. “?” bit is any one of “0b”, “1b”, and “#.” “?” bits in the present code word and following code word are allocated directly in the read code word without being replaced.

The boundary between a sync code and a code word is separated without being replaced.

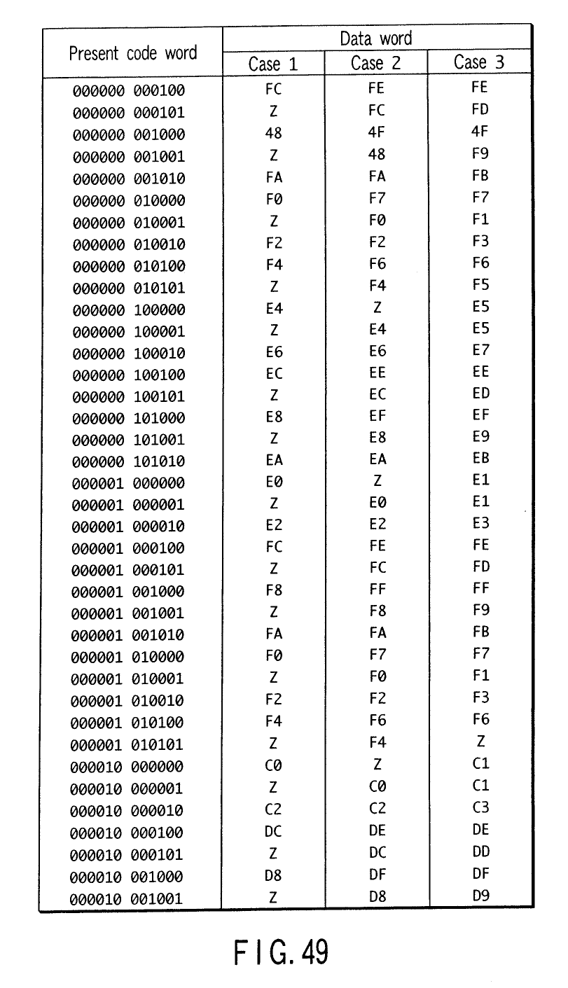

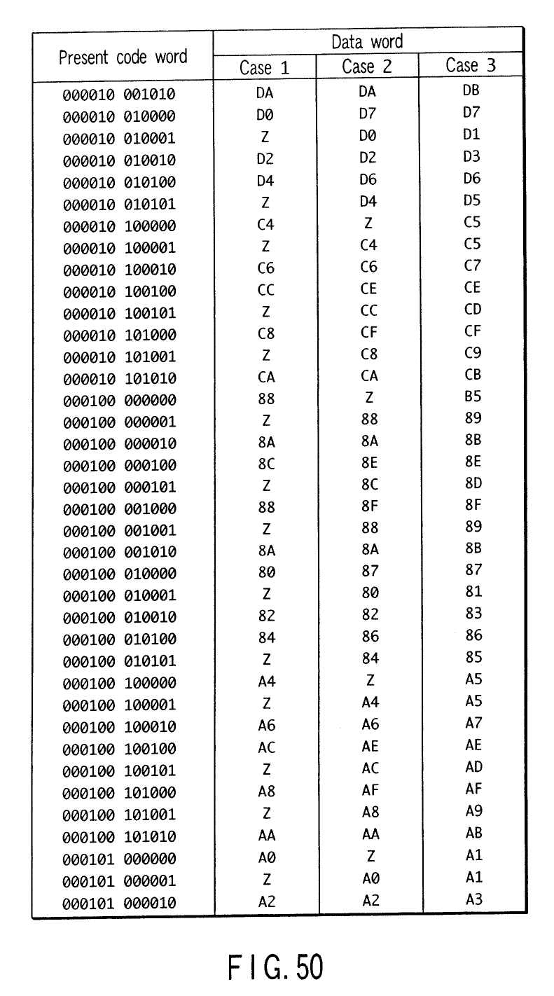

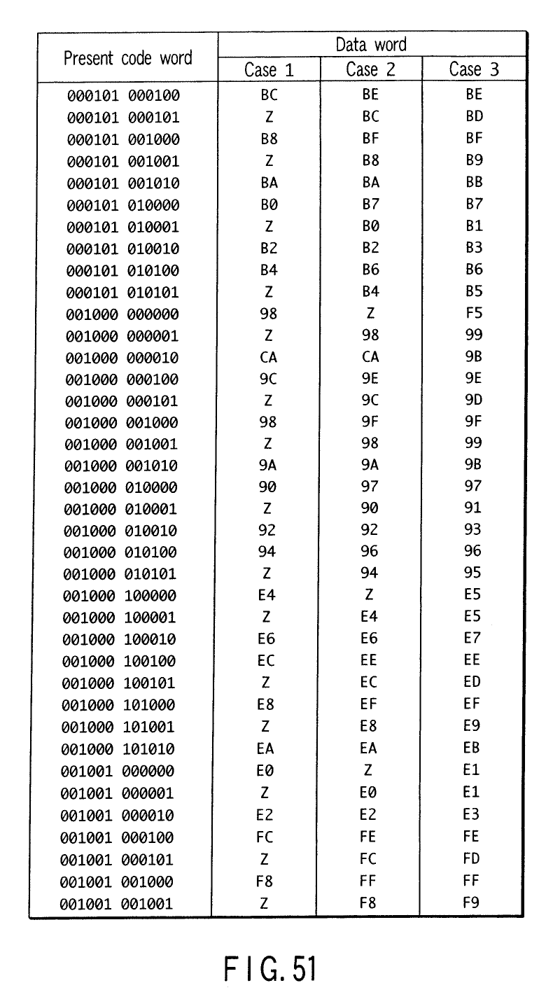

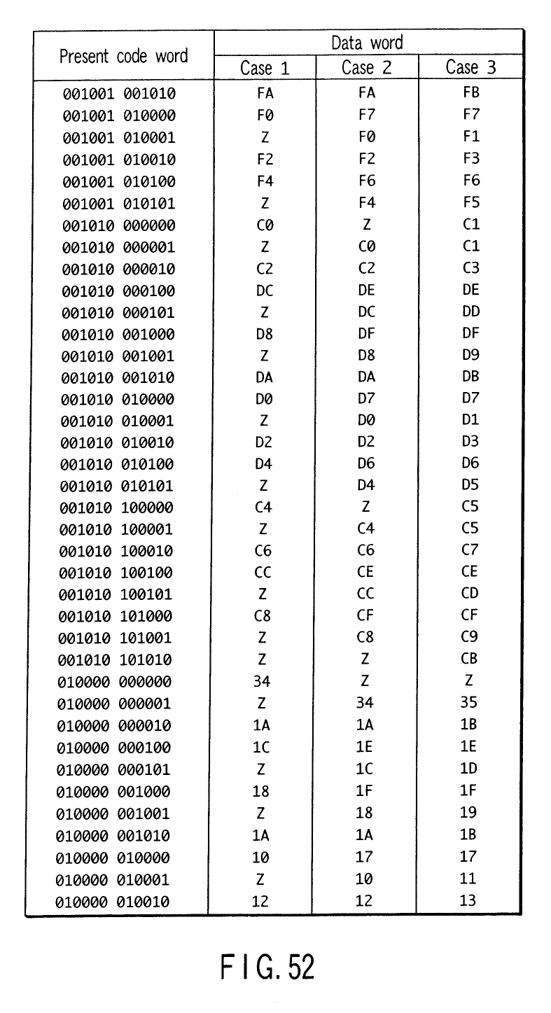

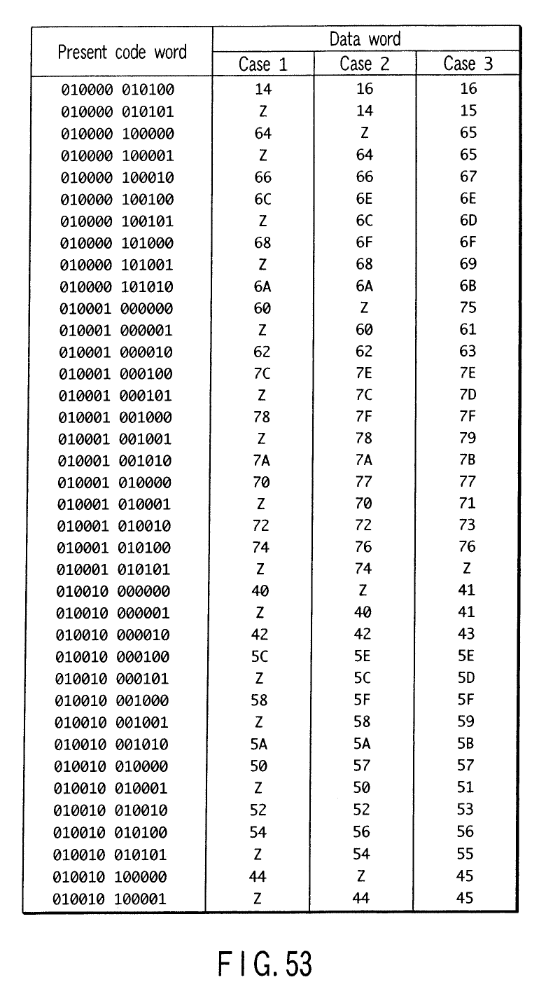

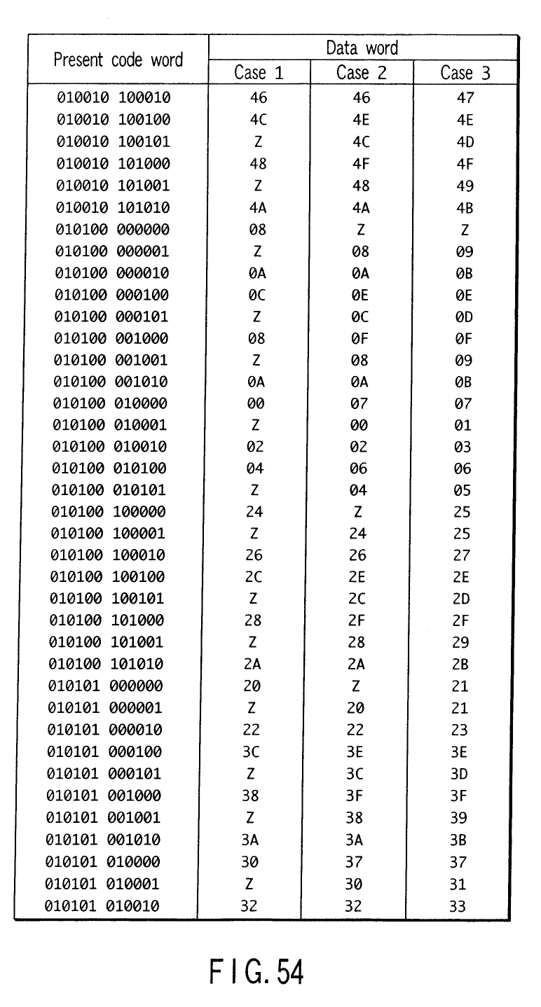

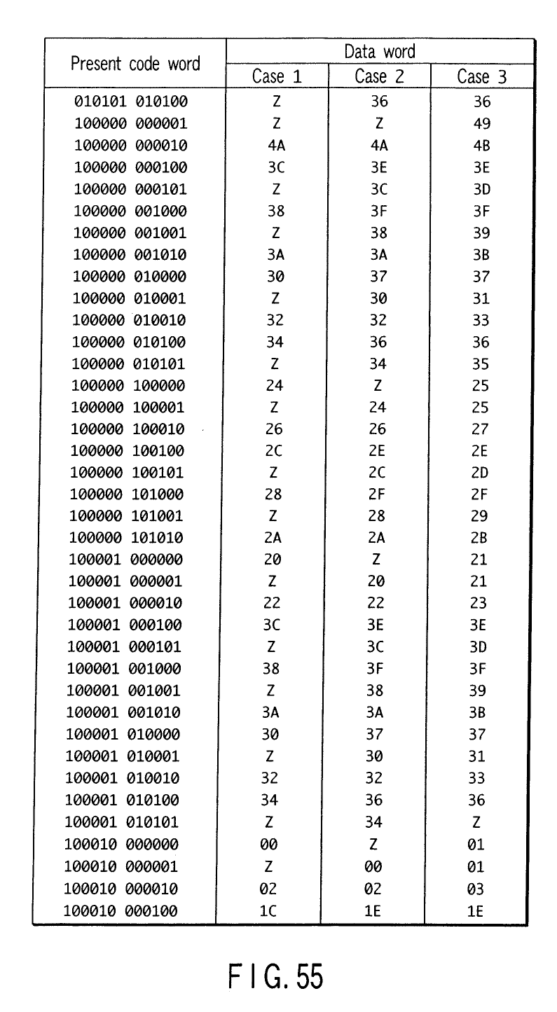

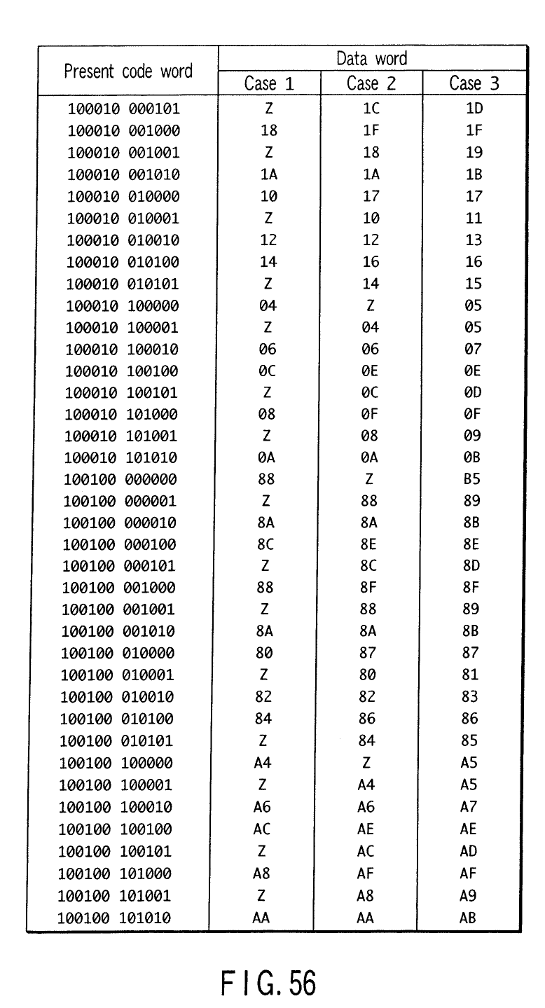

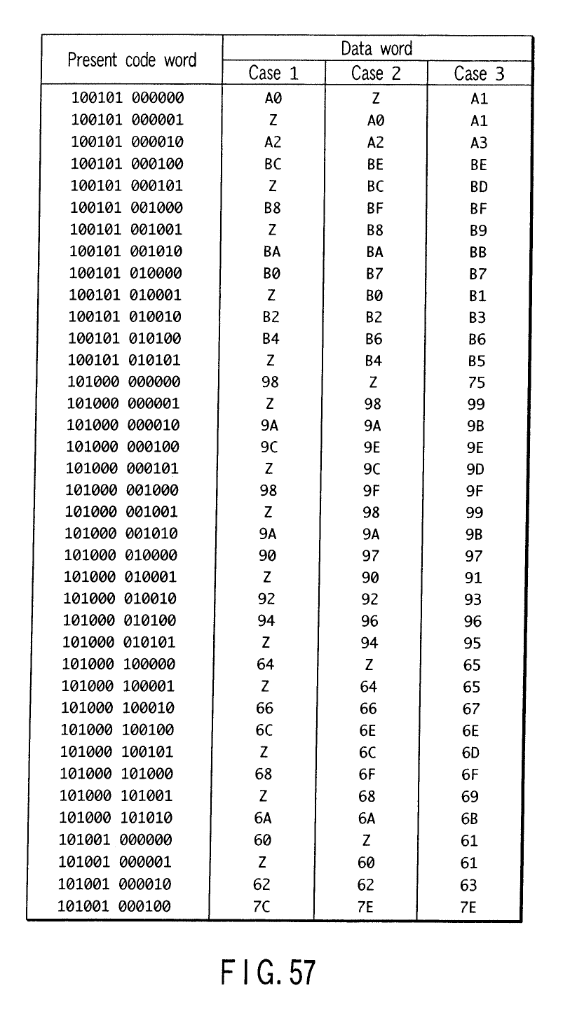

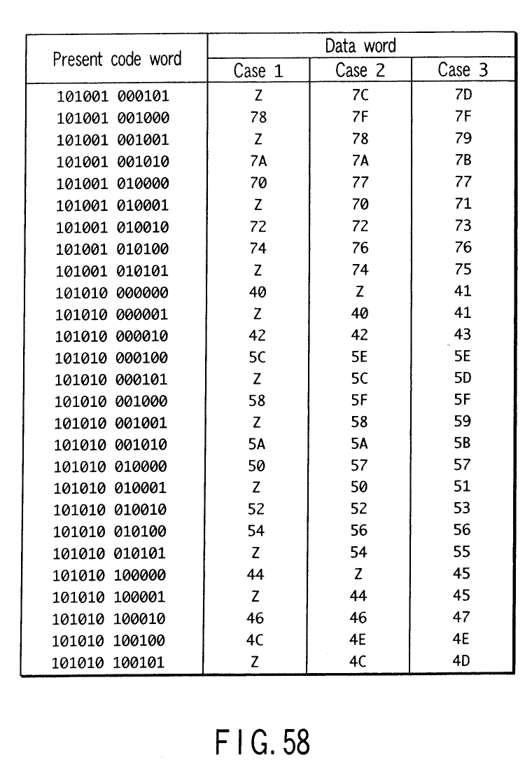

A code word is converted into a data word according to a modulation table shown in FIGS. 49 to 58. All possible code words are listed in the modulation table. “z” may be any data word in the range from “00h” to “FFh.” The separated present code word is decoded by observing 4 channel bits in the following code word or the pattern of the following sync code:

Case 1: The following code word begins with “1b” or the following sync code is SY0 to SY2 in State 0.

Case 2: The following code word begins with “0000b” or the following sync code is SY3 in State 0.

Case 3: The following code word begins with “01b”, “001b”, and “0001b” or the following sync code is SY0 to SY3 in State 1 and State 2.

The contents of a reference code pattern recorded in a reference code recording zone RCZ shown in FIG. 16 will be explained in detail. The existing DVD uses not only an “8/16 modulation” method of converting 8 bits of data into 16 channel bits as the modulation method but also a repeated pattern of “00100000100000010010000010000001” as a reference code pattern serving as a channel bit train recorded onto the information storage medium after modulation. In contrast, as shown in FIGS. 13 to 15, this embodiment uses ETM modulation that modulates 8 bits of data into 12 channel bits, imposes a run-length restriction of RLL (1, 10), and uses the PRML method in reproducing the signal from the data lead-in area DTLDI, data area DTA, data lead-out area DTLDO, and middle area MDA. Therefore, it is necessary to set the optimum reference code pattern for the modulation rule and PML detection. According to a run-length restriction of RLL (1, 10), the minimum value of the number of consecutive “0s” is “d=1” and this gives a repeated pattern of “10101010.” If the distance from code “1” or “0” to the following adjacent code is “T,” the distance between adjacent “1s” in the pattern is “2 T.”

In this embodiment, since the information storage medium has a higher recording density, the reproduction signal from a repeated pattern of “2 T” (“10101010”) recorded on the information storage medium as described above lies near the cut-off frequency of the MTF (Modulation Transfer Function) characteristic of the objective (existing in the information recording and reproducing section 141 of FIG. 1) in the optical head, with the result that almost no modulation degree (signal amplitude) is obtained. Therefore, when the reproduction signal from a repeated pattern of “2 T” (“10101010”) is used as a reproduction signal used for circuit adjustment of the information reproducing apparatus or information recording and reproducing apparatus (e.g., initial optimization of various tap coefficients performed in a tap controller 332 of FIG. 5), the effect of noise is great and therefore stabilization effects are poor. Therefore, it is desirable that a still denser “3 T” pattern should be used in circuit adjustment for the signal modulated according to a run-length restriction of RLL (1, 10).

When the DSV (Digital Sum Value) of the reproduction signal is taken into account, the absolute value of the DC (direct current) value increases in proportion to the number of consecutive “0s” between “1” and the following “1” and the resulting DC value is added to the preceding DSV value. The polarity of the DC value added reverses before “1” is reached. Therefore, as for a method of setting the DSV value to “0” where a channel bit train of consecutive reference codes lasts, the degree of freedom of reference code pattern design increases in a method of setting the number of “1s” appearing in 12 channel bit trains after ETM modulation to an odd number and offsetting the DC component developed in a set of 12-channel-bit reference code cells with the DC component developed in the following set of 12-channel-bit reference code cells as compared with a method of doing setting so that the DSV value may become “0” in 12 channel bit trains after ETM modulation. Therefore, in the embodiment, the number of “1s” appearing in the reference code cell made up of 12 channel bit trains after ETM modulation is set to an odd number. To achieve a higher recording density, the embodiment uses a mark edge recording method where the position of “1” coincides with the position of the boundary between recording marks or between emboss pits. For example, when a repeated pattern of “3 T” (“100100100100100100100”) lasts, the length of a recording mark or an emboss pit and the space between recording marks or emboss pits may differ slightly according to the recording condition or the master disk producing condition. When the PRML detecting method is used, the level value of the reproduction signal is very important. To detect the signal stably and accurately even if the length of a recording mark or an emboss pit and the space between recording marks or emboss pits differ slightly, the slight difference has to be corrected using a circuit. Therefore, when a space of “3 T” in length similar to a recording mark or emboss pit of “3 T” in length is used as a reference code for adjusting the circuit coefficients, this improves the accuracy of circuit coefficient adjustment. For this reason, when a pattern of “1001001” is included as a reference code pattern in the embodiment, a recording mark or emboss pit and space of “3 T” in length won't fail to be arranged.

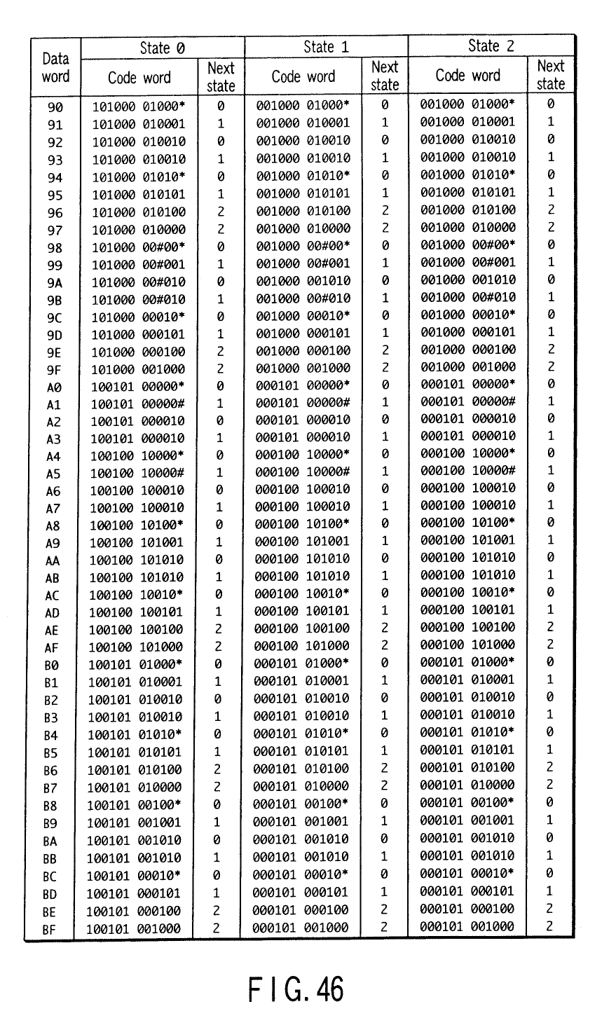

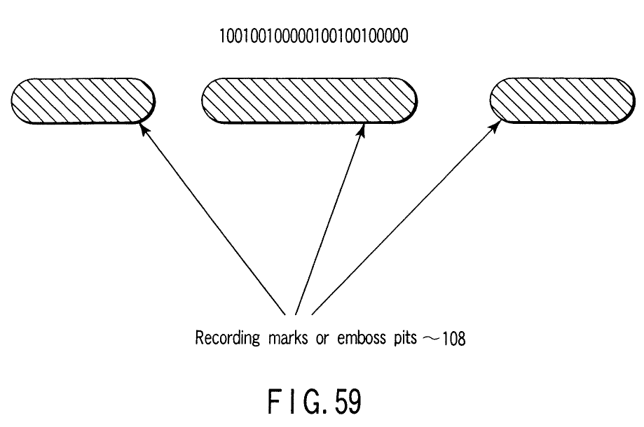

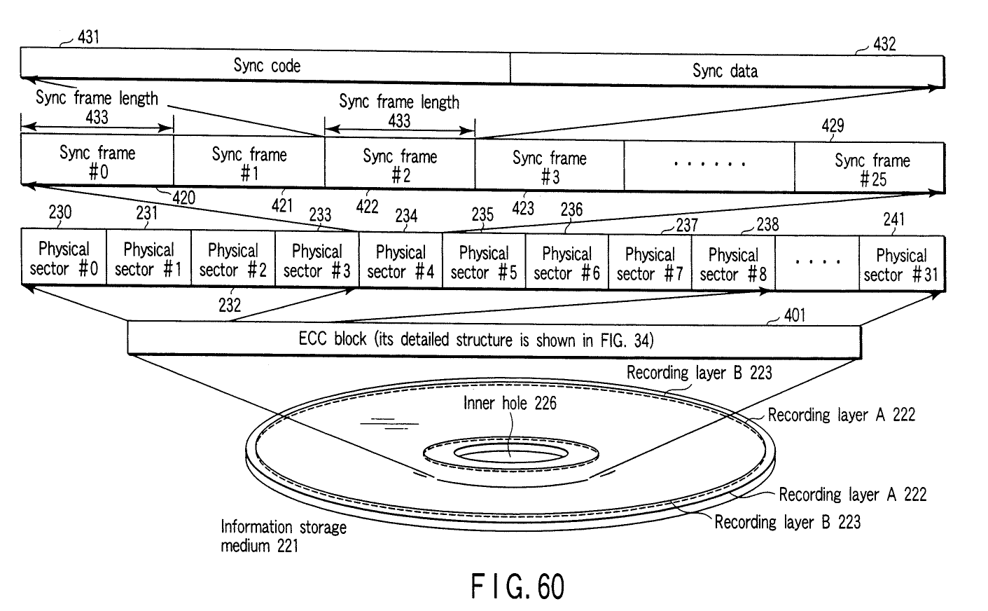

Circuit adjustment requires not only a dense pattern (“1001001”) but also a sparse pattern. Therefore, when a sparse state (a pattern where many “0s” appear consecutively) is produced in the part from which a pattern of “1001001” has been removed in 12 channel bit trains subjected to ETM modulation and the number of “1s” appearing is set to an odd number, the optimum condition for the reference code pattern is a repetition of “100100100000” as shown in FIG. 59. To make the modulated channel bit pattern coincide with the above pattern, it is seen from FIG. 46 that an unmodulated data word has to be set to “A4h”, using the modulation table. “A4h” (hexadecimal representation) corresponds to the data symbol “164” (decimal representation).

A method of creating data according to the data conversion rule will be explained concretely. First, the data symbol “164” (=“0A4h”) is set to main data “D0 to D2047” in the above-described data frame structure. Next, data frame 1 to data frame 15 are prescrambled using initial preset number “0Eh”. Data frame 16 to data frame 31 are prescrambled using initial preset number “0Fh”. With the prescrambling, when scrambling is done following the data conversion rule, this produces the effect of double scrambling, with the result that the data symbol “164” (=“0A4h”) appears as it is (that is, double scrambling returns the pattern to the original one). Since all of the reference codes each composed of 32 physical sectors are prescrambled, DSV control cannot be performed. Therefore, only data frame 0 is not prescrambled. When modulation is performed after the scrambling is done, a pattern shown in FIG. 59 is recorded onto the information storage medium.

FIG. 60 shows the way of recording channel bit data with the structure of a physical sector of FIG. 37 onto an information storage medium 221. In this embodiment, channel bit data recorded on the information storage medium 221 has a recording data hierarchical structure as shown in FIG. 60, regardless of the type of information storage medium 221 (read-only/recordable/rewritable). Specifically, an ECC block 401, which is the largest data unit enabling error detection or error correction of data, is composed of 32 physical sectors 230 to 241. As has descried in FIG. 37 and shown again in FIG. 60, sync frame #0 420 to sync frame #25 429 are composed of sync data 432 having a 1092 channel bit data size placed between 24 channel bits of data forming any one (sync code 431) of sync codes “SY0” to “SY3” and each sync code. Each of physical sector #0 230 to physical sector #31 241 is made up of 26 sync frames #0 420 to #25 429. As described above, one sync frame includes 1116 channel bits (24+1092) of data as shown in FIG. 37. A sync frame length 433, which is a physical distance on the information storage medium 221 on which one sync frame is recorded, is almost constant all over the information storage medium (when the variation in the physical distance caused by synchronization in the zone is removed).

A comparison of data recording format between various information storage media in the present embodiment will be explained using FIG. 61. The diagram (a) of FIG. 61 shows data recording formats in a conventional read-only information storage medium DVD-ROM, a conventional recordable information storage medium DVD-R, and a conventional rewritable information storage medium DVD-RW. The diagram (a) of FIG. 61(c) shows a data recording format of a read-only information storage medium in the embodiment. The diagram (d) of FIG. 61 shows a data recording format of a rewritable information storage medium in the embodiment. Although the individual ECC blocks 411 to 418 are shown in the same size for comparison, 16 physical sectors constitute one ECC block in a conventional read-only information storage medium DVD-ROM, a conventional recordable information storage medium DVD-R, and a conventional rewritable information storage medium DVD-RW shown in FIG. 61, whereas 32 physical sectors constitute one ECC block in the embodiment shown in the diagrams (b) and (d) of FIG. 61. As shown in the diagrams (b) and (d) of FIG. 61, this embodiment is characterized in that guard areas 442 to 448 having the same length as the sync frame length 433 are provided between ECC blocks #1 411 to #8 418 (point [K] in FIG. 125K).

In a conventional read-only information storage medium DVD-ROM, ECC blocks #1 411 to #8 418 are recorded consecutively as shown in the diagram (a) of FIG. 61. When an additional recording or rewriting process called a restricted overwrite is carried out to assure the interchangeability of data recording format between a conventional recordable information storage medium DVD-R and conventional rewritable information storage medium DVD-RW and a conventional read-only information storage medium DVD-ROM, this causes a problem: a part of the ECC block is destroyed by overwriting and therefore the reliability of data in reproduction is impaired seriously. In contrast, providing guard areas 442 to 448 between data fields (ECC blocks) as in the embodiment limits the overwriting area to the guard areas 442 to 448, which produces the effect of preventing the data in the data fields (ECC blocks) from being destroyed.

The present embodiment is characterized in that the length of each of the guard areas 442 to 448 is made equal to the sync frame length 433 of one sync frame size as shown in FIG. 61 (point [K] in FIG. 125K). As shown in FIGS. 37 to 60, sync codes are arranged at regular intervals of a 116-channel-bit sync frame length 433. The sync code position extracting section 145 of FIG. 1 extracts the positions of sync codes using the regular intervals. In the embodiment, making the length of each of the guard areas 442 to 448 equal to the sync frame length 433 keeps the sync frame intervals unchanged, even if the guard areas 442 to 448 are crossed over during reproduction. This produces the effect of making it easy to detect the positions of sync codes during reproduction.

Furthermore, in the embodiment, sync codes (sync data) are provided in the guard areas for the purpose of achieving the following (point (K2) in FIG. 125K):

The frequency of appearances of sync code is made equal even in a place crossing over the guard areas 442 to 448, thereby improving the accuracy of sync code position detection.

The determination of the positions of physical sectors including the guard areas 442 to 448 is made easier.

Specifically, as shown in FIG. 63, a postamble field 481 is formed at the starting position of each of the guard areas 442 to 468. In the postamble, sync code “SY1” with sync code number “1” shown in FIG. 38 is provided. As seen from FIG. 37, combinations of sync code numbers of three consecutive sync codes in physical sectors are different in all of the places. Moreover, combinations of sync code numbers of three consecutive sync codes, taking sync into account code number “1” in the guard areas 442 to 448, are also different in all of the places. Therefore, a combination of sync code numbers of three consecutive sync codes in an arbitrary area makes it possible to determine not only position information in the physical sectors but also the positions in the physical sectors including the positions of the guard areas.

FIG. 63 shows a detailed structure of the guard areas 441 to 448 shown in FIG. 61. FIG. 60 shows the structure of a physical sector composed of a combination of sync code 431 and sync data 432. This embodiment is characterized in that each of the guard areas 441 to 448 is composed of a combination of sync code 433 and sync data 434 and that the data modulated according to the same modulation rule as that of sync data 432 in a sector is placed in the sync data 434 area in the guard area #3 443.

In this invention, the area of one ECC block #2 412 composed of 32 physical sectors is called a data field 470.

In FIG. 63, VFO (Variable Frequency Oscillator) areas 471, 472 are used to synchronize reference clocks in the information reproducing apparatus or information recording and reproducing apparatus in reproducing the data area 470. The contents of data recorded in the VFO areas 471, 472 are such that data before modulation according to a common modulation rule described later is a repetition of consecutive “7Eh” and the actually recorded channel bit pattern after modulation is a repetition of “010001 000100” (a repeated pattern of three consecutive “0s”). To obtain this pattern, the begin byte in each of the VFO areas 471, 472 has to be set to State 2 in modulation.

Pre-sync areas 477, 478 indicate the positions of the boundary between the VFO areas 471, 472 and the data area 470. The recording channel bit pattern after modulation is a repetition of “100000 100000” (a repeated pattern of 5 consecutive “0s”). The information reproducing apparatus or information recording and reproducing apparatus detects the position of a change in a repeated pattern of “100000 100000” in the pre-sync areas 477, 478 from a repeated pattern of “010001 000100” in the VFO areas 471, 471, thereby realizing the approach of the data area 470.

The postamble field 481 indicates not only the end position of the data area 470 but also the starting position of a guard area 443. The pattern in the postamble field 481 coincides with the pattern of “SY1” in a sync code shown in FIG. 38.

An extra area 482 is an area used for copy control and unauthorized copy prevention. When the extra area 482 is not used for copy control and unauthorized copy prevention, all of it is set to channel bits “0s”.

In the buffer area 475, data before modulation as in the VFO areas 471, 472 is a repetition of “7Eh” and the actually recorded channel bit pattern after modulation is a repeated pattern of “010001 000100” (a repeated pattern of three consecutive “0s”). To obtain this pattern, the start byte in each of the VFO areas 471, 472 has to be set to State 2 in modulation.

As shown in FIG. 63, the postamble field 481 in which a pattern of “SY1” is recorded corresponds to the sync code area 433. The area from the extra area 482 just behind the sync code area 433 to the pre-sync area 478 corresponds to the sync data area 434. The area from the VFO area 471 to a buffer area 475 (that is, the area including the data area 470 and a part of the guard areas in front of and behind the data area 470) is called a data segment 490, which indicates the contents different from a “physical segment” explained later. The data size of each item of data shown in FIG. 63 is expressed in the number of bytes of data before modulation.

This embodiment can use not only the structure of FIG. 63 but also a method described below as one other embodiment. The pre-sync area 477 is arranged in the middle of the VOF areas 471, 472 instead of arranging the pre-sync area 477 at the boundary between the VOF are 471 and the data area 470. In the one other embodiment, the distance between the sync code “SY0” at the start position of the data block 470 and the pre-sync area 477 is increased, thereby securing a great distance correlation, which sets the pre-sync area 477 as a tentative Sync and uses it as distance correlation information on the real Sync position (although differing from another inter-Sync distance). If the real Sync cannot be detected, Sync is inserted in the position in which the real one created from the tentative Sync is to be detected. The one other embodiment is characterized in that the pre-sync area 477 is kept a little away from the real sync (“SY0”). Providing the pre-sync area 477 at the beginning of each of the VFO areas 471, 472 reduces the function of pre-sync because PLL of a reading clock is not locked. Therefore, it is desirable that the pre-sync area 477 should be provided in the mid-point of the VFO areas 471, 472.

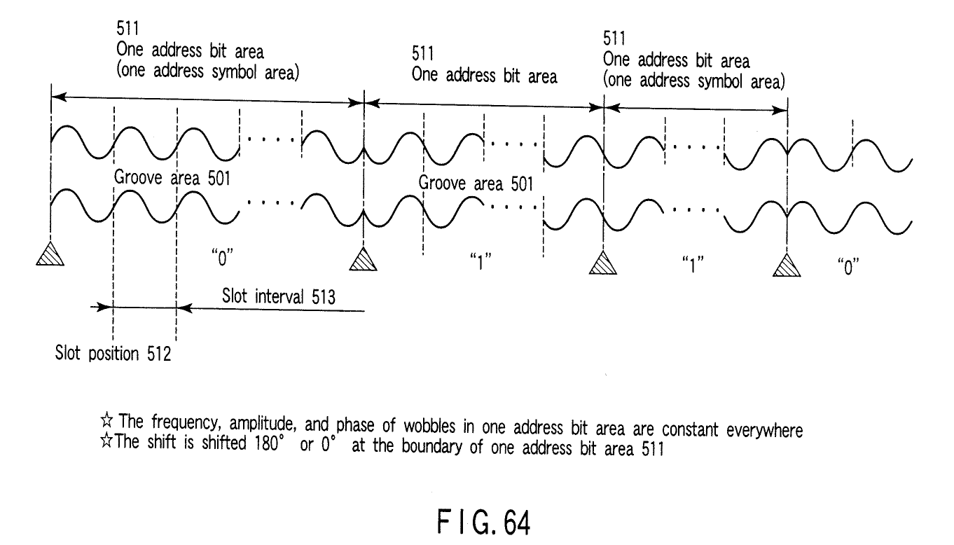

In this embodiment, address information on a recording (rewritable or recordable) information storage medium is recorded in advance by wobble modulation. The present embodiment is characterized in that ±90° (180°) phase modulation is used as the wobble modulation method and that address information is recorded in advance onto the information storage medium by the NRZ (Non-Return to Zero) method (point [J] in FIG. 125G). Using FIG. 64, a detailed explanation will be given. In the embodiment, as for address information, an address bit (also referred to as an address symbol) area 511 is represented at intervals of four wobbles. In one address bit area 511, the frequency, amplitude, and phase coincide with those in the rest. When the same value lasts as the values of address bits, the same phase continues at the boundary of each address bit area 411 (the part marked with a black triangle in FIG. 64). When the address bits reverse, the wobble pattern reverses (the phase is shifted 180°). The wobble signal detecting section 135 of the information recording and reproducing apparatus of FIG. 1 detects the boundary position of the address bit area 511 (the place marked with a black triangle in FIG. 64) and a slot position 512 (the boundary position of one wobble period) simultaneously. Although not shown, the wobble signal detecting section 135, which includes a PLL (Phase Locked Loop) circuit, applies PLL to both of the boundary position of the address bit area 511 and the slot position 512 in synchronization. If the boundary position of the address bit area 511 or the slot position 512 is out of position, the wobble signal detecting section 135 goes out of synchronization and the wobble signal cannot be reproduced (read) accurately. The interval between adjacent slot positions 512 is referred to as a slot interval 513. The shorter the slot interval 513, the easier the PLL circuit is synchronized. Therefore, the wobble signal can be reproduced stably (or the contents of information can be deciphered stably).

As seen from FIG. 64, when the 180° phase modulation method of making a 180° shift or 0° shift is used, the slot interval 513 coincides with one wobble period. As for a wobble modulation method, an AM (Amplitude Modulation) method of changing the wobble amplitude is liable to be affected by dust on or flaws in the surface of an information storage medium, whereas a phase modulation method is less liable to be affected by dust on or flaws in the surface of an information storage medium because a change in the phase, not in the amplitude, is detected. Moreover, in an FSK (Frequency Shift Keying) method of changing the frequency, the slot interval 513 is longer than the wobble period and therefore it is difficult to synchronize the PLL circuit. Therefore, as in the embodiment, when address information is recorded by wobble phase modulation, this produces the effect of making it easier to synchronize the wobble signal.

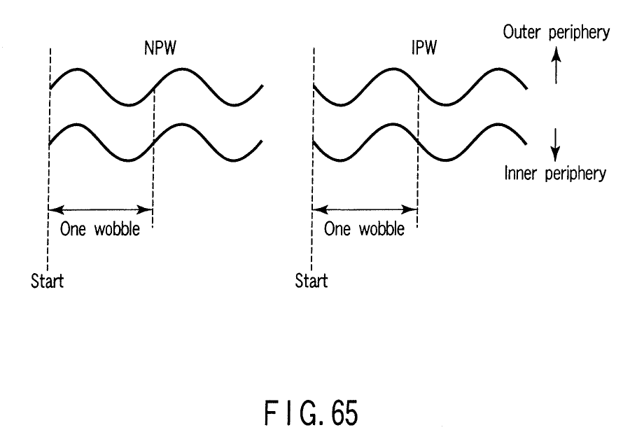

As shown in FIG. 64, either “1” or “0” is allocated as binary data to one address bit area 511. FIG. 65 shows a method of allocating bits in this embodiment. As shown at left of FIG. 65, a wobble pattern which wobbles first from the starting position of one wobble toward the outer periphery is referred to as a normal phase wobble NPW (Normal Phase Wobble). Data “0” is allocated to this. As shown at right of FIG. 65, a wobble pattern which wobbles first from the starting position of one wobble toward the inner periphery is referred to as an inverted phase wobble NPW (Inverted Phase Wobble). Data “1” is allocated to this.

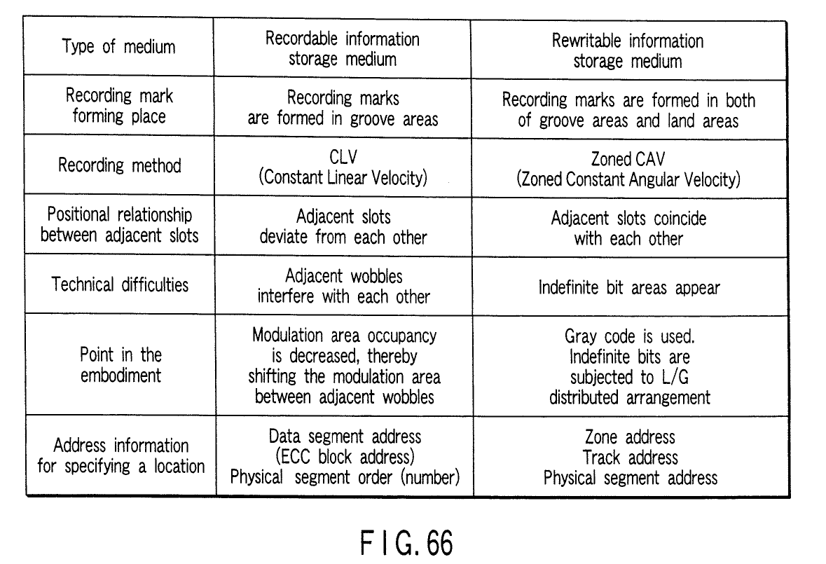

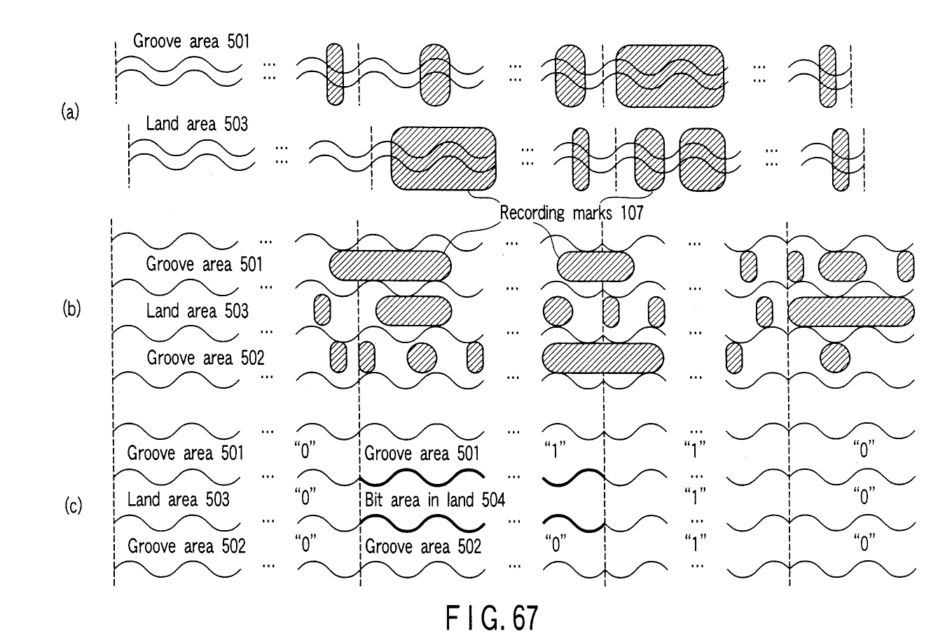

A comparison of wobble arrangement and recording positions between a recordable information storage medium and a rewritable information storage medium in the embodiment will be generally explained. The diagram (a) of FIG. 67 shows wobble arrangement and the forming position of recording mark 107 in a recordable information storage medium. The diagrams (b) and (c) of FIG. 67 show wobble arrangement and the forming position of recording mark 107 in a rewritable information storage medium. In FIG. 67, the diagram is reduced in the horizontal direction and extended in the vertical direction as compared with the actual enlarged diagram. As shown in FIG. 66 and the diagram (a) of FIG. 67, a CLV (Constant Linear Velocity) method is used for the recordable information storage medium. The slot position between adjacent tracks or the position of the boundary between address bit areas (the part shown by a one-dot-dash line in FIG. 67) may be out of position. Recording marks 107 are formed in groove areas 501, 502. In this case, since the wobble position between adjacent tracks is asynchronous, the interference of the wobble signal between adjacent tracks takes place. As a result, the displacement of the slot position detected from the wobble signal by the wobble signal detecting section 135 of FIG. 1 and the displacement of the boundary between address bit areas are liable to take place. To overcome the technical difficulties, the present embodiment reduces the modulated area occupation ratio as described later (point (J2) in FIG. 125G) and shifts the modulated area between adjacent tracks (point (J5) in FIG. 125I).

In contrast, the rewritable information storage medium uses a “land/groove recording method” of forming recording marks 107 in both of the land area 503 and the groove areas 501, 502 as shown in FIG. 66 and the diagram (b) of FIG. 67 and “zoned CAV (Constant Angular Velocity) recording method” of dividing a data area into 19 zones from “0” to “18” as shown in FIGS. 12A and 12B and of synchronizing wobbles between adjacent tracks in the same zone. The embodiment is characterized in that the “land/groove recoding method” is used in a rewritable information storage medium and that address information is recorded in advance (point (J4) in FIG. 125I). In a “groove recording method” which records recording marks 107 in only the groove areas 501, 502 as shown in the diagram (a) of FIG. 67, when recoding is done with a shortened track pitch, the distance between the adjacent groove areas 501, 502, the reproduction signal from the recording mark 107 recorded on one groove area 501 is influenced by the recording mark 107 recorded on the adjacent groove 502 (or crosstalk between adjacent tracks occurs). Therefore, the track pitch cannot be shortened much, which puts a limit on the recording density. In contrast, as shown in the diagram (b) of FIG. 67, when recording marks 107 are recorded in both of the groove areas 501, 502 and the land area 503, setting the step between the groove areas 501, 502 and the land area 502 to λ/(5n) to λ/(6n) (λ: the wavelength of the optical head light source used in reproduction, n: the refractive index of the transparent substrate of the information storage medium at the wavelength) causes crosstalk between adjacent areas (between the land areas and the groove area) to be compensated for even if the track pitch is shortened. Using this phenomenon, the “land/groove recording method” can shorten the track pitch more than the “groove recoding method,” which enables the recording density of the information storage medium to be increased.

To access a specific position on an unrecorded information storage medium (before a recording mark 107 is recorded) with high accuracy, it is necessary to record address information onto the information storage medium in advance. When the address information is recorded in emboss pits in advance, recording marks have to be recorded, avoiding the emboss pit area, which decreases the recording capacity by the amount equal to the emboss pit area. In contrast, when address information is recorded by wobble modulation as in a rewritable information storage medium of the embodiment (point (J4) in FIG. 125I), recording marks 107 can be formed also in the wobble-modulated area, which raises the recording efficiency and increases the recording capacity.

As described above, not only using the “land/groove recoding method” but also recording address information by wobble modulation in advance enables recording marks 107 to be recorded with the highest efficiency and the recording capacity of the information storage medium to be increased. According to user requests that the recording capacity of a recordable information storage medium should coincide with that of a read-only information storage medium, the recording capacity of a recordable information storage medium is caused to coincide with that of a read-only information storage medium, as seen from a comparison of the column of “user usable recording capacity” in FIGS. 13 and 14. Therefore, the recordable information storage medium does not require as large a capacity as the rewritable information storage medium and therefore uses the “groove recording method” as shown in the diagram (a) of FIG. 67.

In the method shown in the diagram (a) of FIG. 67, since the slot position between adjacent tracks and the position of the boundary between address bit areas (shown by a one-dot-dash line in FIG. 67) are all in position, the interference of a wobble signal between adjacent tracks does not occur. Instead, an uncertain bit area 504 appears. In the diagram (c) of FIG. 67, consider a case where the address information “0110” is recorded by wobble modulation in the upper groove area 501. Then, when the address information “0010” is recorded by wobble modulation in the lower groove area 502, an in-land uncertain bit area 504 shown in the diagram (c) of FIG. 67 appears. The width of the land varies in the in-land uncertain bit area 504, from which a wobble sense signal cannot be obtained. To overcome the technical difficulties, the embodiment uses the Gray code (point (J4β) in FIG. 125I) as described later. In the embodiment, the width of the groove area is changed locally to form an uncertain bit area also in the groove area (point (J4γ) in FIG. 125I), thereby distributing uncertain bits over both of the land area and the groove area (point (J4δ) in FIG. 125I).

The point of the embodiment is that the “land/groove (L/G) recording method” is used and 180° (±90°) wobble phase modulation is used for recording address information (point (J4α) in FIG. 125I). In “L/G recording+groove wobble modulation,” if an uncertain bit occurs on the land because the track number of the groove has changed, the whole level of the reproduction signal from the recording mark recoded on it changes, which causes a problem: the error rate of the reproduction signal from the recording mark deteriorates locally. However, as shown in this embodiment, 180° (±90°) wobble phase modulation is used as wobble modulation of grooves, which causes the land width to change in a bilaterally-symmetric, sine-wave form at the position of an uncertain bit on the land, with the result that a change in the whole level of the reproduction signal from the recording mark takes a very gentle form similar to a sine wave. In addition, tracking is done stably, the position of the uncertain bit on the land can be estimated in advance. Therefore, according to the embodiment, it is possible to realize a structure which enables the reproduction signal from the recording mark to be corrected using circuits and improves the quality of the reproduction signal easily.

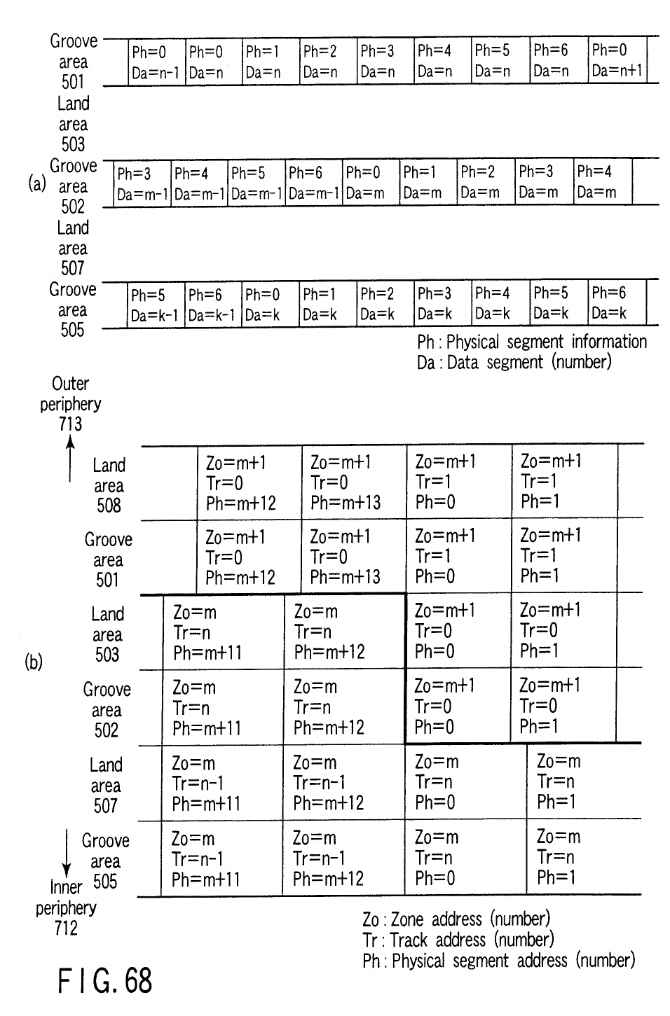

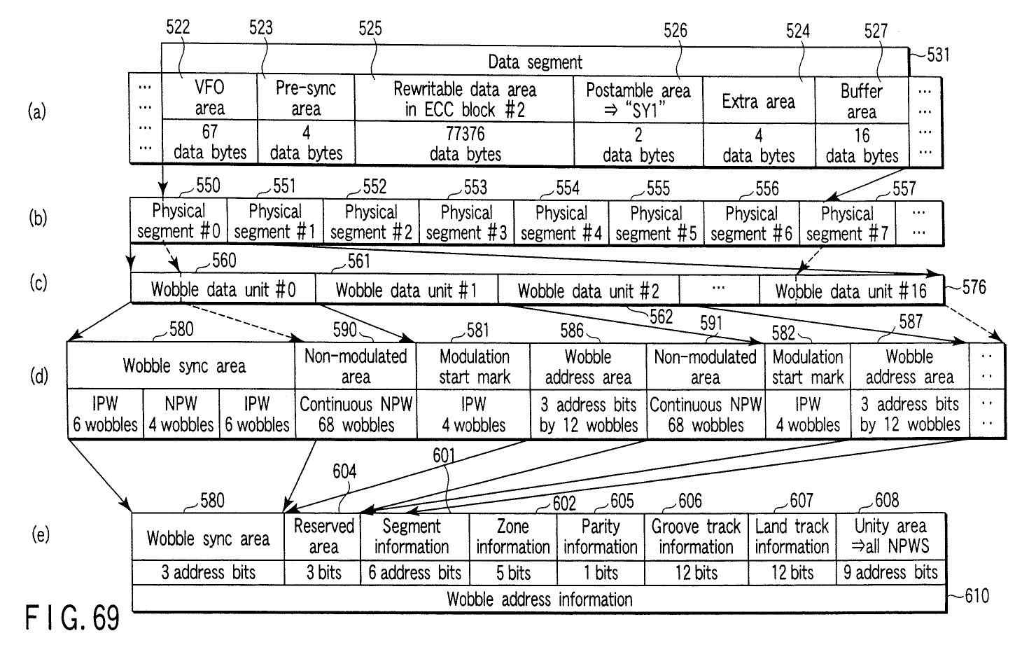

Using FIGS. 66 and 68, address information recorded in advance by wobble modulation will be explained. The diagram (a) of FIG. 68 shows the contents of address information in a recordable information storage medium and a method of setting the address. The diagram (b) of FIG. 68 shows the contents of address information in a rewritable information storage medium and a method of setting the address. As will be described in detail later, in both of the recordable information storage medium and the rewritable one, a unit of physical recording place on an information storage medium is called a “physical segment block.” A unit of data recorded in a physical segment block (in the form of a channel bit train) is called a “data segment.” One data segment of data is recorded in an area of one physical segment block length (the physical length of one physical segment block coincides with the length of one data segment recorded on the information storage medium). One physical segment block is composed of 7 physical segments. In one data segment block, one ECC block of user data shown in FIG. 34 is recorded in one data segment.

In a recordable information storage medium, since the “groove recoding method” with CLV is used as shown in FIG. 66, data segment address number Da is used as address information on the information storage medium as shown in the diagram (a) of FIG. 68. The data segment address may be referred to as ECC block address (number) or physical segment block address (number). Moreover, physical segment sequence Ph is also included in the address information to obtain more accurate position information in the same data segment address Da. That is, each physical segment position on the recordable information storage medium is determined by data segment address DA and physical segment sequence Ph. Data segment addresses Da are numbered in ascending order from the inner periphery side along the groove areas 501, 502, 507, 505. As for physical segment sequence Ph, number “0” to number “6” are set repeatedly from the inner periphery toward the outer periphery.

In a rewritable information storage medium, a data area is divided into 19 zones as shown in FIGS. 12A and 12B. Since a groove continues spirally, the length of one round on one adjacent track differs from that on the other. The difference in the length between adjacent tracks is set zone by zone so as to be ±4 channel bits or less when the length of channel bit interval is made equal everywhere. The boundary positions of physical segments or physical segment blocks coincide (synchronize) with one anther between adjacent tracks in the same zone. Therefore, as shown in FIG. 66 and the diagram (b) of FIG. 68, position information is given in zone address (number) Zo, track address (number) Tr, and physical segment address (number) Ph. Track address Tr represents track numbers arranged from the inner periphery toward the outer periphery in the same zone. A set of a land area and a groove area adjacent to each other (e.g., a set of land area 503 and groove area 502, or a set of land area 507 and groove area 505) is used to set the same track address number Tr. Since the uncertain bit area 504 appears frequently in the parts “Ph=0” and Ph=1” of the land area 507 in the diagram (b) of FIG. 68, the track address Tr cannot be decrypted. Thus, recording marks 107 are inhibited from being recorded into the area. A physical segment address (number) Ph represents a relative physical segment number in one round of the same track. Using the zone switching position in the circumferential direction as a reference, physical segment addresses Ph are numbered. That is, as shown in the diagram (b) of FIG. 68, the starting number of physical segment address Ph is set to “0.”

Using FIG. 69, a recording format of address information in wobble modulation in a recordable information storage medium of the present invention will be explained. A method of setting address information by wobble modulation in the present embodiment is characterized in that address information is allocated in units of the sync frame length 433 shown in FIG. 61. As shown in FIG. 37, one sector is composed of 26 sync frames. Since one ECC block is composed of 32 physical sectors as seen from FIG. 31, one ECC block is composed of 26×32=832 sync frames. As shown in FIG. 61, the length of the guard areas 422 to 468 between the ECC blocks 411 to 418 coincides with one sync frame length 433. Therefore, the length of the sum of one guard area 462 and one ECC block 411 is made up of 832+1=833 sync frames. Since 833 is factorized into:
833=7×17×7 (EQ. 1),

a structural localization making use of this feature is used. Specifically, an area as long as the area of one guard area plus one ECC block is defined as a data segment 531 serving as a basic unit of rewritable data (the structure of a data segment 490 shown in FIG. 63 is common to a read-only information storage medium, a rewritable information storage medium, and a recordable information storage medium). An area having the same length as the physical length of one data segment 531 is divided into “7” physical segments #0 550 to #6 556 (point (K3ε) in FIG. 125L). Address information is recorded in advance by wobble modulation for each of physical segments #0 550 to #6 556. As shown in FIG. 69, the boundary position of the data segment 531 does not coincide with that of the physical segment 550. They are shifted from each other by a specific distance described later. Moreover, as shown FIG. 69, each of physical segments #0 550 to #6 556 is divided into 17 wobble data units (WDU) #0 560 to #16 756 (point (J1) in FIG. 125G). It is seen from equation (EQ. 1) that 7 sync frames are allocated to each of wobble data units #0 560 to #16 756. In this way, 17 wobble data units constitute a physical segment (point (J1) in FIG. 125G) and the length of 7 physical segments is made equal to the length of a data segment (point (K3ε) in FIG. 125L), securing a sync frame boundary in the range extending over the guard areas 442 to 468, which facilitates the detection of a sync code 431 (FIG. 60).

In a rewritable information storage medium, errors are liable to occur in the reproduction signal from the recording mark in the uncertain bit area 504 (FIG. 67). Since the number of physical sectors constituting an ECC block, 32, cannot be divided by the number of physical segments, 7 (or is not a multiple of the number of physical segments, 7), this produces the effect of preventing not only items of data to be recorded in the uncertain area 504 from arranging in a straight line but also the error correcting capability from deteriorating in the ECC block.

As shown in the diagram (d) of FIG. 69, each of wobble data units #0 560 to #16 756 is composed of 16 wobbles of modulated areas and 68 wobbles of unmodulated area 590, 591. This embodiment is characterized in that the occupation ratio of the unmodulated areas 590, 591 to the modulated area is increased remarkably (point (J2) in FIG. 125G). Since the groove area or land area is always wobbling at a specific frequency in the unmodulated areas 590, 591, PLL (Phase Locked Loop) is applied using the unmodulated areas 590, 591, which makes it possible to extract (generate) a reference clock in reproducing the recording mark recording on the information storage medium or a recording reference clock used in recording new data.

As described above, in the embodiment, the occupation ratio of the unmodulated areas 590, 591 to the modulated area is increased remarkably, which makes it possible to improve not only the accuracy of extraction (generation) of a reproducing reference clock or a recording reference clock but also the stability of extraction (generation). Specifically, in wobble phase modulation, when the reproduction signal is caused to pass through a band-pass filter to shape the waveform, the amplitude of the shaped detected signal becomes smaller before and after a phase change. This phenomenon causes a problem: as the number of phase changes in phase modulation increases, the amplitude of the waveform fluctuates more frequently, lowering the clock extraction accuracy, whereas a small number of phase changes makes a bit shift liable to occur in detecting wobble address information. In this embodiment, to overcome this problem, a modulated area by phase modulation and an unmodulated area are provided and the occupation ratio of the unmodulated area to the modulated area is set high, which produces the effect of improving the clock extraction accuracy. Furthermore, since the place in which a modulated area is changed to an unmodulated area or vice versa can be estimated in advance, the unmodulated area is gated in extracting the clock, thereby detecting only the signal from the unmodulated area, which enables the clock to be extracted from the detected signal.

The modulation start marks 581, 582 are set using four wobbles at the boundary between the unmodulated areas 590, 591 and a modulated area so that wobble-modulated wobble address areas 586, 587 may appear immediately after the modulation start marks 581, 582. To actually extract wobble address information 610, the unmodulated areas 590, 591; the wobble sync area 580 except the modulation start marks 581, 582; and the wobble address areas 586, 587 gathered from each of the physical segments #0 550 to #6 556 are rearranged as shown in the diagram (e) of FIG. 69.

As shown in the diagram (d) of FIG. 69, three address bits are set using 12 wobbles in the wobble address areas 586, 587 (point (point (J2α) in FIG. 125G). That is, four consecutive wobbles constitute one address bit. As described above, the embodiment uses a structure which has address information distributed in units of three address bits (point (J2α) in FIG. 125G). When wobble address information 610 is concentrated in one place of the information storage medium as shown in the diagram (d) of FIG. 69, if the surface of the medium captures dust or is damaged, all of the information is difficult to detect. In the embodiment, wobble address information 610 is distributed in units of three address bits (12 wobbles) in each of the wobble data units 560 to 576 and organized information is recorded in units of an integral multiple of three address bits, which produces the effect of enabling other information to be detected even if the information in a place is difficult to detect because of dust or flaws.

As described above, the wobble address information 610 is arranged not only in a distributed manner but also in self-contained manner in each of the physical segments 550 to 557 (point (J1α) in FIG. 125G), enabling address information to be known for each of the physical segments 550 to 557, which makes it possible to find the present position on a physical segment basis, when the information recording and reproducing apparatus accesses the information.

Since the embodiment uses the NRZ method as shown in FIG. 64, the phase will not change in four consecutive wobbles in the wobble address areas 586, 587. Making use of this feature, the wobble sync area 580 is set. Specifically, a wobble pattern impossible to appear in the wobble address information 610 is set in the wobble sync area 580 (point (J3) in FIG. 125H), which makes it easier to identify the position where the wobble sync area 580 is arranged. The embodiment is characterized in that one address bit length is set to a length other than the length of four wobbles in the wobble sync area 580. Specifically, in the wobble sync area 580, an area where a wobble bit is “1” is set to such a wobble pattern change impossible to occur in the wobble address areas 586, 587 as “6 wobbles→4 wobbles→6 wobbles” differing from 4 wobbles. A method of changing the wobble period as described above is used as a method of setting a wobble pattern impossible to appear in the wobble address areas 586, 587 into the wobble sync area 580 (point (J3α) in FIG. 125H), which produces the following effects:

The detection of wobbles (the determination of a wobble signal) can be continued stably without the corruption of PLL related to the slot position 512 (FIG. 64) of wobbles at the wobble signal detecting section 135 of FIG. 1.

A shift in the position of the boundary between address bits in the wobble signal detecting section 135 of FIG. 1 makes it easier to detect the wobble sync area 580 and modulation start marks 561, 582.

Moreover, the embodiment is further characterized in that the wobble sync area 580 is formed in a period of 21 wobbles and the length of the wobble sync area 580 is caused to coincide with a 3-address bit length as shown in the diagram (d) of FIG. 69 (point (J3β) in FIG. 125H). Thus, all of the modulated area (equivalent 16 wobbles) in one wobble data unit #0 560 is allocated to the wobble sync area 580, which makes it easier to detect the starting position of the wobble address information 610 (or the location of the wobble sync area 580).

As shown in the diagram (c) of FIG. 69, the wobble sync area 580 is provided in the first wobble data unit #0 560 in physical segment #0 550. Providing the wobble sync area 589 in the start position of physical segment #0 550 as described above (point (J3γ) in FIG. 125H) produces the effect of enabling the boundary position of physical segments to be extracted by simply detecting the position of the wobble sync area 580.

In wobble data units #1 561, #2 562, the modulation start marks 581, 582 are provided at the start position ahead of the wobble address areas 586, 587, thereby setting a waveform of an inverted phase wobble IPW shown in FIG. 65. Since in the unmodulated areas 590, 591 arranged ahead of the modulation marks, a continuous waveform of normal phase wobbles NPW stands. Therefore, the wobble signal detecting section 135 of FIG. 1 detects the transition from NPW to IPW, thereby extracting the positions of the modulation start marks 581, 582.

As shown in the diagram (e) of FIG. 69, the contents of the wobble address information 610 are as follows:

Track Addresses 606, 607

These mean track numbers in the zone. A groove track address 606 determined in a groove area (including no uncertain bit→an uncertain bit occurs on a land) and a land track address 607 determined on a land (including no uncertain bit→an uncertain bit occurs in a groove) are recorded alternately. Only for the track addresses 606, 607, track number information is recorded using the Gray code of FIG. 70 (which will be explained in detail later).

Physical Segment Address 601

Information representing a physical segment number in a track (one round on an information storage medium 221). The number of physical segments in the same track is represented by “the number of physical segments per track” of FIGS. 12A and 12B. Therefore, the maximum value of a physical segment address 601 in each zone is determined by the number shown in FIGS. 12A and 12B.

Zone Address 602

This means a zone number in an information storage medium 221. The value of “n” in “zone (n)” shown in FIGS. 12A and 12B is recorded.

Parity Information 605

This is set for detecting an error in reproducing the data from the wobble address information 610. This information represents whether the result of adding 14 bits from the reserved information 604 to the zone address 602 bit by bit is even or odd. The value of the parity information 605 is set so that the result of exclusive-ORing, bit by bit, 15 bit address bits in all including one address bit in the address parity information 605 may be “1.”

Unity Area 608

As described earlier, each of wobble data units #0 560 to #16 576 is set so as to be composed of 16 wobbles of modulated area and 68 wobbles of unmodulated areas 590, 591 and the occupation ratio of the unmodulated areas 590, 591 to the modulated area is set considerably large. In addition, the occupation ratio of the unmodulated areas 590, 591 is increased, thereby improving the accuracy and stability of extraction (generation) of a reproducing reference clock or a recording reference clock. Wobble data unit #16 576 and the preceding wobble data unit #15 (not shown) correspond directly to the unity area 608 shown in the diagram (e) of FIG. 69. In monotone information 608, all of six address bits are “0.” Therefore, modulation start marks 581, 582 are not set in wobble data unit #16 576 including monotone information indicating that all are NPW and in the preceding wobble data unit #15 (not shown), thereby making all an uniform phase unmodulated area.

The diagram (e) of FIG. 69 shows the number of address bits allocated to the individual pieces of information. As described above, the wobble address information 610 is divided into sets of three address bits, which are distributed in the wobble data units 560 to 576. Even if a burst error occurs due to dust on or flaws in the surface of the information storage medium, the probability that the error has spread over the different wobble data units 560 to 576 is very low. Therefore, the number of times that the same information is recorded over the wobble data units differing in the place is reduced as much as possible and a break in the individual pieces of information is caused to coincide with the position of the boundary between wobble data units 560 to 576. This enables other information recorded in the remaining individual wobble data units 560 to 576 to be read even if a specific piece of information cannot be read because of a burst error has occurred due to dust on or flaws in the surface of the information storage medium, which improves the reliability of the wobble address information. Specifically, as shown in the diagram (e) of FIG. 69, 9 address bits are allocated to the unity area 608 and the position of the boundary between the unity area 608 and the preceding land track address 607 is caused to coincide with the position of the boundary between wobble data units (point (J3δ) in FIG. 125H). For the same reason, zone address 605 represented in 5 address bits is made adjacent to parity bit information 605 expressed in one address bit (point (J4ε) in FIG. 125I) and the sum total of the address bits on both sides is set to 6 address bits (equivalent to two wobble data units).

This embodiment is further characterized in that the unity area 608 is arranged at the end of wobble address information 610 as shown in the diagram (e) of FIG. 69 (point (J3ε) in FIG. 125H). As described above, since the wobble waveform takes the form of NPW in the unity area 608, NPW continues substantially in as many as three consecutive wobble data units 576. Making use of this feature, the wobble signal detecting section 135 searches for a place where NPW continues as long as three wobble data units 576, making it possible to extract the position of the unity area 608 placed at the end of the wobble address information 610, which produces the effect of enabling the starting position of the wobble address information 610 to be detected using the position information.

In various pieces of address information shown in FIG. 69 or the diagram (b) of FIG. 68 and FIG. 66, the physical segment address 601 and zone address 602 indicate the same values in adjacent tracks, whereas the values of the groove track address 606 and land track address 607 in a track differ from those in an adjacent one. Therefore, an uncertain bit area 504 shown in the diagram (c) of FIG. 67 appears in the area in which the groove track address 606 and land track address 607 are recorded. In the embodiment, to reduce the frequency of appearance of an uncertain bit, an address (number) is represented by the Gray code in connection with the groove track address 606 and land track address 607. FIG. 70 shows an example of the Gray code. The Gray code is such that, when the original value changes by “1”, the code after conversion changes by only “one bit” everywhere as shown in FIG. 70. This decreases the frequency of appearance of an uncertain bit, which helps stabilize the detection of not only the wobble detected signal but also the reproduction signal form the recording marks.

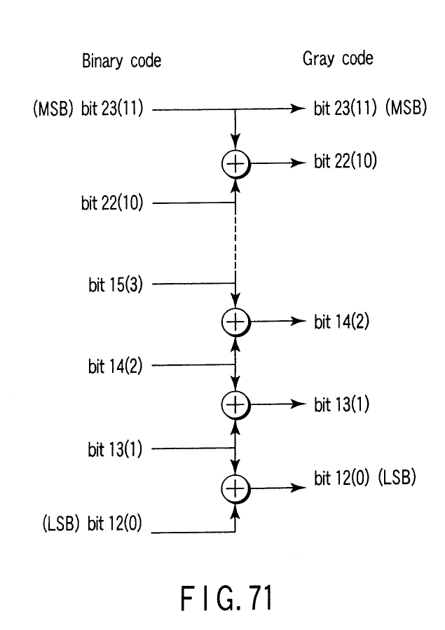

FIG. 71 shows an algorithm for realizing the Gray code conversion shown in FIG. 70. The most significant bit (MSB) (11^{th} bit) in the original binary code is caused to coincide with the MSB (11^{th} bit) in the Gray code. As for the lower codes than the 11^{th} bit, the result of addition (exclusive OR) of the “m-th bit” in the binary code and the “(m+1)th bit” one bit higher than the m-th bit in the binary code is caused to correspond to the “m-th bit” in the Gray code in conversion.

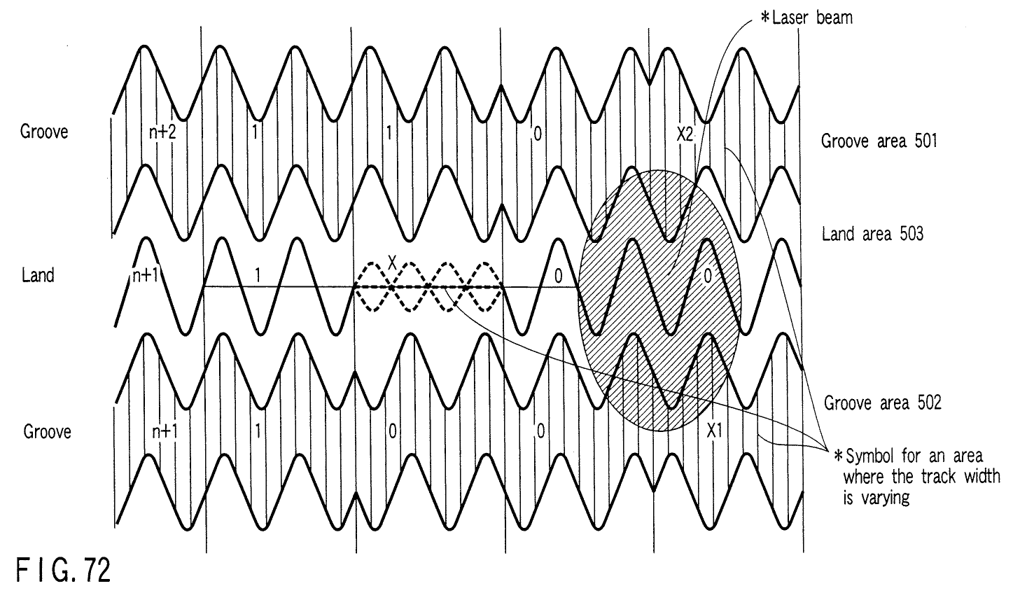

In the embodiment, uncertain bit areas are distributed also in the groove area (point (J4γ) in FIG. 125I). Specifically, a part of the width of each of the groove areas 501, 502 is changed as shown in FIG. 72, thereby keeping the width of the land area 503 sandwiched between them constant. When the groove areas 501, 502 are made with the information storage medium matrix recoding apparatus, the amount of laser light to be irradiate is changed locally, which makes it possible to change the width of each of the grooves 501, 502. This causes the land area to have an area where a track address is determined without the intervention of an uncertain bit, which enables an address to be detected with high accuracy even in the land area. Specifically, in the land area in which information on the land track address 607 of the diagram (e) of FIG. 69 is recorded, the land width is made constant using the above method. This enables address information to be detected stably without the intervention of an uncertain bit in connection with the land track address 607 in the land area.

In the embodiment, uncertain bits are distributed in both to the land area and the groove area (point (J4δ) in FIG. 125I). Specifically, on the rightmost side of FIG. 72, the width of each of the groove areas 501, 502 is changed so as to make the width of the land area 503 constant, whereas on the left side a little from the center of FIG. 72, the width of the land area 503 changes locally, with the width of each of the groove areas 501, 502 being kept constant. Using this method, the groove width is made constant in the groove area in which information on the groove track address 606 is recoded in the diagram (e) of FIG. 69, which enables address information to be detected stably without the intervention of an uncertain bit in connection with the groove track address 606 in the groove area. If uncertain bits are concentrated in either of the land area or the groove area, the frequency of occurrence of an error in reproducing address information is very high at the part in which uncertain bits have been concentrated. Distributing uncertain bits in the land area and groove area, thereby dispersing the risk of erroneous detection, which makes it possible to provide a system capable of detecting address information stably and easily. As described above, distributing uncertain bits in both of the land area and the groove area makes it possible to estimate an area where a track address is determined with no uncertain bit in each of the land area and groove area, which increases the accuracy of track address detection.

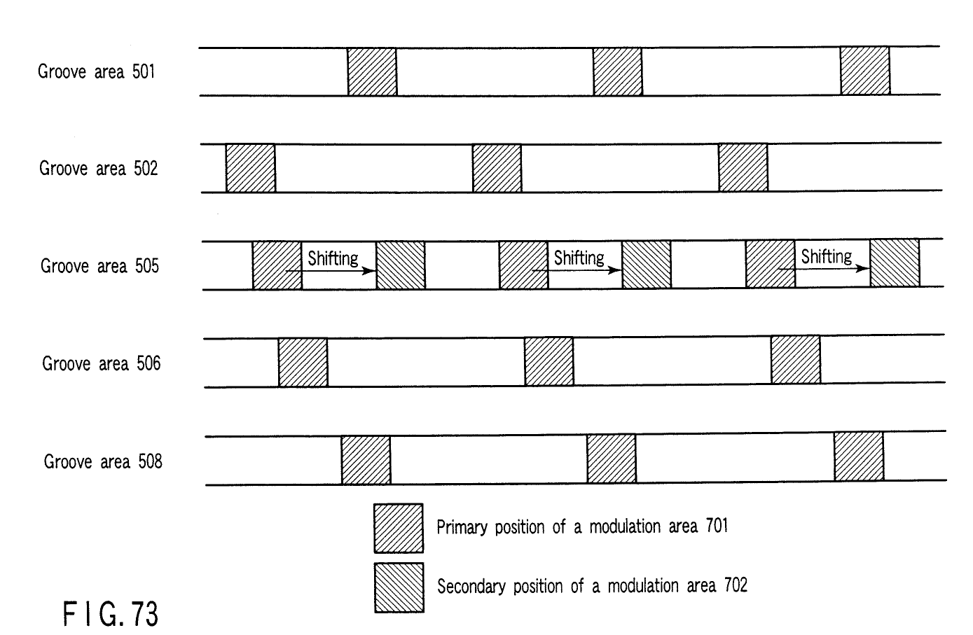

As has been described in FIG. 66, in the recordable information storage medium of the embodiment, recording marks have been formed on the groove area and the CLV recording method has been used. In this case, since the wobble slot position shifts between adjacent tracks, the interference between adjacent wobbles is liable to affect the wobble reproduction signal. This has already been explained. In this embodiment, to eradicate the influence, the modulated areas are shifted from each other so that they may not overlap with each other between adjacent tracks (point (J5) in FIG. 125I). Specifically, as shown in FIG. 73, a primary position 701 and a secondary position 702 are allowed to be set in a place where a modulated area is placed. Basically, all of the recorded areas are allocated temporarily to the primary position. If a part of modulated areas overlap with one another between adjacent tracks, the modulated areas are partially moved to the secondary position. For example, in FIG. 73, if the modulated area of the groove area 505 is set in the primary position, the modulated area of the groove area 502 overlaps partially with the modulated area of the groove 506. Thus, the modulated area of the groove area 505 is moved to the secondary position. This prevents the reproduction signal from the wobble address from interfering between the modulated areas in adjacent tracks, which produces the effect of enabling the wobble address to be reproduced stably.

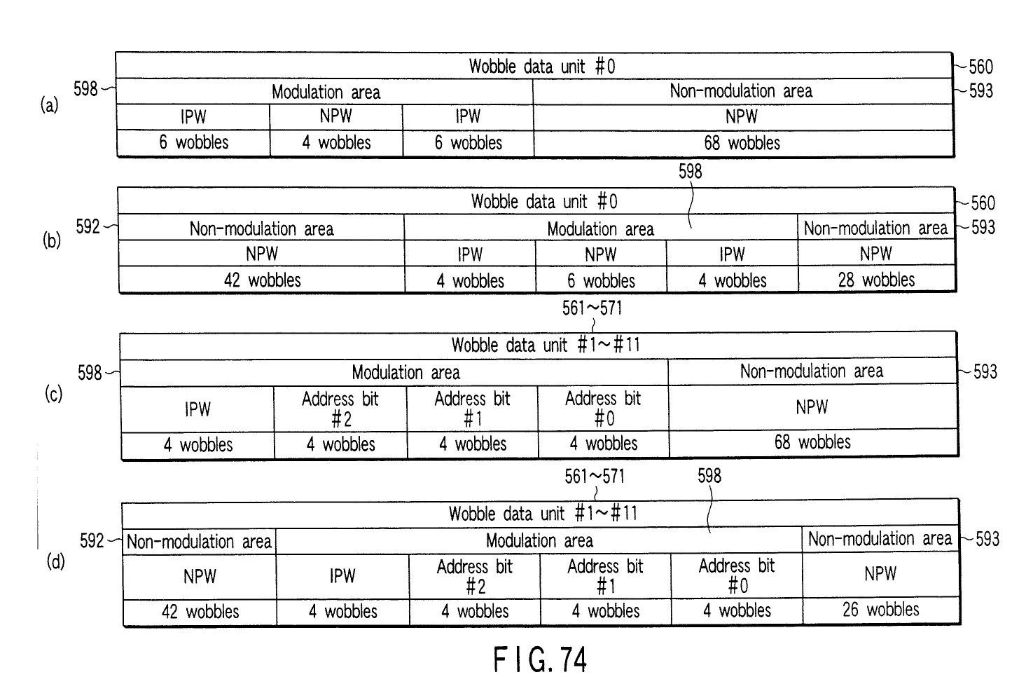

The primary position and secondary position are set in the modulated area by switching between locations in the same wobble data unit. In the embodiment, the occupation ratio of the unmodulated area to the modulated area is set high (point (J2) in FIG. 125G), which makes it possible to switch between the primary position and the secondary position by just changing locations in the same wobble data unit. This enables the same arrangement of physical segments 550 to 557 and of wobble data units 560 to 576 even in the recordable information storage medium as in the rewritable information storage medium shown in the diagrams (b) and (c) of FIG. 69, which improves the interchangeability between different types of information storage media. Specifically, in the primary position 701, a modulated area 598 is placed in the start position of each of the wobble data units 560 to 571 as shown in the diagrams (a) and (c) of FIG. 74. In the secondary position 702, a modulated area 598 is placed in the latter half position of each of the wobble data units 560 to 571 as shown in the diagrams (b) and (d) of FIG. 74.

In the recordable information storage medium of the embodiment, too, the first three address bits in the wobble address information 610 are used for a wobble sync area 580 as in the rewritable information storage medium shown in the diagram (e) of FIG. 69 and are recorded in wobble data unit #0 560 placed at the beginning of each of the physical segments 550 to 556. Modulated areas shown in the diagrams (a) and (b) of FIG. 74 show the wobble sync area 580. The first IPW area in the modulated area 598 in each of the diagrams (c) and (d) of FIG. 74 corresponds to each of the modulation start marks 581, 582, respectively. Address bits #2 to #0 in the modulated area 598 in each of the diagrams (c) and (d) of FIG. 74 correspond to the wobble address areas 586, 587 shown in the diagram (d) of FIG. 69.

This embodiment is characterized in that the wobble sync pattern of the wobble sync area in the primary position is made different from that in the secondary position (point (J5β) in FIG. 125J). In the diagram (a) of FIG. 74, six wobbles (periods) are allocated to IPW as a wobble sync pattern for the wobble sync area 580, or the modulated area 598 and four wobbles (periods) are allocated to NPW, whereas in the modulated area 598 of the diagram (b) of FIG. 74, the number of wobbles (wobble periods) allocated to each IPW is set to four and six wobbles (periods) are allocated to NPW. The wobble signal detecting section 135 of FIG. 1 simply detects the difference between the wobble sync patterns immediately after rough access, enabling the location of the modulated area (either the primary position 701 or secondary position 702) to be known, which makes it easier to estimate the position of a modulated area to be detected next. Since the detection of next modulated area can be prepared in advance, the accuracy of detecting (or determining) a signal in the modulated area can be improved.

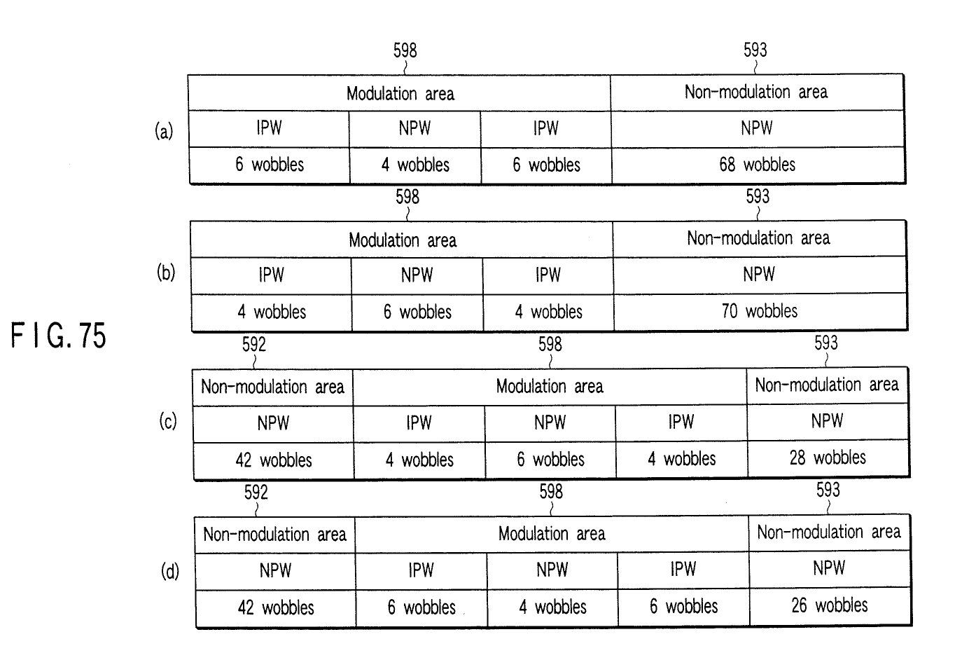

The diagrams (b) and (d) of FIG. 75 show other embodiments other than those shown in the diagrams (a) and (b) of FIG. 74 in connection with the relationship between the locations of modulated areas and a wobble sync pattern. For comparison, the embodiment of the diagram (a) of FIG. 74 is shown in the diagram (a) of FIG. 75 and the embodiment of the diagram (b) of FIG. 74 is shown in the diagram (c) of FIG. 75. In the diagrams (b) and (d) of FIG. 75, the number of wobbles allocated to each of IPW and NPW in a modulated area 598 is the reverse of that in the diagrams (a) and (c) of FIG. 75 (four wobbles are allocated to IPW and six wobbles are allocated to NPW).

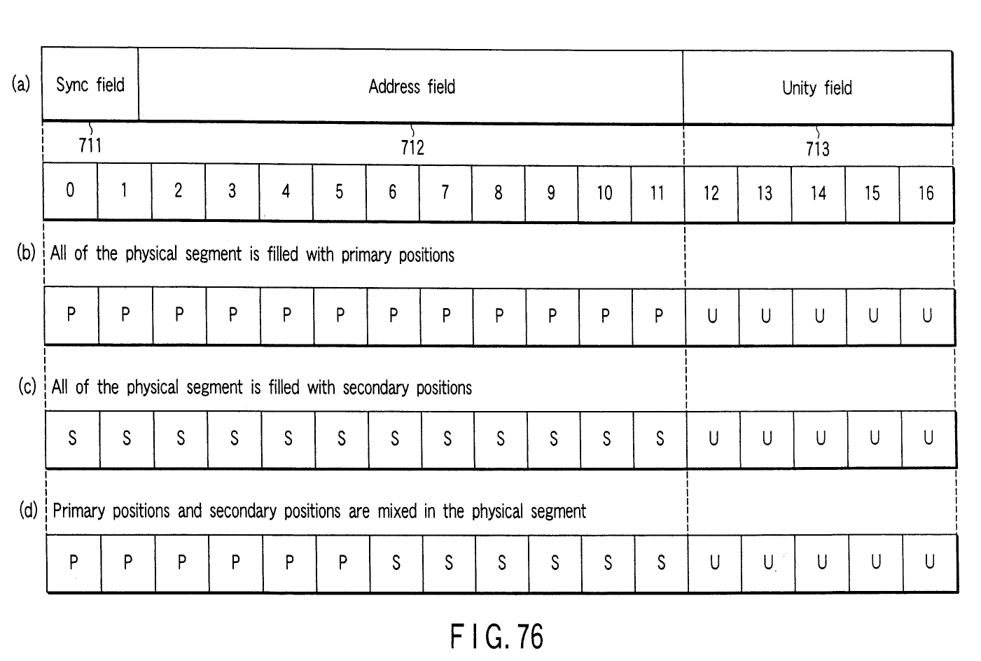

In this embodiment, a range to which each of the primary position 701 and secondary position 702 can be adapted shown in FIGS. 74 and 75, that is, the range either the primary position or the secondary position lasts consecutively is determined to be the range of a physical segment. Specifically, as shown in FIG. 76, three types of (a plurality of) modulated-area arrangement patterns (b) to (d) in the same physical segment are used (point (J5α) in FIG. 125J). As described above, when the wobble signal detecting section 135 of FIG. 1 identifies an arrangement pattern of modulated areas in the physical segment from the wobble sync pattern or the type identifying information 721 in a physical segment explained later, the location of another modulated area 598 in the same physical segment can be estimated in advance. As a result, a preparation for the detection of the next modulated area can be made in advance, which produces the effect of increasing the accuracy of signal detection (determination) in a modulated area.

The second row in FIG. 76 shows the arrangement of wobble data units in a physical segment. Numbers “0” to “16” written in the individual frames represent the wobble data numbers in the same physical segment. The 0^{th} wobble data unit is referred to as sync field 711 as shown in the first row. In a modulated area in the sync field, a wobble sync area exists. The first to eleventh wobble data units are referred to as address field 712. Address information is recorded in a modulated area in the address field 712. In the twelfth to sixteenth wobble data units, all of the wobble patterns are NPW unity fields 713.

The mark “P” written in the diagrams (b) and (d) of FIG. 76 indicates that a modulated area becomes a primary position in a wobble data unit. The mark “S” indicates that a modulated area becomes a secondary position in a wobble data unit. The mark “U” indicates that a wobble data unit is included in the unity field 713 and there is no modulated area. An arrangement pattern of modulated areas shown in the diagram (b) of FIG. 76 indicates that all of the physical segment are primary positions. An arrangement pattern of modulated areas shown in the diagram (b) of FIG. 76 indicates that all of the physical segment becomes primary positions. An arrangement pattern of modulated areas shown in the diagram (c) of FIG. 76 indicates that all of the physical segment becomes secondary positions. In the diagram (d) of FIG. 76, primary positions and secondary positions are mixed in the same physical segment. The modulated areas in the 0^{th} to 5^{th} wobble data units become primary positions and the modulated areas in the 6^{th} to 11^{th} wobble data units become secondary positions. As shown in the diagram (c) of FIG. 76, the half of the area of sync field 711 plus address field 712 is assigned to primary positions and the remaining half is assigned to secondary positions, which prevents modulated areas from overlapping with one another between adjacent tracks.

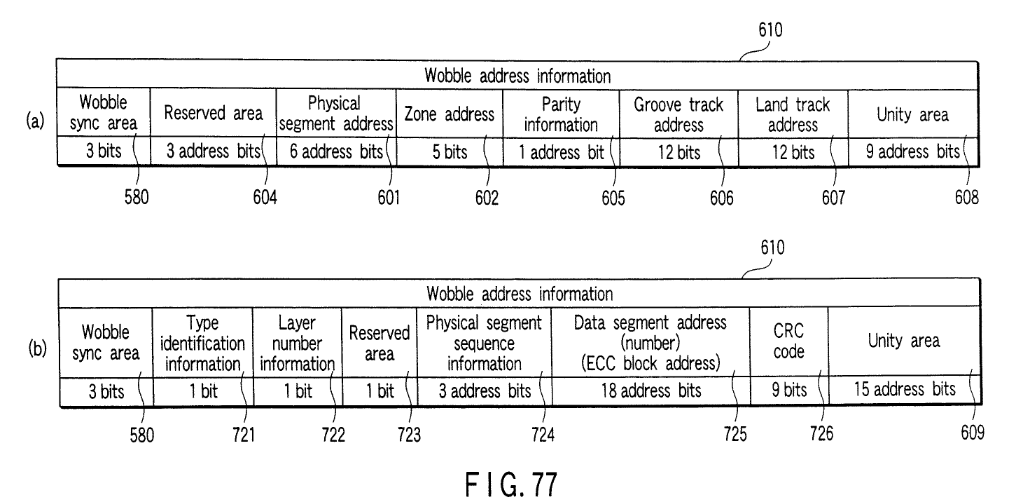

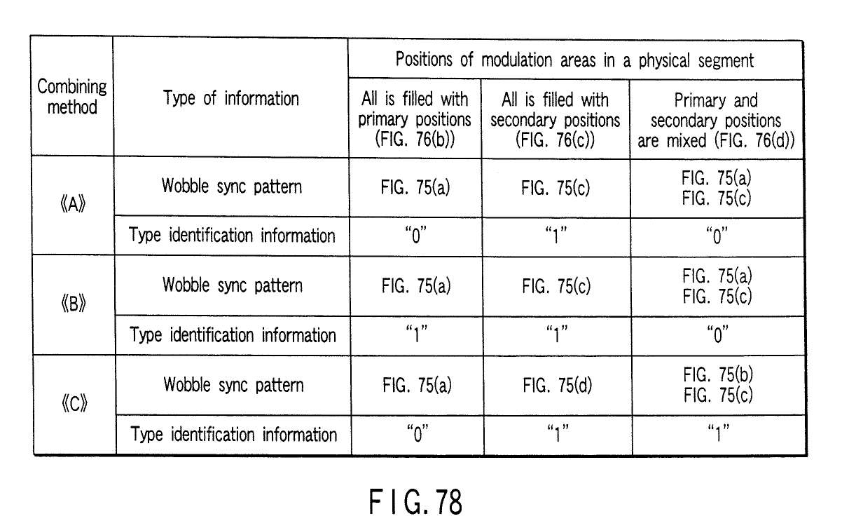

FIG. 77 shows a comparison of a data structure of wobble address information in a rewritable information storage medium and a recordable information storage medium of this embodiment. The diagram (a) of FIG. 77 shows a copy of a data structure of wobble address information 610 in the rewritable information storage medium shown in the diagram (e) of FIG. 69. The diagram (b) of FIG. 77 shows a data structure of wobble address information 610 in the recordable information storage medium. As in the rewritable information storage medium, in the recordable information storage medium, a wobble sync area 680 is placed at the start position of a physical segment (point (J3γ) in FIG. 125H), which facilitates the detection of the start position of the physical segment or the position of the boundary between adjacent physical segments. Type identifying information 721 on the physical segment shown in the diagram (b) of FIG. 77 indicates the location of a modulated area in the physical segment as the wobble sync pattern in the wobble sync area 580 does (point (J5γ) in FIG. 125J), making it possible to estimate the location of another modulated area 598 in the same physical segment in advance and prepare for the detection of a subsequent modulated area, which produces the effect of increasing the accuracy of the detection (determination) of a signal in a modulated area. Specifically, the type identifying information 721 shows the following:
When type identifying information 721 on the physical segment is “0,” this indicates that all of the physical segment shown in the diagram (b) of FIG. 76 is a primary position or that a primary position and a secondary position are mixed as shown in the diagram (d) of FIG. 76.
When type identifying information 721 on the physical segment is “1,” this indicates that all of the physical segment is a secondary position as shown in the diagram (c) of FIG. 76.

As another embodiment related to the above embodiment, the wobble sync pattern may be combined with the type information 721 on the physical segment to indicate the location of a modulated area in the physical segment (point (J5δ) in FIG. 125J). Combining the two types of information makes it possible to represent three or more arrangement patterns of modulated areas shown in the diagrams (b) and (d) of FIG. 76 and provide a plurality of arrangement patters of modulated areas. FIG. 78 shows the relationship between a method of combining a wobble sync pattern and type identifying information on a physical segment and an arrangement pattern of modulated areas in another embodiment. In FIG. 78, <<A>> indicates the above combination. The wobble sync pattern shows either a primary position or a secondary position. The type information 721 on the physical segment shows whether all of the physical segment is a secondary position (when all of the physical segment is a secondary position, it takes the value of “1,” otherwise “0”). In the case of <<A>>, when a primary position and a secondary position are mixed, the wobble sync pattern of the diagram (b) of FIG. 75 is recorded in the primary position and the wobble sync pattern of the diagram (d) of FIG. 75 is recorded in the secondary position.

In contrast, in an embodiment of <<B>>, type identifying information 721 in a physical segment indicates whether all of the locations in the physical segment coincide with one another or are a mixture of a primary position and a secondary position (when all of the locations coincide with one another, it takes the value of “1,” and when they are a mixture it takes the value of “0”).

In an embodiment of <<C>>, a wobble sync pattern indicates whether all of the locations in the physical segment coincide with one another or are a mixture of a primary position and a secondary position (when even a part of the locations are secondary positions, it takes the value of “1,” otherwise “0”).

In the above embodiment, while the location of a modulated area in a physical segment in which a wobble sync area 580 and type identifying information 721 on the physical segment are included is shown, the present invention is not limited to this. For instance, as another embodiment, the wobble sync area 580 and type identifying information 721 on the physical segment may indicate the location of a modulated area in the next subsequent physical segment. This enables the location of a modulated area in the next subsequent segment to be known in advance in doing tracking continuously along the groove area, which produces the effect of enabling a longer preparation time to be secured to detect a modulated area.

Layer number information 722 in the recordable information storage medium shown in the diagram (b) of FIG. 77 indicates either a single-sided single recoding layer or a single-sided double recording layer:
“0” means “L0 layer” (the front layer on the laser light entering side) in either a single-sided single recoding layer or a single-sided double recording layer
“1” means “L1 layer” (the back layer on the laser light entering side) in a single-sided double layer

As explained in FIGS. 66 and 68, physical segment sequence information 724 indicates the order in which physical segments are arranged in the same physical segment blocks. As seen from a comparison with the diagram (a) of FIG. 77, the start position of physical segment sequence information 724 in the wobble address information 610 coincides with the start position of the physical segment address 601 in the rewritable information storage medium. Adapting the position of physical segment sequence information for a rewritable information storage medium (point (J5ε) in FIG. 125J) improves the interchangeability between different types of information storage media, which helps standardize and simplify an address detecting control program using a wobble signal in the information recording and reproducing apparatus compatible with both of a rewritable information storage medium and a recordable information storage medium.

As described in FIGS. 66 and 68, in the data segment address 725, address information on a data segment is written using a number. As has been explained, 32 sectors constitute one ECC block in this embodiment. Therefore, the lower 5 bits of the sector number of the sector placed at the head of a specific ECC block coincides with the sector number of the sector placed at the start position of an adjacent ECC block. When the physical sector number is set so that the lower 5 bits of the physical sector number of the sector put at the head of the ECC block may be “00000,” the values of the 6^{th} and higher bits of all of the sectors in the same ECC block coincide with one another. Therefore, the lower 5 bits of data in the physical sector number of the sector existing in the same ECC block is removed and address information obtained by extracting only data in the 6^{th} and higher bits is used as an ECC block address (or ECC block address number). Since the data segment address 725 (or physical segment block number information) previously recorded by wobble modulation coincides with the ECC block address, position information on a physical segment block in wobble modulation is displayed using a data segment address, reducing the amount of data by 5 bits as compared with use of a physical sector number, which produces the effect of making it easier to detect the present position during access.

CRC code 726 is an CRC code (error correction code) for 24 address bits ranging from type identifying information 721 on a physical segment to data segment address 725. Even if a part of the wobble modulation signal has been deciphered erroneously, it is partially corrected using the CRC code 726.

To write each piece of information, the individual address bits shown in the diagram (b) of FIG. 77 are used. In the recordable information storage medium, the area corresponding to the remaining 15 address bits is allocated to the unity area 609. All of the 12^{th} to 16^{th} wobble data units include NPW (there is no modulated area 598).

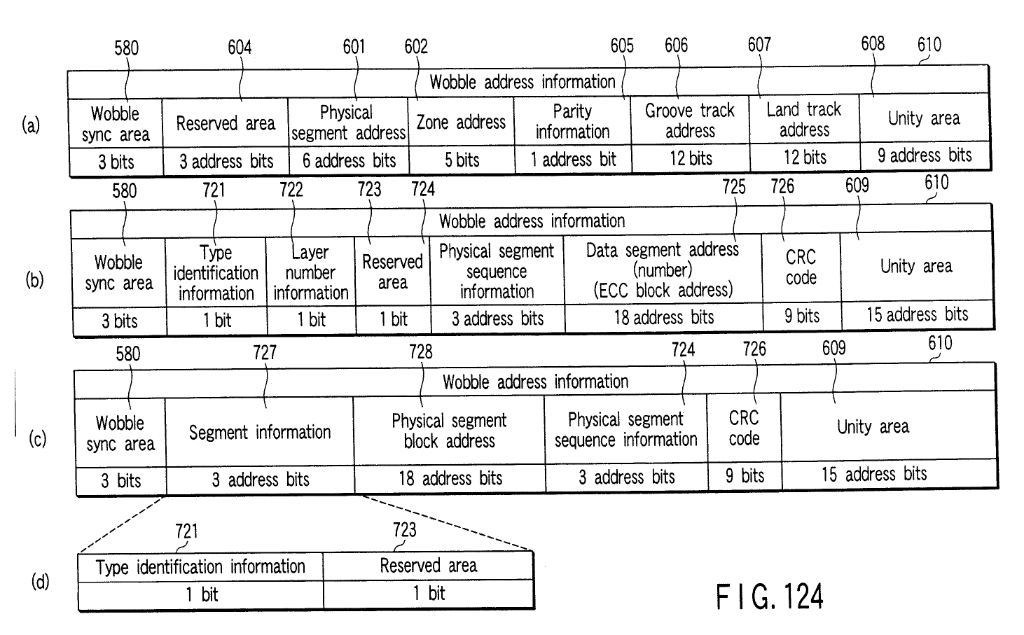

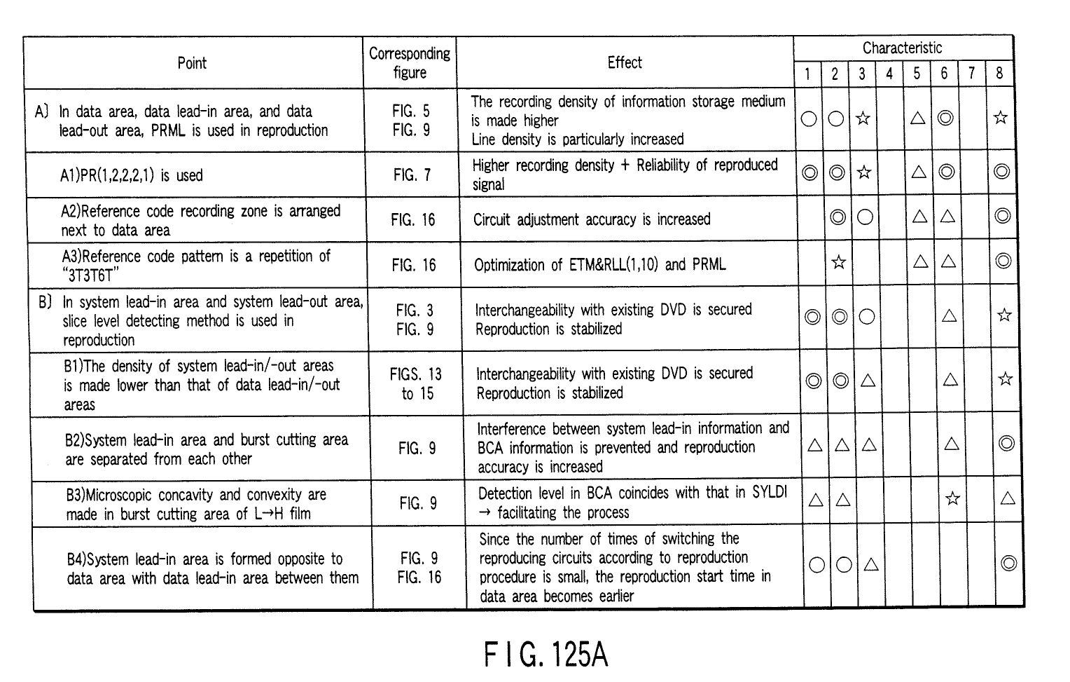

As an application of the embodiment of FIG. 77, the diagrams (c) and (d) of FIG. 124 show another embodiment related to the data structure of a wobble address in the recordable information storage medium. The diagrams (a) and (b) of FIG. 124 are the same as the diagrams (a) and (b) of FIG. 77. A physical segment block address 728 in the diagram (c) of FIG. 124 is an address set for each physical segment block where seven physical segments constitute one unit. The physical segment block address for the first physical segment block in a data lead-in DTLDI is set to “1358h.” The value of the physical segment block address is incremented by one from the first physical segment block in the data lead-in area DTLDI to the last physical segment block in the data lead-out DTLDO including a data area DTA.

Physical segment sequence information 724 indicates the sequence of individual physical segments in one physical segment block as in FIG. 77. “0” is set to the first physical segment and “6” is set to the last physical segment.

The embodiment of FIG. 77 is characterized in that a physical segment block address is placed ahead of the physical segment sequence information 724 (point (J6) in FIG. 125J). For example, as in RMD field 1 shown in FIGS. 123A and 123B, address information is frequently managed in the physical segment block address. When a specific physical segment block address is accessed using these pieces of management information, the wobble signal detecting section 135 of FIG. 1 detects the place of the wobble sync area 580 shown in the diagram (c) of FIG. 124 and then decrypts sequentially the information recorded just behind the wobble sync area 580. When there is a physical segment block address ahead of the physical segment sequence information 724, the wobble signal detecting section 135 first decrypts the physical segment block address. Since the wobble signal detecting section 135 can determine whether the physical segment block address is a specific one, this produces the effect of improving the accessibility using wobble address.

Segment information 727 is composed of type identifying information 721 and a reserved area 723. Type identifying information 721 indicates the location of a modulated area in a physical segment. When the value of type identifying information 721 is “0b”, this indicates a state shown in the diagram (a) of FIG. 76. When the value of type identifying information 721 is “1b”, this indicates a state shown in the diagrams (b) and (c) of FIG. 76.

The present embodiment is characterized in that type identifying information 721 is placed just behind a wobble sync area 580 in FIG. 124 or the diagram (b) of FIG. 77 (point (J5ζ) in FIG. 125J). As described above, the wobble signal detecting section 135 of FIG. 1 detects the position of the wobble sync area 580 shown in the diagram (c) of FIG. 124 and then decrypts sequentially the information recorded just behind the wobble sync area 580. Thus, placing type identifying information 721 just behind the wobble sync area 580 makes it possible to check the location of the modulated area in the physical segment immediately, which enables an accessing process using wobble addresses to be carried out at higher speed.

A method of recording the data segment data into a physical segment or physical segment block into which address information has been recorded beforehand by wobble modulation will be explained. In both of a rewritable information storage medium and a recordable information storage medium, data is recorded using recording clusters as units in continuous data recording. FIG. 79 shows a layout of the recoding cluster. In the recording cluster 540, one or more (an integral number of) data segments 531 having the data structure shown in the diagram (a) of FIG. 69 succeed one after another consecutively. Extended guard fields 528, 529 are set at the beginning or at the end of the succession. To prevent a gap from appearing between adjacent recoding clusters when new data is additionally recorded using recording clusters 540, 542, extended guard fields 528, 529 are set in the recording clusters 540, 542 so as to overlap physically with adjacent recoding clusters for partially redundant writing to prevent a gap from occurring between the adjacent recording clusters in rewriting.

In an embodiment shown in the diagram (a) of FIG. 79, as for the positions of the extended guard fields 528, 529 set in the recording clusters 540, 542, the extended guard field 528 is placed at the end of the recording cluster 540 (point (K3γ) in FIG. 125L). When this method is used, the extended guard field 528 is located behind the postamble 526 shown in the diagram (a) of FIG. 69. Therefore, particularly in the rewritable information storage medium, the postamble area 526 is not destroyed erroneously in rewriting, enabling the postamble area 526 to be protected in rewriting, which helps secure the reliability of the detection of positions using the postamble area 526 in data reproduction.

As another embodiment, the extended guard field 529 may be placed at the beginning of the recording cluster 542 as shown in the diagram (b) of FIG. 79 (point (K3δ) in FIG. 125L). In this case, as seen from a combination of the diagram (b) of FIG. 79 and the diagram (a) of FIG. 69, the extended guard field 529 is located just in front of the VFO area 522. Therefore, when rewriting or additional recording is done, the VFO area 522 can be made sufficiently long, making it possible to lengthen the PLL pull-in time in connection with a reference clock in reproducing the data field 525, which helps improve the reliability of reproduction of the data recorded in the data field 525. As described above, a recording cluster serving as a unit of rewriting is configured to be composed of one or more data segments (point (K3α) in FIG. 125K), which produces the effect of making it easier to record PC data (PC files) frequently rewritten in small amounts and AV data (AV files) recorded continuously at a time in large amounts onto the same information storage medium in a mixed manner. That is, in a personal computer (PC), a relatively small amount of data is frequently rewritten. Therefore, when rewriting or additional recording data unit is set as small as possible, the recording method becomes suitable for PC data. As shown in FIG. 31, in the embodiment, since an ECC block is composed of 32 physical sectors, a data segment including only one ECC block is the smallest unit in doing rewriting or additional recording efficiently. Therefore, the structure of the embodiment where one or more data segments are included in a recoding cluster serving as a unit of rewriting or additional recording is a recording structure suitable for PC data (PC files).

As for audio video AV data, a very large amount of video information and audio information has to be recorded continuously without interruption. In this case, continuously recorded data is organized into one recording cluster, which is then recorded. In AV data recording, when the amount of random shift, the structure of a data segment, the attribute of a data segment, and the like are changed for each of the data segments constituting a recording cluster, the changing process takes a long time, which makes a continuous recording process difficult. In this embodiment, as shown in FIG. 79, a recording cluster is configured by arranging consecutively data segments in the same format (without the change of the attributes and the amount of random shift and without the insertion of specific information between data segments), making it possible not only to provide a recording format suitable for AV data recording that requires a large amount of data to be recorded continuously but also simplify the structure of a recording cluster, which achieves the simplification of the recording control circuit and reproduction detecting circuit and lowers the cost of the information recording and reproducing apparatus or information reproducing apparatus.

The data structure where data segments (excluding extended guard fields 528) in the recording cluster 540 shown in FIG. 79 is the same as that of the read-only information storage medium shown in the diagram (b) of FIG. 61 and of the recordable information storage medium shown in the diagram (c) of FIG. 61. As described above, since the data structure is common to all of the information storage media, regardless of whether the medium is of the read-only type, recordable type, or rewritable type, the interchangeability between various information storage media is secured and the detecting circuit is shared by an information recording and reproducing apparatus and an information reproducing apparatus which assure interchangeability. As a result, not only can a high reproduction reliability be secured, but the cost of the information recording and reproducing apparatus or information reproducing apparatus can also be lowered.

When the structure of FIG. 79 is used, it is inevitable that the amounts of random shift of all of the data segments in the same recording cluster coincide with one another (point (K3β) in FIG. 125K). As described later, in the rewritable information storage medium, recording clusters are recorded by making a random shift. In this embodiment, since the amounts of random shift of all of the data segments coincide with one another in the same recording cluster 540, when data is reproduced over different data segments in the same recording cluster 504, synchronization (phase resetting) is not needed in the VFO area (522 in FIG. 69), which makes it possible to simplify the reproduction detecting circuit in continuous reproduction and secure a high reliability of reproduction detection.

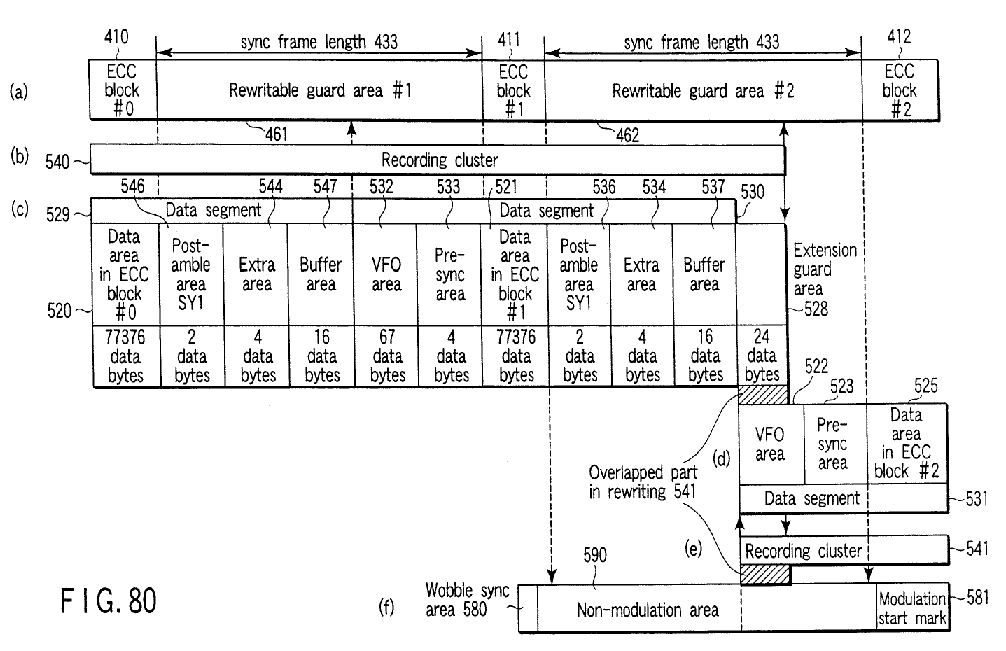

FIG. 80 shows a method of recording rewritable data onto a rewritable information storage medium. Using the diagram (a) of FIG. 79, an example of the layout of a recording cluster in a rewritable information storage medium of the embodiment will be explained. The present invention is not limited to this. For instance, a layout shown in the diagram (b) of FIG. 79 may be used for the rewritable information storage medium. The diagram (a) of FIG. 80 shows the same contents as those of the diagram (d) of FIG. 61. In the embodiment, rewritable data is rewritten in recording clusters 540, 541 shown in the diagrams (b) and (e) of FIG. 80. One recording cluster is composed of one or more data segments 529 to 531 and an extended guard field 528 as described later. Specifically, the start of one recording cluster 531 coincides with the starting position of the data segment 531 and starts at the VFO area 522.

When a plurality of data segments 529, 530 are recorded consecutively, a plurality of data segments 529, 530 are arranged consecutively in the same recording cluster 531 as shown in the diagrams (b) and (c) of FIG. 80. Since the buffer area 547 existing at the end of the data segment 529 is connected consecutively to the VFO area 532 existing at the beginning of the next data segment, the phases (of the recording reference clock) in both areas coincide with each other. After the continuous recoding is completed, an extended guard area 528 is placed at the end position of the recording cluster 540. The data size of the extended guard area 528 is a 24-data-byte size in unmodulated data.

As seen from a comparison between the diagram (a) of FIG. 80 and the diagram (c) of FIG. 80, the rewritable guard areas 461, 462 include postamble areas 546, 536, extra areas 544, 534, buffer areas 547, 437, VFO areas 532, 522, and pre-sync areas 533, 523, respectively. Only in a continuous recording end place, an extended guard field 528 is provided.

To compare physical ranges of rewriting units, the diagram (c) of FIG. 80 shows a part of the recording cluster 540 serving as a unit of information rewriting and the diagram (d) of FIG. 80 shows a part of the recording cluster 541 serving as a unit of next rewriting. This embodiment is characterized in that rewriting is done so that the extended guard area 523 and the following VFO 522 may partially overlap with each other at the overlap 541 in rewriting (point (K3) in FIG. 125K). As described above, rewriting with partial overlapping prevents a gap (an area where no recording mark is formed) from occurring between the recording clusters 540, 541 and interlayer crosstalk on the information storage medium enabling data to be recorded on a single-sided double recording layer is removed, which makes it possible to detect a stable reproduction signal.

As seen from the diagram (a) of FIG. 69, the size of rewritable data in one data segment in the embodiment is:

$$67 + 4 + 77376 + 2 + 4 + 16 = 77469 data bytes \qquad ( EQ . 2 )$$

In addition, as seen from the diagrams (c) and (d) of FIG. 69, one wobble data unit 560 is composed of:
6+4+6+68=84 wobbles (EQ. 3)

Since 17 wobble data units constitute one physical segment 550 and the length of seven physical segments 550 to 556 coincides with the length of one data segment 531, the length of one data segment 531 includes:
84×17×7=99o6 wobbles (EQ. 4)

Therefore, from equation (EQ. 2) and equation (EQ. 4), the following corresponds to one wobble:
77496÷9996=7.75 data bytes/wobble (EQ. 5)

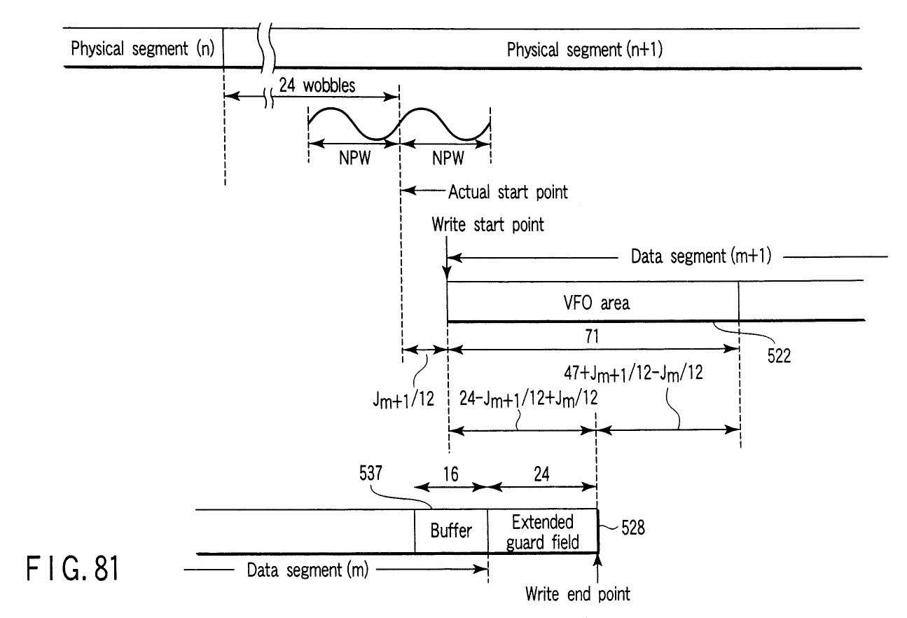

As shown in FIG. 81, the part where the next VFO area 522 and the extended guard field 528 overlap with each other lies 24 wobbles or more from the start position of a physical segment. As seen from the diagram (d) of FIG. 69, 16 wobbles from the head of a physical segment 550 constitute a wobble sync area 580 and the following 68 wobbles constitute an unmodulated area 590. Therefore, the part where the next VFO area 522 and the extended guard field 528 overlap with each other from 24 wobbles or more from the head of the physical segment 550 is in the unmodulated area 590. As described above, locating the start position of the data segment 24 wobbles or more from the start position of the physical segment (point (K5) in FIG. 125L) not only causes the overlapping place to lie in the unmodulated area 590 but also secures the detection time for a wobble sync area 580 and the preparation time for a recording process suitably, which assures a stable, high-accuracy recording process.

In the embodiment, the recording film of the rewritable information storage medium uses a phase-change recording film. In a phase-change recording film, since the recording film begins to deteriorate near the rewrite starting and end positions, repeating the recording start and end in the same position limits the number of rewrites due to the deterioration of the recording film. In the embodiment, to alleviate this problem, a shift of (Jₘ₊₁/12) data bytes is made in rewriting as shown in FIG. 81, thereby shifting the recording start position at random.

In the diagrams (c) and (d) of FIG. 80, to explain the basic concept, the start position of the extended guard field 528 coincides with the start position of the VFO area 522. Strictly speaking, however, the start position of the VFO area 522 is shifted at random as shown in FIG. 81 in the embodiment.

A DVD-RAM disk, an existing rewritable information storage medium, also uses a phase-change recording film and shifts the recording start and end positions at random to increase the number of rewrites. The maximum amount of shift in making a random shift on an existing DVD-RAM disk is set to eight data bytes. The channel bit length (of modulated data recorded on the disk) in an existing DVD-RAM disk is set to 0.143 μm on average. In the rewritable information storage medium of the embodiment, from FIG. 15, the average length of a channel bit is:
(0.087+0.093)÷2=0.090 μm (EQ. 6)

When the length of the physical shift range is adapted to the existing DVD-RAM disk, the required minimum length as the random shift range in the embodiment is calculated using the above value as follows:

$$8 bytes \times ( 0.143 μm \div 0.090 μm ) = 12.7 byte \qquad ( EQ . 7 )$$

In the embodiment, to facilitate the reproduction signal detecting process, the unit of the amount of random shift is adapted to a “channel bit” after modulation. In the embodiment, since ETM modulation (Eight to Twelve modulation) that converts 8 bits into 12 bits is used, the amount of random shift is expressed using a mathematical formula with a date byte as a reference:
Jₘ/12 data bytes (EQ. 8)

It follows from equation (7) that:
12.7×12=152.4 (EQ. 9)

Therefore, the values Jₘ can take are from 0 to 152. For the above reasons, in the range satisfying equation (EQ. 9), the length of the random shift range agrees with the existing DVD-RAM disk, which assures the same number of rewrites as that of the existing DVD-RAM disk. In the embodiment, to secure the number of rewrites larger than that of the existing DVD-RAM disk, a small margin is allowed for the value of equation (EQ. 7) as follows:
The length of the random shift range is set to 14 data bytes (EQ. 10)

Substituting the value of equation (EQ. 10) into equation (EQ. 8) gives 14×12=168. Therefore, it follows that:
The values Jₘ can take are from 0 to 167 (EQ. 11)

As described above, the amount of random shift is set to a larger range than Jₘ/12 (0≦Jₘ≦154) (point (K4) in FIG. 125L), thereby satisfying equation (EQ. 9) and causing the length of the physical range for the amount of random shift to agree with the existing DVD-RAM, which produces the effect of assuring the same number of repeated recordings as that of the existing DVD-RAM.

In FIG. 80, the length of the buffer area 547 and that of the VFO area 532 are constant in the recording cluster 540. As seen from the diagram (a) of FIG. 79, the amount Jₘ of random shift of each of the data segments 529, 530 has the same value throughout the same recording cluster 540. When a recording cluster 540 including many data segments is recorded consecutively, the recording positions are monitored using wobbles. Specifically, the position of the wobble sync area 580 shown in FIG. 69 is detected and the number of wobbles in the unmodulated areas 590, 591 are counted, thereby checking the recording positions on the information storage medium and recording data at the same time. At this time, there may be rare occasions when a wobble slip (recording done in a position shifted by one wobble period) will occur due to the miscounting of wobbles or uneven rotation of the rotating motor (e.g., motor of FIG. 1) that rotates the information storage medium and therefore the recording position will shift on the information storage medium. The information storage medium of the embodiment is characterized in that, if a shift in the recoding position has been detected, adjustment is made in a rewritable guard area 461 of FIG. 80 or in a recordable guard area 452 of FIG. 61, thereby correcting the recording timing (point (K3) in FIG. 125K). In FIG. 80, important information that permits neither the omission of bits nor the redundancy of bits is recorded in the postamble area 546, extra area 544, and pre-sync area 533. However, in the buffer area 547 and VFO area 532, a specific pattern is repeated. Therefore, the omission and redundancy of only one pattern are permitted, as long as the repeated boundary positions are secured. Therefore, in the guard area 461, particularly in the buffer area 547 or VFO area 532, adjustment is made to correct the recording timing.

In this embodiment, as shown in FIG. 81, the actual start point position serving as a reference of position setting is set so as to coincide with the position of the wobble amplitude “0” (the center of wobble). However, since the wobble position detecting accuracy is low, this embodiment, as written as “±1 max” in FIG. 81, permits the actual start point position to have up to
a shift of ±1 data byte (EQ. 12)

In FIGS. 80 and 81, the amount of random shift in the data segment 530 is set to Jₘ (as described above, the amount of random shift is the same in all of the data segments 59 in the recording cluster 540). Thereafter, the amount of random shift in a data segment 531 in which additional recording is done is set to Jₘ₊₁. A value Jₘ in (EQ. 11) and Jₘ₊₁ can take is, for example, the intermediate value: Jₘ=Jₘ₊₁=84. When the position accuracy of the actual start point is sufficiently high, the starting position of the extended guard field 528 coincides with the starting position of the VFO area 522 as shown in FIG. 80.

In contrast, when a data segment 530 is recorded in the rearmost position and a data segment 531 to be rewritten or additionally recorded later is recorded in the very front position, the start position of the VFO area 522 may go into the buffer area 537 by up to 15 data bytes because of (10) and (12). In the extra area 534 just in front of the buffer area 537, specific important information has been recorded. Therefore, in the embodiment, the following must be met:
the length of the buffer area 537 has to be 15 data bytes or more (13)

If a gap occurs between the extended guard area 528 and the VFO area 522 as a result of a random shift, when a single-sided double-recording-layer structure is used, interlayer crosstalk is caused by the gap during reproduction. To overcome this problem, the extended guard field 528 and VFO area 522 are caused to always partially overlap with each other even when a random shift is made, thereby preventing a gap from occurring (point (K3) in FIG. 125K). Therefore, in the embodiment, from (EQ. 13), the length of the extended guard field 528 must be set to 15 data bytes or more. Since a subsequent VFO 522 is made as long as 71 data bytes, even if the overlapping area of the extended guard field 528 and VFO area 522 becomes a little wider, this has no adverse effect in reproducing a signal (because the time required to synchronize the reproduction reference clock in the unoverlapped VFO area 522 is secured sufficiently). Therefore, the extended guard field 528 can be set to a larger value than 15 data bytes. As explained above, there may be rare occasions when a wobble slip will occur in continuous recording and the recording position will shift by one wobble period. As seen from equation (EQ. 5), a wobble period corresponds to 7.75 (about 8) data bytes. Thus, taking this into account, (EQ. 13) is modified as follows in the embodiment:
The length of the extended guard field 528 is set to (15+8)=23 data bytes or more (EQ. 14)

In the embodiment of FIG. 80, a margin of one data byte is given as in the buffer area 537 and the length of the extended guard field 528 is set to 24 data bytes.

In the diagram (e) of FIG. 80, the recording start position of the recording cluster 541 has to be set accurately. The information recording and reproducing apparatus of the embodiment detects the recording start position by using the wobble signal previously recorded on a rewritable or a recordable information storage medium. As seen from the diagram (d) of FIG. 69, all of the areas excluding the wobble sync area 580 are changed in pattern from NPW to IPW in units of 4 wobbles. In contrast, in the wobble sync area 580, since the wobble switching unit partially shifts from 4 wobbles, the wobble sync area 580 is easiest to detect. Therefore, the information recording and reproducing apparatus of the embodiment detects the position of the wobble sync area 580 and then prepares for a recording process and starts recording. Thus, the starting position of the recording cluster must lie in the unmodulated area 590 just behind the wobble sync area 580. FIG. 81 shows its contents. A wobble sync area 580 is provided immediately after the switching of physical segments. As shown in the diagram (d) of FIG. 69, the length of the wobble sync area 580 is equivalent to 16 wobble periods. After the wobble sync area 580 is detected, 8 wobble periods are needed, allowing a margin for preparation for a recording process. As shown in FIG. 81, the start position of the VFO area 522 existing at the start position of the recording cluster 541 has to be placed 24 wobbles or more behind a physical segment switching position, even taking random shift into account.

As shown in FIG. 80, a recording process is carried out many times in an overlapping place 541 in rewriting. When rewriting is repeated, the physical shape of a wobble groove or a wobble land changes (or deteriorates), resulting in a decrease in the quality of the wobble reproduction signal. In the embodiment, as shown in the diagram (f) of FIG. 80 or the diagrams (a) and (d) of FIG. 69, an overlapping place 541 is prevented from lying in the wobble sync area 580 or wobble address area 586 in rewriting or additional recording and then is recorded in the unmodulated area 590 (point (K3ζ) in FIG. 125L). Since a specific wobble pattern (NPW) is just repeated in the unmodulated area 590, even if the quality of the wobble reproduction signal has partially deteriorated, the signal can be supplemented with the preceding and following wobble reproduction signals. As described above, setting is done so that the position of the overlapping place 541 may lie in the unmodulated area 590 in rewriting or additional recording, making it possible to prevent the quality of the wobble reproduction signal from deteriorating due to the deterioration of the shape in the wobble sync area 580 or wobble address area 586, which produces the effect of assuring a stable wobble detection signal from the wobble address information 610.

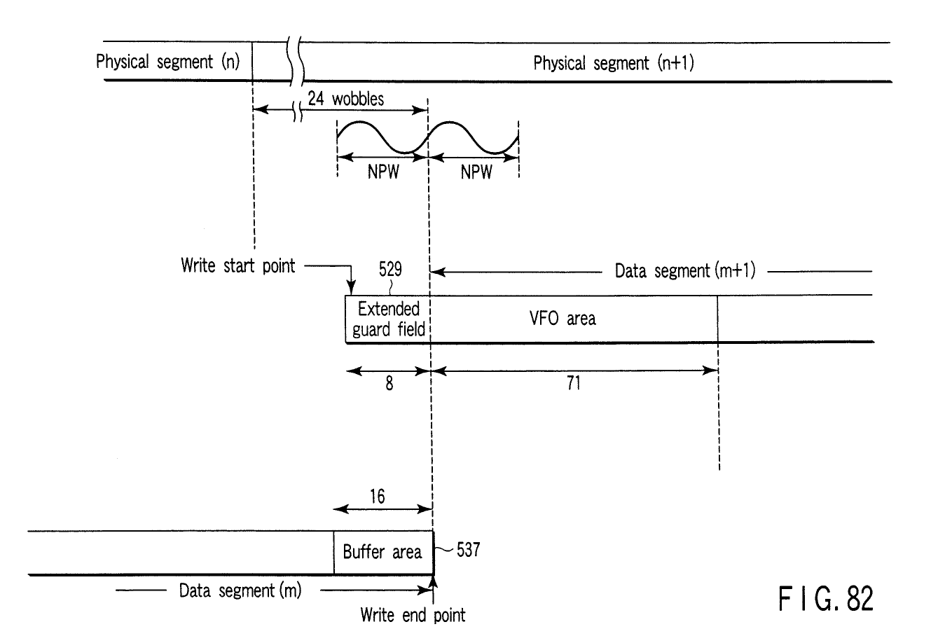

FIG. 82 shows an embodiment of recording additional data onto a recordable information storage medium. While in the embodiment, a method of the diagram (b) of FIG. 79 is used for the layout of a recording cluster in the recordable information storage medium, this invention is not limited to this. For instance, a method of the diagram (a) of FIG. 79 may be used. Since recording is done only once on a recordable information storage medium, the above-described random shift is not needed. In a recordable information storage medium, too, as shown in FIG. 81, setting is done so that the start position of a data segment may lie 24 wobbles or more from the start position of a physical segment (point (K5) in FIG. 125L). An overlapping place lies in the unmodulated are of a wobble.

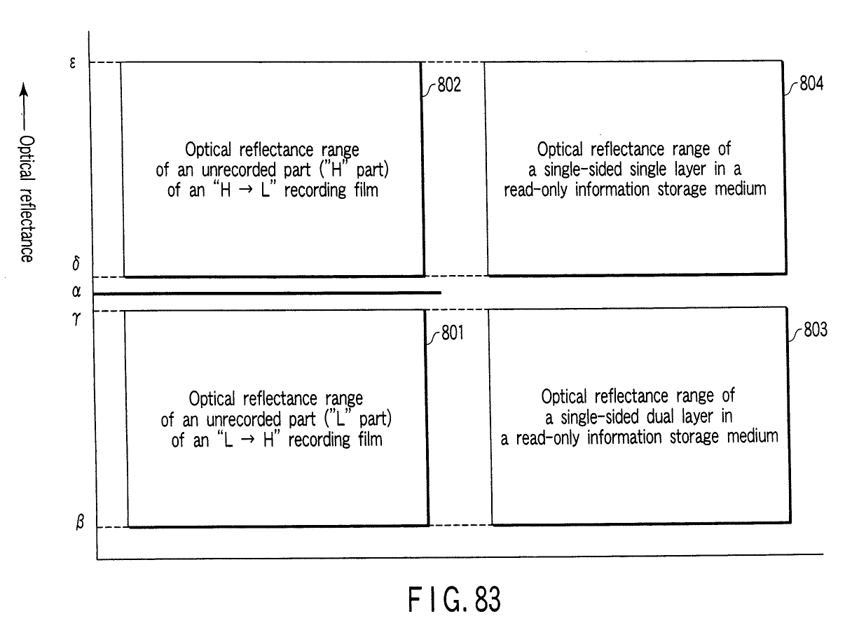

As has been explained in “recording mark polarity” (identifying either High-to-Low or Low-to-High) information” at the 192^{nd} byte, use of both of a High-to-Low recording film and a Low-to-High recording film is permitted in the embodiment. FIG. 83 shows the reflectivity ranges of a High-to-Low recording film and a Low-to-High recording film determined in the embodiment. This embodiment is characterized in that the lower limit of reflectivity at an unrecorded part of the High-to-Low recording film is set higher than the upper limit of reflectivity at an unrecorded part of the Low-to-High recording film (point [M] in FIG. 125R). When the information storage medium is installed in the information recording and reproducing apparatus or information reproducing apparatus, the slice level detecting section 132 or PR equalizing circuit 130 of FIG. 1 can measure the reflectivity of an unrecorded part and determine whether the film is a High-to-Low recording film or a Low-to-High recording film, which makes it very easy to determine the type of recording film. As a result of forming and measuring High-to-Low recording films and Low-to-High recording films by changing many manufacturing conditions, it was found that, when the reflectivity α between the lower limit of reflectivity at an unrecorded part of the High-to-Low recording film and the upper limit of reflectivity at an unrecorded part of the Low-to-High recording film was set to 36% (point (M1) in FIG. 125R), the productivity of the recording film was high and the cost of the recording medium was easy to reduce. When the reflectivity range 801 of an unrecorded part (“L” part) of the Low-to-High recording film is caused to coincide with the reflectivity range 802 of the single-sided double layer of a read-only information storage medium (point (M3) in FIG. 125R) and the reflectivity range 802 of an unrecorded part (“H” part) of the High-to-Low recording film is caused to coincide with the reflectivity range 804 of the single-sided single layer of a read-only information storage medium (point (M2) in FIG. 125R), the interchangeability with the read-only information storage medium and a recordable information storage medium is good and the reproducing circuit of a reproduction-only apparatus and that of an information recording and reproducing apparatus can be shared, which enables the information reproducing apparatus to be produced at low cost. As a result of forming and measuring High-to-Low recording films and Low-to-High recording films by changing many manufacturing conditions, to increase the productivity of the recording film and make it easier to reduce the cost of the recording medium, the lower limit β of the reflectivity of an unrecorded part (“L” part) of the Low-to-High recording film was set to 18%, its upper limit γ was set to 32%, the lower limit δ of the reflectivity of an unrecorded part (“H” part) of the High-to-Low recording film was set to 40%, and its upper limit ε was set to 70% in this embodiment.

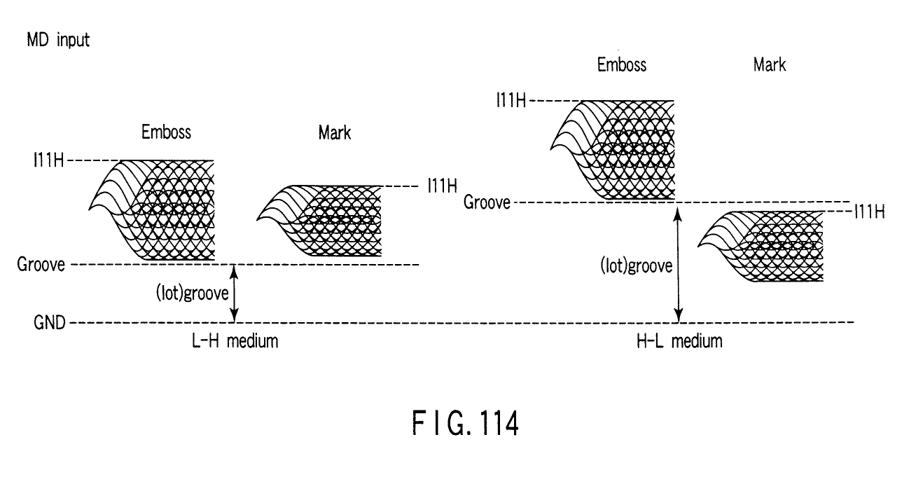

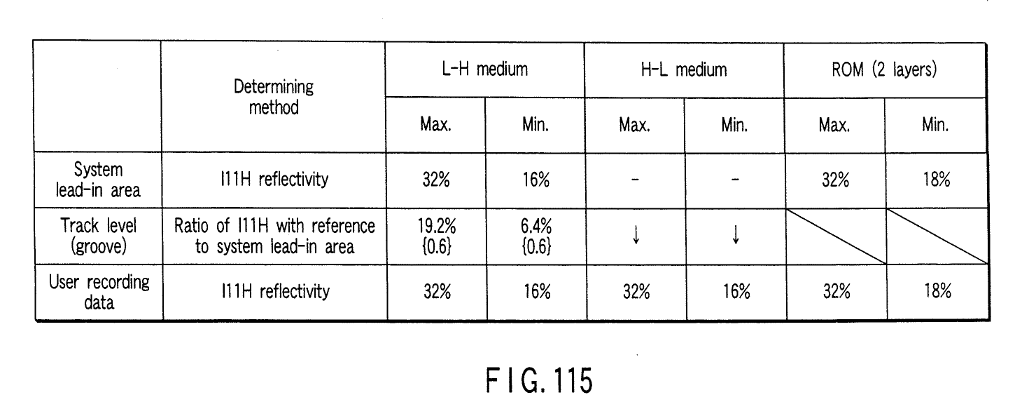

FIGS. 114 and 115 show the reflectivity of each of an unrecorded portion and a recorded portion on various types of recording films in the embodiment. When the reflectivity range at an unrecorded portion is determined as shown in FIG. 83, a signal appears in the same direction in emboss areas (including system lead-in SYLDI) and in recording mark areas (data lead-in/-out DTLDI, DTLDO and data area DTA) in the Low-to-High recording film, with the groove level as a reference. Similarly, a signal appears in the opposite direction in emboss areas (including system lead-in SYLDI) and in recording mark areas (data lead-in/-out DTLDI, DTLDO and data area DTA) in the High-to-Low recording film, with the groove level as a reference. Use of this phenomenon not only helps identify whether the recording film is a Low-to-High recording film or a High-to-Low recording film but also makes it easier to design a detecting circuit compatible with both of a Low-to-High recording film and a High-to-Low recording film.

The operational advantages shown in the above embodiments are put in order as follows.

FIGS. 125A to 125R list in order points of the above embodiments, effects of the points, and advantages of a combination of points. A contribution of each point to advantages 1 to 8 is marked with symbol ⋆, ⊚, ◯, or Δ in descending order of a degree of contribution. Advantages of a combination of points are generally stated as follows.

Advantage 1. Determining the Optimum Recording Condition:

After a burst cutting area BCA is detected stably, it is determined from the value of the rim intensity stably read in slice level detection whether recommended recording condition information can be used. If it has been determined that the condition information cannot be used, the drive test zone requires recording conditions to be determined carefully. Therefore, the extension of the test zone and the management of its position are needed.

Points contributing this effect are (E2), (G3); (A1), [B], (B1), (E3), (E4), (E6), [G], (G2); [A], (B4), (G1), (G1α); (B2), (B3), [E], (E1) in that order. Specifically, points with a high degree of contribution are (E2) enabling the extension of a drive test zone (FIGS. 18A and 18B) makes it possible to increase the number of times of test recording and improve the recording accuracy and (G3) placing optical system condition information at the starting position of recording conditions (FIGS. 23A and 23B) makes it possible to determine at high speed whether recording conditions placed just behind the optical system condition information are adaptable.

Advantage 2. Reproducing Circuit Setting Method:

After a burst cutting area BCA is detected stably, identifying information on High-to-Low or Low-to-High stably read in slice level detection is read at high speed and the optimum circuit adjustment is made to PR(1, 2, 2, 2, 1), making use of reference codes.

Points contributing this effect are (A3), (G2); (A1), (A2), [B], (B1), [G]; [A], (B4); (B2), (B3) in that order. Specifically, points with a high degree of contribution are (A3) a reference code pattern repeats “3 T3 T6 T” (FIG. 16), thereby optimizing ETM & RLL(1, 10) and PRML and (G2) having recording mark polarity information in physical format information or R physical format information (FIGS. 23A and 23B) permits both of a High to Low recording film and a Low to High recording film, expanding the selection range of recording films, which helps achieve high-speed recording and cost reduction.

Advantage 3. Securing High Reliability of Reproduction of User Recording Information:

After a burst cutting area BCA is detected stably, system lead-in information is reproduced in slice level detection and then user recording information is reproduced by the PRML method. The reliability of recoding information is secured by the process of replacing a defective place. Servo in reproduction is stabilized.

Points contributing this effect are [A], (A1), [H], (H1), (H2), (H3), (H4), (H5); (C3α), (C3β), (C6), (C7), (G2), [I], (J1), [K], (L10), (L10β), (L11); (A2), [B], (G1), (K1), (K2), (K3), (K3), (L3), (L6α), (L7), (L10α); (B1), (B2), (B4), (C3), (C4α), (C8α), [F], (K3α), (K3β), (K3γ), (K3δ), (K3ε), (K3ζ), (K4), (K5), (L1), (L1α), (L1β), (L2), (L11α), [M], (M1), (M2), (M3), [N], (N1), (N1α), (N2), (N3), (N4). Specifically, points with a high degree of contribution are [A] use of PRML for reproduction in the data area, data lead-in area, and data lead-out area (FIGS. 5 and 9) increases the recording density of an information storage medium and particularly improves the linear density, (A1) making use of PR(1, 2, 2, 2, 1) (FIG. 7) increases the recording density and improves the reliability of reproduction signals, [H] distributing a plurality of small ECC blocks in the same data frame (FIG. 35) improves the error correcting capability and therefore the reliability of recorded data, (H1) the same physical sectors are caused to belong to two small ECC blocks alternately (FIGS. 35 and 37), realizing a structure resistant to burst errors, (H2) one ECC block is composed of 32 physical sectors (FIG. 31), thereby extending an allowable length of a flaw in the surface of a medium which enables error correction, (H3) the data structure of an even-numbered physical sector differs from that of an odd-numbered physical sector (FIG. 37), which makes a PO inserting method easier, facilitates the extraction of information after error correction, and simplifies the construction of an ECC blocks, (H4) the place in which PO is inserted in an even-numbered recording frame differs from that in an odd-numbered recording frame (FIG. 37), which makes it possible to arrange data ID at the head of a physical sector, and (H5) the small ECC block including data ID in an odd-numbered recording frame differs that in an even-numbered recording frame (they are arranged alternately) (FIG. 84), which improves the data ID reproduction reliability and therefore the access reliability.

Advantage 4. Shortening the Time Required to Access a Recording (Rewriting or Additional Recording) Place:

A recording (rewriting or additional recording) portion is checked in advance on the basis of defect management information. This improves reliability in reproducing the address information.

Points contributing this effect are [J], (K3), [L], (L6); (H5), (H6), (J2), (J3), (J4), (J5), (L5α); (C3α), (C3β), [E], (E1), (E2), (E3), (E4), (E5), (E6), (E7), [H], (H1), (H2), (J1), (J1α), (J2α), (J2β), (J3α), (J3β), (J3γ), (J3δ), (J3ε), (J4α), (J4β), (J4γ), (J4δ), (J4ε), (J5α), (J5β), (J5γ), (J5ε), (J5ζ), (J6); (H3), [N], (N1), (N1α), (N2), (N3), (N4). Specifically, points with a high degree of contribution are [J] address information is recorded in advance by wobble phase modulation (FIG. 64), making the slot interval narrower, which makes it easy to synchronize wobble signals, (K3) if the recording position has shifted, the position is adjusted in the guard area (FIG. 80), which makes it possible to correct the recording timing to the shift in the recording position, [L] the latest RMD is reproduced in reproduction and, after additional recording, the updated RMD is additionally recorded in RMZ (FIGS. 87, 99, 91), which makes it possible to increase the number of times of additional recording in the additional recording and reproduction of recording management data RMD in the last state and which enables high-speed access in reproduction, and (L6) after RMD duplication zone RDZ is reproduced, the recording position of the latest recording management data RMD is searched for (FIG. 108), which facilitates rough search using an RMD duplication zone RDZ and close search in the last border.

Advantage 5. Recording Stable, High-Accuracy Recording Marks:

Points contributing this effect are (G1), (G1α), (G3), (K3); [E], (E1), (E2), (E3), (E4), (E5), (E6), (E7), [J], (J2), (J3), (J4), (J5), [K], (K3α), (K3β), (K3γ), (K3δ), (K3ε), (K3ζ), (K4), (K5); [A], (A1), (A2), (A3), (J2α), (J2β), (J3α), (J3β), (J3γ), (J3δ), (J3ε), (J4α), (J4β), (J4δ), (J4δ), (J4ε), (J5α), (J5β), (J5γ), (J5δ), (J5ε), (J5ζ), (J6), (K1), (K2), (K3). Specifically, points with a high degree of contribution are (G1) using revision information according to the recording speed (FIGS. 23A and 23B) assures the extension of functions to a future high-speed-compatible medium and enables standards to be coped with by a simple method known as revision, (G1α) a different revision number can be set to each of the maximum and minimum values of the recording speed (FIGS. 23A and 23B), expanding the selection range of recording films that can be developed, which makes it possible to supply media which enable higher-speed recording or lower-cost media, (G3) placing optical system condition information at the start position of recording conditions (FIGS. 23A and 23B) makes it possible to determine at high speed whether recording conditions placed just behind are acceptable, and (K3) if the recording position has shifted, the position is adjusted in the guard area (FIG. 80), which makes it possible to correct the recording timing to the shift in the recording position.

Advantage 6. Both of a Low-to-High Recording Film and a High-to-Low Recording Film are Dealt with to Standardize Circuits, which Simplifies Control.

Points contributing this effect are (B3), (G2), [M], (M1); [A], (A1); (M2), (M3); (A2), (A3), [B], (B1), (B2). Specifically, points with a high degree of contribution are (B3) microscopic concavity and convexity are made in a burst cutting area of a Low-to-High film (FIG. 9), causing the detection level in BCA to coincide with that in SYLDI (or making the process easy), (G2) polarity information on recording marks is included in physical format information or R physical format information (FIGS. 23A and 23B), permitting both of a High-to-Low recording film and a Low-to-High recording film, which expands the recording film selection range and realizes high-speed recording and cost reduction, [M] the lower limit of the reflectivity of a High-to-Low recording film is higher than the upper limit of the reflectivity of a Low-to-High recording film (FIG. 83), making it very easy to determine the type of a recording film by just measuring reflectivity, and (M1) the difference between the lower limit of the reflectivity of a High-to-Low recording film and the upper limit of the reflectivity of a Low-to-High recording film is set to 36% (FIG. 83), which assures a high productivity of recording films and facilitates cost reduction.

Advantage 7. A Data Structure is Made Extendable to Increase the Flexibility of a Management Method.

A recording management zone (RMZ) and a test zone (DRTZ) are made extendable, which improve the upper limit of the number of times of additional recording and the upper limit of the number of times of test recording. Setting an extended area increases the frequency of access. Improving the reliability of address information or recording information causes the access reliability to be increased, which eases the burden of controlling the apparatus during access (or the burden of processing errors during access).

Points contributing this effect are [C], (C1), (C3), (C4), (C8), (G1), (L6α), (L7), (L8), (L11α); (C3α), (J5), (J5ζ), (L4), (L6), (L13), (L14); (C3β), (C6), (C7), (C8α), [E], (E1), (E2), (E3), (E4), (E5), (E6), (E7), [H], (H1), (H2), (H3), (H4), (H5), (H6), (J2), (J2β), (J3), (J5α), [K], (K3), [L], (L1), (L1α), (L1β), (L2), (L3), (L4β), (L4β), (L5), (L5α), (L9), (L9α), (L10), (L10α), (L10β), (L11), (L12), (L12α), (L12β), (L12γ), (L13α) (L13β), (L14α), [M] [N], (N1), (N1α), (N2), (N3), (N4); (C2), (C4α), (C5) (J2α), (J5β), (J5γ), (J5δ), (M1), (M2), (M3). Specifically, points with a high degree of contribution are [C] a recording management zone is made extendable (FIGS. 92 and 93), which enables an RMD recording area to be extended and the upper limit of the number of times of additional recording to be increased, (C1) the recording management zone in the first bordered area BRDA#1 is placed in a data lead-in area DTLDI (FIG. 16), thereby sharing the border-in area in the first bordered area with the data lead-in, which makes it possible to use the data area effectively, (C3) an RMD duplication zone RDZ is set in the data lead-in area DTLDI (FIG. 16), causing a part of recording management data RMD to be recorded redundantly, which makes it possible to restore the data in case reproduction is impossible due to defect or the like, (C3α) the last recording management data RMD related to the bordered area is recorded in the RMD duplication zone RDZ (FIG. 16), which makes it possible to use the RMD duplication zone RDZ effectively and increases the number of times of additional recording, (C3β) each time a new RMZ is formed, the last RMD is recorded in the RMD duplication zone RDZ (FIG. 17), which increases the number of times of additional recording onto a recordable information storage medium remarkably, makes it easier to search for the position of the latest RMD, and improves the RMD reliability, (C4) an RDZ lead-in area is placed in the data lead-in area (FIG. 17), which makes it possible to determine whether the information storage medium is immediately after shipment or has been used even once, (C4α) an RDZ lead-in area RDZLI is placed in the RMD duplication zone RDZ (FIG. 17), which makes it possible to shorten the time required to acquire necessary information, (C5) the RDZLI size or RMD size is set to 64 KB (FIG. 17), making it possible to prevent the recording efficiency of RDZLI or RMD from decreasing, (C6) a copy CRMD of RMD is written repeatedly (FIG. 86), which improves the reliability of a copy CRMD of RMD, (C7) updated physical format information is written repeatedly (FIG. 86), which improves the reliability of the updated physical format information, (C8) an R zone is used as an extended recording management zone RMZ (FIG. 103), which increases the number of times of additional recording in the same bordered area remarkably, (G1) using revision information according to the recording speed (FIGS. 23A and 23B) assures the extension of functions to a future high-speed-compatible medium and enables standards to be coped with by a simple method known as revision, (L6α) RMD is used to manage RMZ positions (FIG. 92), which makes it easier to search for RMZ positions using RDZ, (L7) RMD is updated at the time of initialization, R zone reservation or R zone closing, border closing, or recording interruption (FIGS. 89 and 101), which simplifies search control during reproduction and makes it easier to search for a recordable area during additional recording, (L8) when RMZ is filled up or when the remaining reserved area in RMZ is running short, a new RMZ is formed (FIG. 91), which prevents the filled RMZ from making it impossible not only to additionally record the updated RMD but also to do additional recording, and (L11α) an extended drive test zone EDRTZ is also included in a new data lead-out area NDTLDO (FIGS. 119, 120, 18A and 18B), which prevents the information reproducing apparatus from accessing the extended drive test zone EDRTZ erroneously.

Advantage 8. The Interchangeability Between Different Types of Media is Secured, which Helps Simplify an Information Recording and Reproducing Apparatus and an Information Reproducing Apparatus:

When a new recording management zone (RMZ) is set or when a border is closed, a gap in the data is filled with specific data, which assures stable tracking by the DPD method on the information reproducing apparatus. The interchangeability between various types of media are secured in terms of burst cutting area BCA information or physical format information, thereby standardizing control circuits, which helps simplify an information reproducing apparatus and an information recording and reproducing apparatus and reduce costs. At the same time, the stabilization of reproduction of the information recorded there is secured, which further simplifies an information reproducing apparatus and an information recording and reproducing apparatus and reduce costs more.

Points contributing this effect are [A], [B], (B1), [G], [H], (L2), (L10), (L10β), (L11α), [N]; (A1), (A2), (A3), (B2), (B4), [F], (H1), (H2), (H3), (H4), (H5), (H6), (J5ε), (L3); [L], (L1), (L1α), (L1β); (B3). Specifically, points with a high degree of contribution are [A] use of PRML for reproduction in the data area, data lead-in area, and data lead-out area (FIGS. 5 and 9) increases the recording density of an information storage medium and particularly improves the line density, [B] the slice level detecting method is used for reproduction in the system lead-in area and system lead-out area (FIGS. 3 and 9), which secures the interchangeability with the existing DVD and stabilizes reproduction, (B1) the density of each of the system lead-in area and system lead-out area is set lower than that of each of the data lead-in area and data lead-out area (FIGS. 13 to 15), which secures the interchangeability with the existing DVD and stabilizes reproduction, [G] the locations of physical format information are standardized (FIG. 22), which helps standardize and simplify the information reproducing processes in the apparatus, [H] the same data frame is distributed over a plurality of small ECC blocks (FIG. 35), which improves the error correcting capability and therefore the reliability of recorded data, (L2) the reserved area is filled with the last recording management data RMD at the time of closing or of finalization the corresponding bordered area (FIGS. 17 and 85), which assures stable tracking by DPD and improves the reliability of the last recording management data RMD, (L10) RMZ is filled at the time of border closing, PFI is recorded, and border-out area BRDO is recorded (FIG. 94), which assures stable tracking on a reproduce-only apparatus and the process of accessing the recorded information, (L10β) the R zone is filled at the time of border closing (FIG. 97), which prevents the optical head from coming off the track in R zone by DPD, (L11α) when the second or later bordered area BRDA is closed, the latest RMD is copied into RDZ (FIG. 95), making it easier to search for the position of RMZ in the second or later bordered area BRDA, which makes access control easier and more reliable, and [N] data lead-out position identifying information is set on the basis of area type information 935 in data ID (FIGS. 118, 119, and 120), enabling the position of the data lead-out to be known from the data ID immediately after access, which facilitates access control.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. (canceled)

2. An information recording method for recording information in an information storage medium comprising a system lead-in area, a connection area located in an outer side of the system lead-in area, a data lead-in area located in an outer side of the connection area, and a data area located in an outer side of the data lead-in area, wherein the data lead-in area includes a recording management data (RMD) duplication zone which records a latest recording management data (RMD), the method comprising:
recording information in the data area.
